(19) United States
(12) Patent Application Publication
(10) Pub. No.: US 2026/0044668 A1
(43) Pub. Date: Feb. 12, 2026

(54) MANIPULATION OF HANDWRITTEN CONTENT DISPLAYED ON AN ELECTRONIC DEVICE

(71) Applicant: Apple Inc., Cupertino, CA (US)

(72) Inventors: Marisa R. LU, San Francisco, CA (US); Daniel T. PRESTON, San Jose, CA (US); Matthew J. SUNDSTROM, Campbell, CA (US)

(21) Appl. No.: 19/172,138

(22) Filed: Apr. 7, 2025

Related U.S. Application Data
(60) Provisional application No. 63/631,447, filed on Apr. 8, 2024.
(60) Provisional application No. 63/657,047, filed on Jun. 6, 2024.
(60) Provisional application No. 63/662,128, filed on Jun. 20, 2024.

(51) Int. Cl. G06F 40/166; G06F 3/04883

(52) U.S. Cl. CPC G06F 40/166; G06F 3/04883

(57) ABSTRACT

Some embodiments described in this disclosure are directed to facilitating manipulation of handwritten content displayed in a user interface, including deleting a portion of the handwritten content and subsequently reflowing undeleted portions of the handwritten content in the user interface. Some embodiments described in this disclosure are directed to facilitating conversion of handwritten input into handwriting based on a model handwriting. Some embodiments described in this disclosure are directed to pasting stored text on a user interface as handwritten text or font-based text based on the type of input.

### CROSS REFERENCE TO RELATED APPLICATIONS

This application claims the benefit of U.S. Provisional Application No. 63/631,447, filed Apr. 8, 2024, U.S. Provisional Application No. 63/657,047, filed Jun. 6, 2024, and U.S. Provisional Application No. 63/662,128, filed Jun. 20, 2024, the contents of which are herein incorporated by reference in their entireties for all purposes.

### FIELD OF THE DISCLOSURE

This relates generally to electronic devices that interact with input devices, and user interactions with such devices.

### BACKGROUND OF THE DISCLOSURE

User interaction with electronic devices has increased significantly in recent years. These devices can be devices such as computers, tablet computers, televisions, multimedia devices, mobile devices, and the like.

In some circumstances, users wish to interact with an electronic device with an input device such as a stylus. Enhancing these interactions improves the user's experience with the device and decreases user interaction time, which is particularly important where input devices are battery-operated.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

### SUMMARY OF THE DISCLOSURE

Some embodiments described in this disclosure are directed to facilitating manipulation of handwritten content displayed in a user interface, including deleting a portion of the handwritten content and subsequently reflowing undeleted portions of the handwritten content in the user interface. Some embodiments described in this disclosure are directed to facilitating conversion of handwritten input into handwriting based on a model handwriting. Some embodiments described in this disclosure are directed to pasting stored text on a user interface as handwritten text or font-based text based on the type of input.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIGS. 3A-3G is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 5C-5D illustrate exemplary components of a personal electronic device having a touch-sensitive display and intensity sensors in accordance with some embodiments.

FIGS. 5E-5H illustrate exemplary components and user interfaces of a personal electronic device in accordance with some embodiments.

FIG. 5I illustrates a block diagram of an exemplary architectures for devices according to some embodiments.

FIGS. 6A-6FF illustrate exemplary ways in which an electronic device facilitates manipulation of handwritten content in accordance with some embodiments.

FIG. 7 is a flowchart illustrating a method for facilitating manipulation of handwritten content in accordance with some embodiments.

FIGS. 8A-8R illustrate various examples of the operation of an electronic device that converts handwritten input into handwriting based on a model handwriting in accordance with some embodiments.

FIG. 9 is a flowchart illustrating a method for converting handwritten input into handwriting based on a model handwriting in accordance with some embodiments.

FIGS. 10A-ION illustrate various examples of the operation of electronic device that pastes stored text on a user interface as handwritten text or font-based text based on the type of input in accordance with some embodiments.

FIG. 11 is a flowchart illustrating a method for pasting stored text on a user interface as handwritten text or font-based text based on the type of input in accordance with some embodiments.

### DETAILED DESCRIPTION

In the following description of embodiments, reference is made to the accompanying drawings which form a part hereof, and in which it is shown by way of illustration specific embodiments that are optionally practiced. It is to be understood that other embodiments are optionally used, and structural changes are optionally made without departing from the scope of the disclosed embodiments.

Some embodiments described in this disclosure are directed to facilitating manipulation of handwritten content displayed in a user interface, including deleting a portion of the handwritten content and subsequently reflowing undeleted portions of the handwritten content in the user interface. Some embodiments described in this disclosure are directed to facilitating conversion of handwritten input into handwriting based on a model handwriting. Some embodiments described in this disclosure are directed to pasting stored text on a user interface as handwritten text or font-based text based on the type of input.

Although the following description uses terms “first,” “second,” etc. to describe various elements, these elements should not be limited by the terms. These terms are only used to distinguish one element from another. For example, a first touch could be termed a second touch, and, similarly, a second touch could be termed a first touch, without departing from the scope of the various described embodiments. The first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context. EXEMPLARY DEVICES

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touch pads), are, optionally, used. It should also be understood that, in some embodiments, the device is not a portable communications device, but is a desktop computer or a television with a touch-sensitive surface (e.g., a touch screen display and/or a touch pad). In some embodiments, the device does not have a touch screen display and/or a touch pad, but rather is capable of outputting display information (such as the user interfaces of the disclosure) for display on a separate display device, and capable of receiving input information from a separate input device having one or more input mechanisms (such as one or more buttons, a touch screen display and/or a touch pad). In some embodiments, the device has a display, but is capable of receiving input information from a separate input device having one or more input mechanisms (such as one or more buttons, a touch screen display and/or a touch pad). In some embodiments, the electronic device is a computer system that is in communication (e.g., via wireless communication, via wired communication) with a display generation component (e.g., a display device such as a head-mounted device (HMD), a display, a projector, a touch-sensitive display, or other device or component that presents visual content to a user, for example, on or in the display generation component itself or produced from the display generation component and visible elsewhere). The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse and/or a joystick. Further, as described above, it should be understood that the described electronic device, display and touch-sensitive surface are optionally distributed amongst two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

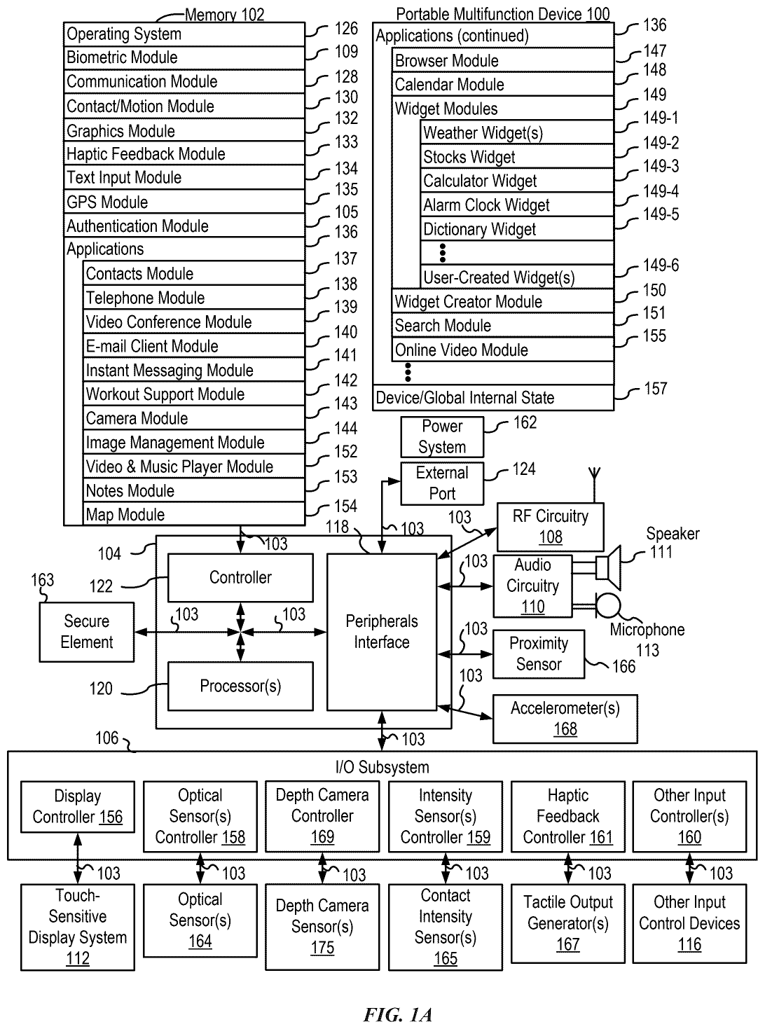

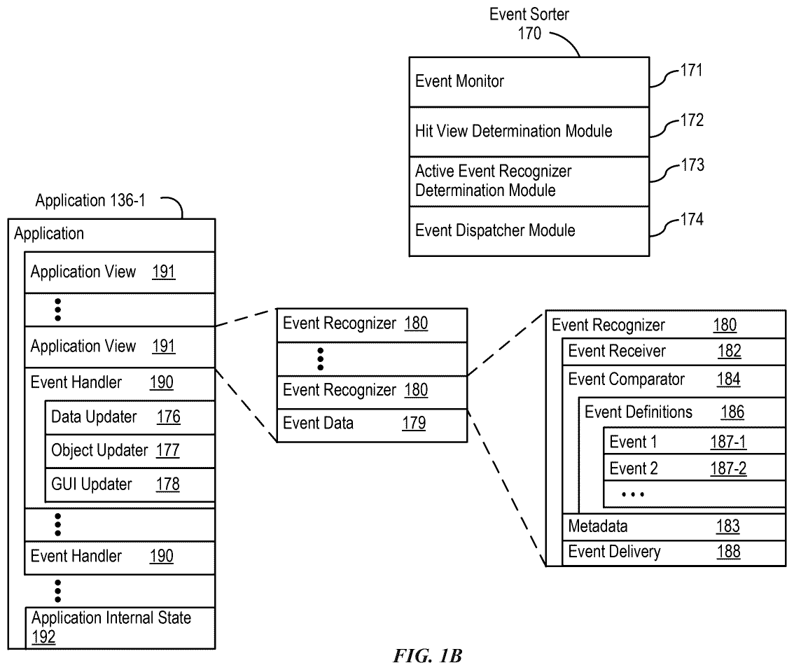

Attention is now directed toward embodiments of portable or non-portable devices with touch-sensitive displays, though the devices need not include touch-sensitive displays or displays in general, as described above. FIG. 1A is a block diagram illustrating portable or non-portable multifunction device 100 with touch-sensitive displays 112 in accordance with some embodiments. Touch-sensitive display 112 is sometimes called a “touch screen” for convenience, and is sometimes known as or called a touch-sensitive display system. Device 100 includes memory 102 (which optionally includes one or more computer readable storage mediums), memory controller 122, one or more processing units (CPU's) 120, peripherals interface 118, RF circuitry 108, audio circuitry 110, speaker 111, microphone 113, input/output (I/O) subsystem 106, other input or control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as a “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable or non-portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application specific integrated circuits. Further, the various components shown in FIG. 1A are optionally implemented across two or more devices; for example, a display and audio circuitry on a display device, a touch-sensitive surface on an input device, and remaining components on device 100. In such an embodiment, device 100 optionally communicates with the display device and/or the input device to facilitate operation of the system, as described in the disclosure, and the various components described herein that relate to display and/or input remain in device 100, or are optionally included in the display and/or input device, as appropriate.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs and/or sets of instructions stored in memory 102 to perform various functions for device 100 and to process data.

In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

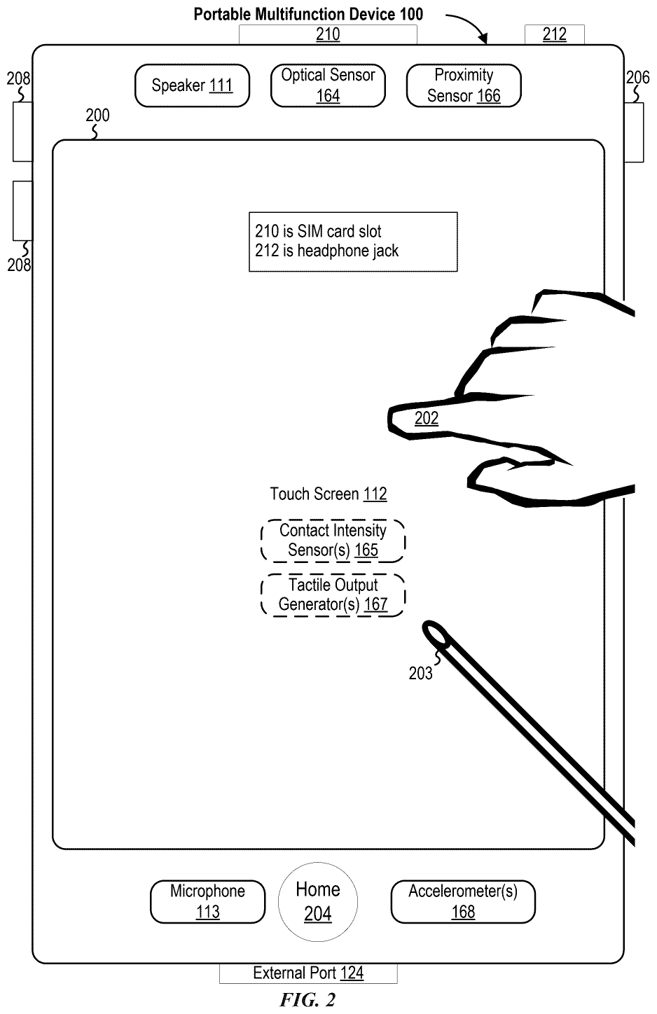

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, intensity sensor controller 159, haptic feedback controller 161 and one or more input controllers 160 for other input or control devices. The one or more input controllers 160 receive/send electrical signals from/to other input or control devices 116. The other input control devices 116 optionally include physical buttons (e.g., push buttons, rocker buttons, etc.), dials, slider switches, joysticks, click wheels, and so forth. In some alternate embodiments, input controller(s) 160 are, optionally, coupled to any (or none) of the following: a keyboard, infrared port, USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. As described above, the touch-sensitive operation and the display operation of touch-sensitive display 112 are optionally separated from each other, such that a display device is used for display purposes and a touch-sensitive surface (whether display or not) is used for input detection purposes, and the described components and functions are modified accordingly. However, for simplicity, the following description is provided with reference to a touch-sensitive display. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output corresponds to user-interface objects.

Touch screen 112 has a touch-sensitive surface, sensor or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone®, iPod Touch®, and iPad® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad (not shown) for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable or non-portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112 which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112 which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer (not shown) and a GPS (or GLONASS or other global navigation system) receiver (not shown) for obtaining information concerning the location and orientation (e.g., portrait or landscape) of device 100.

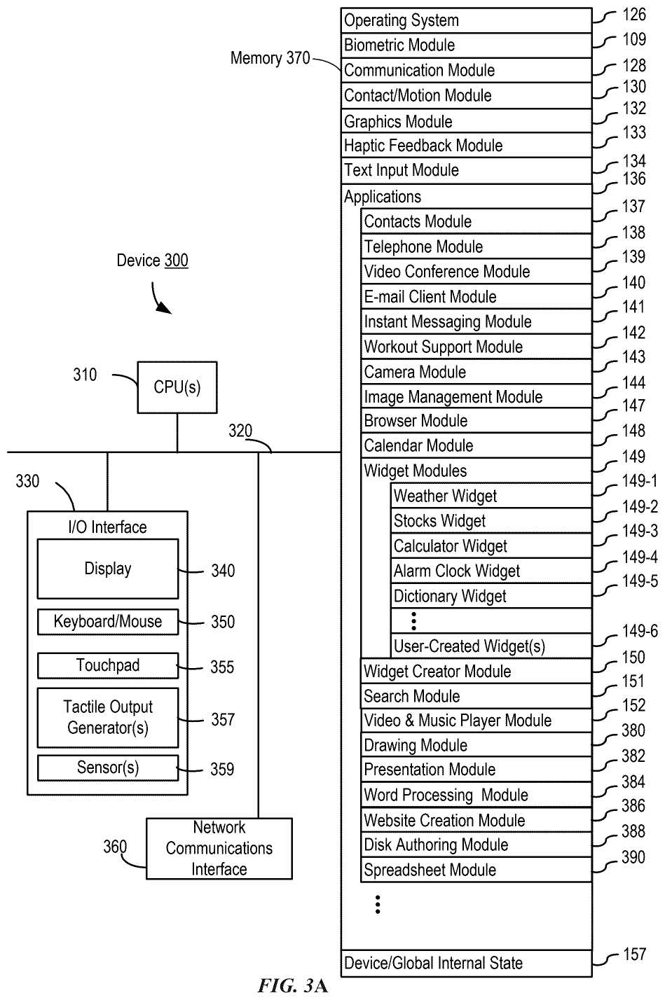

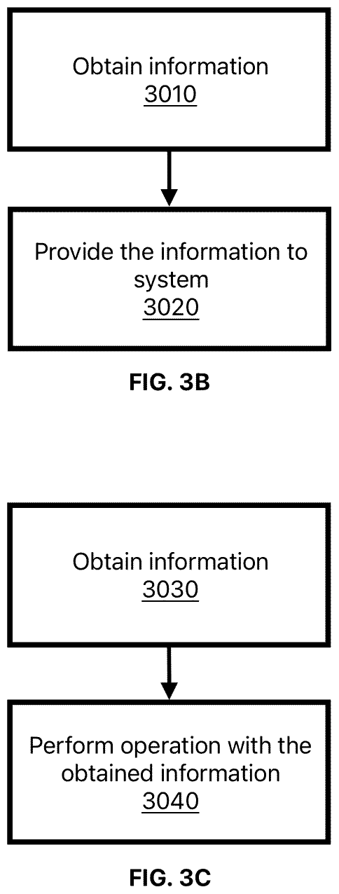

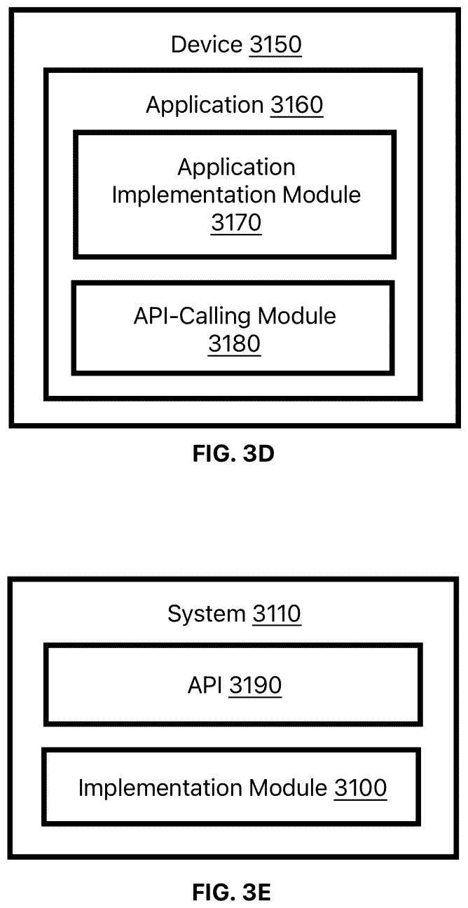

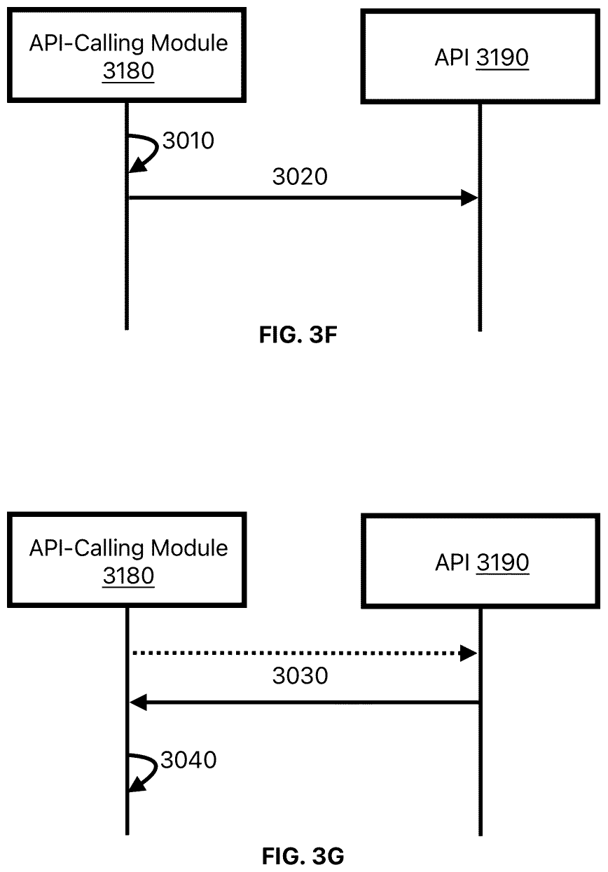

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3A) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, iOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used on iPod (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact) determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast or other visual property) of graphics that are displayed. As used herein, the term “graphics” includes any object that can be displayed to a user, including without limitation text, web pages, icons (such as user-interface objects including soft keys), digital images, videos, animations and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing, to camera 143 as picture/video metadata, and to applications that provide location-based services such as weather widgets, local yellow page widgets, and map/navigation widgets).

Applications 136 optionally include the following modules (or sets of instructions), or a subset or superset thereof:
contacts module 137 (sometimes called an address book or contact list);
telephone module 138;
video conferencing module 139;
e-mail client module 140;
instant messaging (IM) module 141;
workout support module 142;
camera module 143 for still and/or video images;
image management module 144;
video player module;
music player module;
browser module 147;
calendar module 148;
widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
widget creator module 150 for making user-created widgets 149-6;
search module 151;
video and music player module 152, which merges video player module and music player module;
notes module 153;
map module 154; and/or
online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo!Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs, procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3A) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit (not shown) or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (187) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable or non-portable multifunction device 100 having a touch screen 112 in accordance with some embodiments. As stated above, multifunction device 100 is described as having the various illustrated structures (such as touch screen 112, speaker 111, accelerometer 168, microphone 113, etc.); however, it is understood that these structures optionally reside on separate devices. For example, display-related structures (e.g., display, speaker, etc.) and/or functions optionally reside on a separate display device, input-related structures (e.g., touch-sensitive surface, microphone, accelerometer, etc.) and/or functions optionally reside on a separate input device, and remaining structures and/or functions optionally reside on multifunction device 100.

The touch screen 112 optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward) and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also includes one or more physical buttons, such as “home” or menu button 204. As previously described, menu button 204 is, optionally, used to navigate to any application 136 in a set of applications that are, optionally executed on device 100. Alternatively, in some embodiments, the menu button is implemented as a soft key in a GUI displayed on touch screen 112.

In one embodiment, device 100 includes touch screen 112, menu button 204, push button 206 for powering the device on/off and locking the device, volume adjustment button(s) 208, Subscriber Identity Module (SIM) card slot 210, head set jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3A is a block diagram of an exemplary multifunction device with a display and a touch-sensitive surface in accordance with some embodiments. Device 300 need not include the display and the touch-sensitive surface, as described above, but rather, in some embodiments, optionally communicates with the display and the touch-sensitive surface on other devices. Additionally, device 300 need not be portable. In some embodiments, device 300 is a laptop computer, a desktop computer, a tablet computer, a multimedia player device (such as a television or a set-top box), a navigation device, an educational device (such as a child's learning toy), a gaming system, or a control device (e.g., a home or industrial controller). Device 300 typically includes one or more processing units (CPU's) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable or non-portable multifunction device 100 (FIG. 1A), or a subset thereof. Furthermore, memory 370 optionally stores additional programs, modules, and data structures not present in memory 102 of portable or non-portable multifunction device 100. For example, memory 370 of device 300 optionally stores drawing module 380, presentation module 382, word processing module 384, website creation module 386, disk authoring module 388, and/or spreadsheet module 390, while memory 102 of portable or non-portable multifunction device 100 (FIG. 1A) optionally does not store these modules.

Each of the above identified elements in FIG. 3A are, optionally, stored in one or more of the previously mentioned memory devices. Each of the above identified modules corresponds to a set of instructions for performing a function described above. The above identified modules or programs (e.g., sets of instructions) need not be implemented as separate software programs, procedures or modules, and thus various subsets of these modules are, optionally, combined or otherwise re-arranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

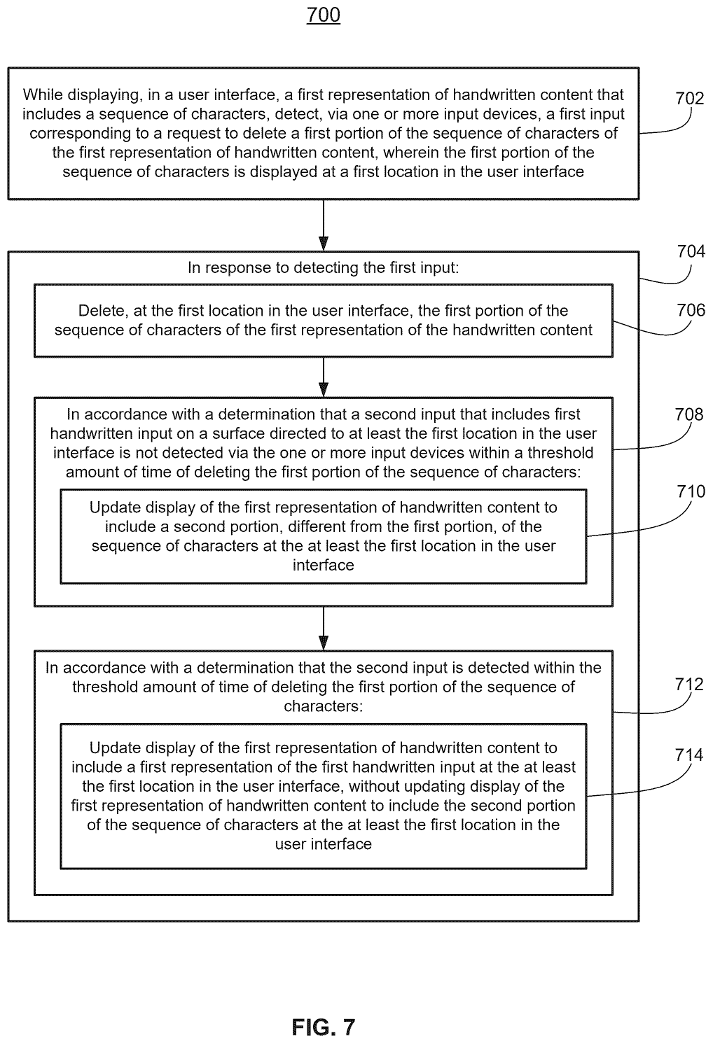

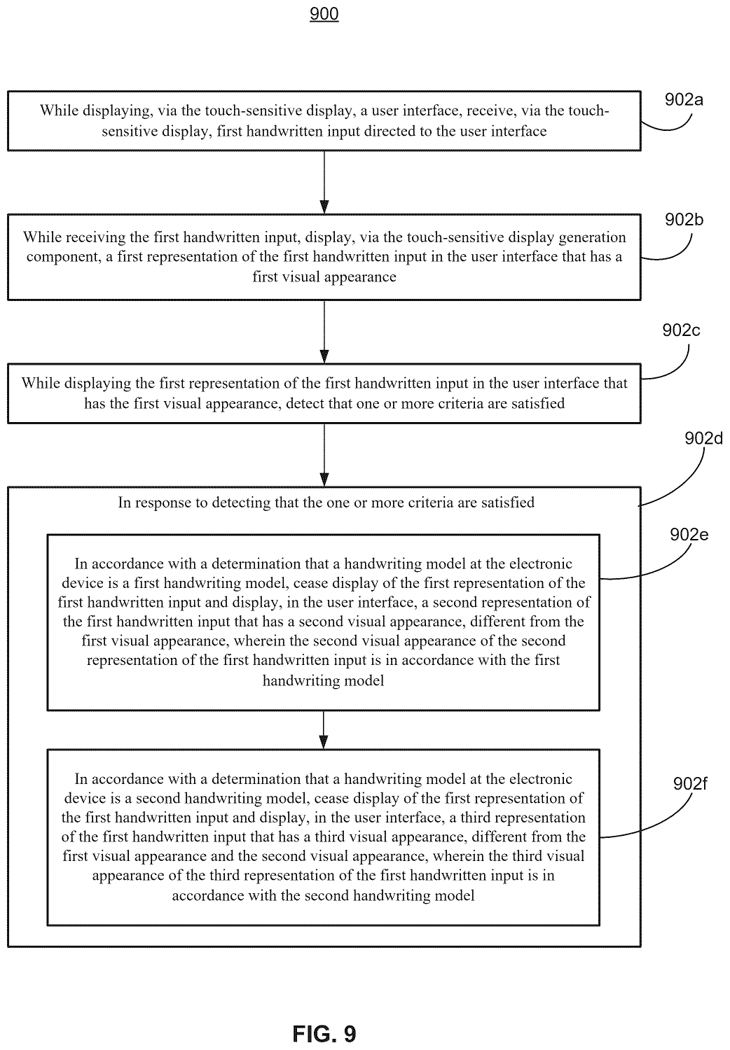

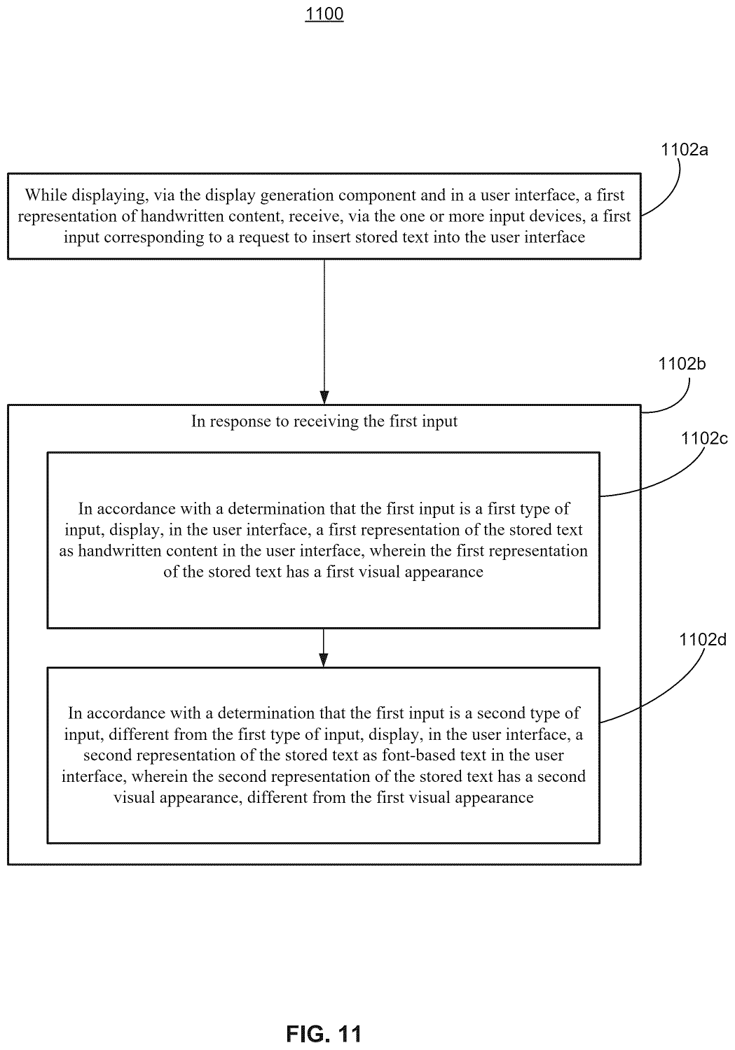

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform methods 700 (FIG. 7), 900 (FIG. 9), and/or 1100 (FIG. 11) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module) to access and use one or more functions, methods, procedures, data structures, classes, and/or other services provided by an implementation module of the system process. The API can define one or more parameters that are passed between the API-calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces that are, optionally, implemented on, for example, portable multifunction device 100.

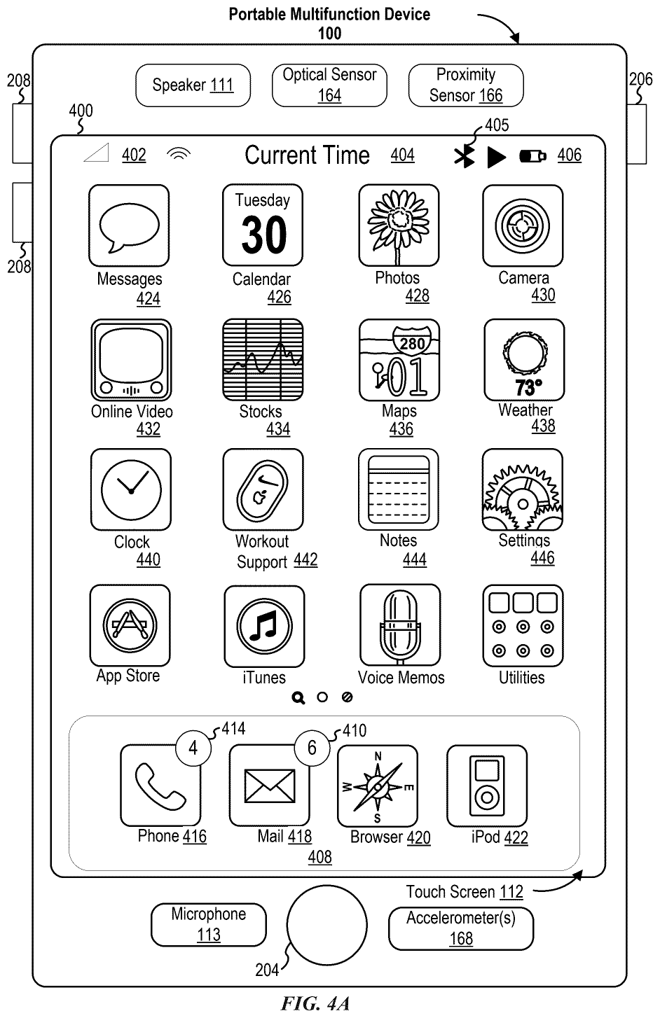

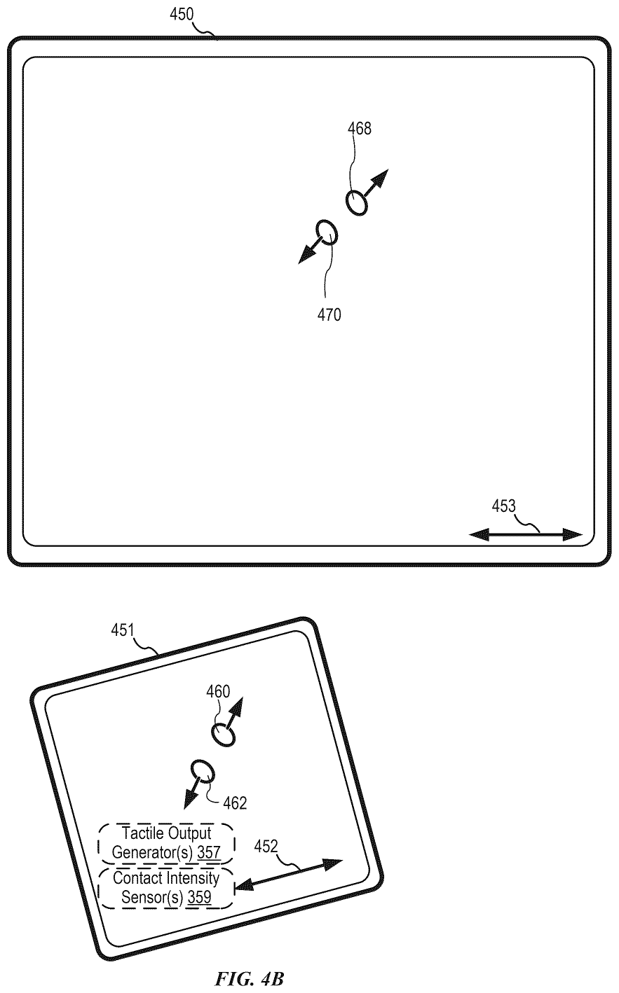

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3A) with a touch-sensitive surface 451 (e.g., a tablet or touchpad 355, FIG. 3A) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

As used herein, the term “focus selector” refers to an input element that indicates a current part of a user interface with which a user is interacting. In some implementations that include a cursor or other location marker, the cursor acts as a “focus selector,” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider or other user interface element), the particular user interface element is adjusted in accordance with the detected input. In some implementations that include a touch-screen display (e.g., touch-sensitive display system 112 in FIG. 1A) that enables direct interaction with user interface elements on the touch-screen display, a detected contact on the touch-screen acts as a “focus selector,” so that when an input (e.g., a press input by the contact) is detected on the touch-screen display at a location of a particular user interface element (e.g., a button, window, slider or other user interface element), the particular user interface element is adjusted in accordance with the detected input. In some implementations focus is moved from one region of a user interface to another region of the user interface without corresponding movement of a cursor or movement of a contact on a touch-screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch-screen display) that is controlled by the user so as to communicate the user's intended interaction with the user interface (e.g., by indicating, to the device, the element of the user interface with which the user is intending to interact). For example, the location of a focus selector (e.g., a cursor, a contact or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90% or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the description of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

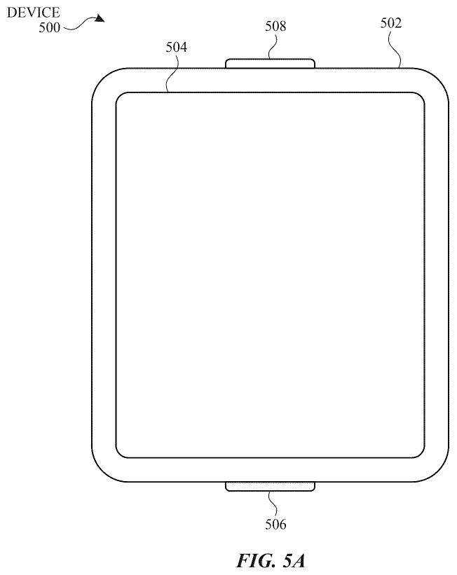

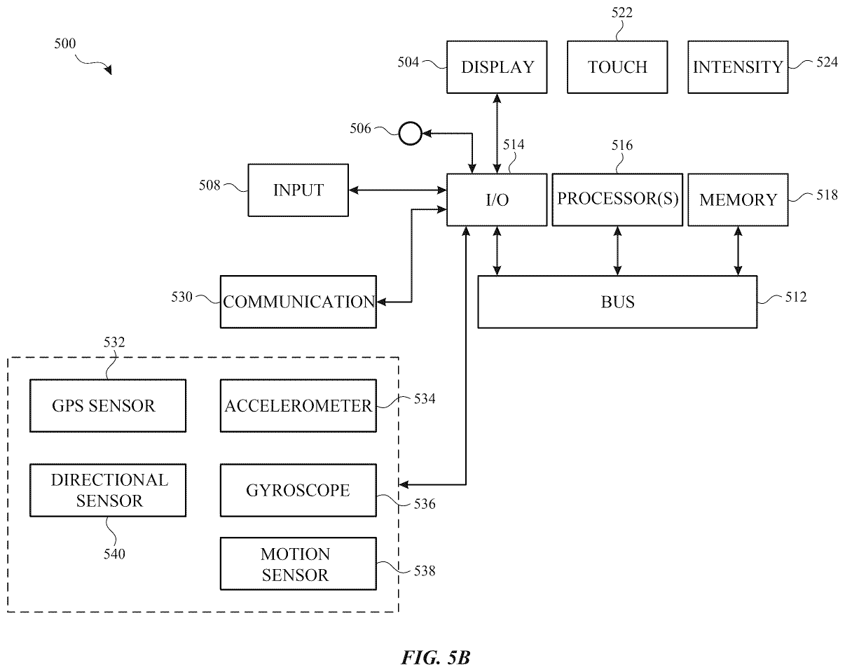

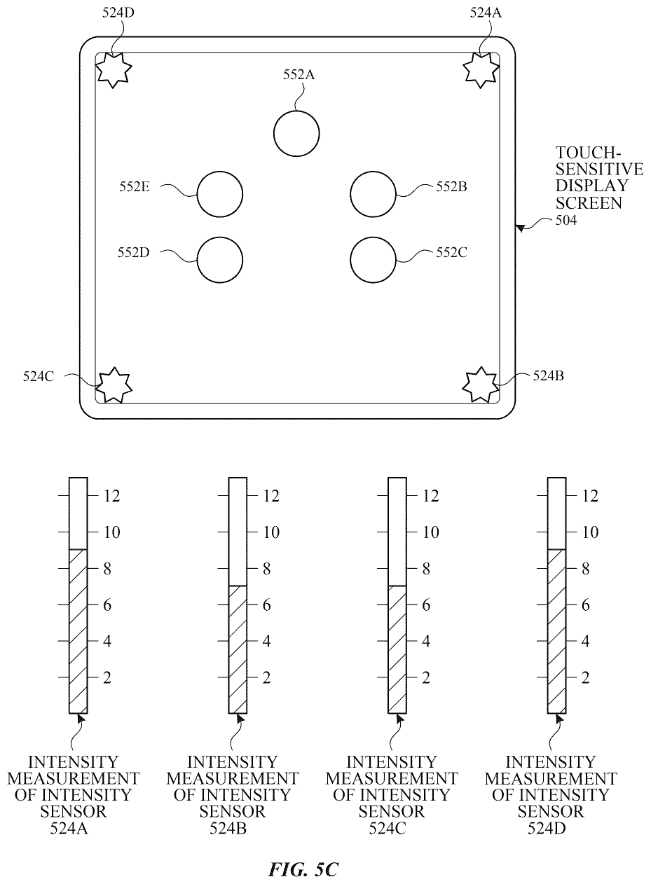

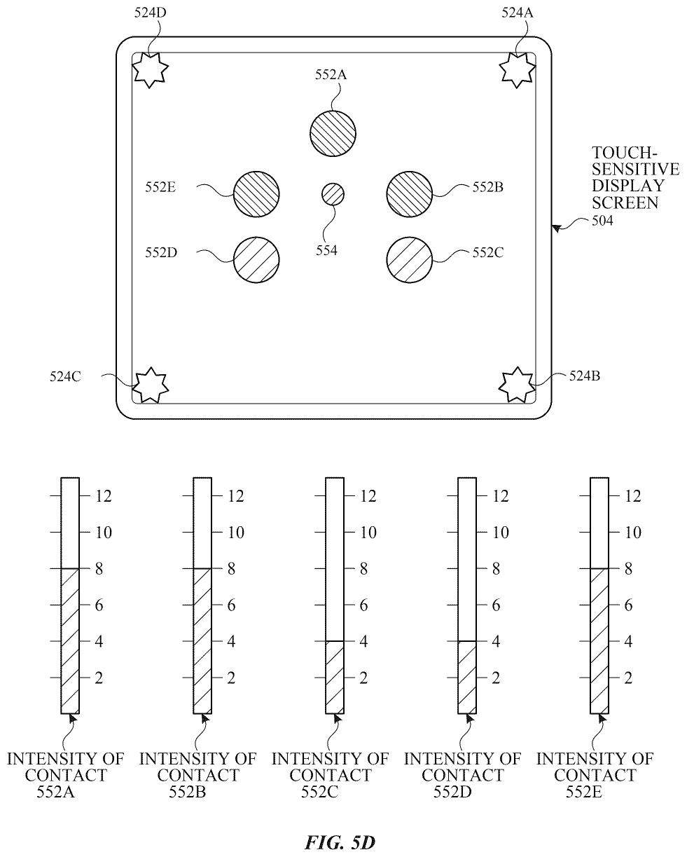

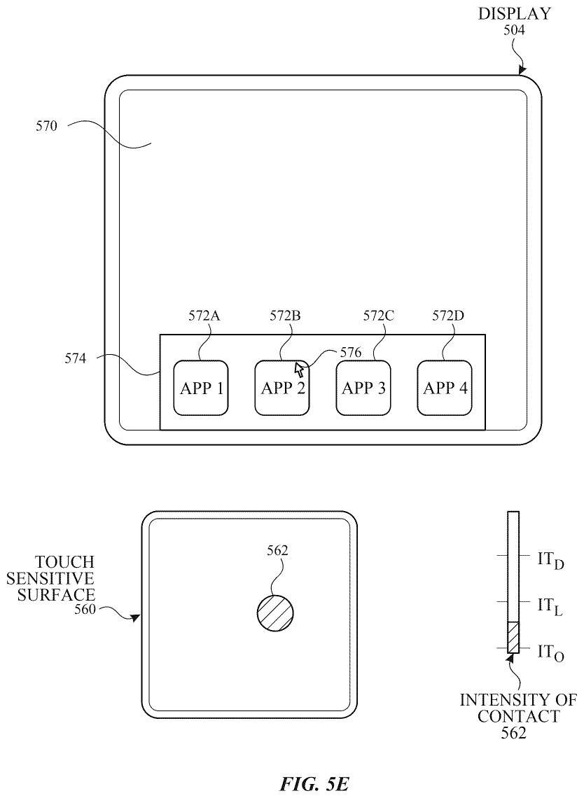

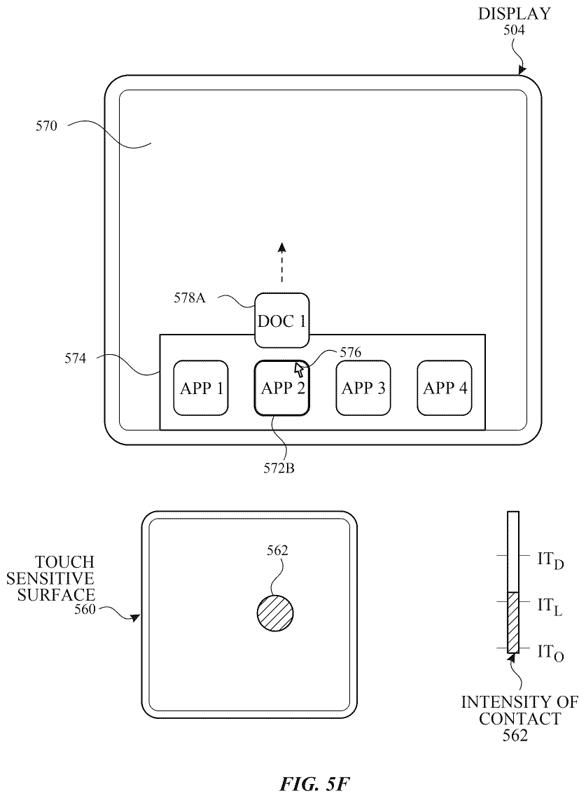

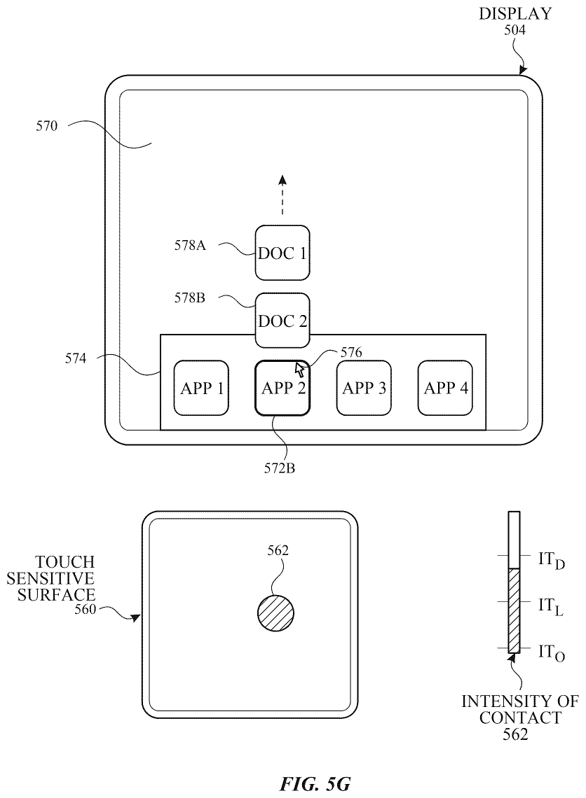

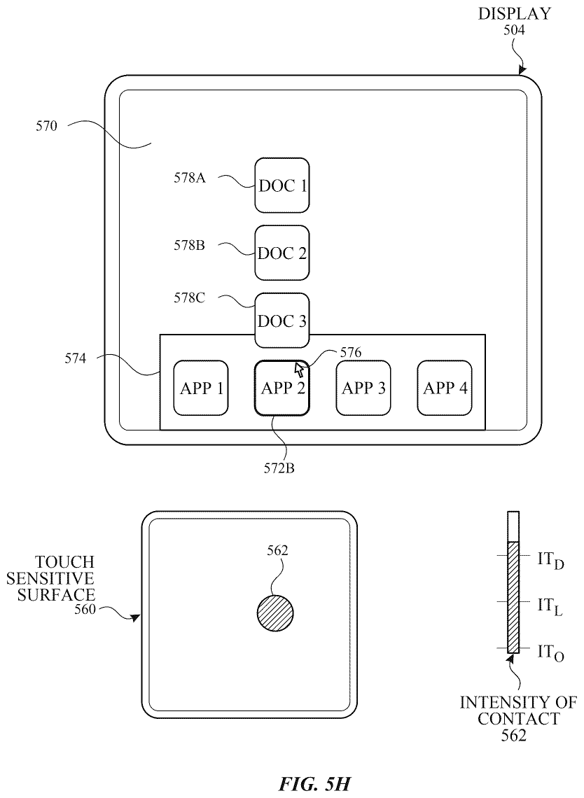

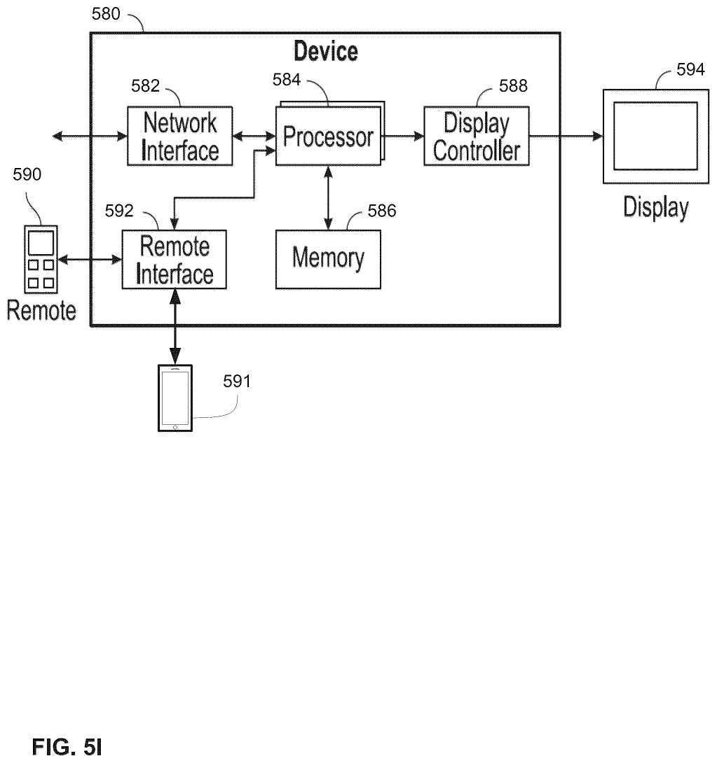

FIG. 5A illustrates a block diagram of an exemplary architecture for the device 500 according to some embodiments of the disclosure. In the embodiment of FIG. 5A, media or other content is optionally received by device 500 via network interface 502, which is optionally a wireless or wired connection. The one or more processors 516 optionally execute any number of programs stored in memory 506 or storage, which optionally includes instructions to perform one or more of the methods and/or processes described herein (e.g., methods 700, 900, 1100, and/or 1200). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIGS. 5, but can include other or additional components in multiple configurations.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

FIG. 5C illustrates detecting a plurality of contacts 552A-552E on touch-sensitive display screen 504 with a plurality of intensity sensors 524A-524D. FIG. 5C additionally includes intensity diagrams that show the current intensity measurements of the intensity sensors 524A-524D relative to units of intensity. In this example, the intensity measurements of intensity sensors 524A and 524D are each 9 units of intensity, and the intensity measurements of intensity sensors 524B and 524C are each 7 units of intensity. In some implementations, an aggregate intensity is the sum of the intensity measurements of the plurality of intensity sensors 524A-524D, which in this example is 32 intensity units. In some embodiments, each contact is assigned a respective intensity that is a portion of the aggregate intensity. FIG. 5D illustrates assigning the aggregate intensity to contacts 552A-552E based on their distance from the center of force 554. In this example, each of contacts 552A, 552B, and 552E are assigned an intensity of contact of 8 intensity units of the aggregate intensity, and each of contacts 552C and 552D are assigned an intensity of contact of 4 intensity units of the aggregate intensity. More generally, in some implementations, each contact j is assigned a respective intensity Ij that is a portion of the aggregate intensity, A, in accordance with a predefined mathematical function, Ij=A·(Dj/ΣDi), where Dj is the distance of the respective contact j to the center of force, and ΣDi is the sum of the distances of all the respective contacts (e.g., i=1 to last) to the center of force. The operations described with reference to FIGS. 5C-5D can be performed using an electronic device similar or identical to device 100, 300, or 500. In some embodiments, a characteristic intensity of a contact is based on one or more intensities of the contact. In some embodiments, the intensity sensors are used to determine a single characteristic intensity (e.g., a single characteristic intensity of a single contact). It should be noted that the intensity diagrams are not part of a displayed user interface, but are included in FIGS. 5C-5D to aid the reader.

In some embodiments, a portion of a gesture is identified for purposes of determining a characteristic intensity. For example, a touch-sensitive surface optionally receives a continuous swipe contact transitioning from a start location and reaching an end location, at which point the intensity of the contact increases. In this example, the characteristic intensity of the contact at the end location is, optionally, based on only a portion of the continuous swipe contact, and not the entire swipe contact (e.g., only the portion of the swipe contact at the end location). In some embodiments, a smoothing algorithm is, optionally, applied to the intensities of the swipe contact prior to determining the characteristic intensity of the contact. For example, the smoothing algorithm optionally includes one or more of: an unweighted sliding-average smoothing algorithm, a triangular smoothing algorithm, a median filter smoothing algorithm, and/or an exponential smoothing algorithm. In some circumstances, these smoothing algorithms eliminate narrow spikes or dips in the intensities of the swipe contact for purposes of determining a characteristic intensity.

The intensity of a contact on the touch-sensitive surface is, optionally, characterized relative to one or more intensity thresholds, such as a contact-detection intensity threshold, a light press intensity threshold, a deep press intensity threshold, and/or one or more other intensity thresholds. In some embodiments, the light press intensity threshold corresponds to an intensity at which the device will perform operations typically associated with clicking a button of a physical mouse or a trackpad. In some embodiments, the deep press intensity threshold corresponds to an intensity at which the device will perform operations that are different from operations typically associated with clicking a button of a physical mouse or a trackpad. In some embodiments, when a contact is detected with a characteristic intensity below the light press intensity threshold (e.g., and above a nominal contact-detection intensity threshold below which the contact is no longer detected), the device will move a focus selector in accordance with movement of the contact on the touch-sensitive surface without performing an operation associated with the light press intensity threshold or the deep press intensity threshold. Generally, unless otherwise stated, these intensity thresholds are consistent between different sets of user interface figures.

An increase of characteristic intensity of the contact from an intensity below the light press intensity threshold to an intensity between the light press intensity threshold and the deep press intensity threshold is sometimes referred to as a “light press” input. An increase of characteristic intensity of the contact from an intensity below the deep press intensity threshold to an intensity above the deep press intensity threshold is sometimes referred to as a “deep press” input. An increase of characteristic intensity of the contact from an intensity below the contact-detection intensity threshold to an intensity between the contact-detection intensity threshold and the light press intensity threshold is sometimes referred to as detecting the contact on the touch-surface. A decrease of characteristic intensity of the contact from an intensity above the contact-detection intensity threshold to an intensity below the contact-detection intensity threshold is sometimes referred to as detecting liftoff of the contact from the touch-surface. In some embodiments, the contact-detection intensity threshold is zero. In some embodiments, the contact-detection intensity threshold is greater than zero.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

FIGS. 5E-5H illustrate detection of a gesture that includes a press input that corresponds to an increase in intensity of a contact 562 from an intensity below a light press intensity threshold (e.g., “IT”) in FIG. 5E, to an intensity above a deep press intensity threshold (e.g., “IT_{D}”) in FIG. 5H. The gesture performed with contact 562 is detected on touch-sensitive surface 560 while cursor 576 is displayed over application icon 572B corresponding to App 2, on a displayed user interface 570 that includes application icons 572A-572D displayed in predefined region 574. In some embodiments, the gesture is detected on touch-sensitive display 504. The intensity sensors detect the intensity of contacts on touch-sensitive surface 560. The device determines that the intensity of contact 562 peaked above the deep press intensity threshold (e.g., “IT_{D}”). Contact 562 is maintained on touch-sensitive surface 560. In response to the detection of the gesture, and in accordance with contact 562 having an intensity that goes above the deep press intensity threshold (e.g., “IT_{D}”) during the gesture, reduced-scale representations 578A-578C (e.g., thumbnails) of recently opened documents for App 2 are displayed, as shown in FIGS. 5F-5H. In some embodiments, the intensity, which is compared to the one or more intensity thresholds, is the characteristic intensity of a contact. It should be noted that the intensity diagram for contact 562 is not part of a displayed user interface, but is included in FIGS. 5E-5H to aid the reader.

In some embodiments, the display of representations 578A-578C includes an animation. For example, representation 578A is initially displayed in proximity of application icon 572B, as shown in FIG. 5F. As the animation proceeds, representation 578A moves upward and representation 578B is displayed in proximity of application icon 572B, as shown in FIG. 5G. Then, representations 578A moves upward, 578B moves upward toward representation 578A, and representation 578C is displayed in proximity of application icon 572B, as shown in FIG. 5H. Representations 578A-578C form an array above icon 572B. In some embodiments, the animation progresses in accordance with an intensity of contact 562, as shown in FIGS. 5F-5G, where the representations 578A-578C appear and move upwards as the intensity of contact 562 increases toward the deep press intensity threshold (e.g., “IT_{D}”). In some embodiments, the intensity, on which the progress of the animation is based, is the characteristic intensity of the contact. The operations described with reference to FIGS. 5E-5H can be performed using an electronic device similar or identical to device 100, 300, or 500.

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90%, or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the descriptions of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

Attention is now directed towards embodiments of user interfaces (“UI”) and associated processes that are implemented on an electronic device, such as portable multifunction device 100, device 300, or device 500.

### User Interfaces and Associated Processes

As described herein, content is automatically generated by one or more computers in response to a request to generate the content. The automatically-generated content is optionally generated on-device (e.g., generated at least in part by a computer system at which a request to generate the content is received) and/or generated off-device (e.g., generated at least in part by one or more nearby computers that are available via a local network or one or more computers that are available via the internet). This automatically-generated content optionally includes visual content (e.g., images, graphics, and/or video), audio content, and/or text content.

In some embodiments, novel automatically-generated content that is generated via one or more artificial intelligence (AI) processes is referred to as generative content (e.g., generative images, generative graphics, generative video, generative audio, and/or generative text). Generative content is typically generated by an AI process based on a prompt that is provided to the AI process. An AI process typically uses one or more AI models to generate an output based on an input. An AI process optionally includes one or more pre-processing steps to adjust the input before it is used by the AI model to generate an output (e.g., adjustment to a user-provided prompt, creation of a system-generated prompt, and/or AI model selection). An AI process optionally includes one or more post-processing steps to adjust the output by the AI model (e.g., passing AI model output to a different AI model, upscaling, downscaling, cropping, formatting, and/or adding or removing metadata) before the output of the AI model used for other purposes such as being provided to a different software process for further processing or being presented (e.g., visually or audibly) to a user. An AI process that generates generative content is sometimes referred to as a generative AI process.

A prompt for generating generative content can include one or more of: one or more words (e.g., a natural language prompt that is written or spoken), one or more images, one or more drawings, and/or one or more videos. AI processes can include machine learning models including neural networks. Neural networks can include transformer-based deep neural networks such as large language models (LLMs). Generative pre-trained transformer models are a type of LLM that can be effective at generating novel generative content based on a prompt. Some AI processes use a prompt that includes text to generate either different generative text, generative audio content, and/or generative visual content. Some AI processes use a prompt that includes visual content and/or an audio content to generate generative text (e.g., a transcription of audio and/or a description of the visual content). Some multi-modal AI processes use a prompt that includes multiple types of content (e.g., text, images, audio, video, and/or other sensor data) to generate generative content. A prompt sometimes also includes values for one or more parameters indicating an importance of various parts of the prompt. Some prompts include a structured set of instructions that can be understood by an AI process that include phrasing, a specified style, relevant context (e.g., starting point content and/or one or more examples), and/or a role for the AI process.

Generative content is generally based on the prompt but is not deterministically selected from pre-generated content and is, instead, generated using the prompt as a starting point. In some embodiments, pre-existing content (e.g., audio, text, and/or visual content) is used as part of the prompt for creating generative content (e.g., the pre-existing content is used as a starting point for creating the generative content). For example, a prompt could request that a block of text be summarized or rewritten in a different tone, and the output would be generative text that is summarized or written in the different tone. Similarly a prompt could request that visual content be modified to include or exclude content specified by a prompt (e.g., removing an identified feature in the visual content, adding a feature to the visual content that is described in a prompt, changing a visual style of the visual content, and/or creating additional visual elements outside of a spatial or temporal boundary of the visual content that are based on the visual content). In some embodiments, a random or pseudo-random seed is used as part of the prompt for creating generative content (e.g., the random or pseud-random seed content is used as a starting point for creating the generative content). For example when generating an image from a diffusion model, a random noise pattern is iteratively denoised based on the prompt to generate an image that is based on the prompt. While specific types of AI processes have been described herein, it should be understood that a variety of different AI processes could be used to generate generative content based on a prompt.

### Reflow of Handwritten Content

Users interact with electronic devices in many different manners, including using peripheral devices in communication with such devices. In some embodiments, an electronic device receives indications of a peripheral device (e.g., a stylus) contacting a surface, such as a touch-sensitive surface in communication with the electronic device, directed to handwritten content displayed on the electronic device. The embodiments described herein provide ways in which the electronic device responds to such indications and, for example, facilitating deletion of portions of the handwritten content and subsequent reflow of undeleted portions of the handwritten content, thus enhancing interactions with the device. Enhancing interactions with a device reduces the amount of time needed by a user to perform operations, and thus reduces the power usage of the device and increases battery life for battery-powered devices. It is understood that people use devices. When a person uses a device, that person is optionally referred to as a user of the device.

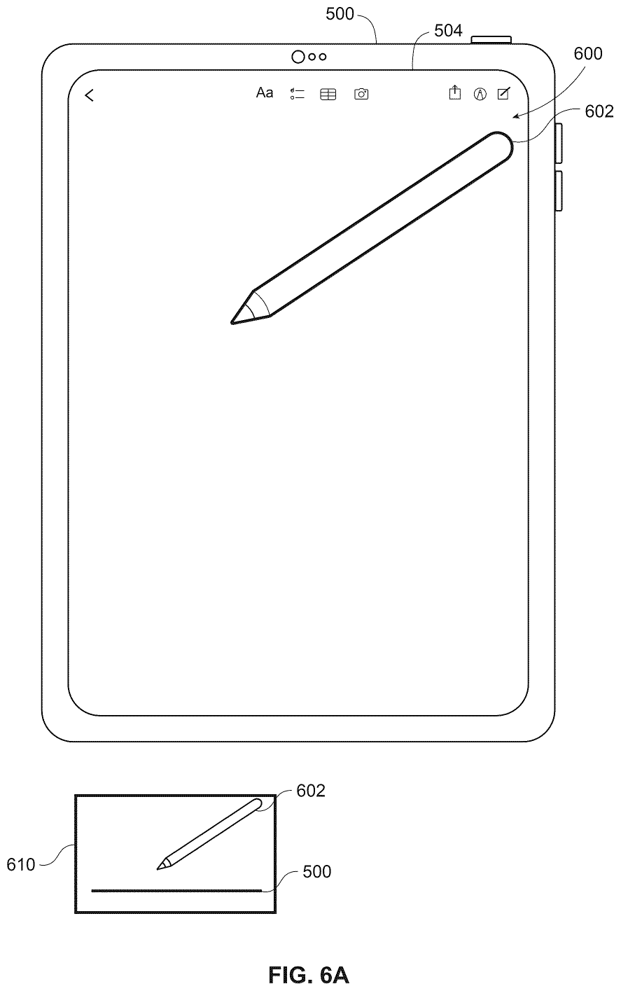

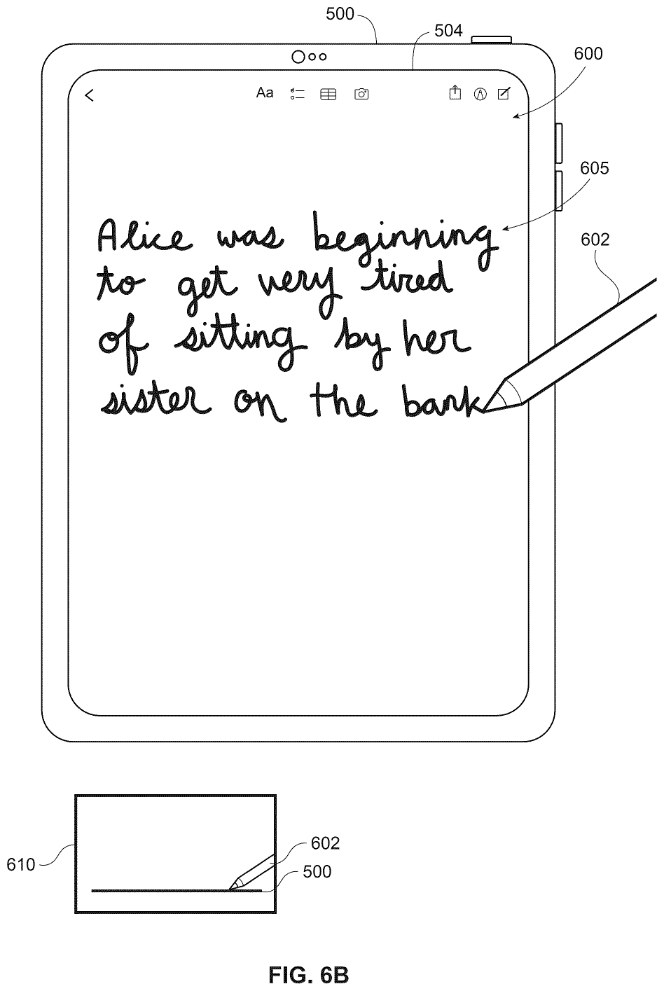

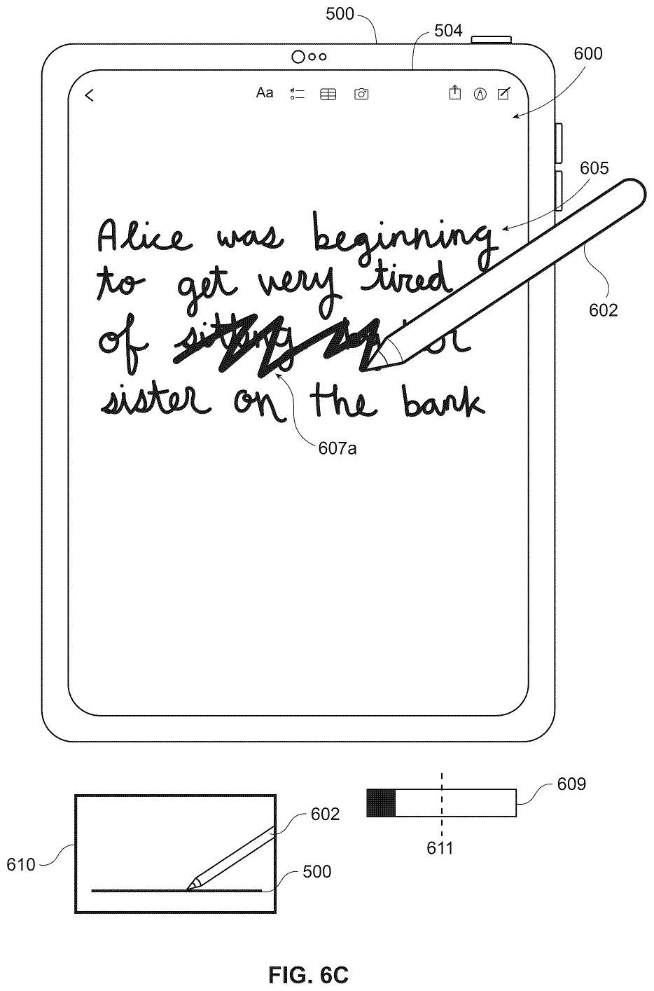

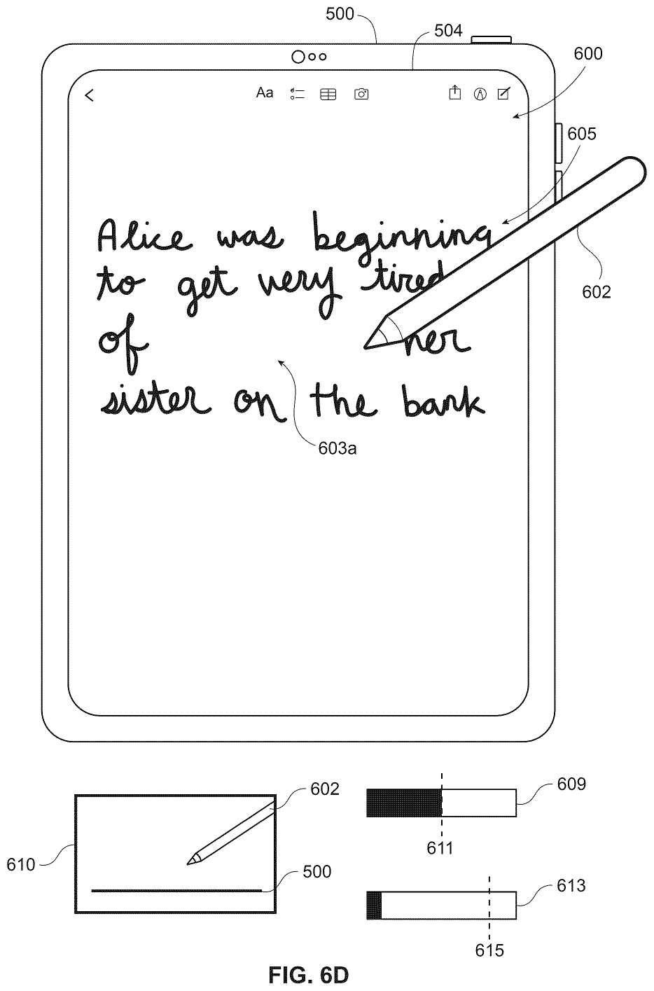

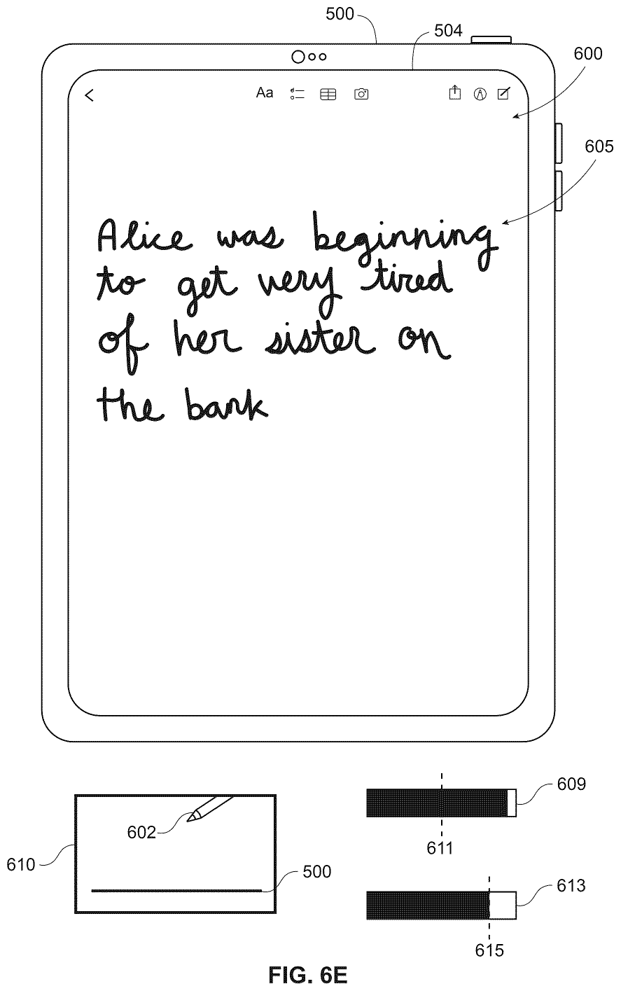

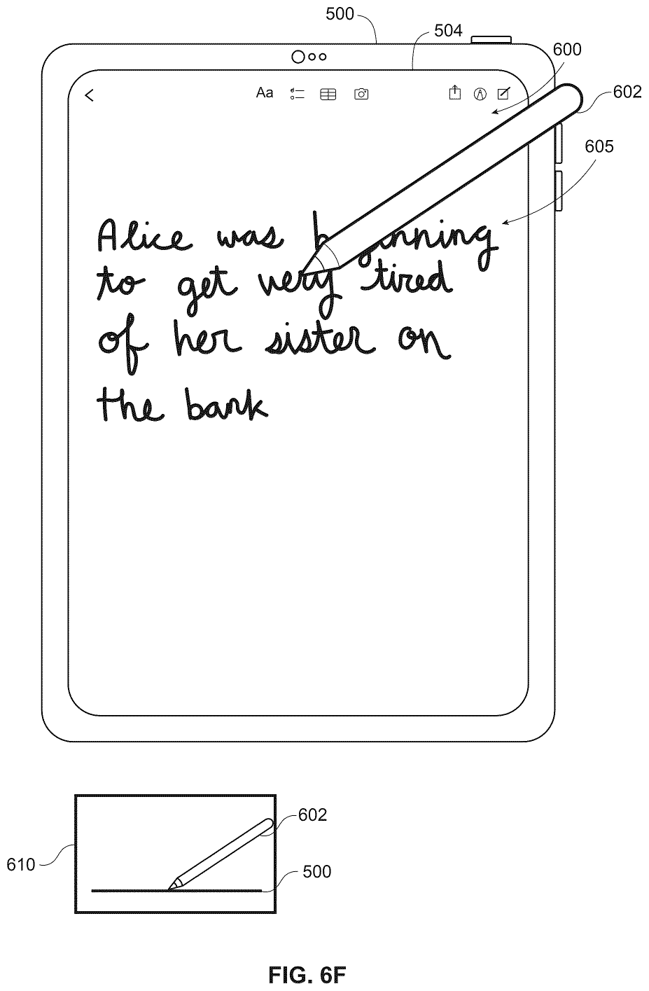

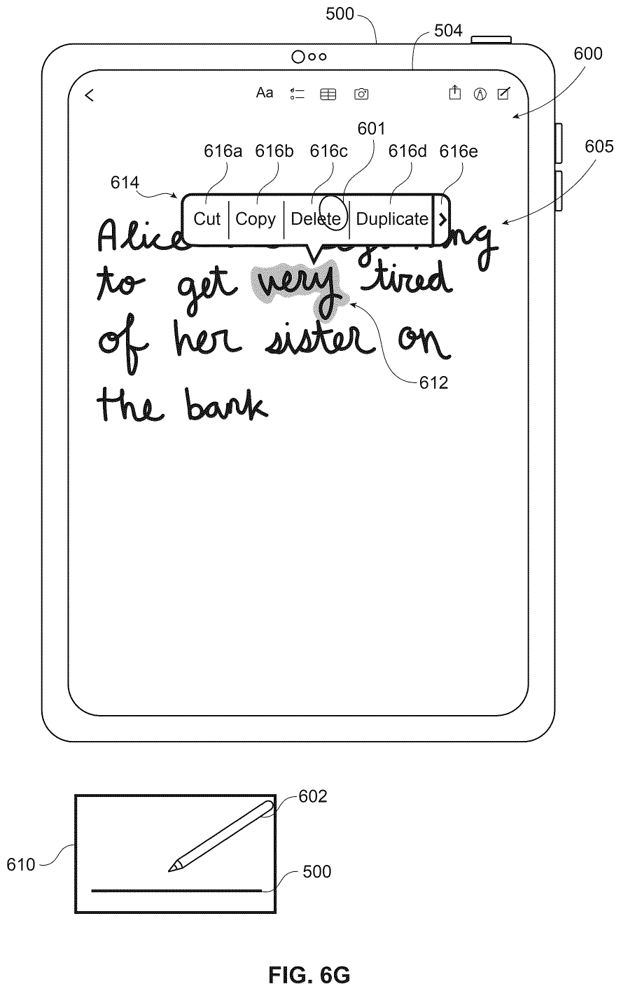

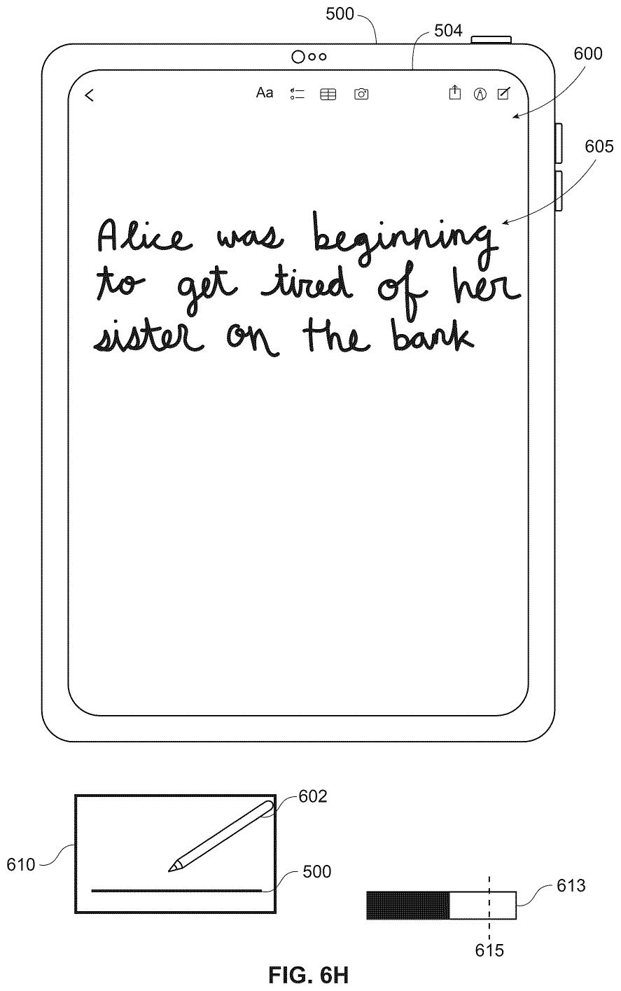

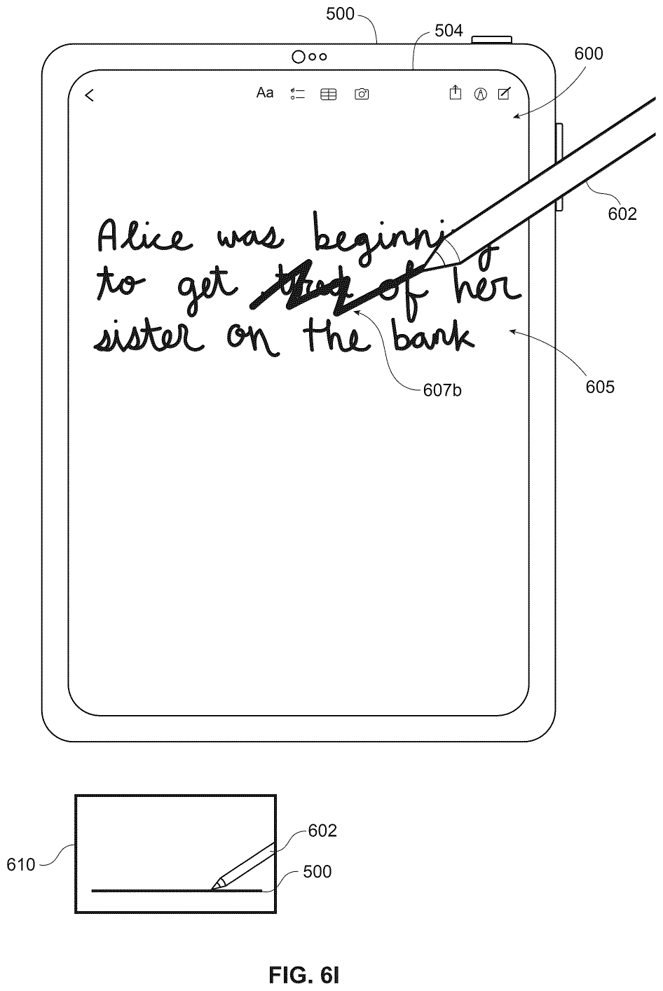

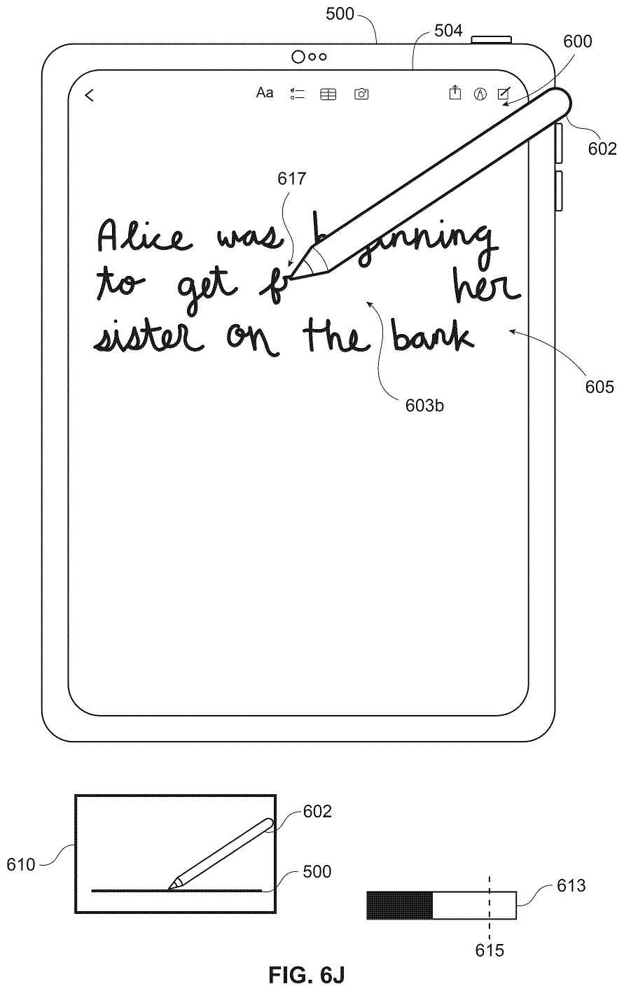

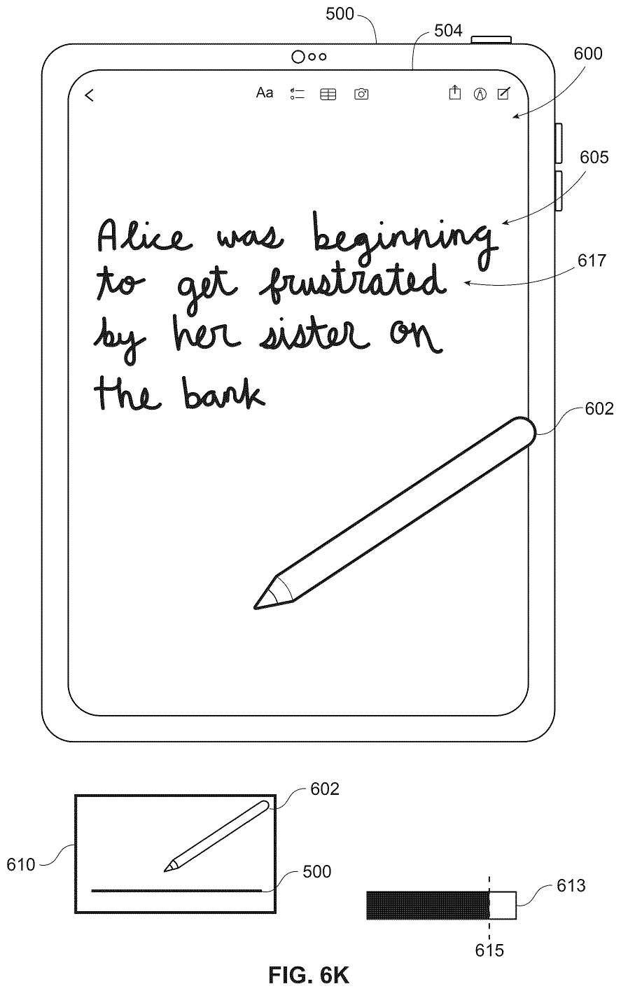

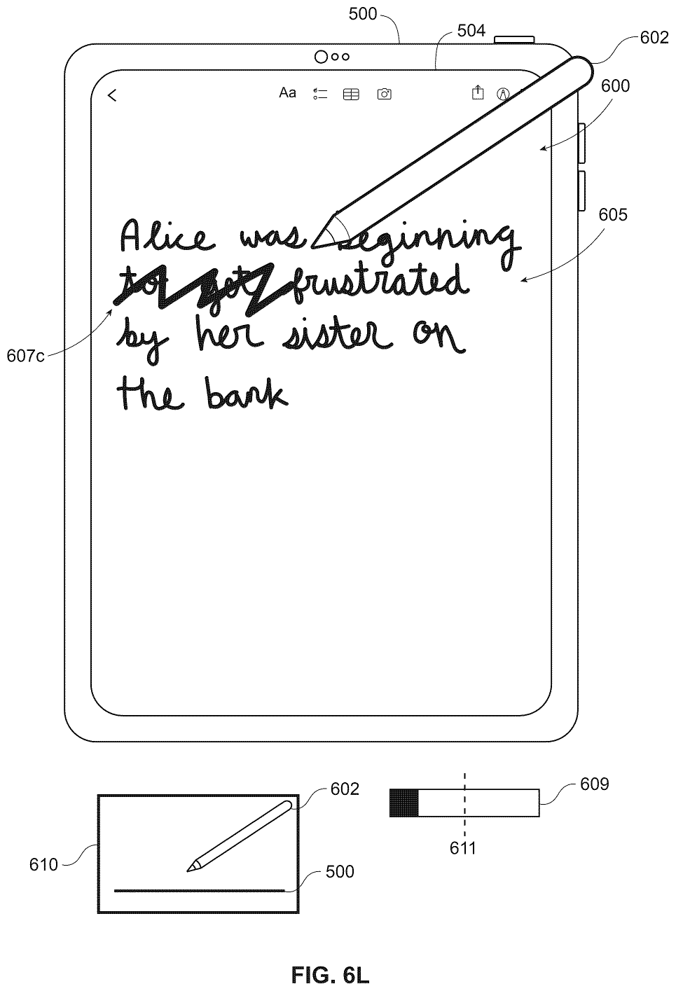

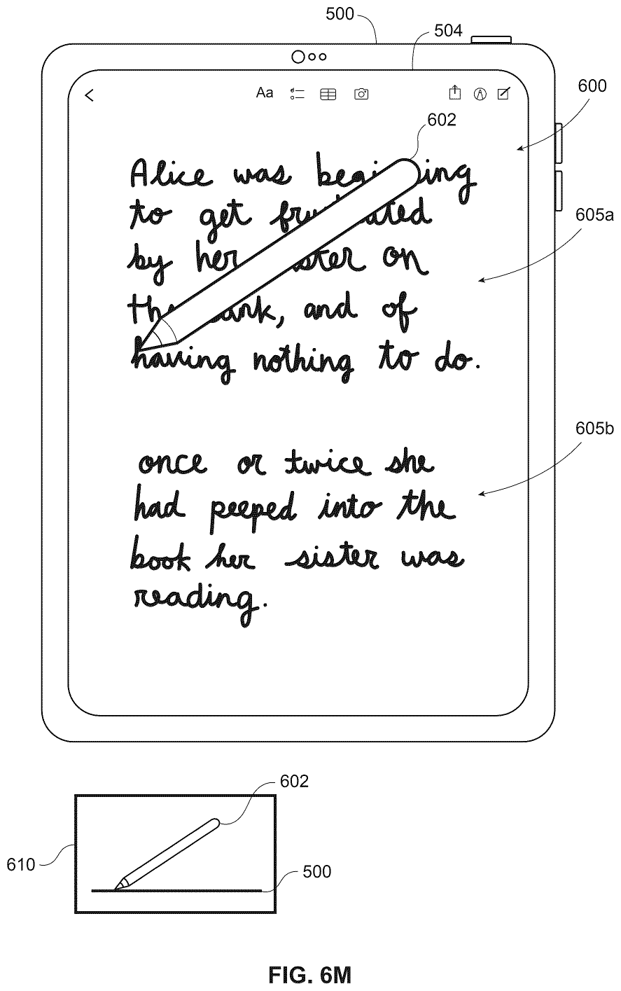

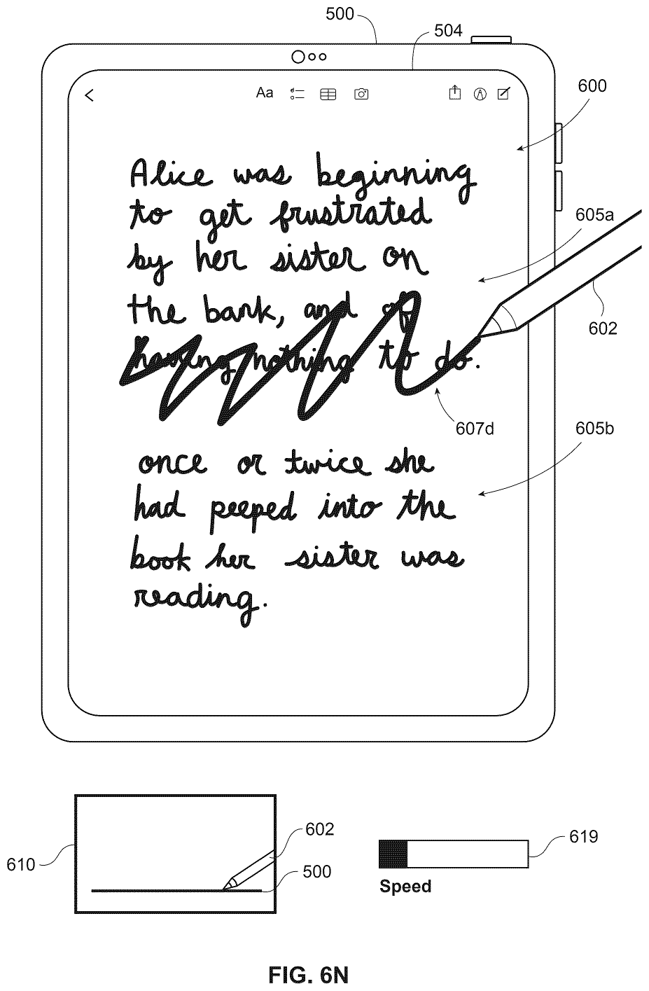

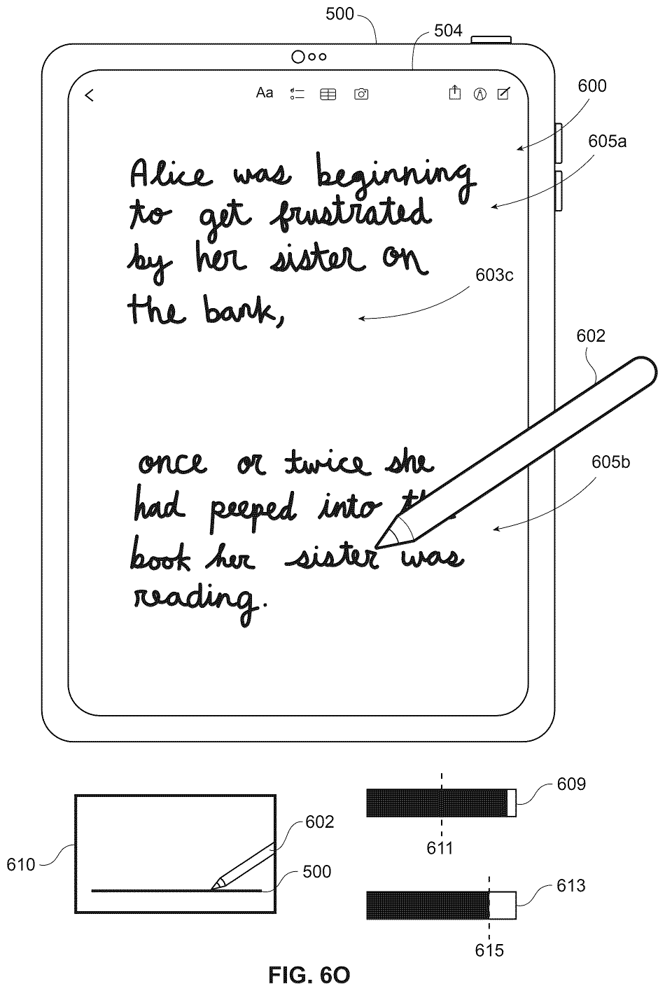

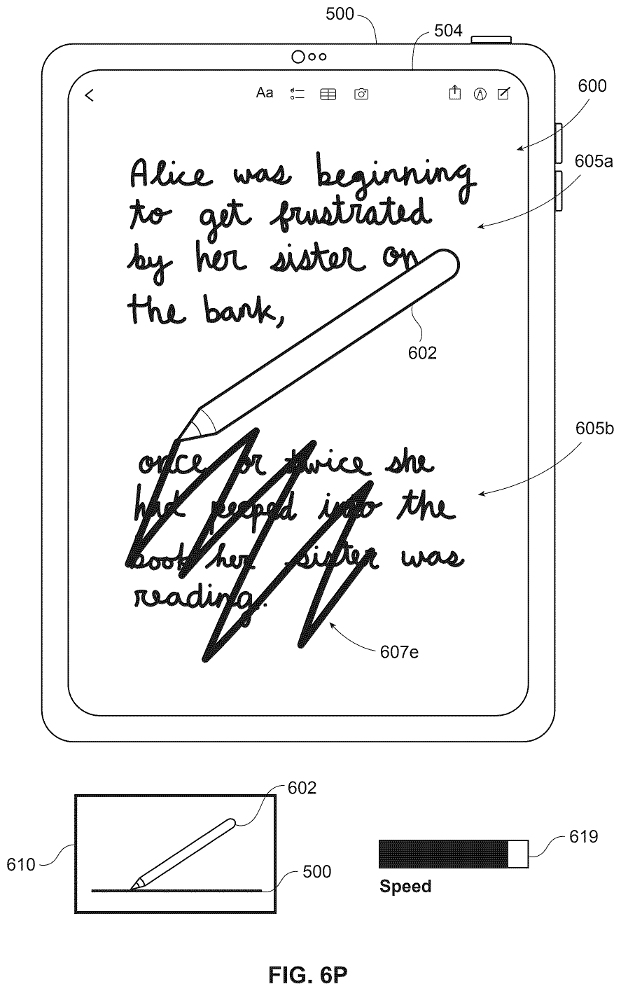

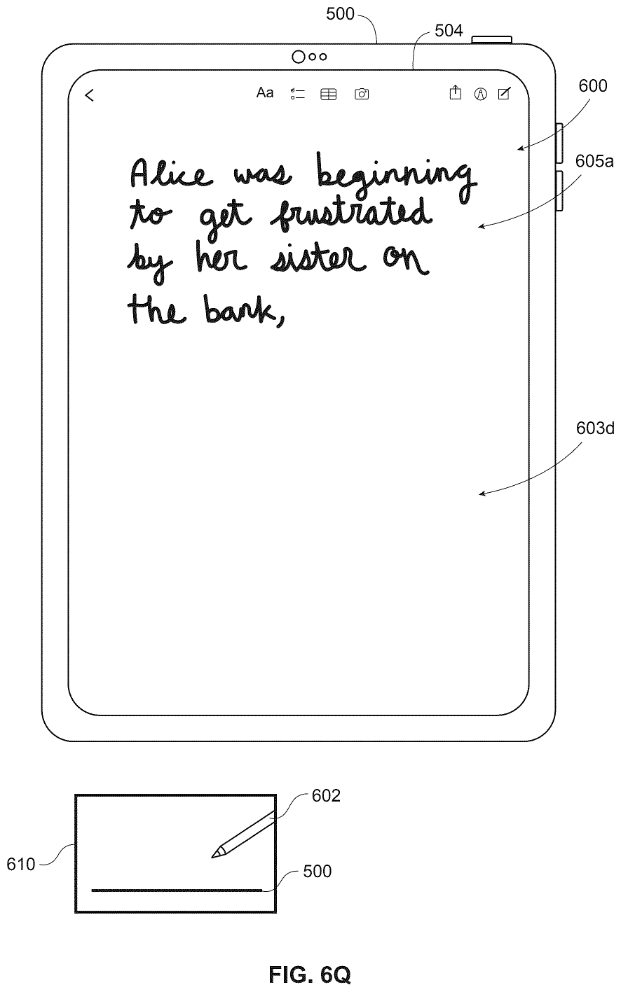

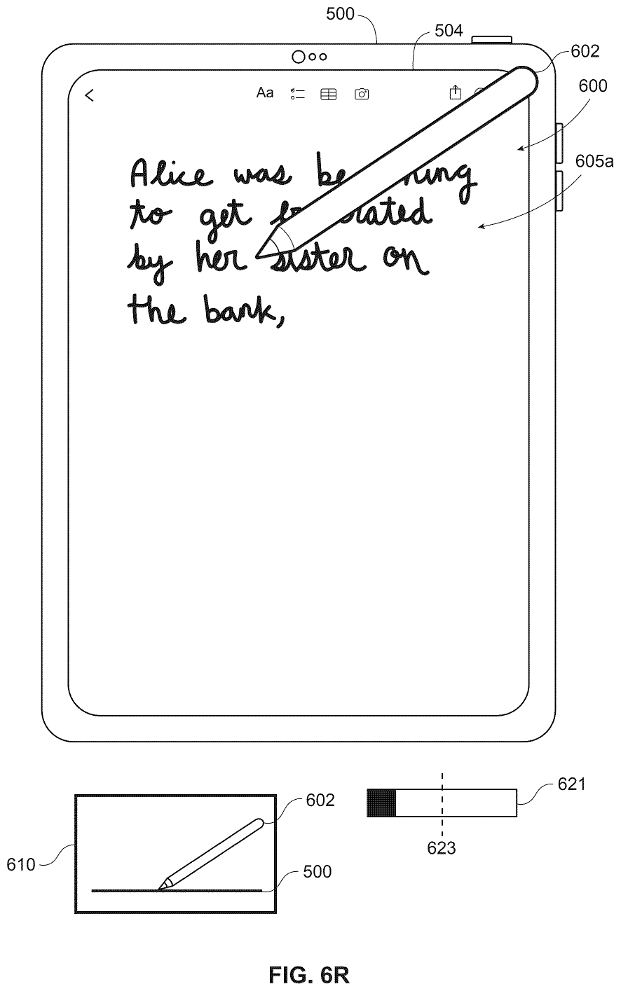

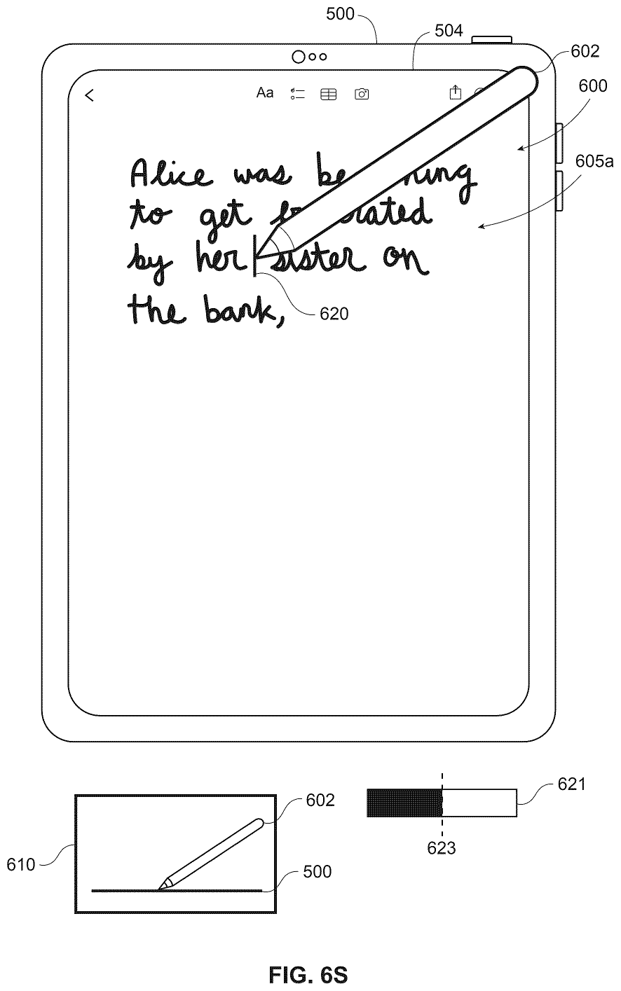

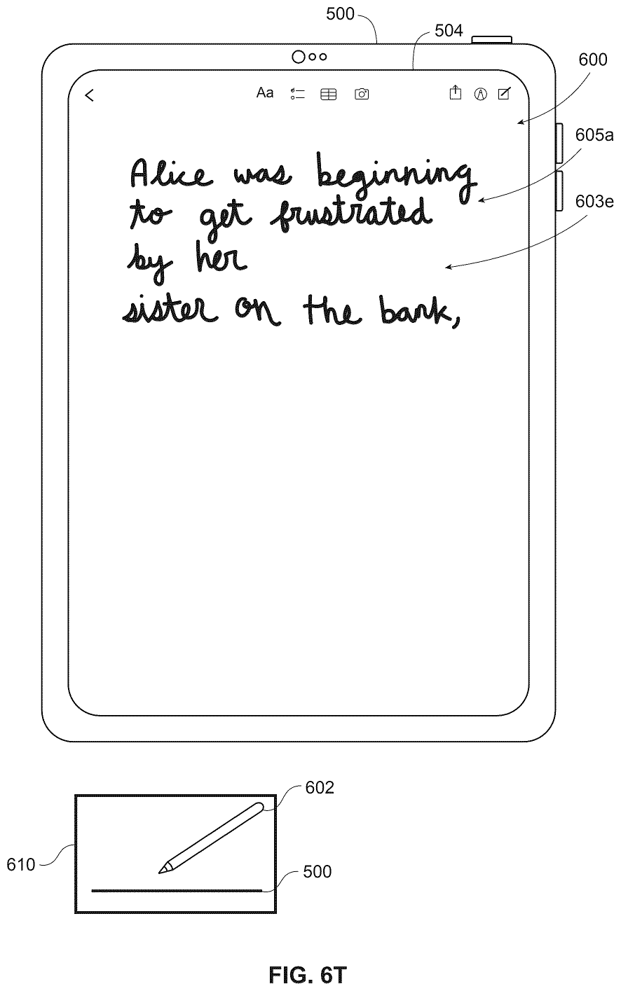

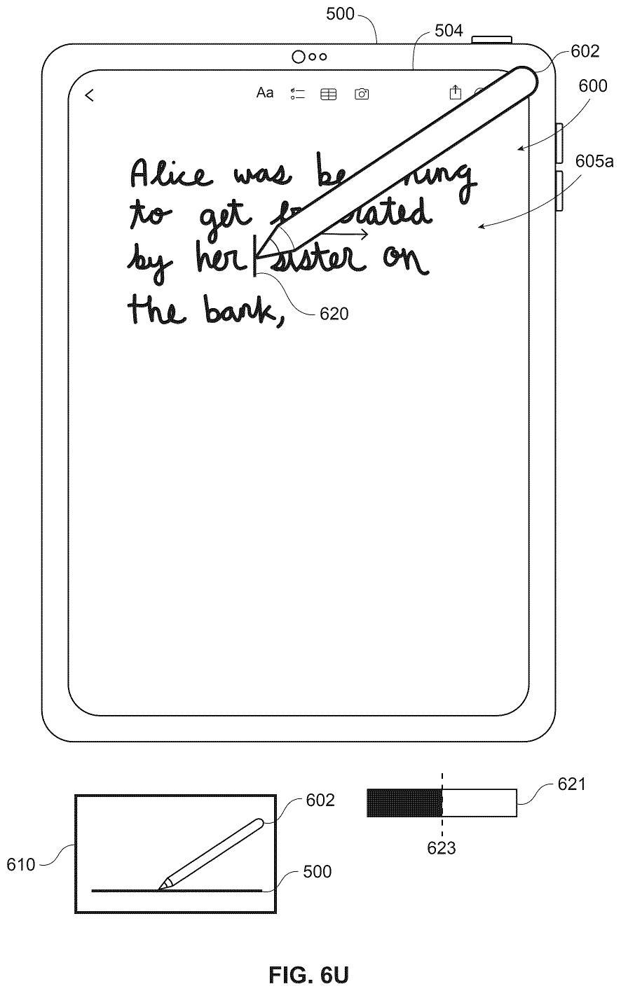

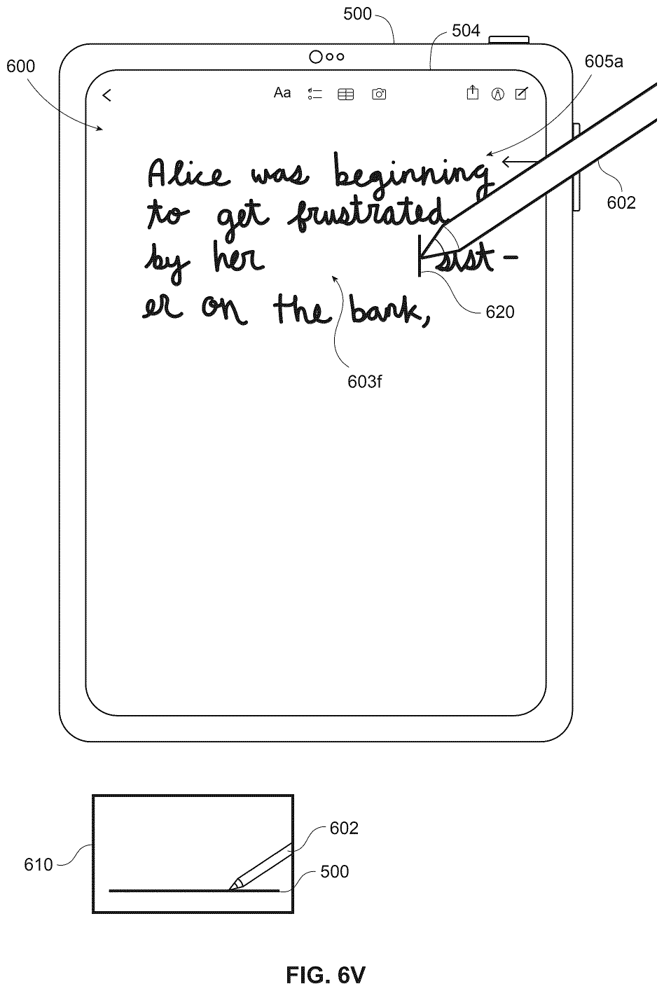

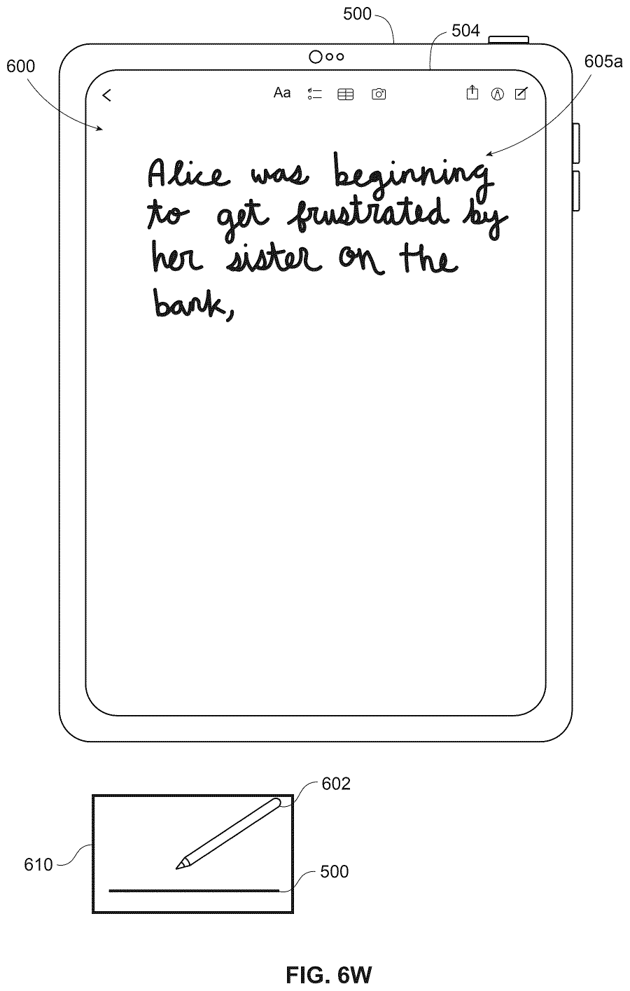

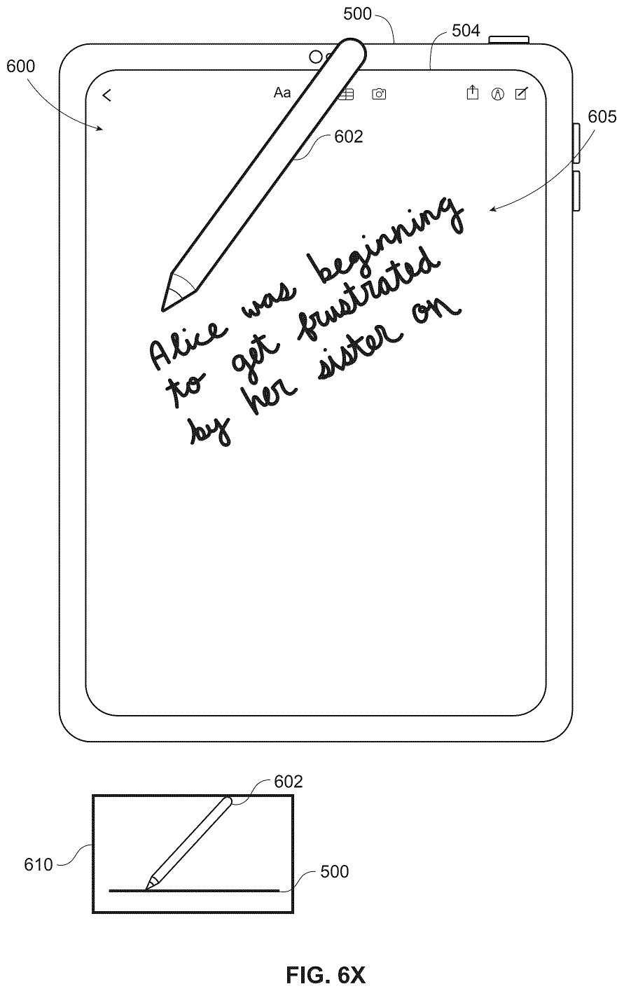

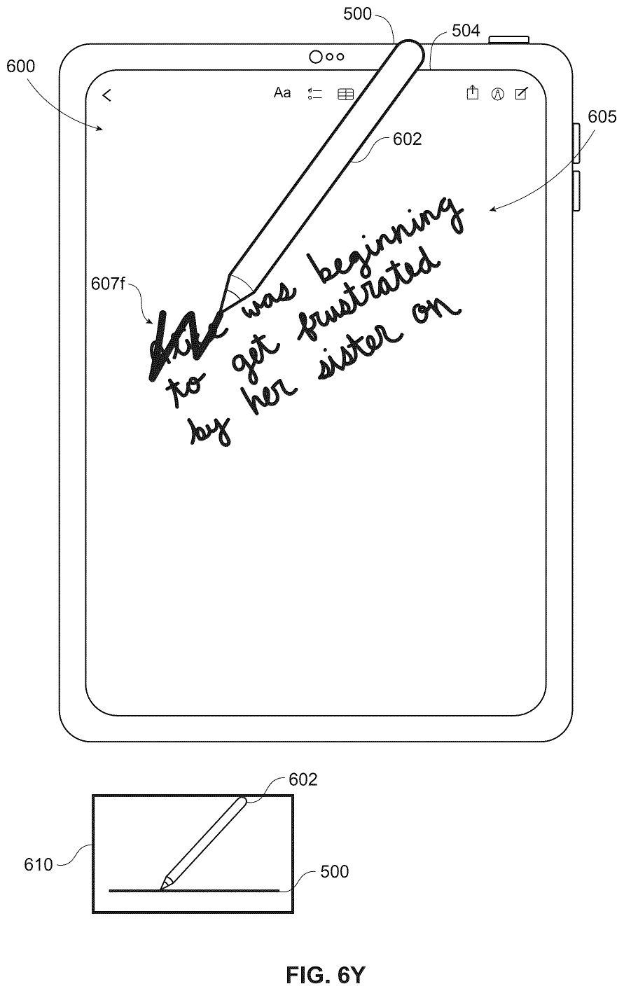

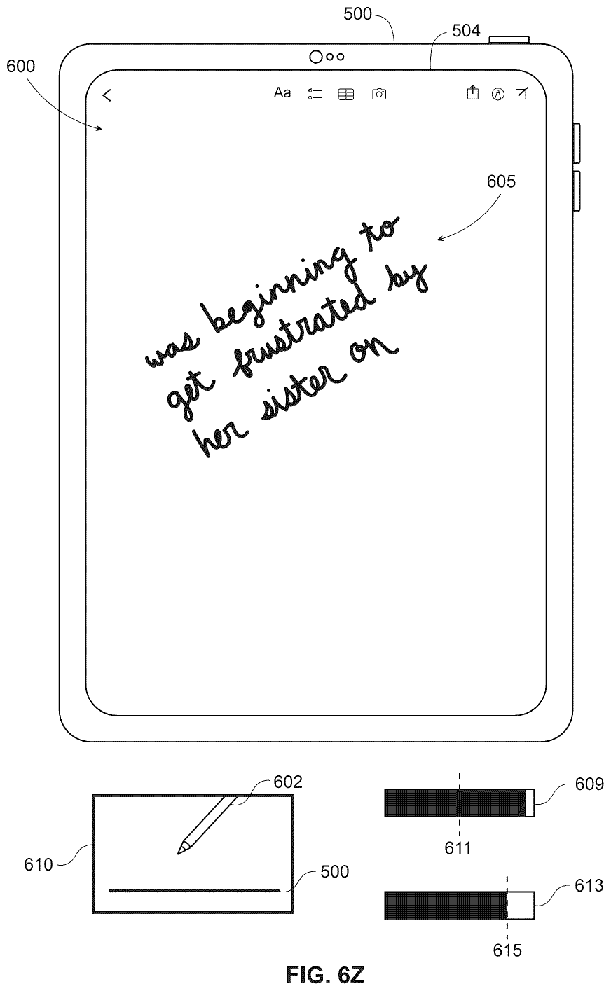

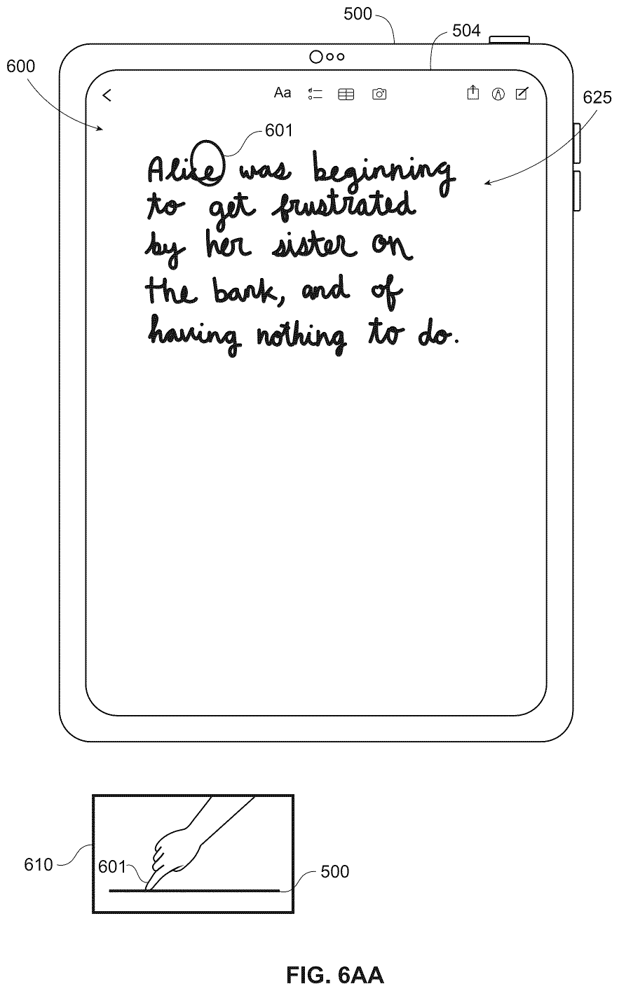

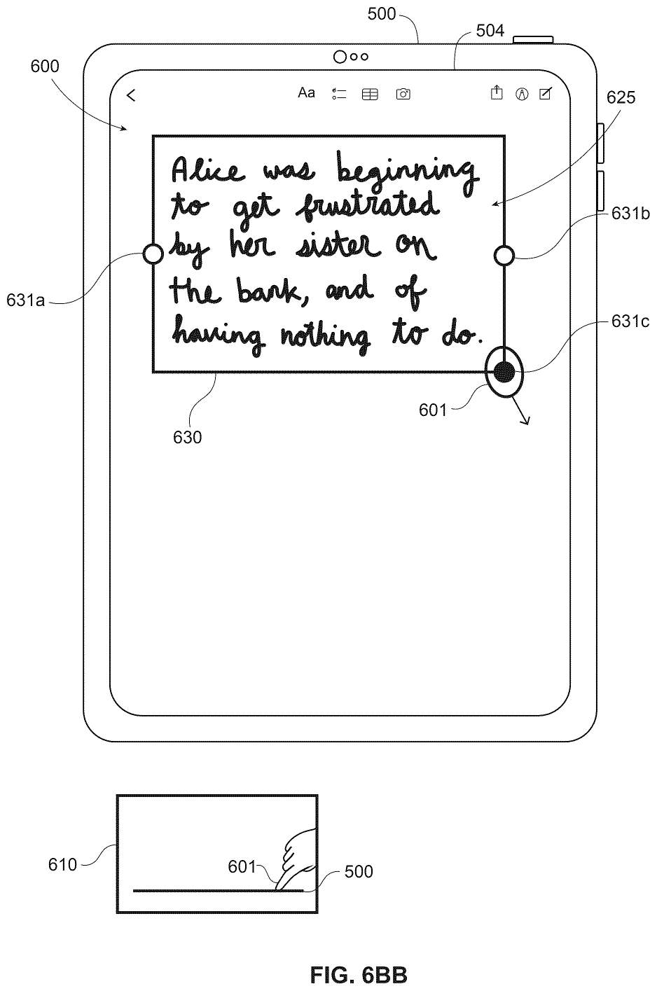

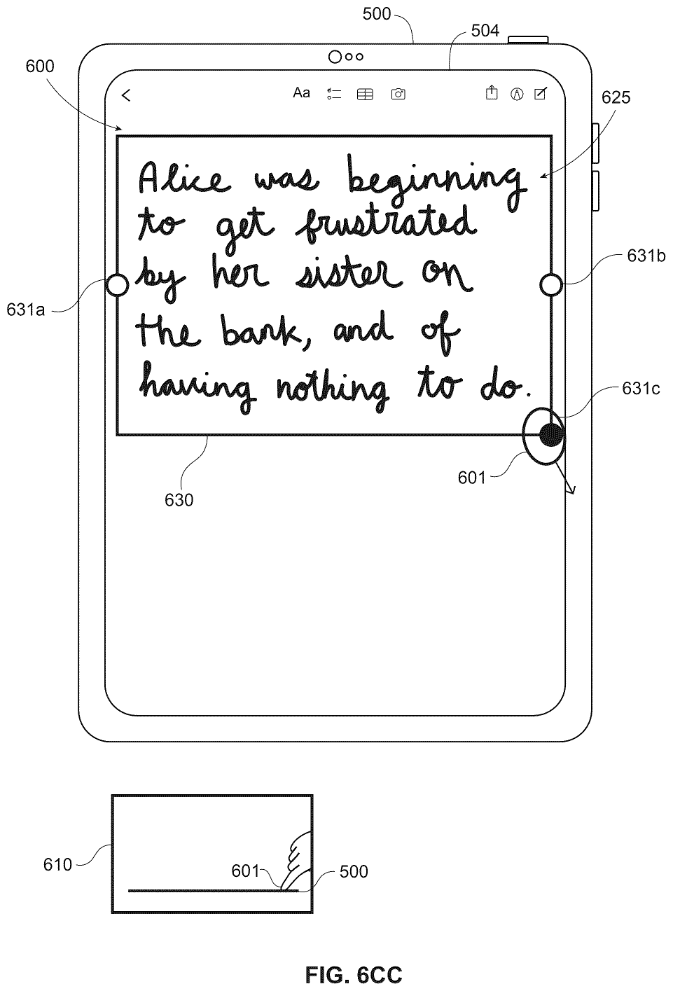

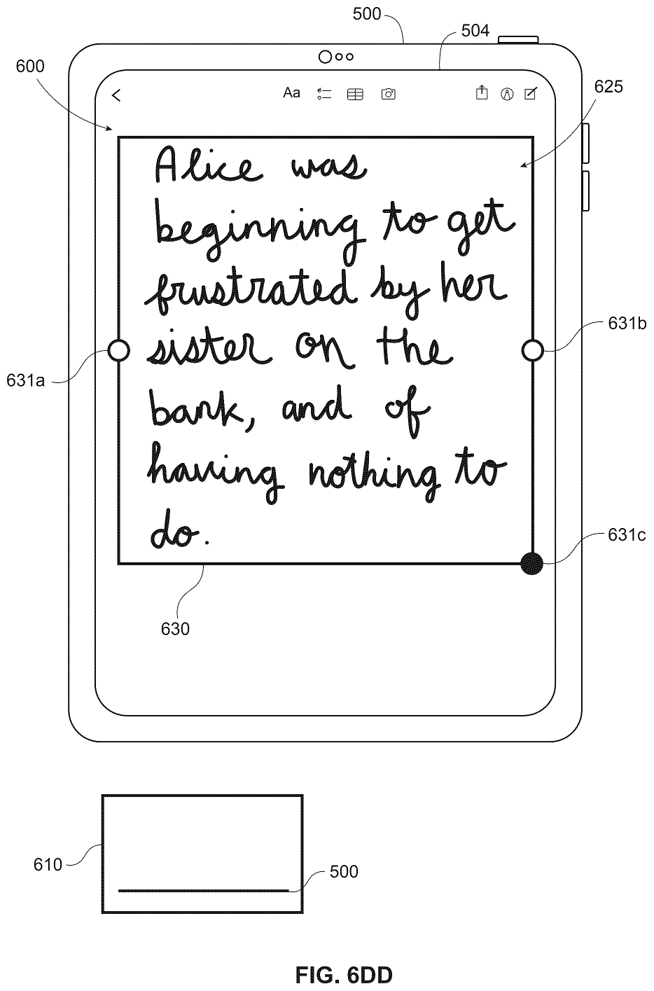

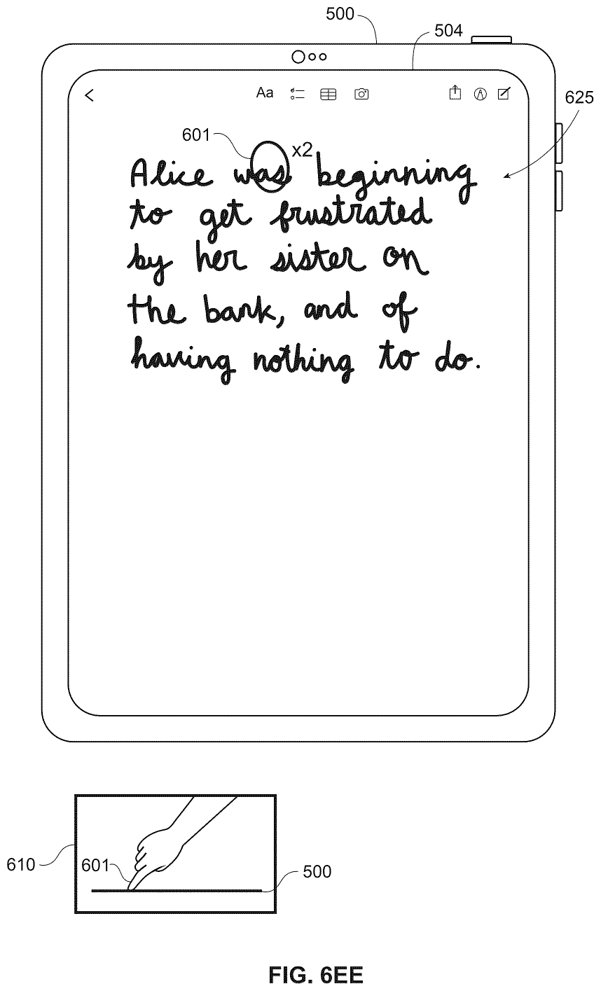

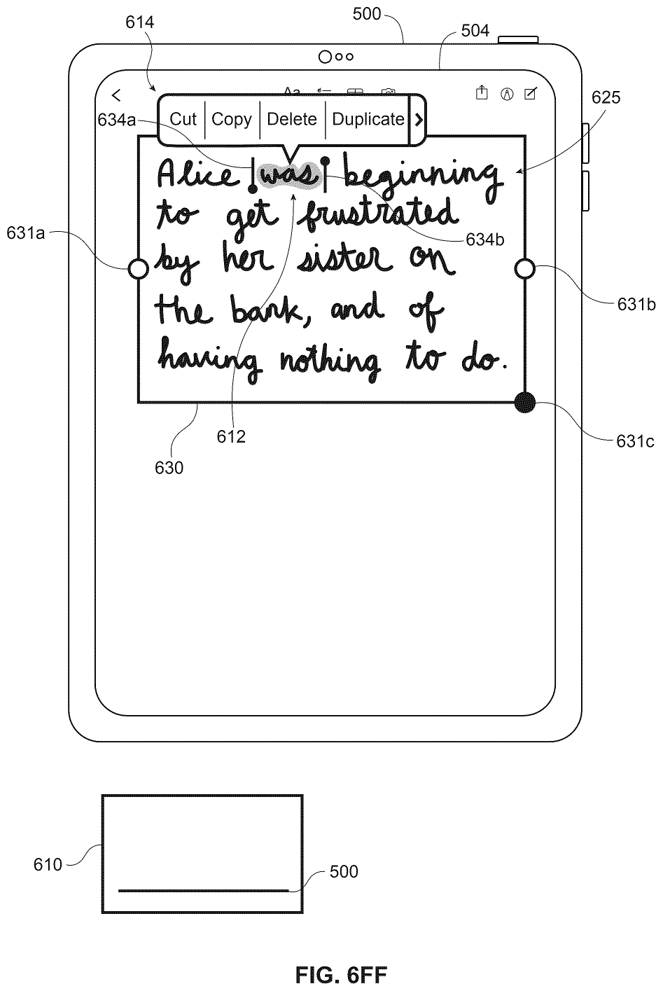

FIGS. 6A-6FF illustrate exemplary ways in which an electronic device facilitates manipulation of handwritten content. The embodiments in these figures are used to illustrate the processes described below, including the processes described with reference to FIG. 7.

FIGS. 6A-6FF illustrate operation of the electronic device 500 for facilitating manipulation of handwritten content. FIG. 6A illustrates electronic device 500 displaying user interface 600 (e.g., via a display device, via a display generation component, or via a touch screen). In some embodiments, user interface 600 is displayed via a display generation component. In some embodiments, the display generation component is a hardware component (e.g., including electrical components) capable of receiving display data and displaying a user interface. In some embodiments, examples of a display generation component include a touch screen display (such as touch screen 504), a monitor, a television, a projector, an integrated, discrete, or external display device, or any other suitable display device that is in communication with electronic device 500.

In some embodiments, user interface 600 is a user interface of a free-form handwriting application (e.g., for taking handwritten notes, drawing shapes, sketches, and/or drawings, composing handwritten text, and/or generating handwritten lists). In some embodiments, the handwriting application is an application installed on electronic device 500.

In FIG. 6A, user interface 600 includes a content-entry region. In some embodiments, the content-entry region is configured to receive handwritten input (e.g., a drawing and/or handwriting input via a stylus device) and display a representation of the handwritten input (e.g., if drawing and/or handwritten input is provided) and/or display font-based text (e.g., if font-based text input is provided).

From FIGS. 6A-6B, the electronic device 500 detects a contact with touch screen 504 provided by the stylus 602 (e.g., controlled by a user of the electronic device 500) while a respective handwriting entry tool (e.g., a pen entry tool) is active. In some embodiments, in response to the contact by stylus 602, a representation of the handwritten input (e.g., by stylus 602) is displayed at the contact location. Thus, the user is able to begin directly drawing/writing in the user interface 600.

In FIG. 6B, while the contact is maintained with touch screen 504, as indicated by contact of the stylus 602 with the surface of the electronic device 500 in side view 610, the electronic device 500 detects handwriting movement by the stylus 602. In some embodiments, in response to detecting the handwriting movement, the electronic device 500 displays a representation of the handwritten input, corresponding to handwritten content 605 in the user interface 600, as shown in FIG. 6B. In some embodiments, a representation of the handwritten input is displayed while the input is being received. As shown in FIG. 6B, the handwritten content 605 corresponds to handwritten text provided by the user using the stylus 602 (e.g., comprising the words “Alice was beginning to get very tired of sitting by her sister on the bank”).

In some embodiments, the electronic device 500 facilitates manipulation of the handwritten content in the user interface 600. As described herein, one such manipulation includes deleting (e.g., ceasing display of) a portion of the handwritten content in the user interface 600, such that a blank space is created at a location of the portion of the handwritten content in the user interface 600. As described below, deleting the portion of the handwritten content enables additional and/or new handwritten content to be provided at the location of the portion of the handwritten content in the user interface 600. Additionally, in some embodiments, the electronic device 500 automatically updates display of a number of lines of the handwritten content and/or locations of characters within the lines of the handwritten content in which the handwritten content is displayed based on the deletion of the portion of the handwritten content and/or the addition of new handwritten content in the user interface.

In some embodiments, the electronic device 500 deletes a portion of the handwritten content in response to detecting one or more handwritten marks directed to the portion of the handwritten content. For example, as shown in FIG. 6C, the electronic device 500 detects handwritten marks 607a from the stylus 602 (e.g., continuous or sequential lines/scratches of the stylus 602) on the surface of the touch screen 504. In some embodiments, as shown in FIG. 6C, the handwritten marks 607a are directed to a first portion of the handwritten content 605. Particularly, as shown in FIG. 6C, the handwritten marks 607a are optionally provided over and/or are directed to the text “sitting by” in the handwritten content 605. In some embodiments, as shown in FIG. 6C, the electronic device 500 displays a representation of the handwritten marks 607a concurrently with (e.g., overlaid on the first portion of) the handwritten content 605 in the user interface 600.

In some embodiments, the electronic device 500 deletes the portion of the handwritten content 605 in the user interface 600 after detecting the handwritten marks 607a in response to detecting contact of the stylus 602 on the touch screen 504 for at least a threshold amount of time (e.g., 0.5, 1, 1.5, 2, 3, 4, or 5 seconds), as indicated by threshold time 611 in time bar 609. For example, as shown in the side view 610 in FIG. 6C, after providing the handwritten marks 607a in the user interface 600, contact is maintained by the stylus 602 on the surface (e.g., touch screen 504) of the electronic device 500 (optionally without detecting liftoff after providing the handwritten marks 607a). As illustrated in FIG. 6C, the threshold amount of time, indicated by the threshold time 611 in the time bar 609, has not yet elapsed since detecting the contact of the stylus 602 on the surface of the electronic device 500 after detecting the handwritten marks 607a. Accordingly, in FIG. 6C, the electronic device 500 forgoes deleting the first portion of the handwritten content 605 in the user interface 600.

In some embodiments, as shown in FIG. 6D, in accordance with a determination that the threshold amount of time, indicated by the threshold time 611 in the time bar 609, has elapsed since detecting the contact of the stylus 602 on the surface of the electronic device 500, the electronic device 500 deletes the first portion of the handwritten content 605 in the user interface 600. For example, as shown in FIG. 6D, the electronic device 500 ceases display of the text “sitting by” of the handwritten content 605 in the user interface 600, as indicated by the handwritten marks 607a (e.g., indicated by the overlap of the handwritten marks 607a with the first portion of the handwritten content 605). Additionally, as shown in FIG. 6D, when the electronic device 500 ceases display of the first portion of the handwritten content 605, the electronic device 500 ceases display of the handwritten marks 607a in the user interface 600. In some embodiments, as shown in FIG. 6D, when the first portion of the handwritten content 605 is deleted in the user interface 600, a blank space 603a is created/inserted at a location of the first portion of the handwritten content 605. For example, as shown in FIG. 6D, deleting the text “sitting by” creates the blank space 603a within the handwritten content 605, a size of the blank space 603a corresponding to a size of the text “sitting by” that is deleted (e.g., a size of the characters forming the text “sitting by”).

In some embodiments, after the electronic device 500 deletes the first portion of the handwritten content 605 in the user interface 600, the electronic device 500 facilitates “reflow” of the handwritten content 605 in the user interface 600 based on user input following the deletion of the first portion of the handwritten content 605. As used herein, reflowing the handwritten content 605 refers to moving/shifting one or more characters of the handwritten content 605 in the user interface 600, optionally the one or more characters adjacent to (e.g., following or preceding) the location of the deleted first portion of the handwritten content 605 in the user interface 600. For example, as discussed herein, the electronic device 500 moves the text “her sister on the bank” of the handwritten content 605, which is adjacent to (e.g., follows) the location of the deleted first portion of the handwritten content 605, based on user input (e.g. provided via the stylus 602) that is detected or not detected following the deletion of the first portion of the handwritten content 605.

In some embodiments, the electronic device 500 reflows the handwritten content 605 in the user interface 600 after deleting the first portion of the handwritten content in accordance with a determination that a second threshold amount of time (e.g., 0.5, 1, 1.5, 2, 3, 4, or 5 seconds), indicated by threshold time 615 in time bar 613 in FIG. 6D, elapses after deleting the first portion of the handwritten content 605 without detecting input directed to the location of the first portion of the handwritten content 605. For example, from FIGS. 6D-6E, after deleting the text “sitting by” in the user interface 600, the electronic device 500 does not detect input, such as handwritten input, from the stylus 602 directed to the blank space 603a (e.g., corresponding to the location of the text “sitting by”) in the user interface 600 before the second threshold amount of time elapses, as indicated by the threshold time 615 in the time bar 613. As shown in the side view 610 in FIG. 6E, the stylus 602 is not in contact with the surface of the electronic device 500. Accordingly, as shown in FIG. 6E, the electronic device 500 optionally reflows the handwritten content 605 in the user interface 600. For example, as shown in FIG. 6E, the electronic device 500 moves the text “her sister on the bank” leftward in the user interface 600 to occupy the blank space 603a corresponding to the location of the deleted text “sitting by” of FIG. 6C.

In some embodiments, when the electronic device 500 reflows the handwritten content 605 in the user interface 600, the electronic device 500 updates locations of particular characters (e.g., and/or words) of the handwritten content 605 within the lines of the handwritten content 605. For example, in FIG. 6D, prior to the reflow of the handwritten content 605, the text “sister on” is located in a fourth line (e.g., from the top line in the user interface 600) of the lines in which the handwritten content 605 is displayed in the user interface 600. Following the reflow of the handwritten content 605, as shown in FIG. 6E, the text “sister on” is located in a third line, above the fourth line, of the lines in which the handwritten content 605 is displayed in the user interface 600. Additional details relating to reflow (e.g., movement) of handwritten content are provided below with reference to method 700.

In FIG. 6F, the electronic device 500 detects input provided by the stylus 602 (e.g., a selection input) directed to a second portion of the handwritten content 605. For example, as shown in FIG. 6F, the electronic device 500 detects a tap of the stylus 602 on the touch screen 504 at a location of the text “very” of the handwritten content 605 in the user interface 600. In some embodiments, the electronic device 500 detects the stylus 602 on the surface of the touch screen 504 directed to the second portion of the handwritten content 605 for at least a threshold amount of time (e.g., 0.5, 1, 1.5, 2, 3, 4, or 5 seconds). In some embodiments, the electronic device 500 detects the selection input directed to the second portion of the handwritten content 605 while a selection mode is active in the user interface 600.

In some embodiments, as shown in FIG. 6G, in response to detecting the input provided by the stylus 602 corresponding to selection of the second portion of the handwritten content 605 in the user interface 600, the electronic device 500 (e.g., upon detecting lift-off of the stylus 602 from the surface of the electronic device 500, as indicated in the side view 610) selects the second portion of the handwritten content 605, as indicated by visual indication 612 (e.g., highlighting), and optionally displays a toolbar element 614 in the user interface 600. As shown in FIG. 6G, the toolbar element 614 includes a plurality of selectable options 616a-616e that is selectable to cause the electronic device 500 to perform corresponding options involving the second portion of the handwritten content 605. For example, as shown in FIG. 6G, the selectable option 616a is selectable to cut the second portion of the handwritten content 605 (e.g., remove and copy the text “very” in the handwritten content 605), the selectable option 616b is selectable to copy the second portion of the handwritten content 605 (e.g., for pasting a copy of the text “very” (e.g., in the user interface or in a content-entry region of another user interface), the selectable option 616c is selectable to cease display of the second portion of the handwritten content 605, the selectable option 616d is selectable to display a duplicate of the second portion of the handwritten content 605 in the user interface 600, and/or the selectable option 616e is selectable to expand the toolbar element 614 to reveal additional and/or alternative selectable options in the user interface 600. Additionally or alternatively, in some embodiments, the toolbar element 614 is scrollable (e.g., horizontally scrollable) in the user interface 600 to reveal additional and/or alternative selectable options in the user interface 600. In some embodiments, the toolbar element 614 includes a different number (e.g., fewer or greater) of the selectable options than that shown in FIG. 6G.

As shown in FIG. 6G, while displaying the toolbar element 614 in the user interface 600, the electronic device 500 detects a selection input, such as a tap of contact 601 (e.g., provided by the stylus 602 or a finger of the user), directed to the selectable option 616c in the toolbar element 614. In some embodiments, as shown in FIG. 6H, in response to detecting the selection of the selectable option 616c, the electronic device 500 deletes (e.g., ceases display of) the second portion of the handwritten content 605 in the user interface 600. For example, as shown in FIG. 6H, the electronic device 500 ceases display of the handwritten text “very” in the user interface 600.

In some embodiments, in accordance with the determination that the electronic device 500 deletes a respective portion of the handwritten content in the user interface 600 in response to detecting a selection of the selectable option 616c (e.g., the delete option) in the toolbar element 614 in the user interface 600, the electronic device 500 reflows the handwritten content 605 in the user interface 600 irrespective of whether the second threshold amount of time discussed above has elapsed since deleting the respective portion of the handwritten content. For example, as shown in FIG. 6H, though the second threshold amount of time has not elapsed, as indicated by the threshold time 615 in the time bar 613, since deleting the second portion of the handwritten content 605 (e.g., the text “very”), the electronic device 500 (e.g., automatically) reflows the text “tired of her sister on the bank” following the deleted first portion of the handwritten content 605 in the user interface (e.g., moves the text “tired of her sister on the bank” leftward toward the location of the deleted text “very” in the user interface 600), as similarly described above.

In FIG. 6I, the electronic device 500 detects an input corresponding to a request to delete a third portion of the handwritten content 605, such as the stylus 602 providing handwritten marks 607b directed to the third portion of the handwritten content 605 in the user interface 600. For example, as shown in FIG. 6I, the electronic device 500 detects the handwritten marks 607b directed to the text “tired of” in the handwritten content 605 in the user interface 600. As similarly discussed above, the electronic device 500 displays a representation of the handwritten marks 607b concurrently with the handwritten content 605 (e.g., overlaid on the third portion of the handwritten content 605) in the user interface 600.

In some embodiments, as shown in FIG. 6J, in response to detecting the input corresponding to the request to delete the third portion of the handwritten content 605, the electronic device 500 deletes the third portion of the handwritten content 605 in the user interface 600. For example, as shown in FIG. 6J, after detecting the handwritten marks 607b discussed above and after detecting that the threshold amount of time (e.g., discussed above) has elapsed while detecting contact of the stylus 602 on the surface of the electronic device 500, as similarly described above, the electronic device 500 ceases display of the text “tired of” in the user interface 600. In some embodiments, as similarly discussed above, when the electronic device 500 deletes the third portion of the handwritten content 605 in the user interface 600, a blank space 603b is created/inserted at a location of the third portion in the user interface 600.

In FIG. 6J, after deleting the third portion of the handwritten content 605 in the user interface 600, but prior to detecting that the second threshold amount of time, indicated by the threshold time 615 in the time bar 613, has elapsed since deleting the third portion of the handwritten content 605, the electronic device 500 detects input provided by the stylus 602 directed to the blank space 603b (e.g., corresponding to the location of the deleted third portion) in the user interface 600. For example, as shown in FIG. 6J, the electronic device 500 detects, via the touch screen 504, initiation of handwriting by the stylus 602 within the blank space 603b in the user interface 600. In some embodiments, because the handwriting provided by the stylus 602 directed to the blank space 603b is detected before the second threshold amount of time has elapsed since deleting the third portion of the handwritten content 605, the electronic device 500 forgoes reflowing the handwritten content 605 based on the deleted third portion. For example, as shown in FIG. 6J, the electronic device 500 maintains display of (e.g., forgoes moving) the text “her sister on the bank” that spatially follows the blank space 603b in the user interface 600 while detecting the handwriting by the stylus 602. As shown in FIG. 6J, as the electronic device 500 detects movement of the stylus 602 on the touch screen 504, the electronic device 500 displays a representation of handwritten input 617 (e.g., at the location of the movement of the stylus) in the blank space 603b in the user interface 600.

In some embodiments, the electronic device 500 reflows the handwritten content 605 in the user interface 600 when and/or in response to detecting handwriting provided by the stylus 602 in accordance with a determination that a representation of the handwritten input causes one or more portions of the handwritten content to extend beyond a boundary associated with the handwritten content. For example, in FIG. 6J, as similarly discussed above, the handwritten content 605 is displayed in a number of lines (e.g., four lines) in the user interface 600. In some embodiments, a respective line of the lines in which the handwritten content 605 is displayed is associated with a boundary. In some embodiments, the boundary corresponds to a margin assigned/selected for the display of content, including the handwritten content 605, in the user interface 600. In some embodiments, the boundary corresponds to a physical edge/limit of the touch screen 504 via which the user interface 600, including the handwritten content 605, is displayed. In some embodiments, as the electronic device 500 is detecting the handwriting provided by the stylus 602 in FIG. 6J, the electronic device 500 reflows the handwritten content 605 to accommodate the display of the representation of the handwritten input 617 in the user interface 600. For example, the electronic device 500 moves the text “her” that follows the blank space 603b in which the representation of the handwritten input 617 is being displayed (e.g., rightward along the second line in the user interface 600).

In FIG. 6K, the display of the representation of the handwritten input 617 (optionally after detecting liftoff of the stylus 602 from the surface of the electronic device 500, as shown in the side view 610) causes the locations of particular characters (e.g., and/or words) of the handwritten content 605 to change within the lines of the handwritten content 605. For example, in FIG. 6J, prior to the display of the representation of the handwritten input 617 (e.g., the text “frustrated by”) in the user interface 600, the text “her” is located in the second line (e.g., from the top line in the user interface 600) of the lines in which the handwritten content 605 is displayed in the user interface 600 and the text “the bank” is located in the third line (e.g., the last line in the user interface 600). Following the display of the representation of the handwritten input 617, as shown in FIG. 6K, the text “her” is located in the third line and the text “the bank” is located in a new fourth line (e.g., a new last line) in the user interface 600.

In FIG. 6L, the electronic device 500 has detected handwritten marks 607c provided by the stylus 603 directed to a fourth portion of the handwritten content 605 in the user interface 600. For example, as shown in FIG. 6L, the electronic device 500 detects the handwritten marks 607c directed to the text “to get” of the handwritten content 605 in the user interface 600. In some embodiments, as similarly discussed above, the electronic device 500 displays a representation of the handwritten marks 607c concurrently with (e.g., overlaid on) the fourth portion of the handwritten content 605 in the user interface 600.

As previously discussed herein, in some embodiments, the electronic device 500 deletes a respective portion of the handwritten content 605 designated for deletion (e.g., via one or more handwritten marks provided by the stylus 602) in response to detecting contact of the stylus 602 on the surface of the electronic device 500 (e.g., on the touch screen 504) for at least a threshold amount of time, indicated by the threshold time 611 in the time bar 609, after detecting the one or more handwritten marks. In FIG. 6L, the electronic device 500 has detected liftoff of the stylus 602 from the surface of the electronic device 500, as illustrated in the side view 610, before the threshold amount of time has elapsed since detecting the handwritten marks 607c provided by the stylus 602. Accordingly, as shown in FIG. 6L, the electronic device 500 forgoes deleting the fourth portion of the handwritten content 605 in the user interface 600. For example, as shown in FIG. 6L, the electronic device 500 maintains display of the text “to get” in the handwritten content 605 and optionally maintains display of the representation of the handwritten marks 607c in the user interface.

In some embodiments, in accordance with a determination that the handwritten marks 607c are directed to font-based text (e.g., text written in Times New Roman, Arial, Calibri, etc.) in the user interface 600, the electronic device 500 deletes the font-based text irrespective of whether the threshold amount of time discussed above has elapsed since detecting contact of the stylus 602 on the surface of the electronic device 500 after the handwritten marks 607c are provided by the stylus 602. For example, in FIG. 6L, if the words “to get” were alternatively displayed/provided in font-based text, rather than the handwritten text shown, the electronic device 500 would delete the words “to get” in response to detecting the handwritten marks 607c provided by the stylus 602 in the user interface 602.

In FIG. 6M, the electronic device 500 is displaying a first group of handwritten content 605a (e.g., a first paragraph of words) and a second group of handwritten content 605b (e.g., a second paragraph of words). In some embodiments, as illustrated in FIG. 6M, the first group of handwritten content 605a is displayed in a first region of the user interface 600 and the second group of handwritten content 605b is displayed in a second region (e.g., below the first region) of the user interface 600. Additionally, in some embodiments, the first group of handwritten content 605a and the second group of handwritten content 605b is separated by blank space in the user interface 600.

In FIG. 6M, the electronic device 500 detects contact of the stylus 602 on the surface of the electronic device 500, as indicated in the side view 610, directed to a location within the first group of handwritten content 605a in the user interface 600. From FIGS. 6M-6N, the electronic device 500 detects movement of the stylus 602 on the surface of the electronic device 500 (e.g., the touch screen 504), which provides/generates handwritten marks 607d directed to a portion of the first group of handwritten content 605a in the user interface. In some embodiments, as similarly discussed above, the electronic device 500 displays a representation of the handwritten marks 607d concurrently with (e.g., overlaid on) the first group of handwritten content 605a in the user interface 600.

In some embodiments, an amount of handwritten content that is deleted in the user interface 600 is based on one or more characteristics of handwritten marks provided by the stylus 602 that is directed to the handwritten content. In some embodiments, the one or more characteristics of the handwritten marks include a size of the handwritten marks, such as a length and/or thickness of each stroke/mark of the handwritten marks. In some embodiments, the one or more characteristics of the handwritten marks include a speed at which the handwritten marks are proved by the stylus 602 on the surface of the electronic device 500 (e.g., a speed at which the user draws the handwritten marks in the user interface 600 using the stylus 602). Other examples of the one or more characteristics of the handwritten marks are provided below with reference to method 700.

In FIG. 6N, the handwritten marks 607d have one or more first characteristics. For example, the handwritten marks 607d are provided in the user interface 600 with a first size (e.g., one or more first lengths and/or one or more first thicknesses). In some embodiments, the first size of the handwritten marks 607d is smaller than a size threshold (e.g., a length threshold and/or a thickness threshold). Additionally, in FIG. 6N, the handwritten marks 607d are provided with a first speed, indicated by speed bar 619, in the user interface 600. In some embodiments, the first speed at which the handwritten marks 607d are provided is less than a speed threshold.

In some embodiments, as shown in FIG. 6O, in response to detecting the handwritten marks 607d having the one or more first characteristics discussed above (e.g., and in response to detecting that the threshold amount of time, indicated by the threshold time 611 in the time bar 609 has elapsed as previously discussed herein), the electronic device 500 deletes a first portion of the first group of handwritten content 605a in the user interface 600. In FIG. 6O, because the handwritten marks 607d had the one or more first characteristics (e.g., a relatively small size and/or a relatively slow speed), the electronic device 500 deletes only the amount of the first group of handwritten content 605a that is overlapped/intersected by the handwritten marks 607d. For example, the first portion of the first group of handwritten content 605a that is deleted in FIG. 6O corresponds to only the text that was overlapped by the handwritten marks 607d in FIG. 6N. Additionally, as shown in FIG. 6O, as similarly discussed above, the deletion of the first portion of the first group of handwritten content 605a causes a blank space 603c to be created/inserted at a location of the deleted first portion in the user interface 600.

In some embodiments, the approaches described above for deleting one or more portions of handwritten content in the user interface 600 are not applicable for blank space that already exists within the user interface 600, such as the blank space between two paragraphs in the user interface 600. For example, as shown in FIG. 6N, the handwritten marks 607d encompass and/or overlap with the blank space separating the first group of handwritten content 605a (e.g., the first paragraph) and the second group of handwritten content 605b (e.g., the second paragraph). However, as shown in FIG. 6O, when the electronic device 500 deletes the first portion of the first group of handwritten content 605a in the manner discussed above, the electronic device 500 forgoes removing/deleting the blank space separating the first group of handwritten content 605a and the second group of handwritten content 605b. Accordingly, as shown in FIG. 6O, after the second threshold amount of time, indicated by the threshold time 615 in the time bar 613 has elapsed as similarly discussed above, the electronic device 500 forgoes reflowing the second group of handwritten content 605b into the first group of handwritten content 605a in the user interface 600 (e.g., forgoes moving/shifting the second group of handwritten content 605a upward in the user interface 600, such that the text “once or twice she . . . ” is moved to be adjacent to (e.g., to the right of) the text “the bank,” in the first group of handwritten content 605a).

In FIG. 6O, the electronic device 500 detects contact of the stylus 602 on the surface of the electronic device 500, as indicated in the side view 610, directed to a location within the second group of handwritten content 605b in the user interface 600. From FIGS. 60-6P, the electronic device 500 detects movement of the stylus 602 on the surface of the electronic device 500 (e.g., the touch screen 504), which provides/generates handwritten marks 607e directed to a portion of the second group of handwritten content 605b in the user interface 600. In some embodiments, as similarly discussed above, the electronic device 500 displays a representation of the handwritten marks 607e concurrently with (e.g., overlaid on) the second group of handwritten content 605b in the user interface 600.

In FIG. 6P, the handwritten marks 607e have one or more second characteristics (e.g., different from the one or more first characteristics of the handwritten marks 607d in FIG. 6N). For example, the handwritten marks 607e are provided in the user interface 600 with a second size (e.g., one or more second lengths and/or one or more second thicknesses), optionally larger than the first size of the handwritten marks 607d in FIG. 6N. In some embodiments, the second size of the handwritten marks 607e is larger than a size threshold (e.g., a length threshold and/or a thickness threshold). Additionally, in FIG. 6P, the handwritten marks 607e are provided with a second speed, indicated by the speed bar 619, optionally faster than the first speed of the handwritten marks 607d in FIG. 6N, in the user interface 600. In some embodiments, the second speed at which the handwritten marks 607e are provided is greater than a speed threshold.

In some embodiments, as shown in FIG. 6Q, in response to detecting the handwritten marks 607e having the one or more second characteristics discussed above (e.g., and in response to detecting that the threshold amount of time has elapsed as previously discussed herein), the electronic device 500 deletes the second group of handwritten content 605b in the user interface 600. In FIG. 6Q, because the handwritten marks 607e had the one or more second characteristics (e.g., a relatively large size and/or a relatively fast speed), the electronic device 500 deletes an amount of the second group of handwritten content 605b that is more than the portion of the second group of handwritten content 605b overlapped/intersected by the handwritten marks 607e. For example, as shown in FIG. 6Q, the entirety of the second group of handwritten content 605b (e.g., the whole second paragraph) is deleted in the user interface 600 despite the handwritten marks 607e not overlapping each word/character of the second group of handwritten content 605b in FIG. 6P. Additionally, as shown in FIG. 6Q, as similarly discussed above, the deletion of the second group of handwritten content 605b causes a blank space 603d (e.g., corresponding to the second region) to be created/inserted at a location of the deleted second group of handwritten content 605b in the user interface 600.

In some embodiments, the electronic device 500 provides for manipulation of handwritten content, including insertion of a blank space relative to one or more portions of the handwritten content in the user interface 600 (e.g., enabling the provision of additional/new handwritten content in the user interface 600 at the location of the blank space). In FIG. 6R, while displaying handwritten content 605a (e.g., corresponding to the first group of handwritten content 605a discussed above) in the user interface 600, the electronic device 500 detects contact of the stylus 602 on the surface of the electronic device 500, as indicated in the side view 610, directed to a location within the handwritten content 605a in the user interface 600. For example, as shown in FIG. 6R, the electronic device 500 detects the stylus 602 contact the touch screen 504 at a blank space between the words “her” and “sister” in the handwritten content 605a.

In some embodiments, in response to detecting contact of the stylus 602 for at least a threshold amount of time (e.g., 0.5, 1, 1.5, 2, 3, 4, or 5 seconds), indicated by threshold time 623 in time bar 621 in FIG. 6R, the electronic device 500 displays a cursor in the user interface 600 via which to enter a blank space within the handwritten content 605a. For example, as shown in FIG. 6S, after detecting the contact of the stylus 602 on the surface of the electronic device 500 for at least the threshold amount of time, as indicated by the threshold time 623 in the time bar 621, the electronic device 500 displays cursor 620 at a location in the user interface 600 corresponding to a location of the contact of the stylus 602 on the surface of the electronic device 500. As shown in FIG. 6S, for example, the cursor 620 is displayed at the location of the tip of the stylus 602 in the user interface 600 (e.g., between the words “her” and “sister” in the handwritten content 605a).

From FIGS. 6S-6T, while displaying the cursor 620 in the user interface 600, the electronic device 500 detects liftoff of the stylus 602 from the surface of the electronic device 500, as shown in the side view 610 in FIG. 6T. In some embodiments, as shown in FIG. 6T, in response to detecting the liftoff of the stylus 602 from the surface of the electronic device 500 (e.g., from the touch screen 504), the electronic device 500 inserts a blank space 603e at a location of the cursor 620 in the user interface 600. For example, as shown in FIG. 6T, the electronic device 500 enters the blank space 603e between the words “her” and “sister” in the handwritten content 605a in the user interface 600. In some embodiments, a size of the blank space 603e is a predetermined size (e.g., a default size selected automatically by the electronic device 500). In some embodiments, the size of the blank space 603e corresponds to a distance between the location of the cursor 620 and a boundary/edge of the user interface 600, such as a boundary of the third line of the handwritten content 605a in which the cursor 620 was displayed in FIG. 6S. Additionally, in some embodiments, as shown in FIG. 6S, entering the blank space 603e in the user interface 600 causes a portion of the handwritten content 605a to be reflowed in the user interface 600. For example, as similarly discussed above, the electronic device 500 shifts the text “sister” to the fourth line (e.g., the last line) in the user interface 600. In some embodiments, as shown in FIG. 6S, after inserting the blank space 603e within the handwritten content 605a in response to detecting liftoff of the stylus 602 from the surface of the electronic device 500, the electronic device 500 ceases display of the cursor 620 in the user interface 600.

In some embodiments, while the cursor 620 is displayed in the user interface 600, the cursor 620 is movable (e.g., in accordance with movement of the stylus 602 on the surface of the electronic device 500) to enter a blank space having a size corresponding to the movement of the cursor 620. For example, in FIG. 6U, while displaying the cursor 620 is displayed in the user interface 600, the electronic device 500 detects movement of the stylus 602 on the surface of the electronic device 500 (e.g., without detecting liftoff of the stylus 602 from the surface). In some embodiments, as shown in FIG. 6U, the movement of the stylus 602 corresponds to rightward movement relative to the location of the cursor 620.

In some embodiments, as shown in FIG. 6V, in response to detecting the movement of the stylus 602 on the surface of the electronic device 500 (e.g., the touch screen 504), the electronic device 500 moves the cursor 620 in accordance with the movement of the stylus 602. For example, as shown in FIG. 6V, the electronic device 500 moves the cursor 620 rightward in the user interface 600 to remain located at the location of the tip of the stylus 602 in the user interface 600. In some embodiments, as shown in FIG. 6V, when the electronic device 500 moves the cursor 620 in accordance with the movement of the stylus 602, the electronic device 500 reflows a portion of the handwritten content 605a following the cursor 620, which creates a blank space 603f in the handwritten content 605a. For example, as shown in FIG. 6V, the blank space 603f that is created in the user interface 600 extends between (e.g., has a size corresponding to a distance between) the prior location of the cursor 620 in FIG. 6U and the current location of the cursor 620 in FIG. 6V. Particularly, as shown in FIG. 6V, in some embodiments, the electronic device 500 reflows a portion of the handwritten content 605a (e.g., the portion following the cursor 620) in accordance with the movement of the cursor 620, thereby creating the blank space 603f in the handwritten content 605a in the user interface 600.

In some embodiments, when the electronic device 500 reflows handwritten content in the user interface 600, the electronic device 500 introduces a hyphen between letters of a word in the handwritten content. For example, as shown in FIG. 6V, when the electronic device 500 reflows the portion of the handwritten content 605a in accordance with the movement of the cursor 620, the electronic device 500 introduces a hyphen in the word “sister” in the handwritten content 605a in the user interface 600. In some embodiments, the electronic device 500 introduces a handwriting-based hyphen (as illustrated in FIG. 6V) or a font-based hyphen. In some embodiments, the hyphen is introduced between syllable breaks within a respective word in the handwritten content 605a. In some embodiments, the hyphen is not specifically introduced between syllable breaks within a respective word in the handwritten content 605a. For example, as shown in FIG. 6V, the hyphen is displayed between the letters “t” and “e” in the word “sister” in the user interface.

In FIG. 6V, the electronic device 500 detects further movement of the stylus 602 on the surface of the electronic device 500 (e.g., the touch screen 504). For example, as shown in FIG. 6V, while the cursor 620 is displayed in the user interface 600, the electronic device 500 detects leftward movement of the stylus 602 relative to the location of the cursor 620 in the user interface 600.

In some embodiments, as shown in FIG. 6W, in response to detecting the movement of the stylus 602 on the surface of the electronic device 500 (e.g., the touch screen 504), the electronic device 500 reflows a portion of the handwritten content 605a preceding the cursor 620 in FIG. 6V, which optionally removes the blank space 603f in the handwritten content 605a. For example, as shown in FIG. 6V, the electronic device 500 moves the text “sister on the bank,” leftward in the user interface 600 based on the leftward movement of the stylus 602 on the surface of the electronic device 500, which causes the text “sister on” to occupy the blank space 603f in the user interface 600. Additionally, as shown in FIG. 6W and as similarly described above, when the electronic device 500 reflows the portion of the handwritten content 605a, the electronic device 500 updates locations at which one or more characters are displayed within the lines of the handwritten content 605a in the user interface 600 based on the movement of the stylus 602. For example, as shown in FIG. 6W, the leftward movement of the stylus 602 in the user interface 600 causes the text “by her” to be moved leftward in the user interface 600 and the word “by” to be shifted up from the third line (e.g., in FIG. 6V) in the user interface 600 to the second line, preceding the third line, in the user interface 600 (e.g., due to the magnitude (e.g., of distance) of the leftward movement of the stylus 602). Additionally, in FIG. 6W, the electronic device 500 is no longer detecting contact of the stylus 602 on the surface of the electronic device 500, as indicated in the side view 610, causing the electronic device 500 to cease display of the cursor 620 in the user interface 600 as similarly discussed above.

In some embodiments, a manner in which the electronic device 500 reflows a portion of handwritten content in the user interface 600 is based on one or more characteristics of the handwritten content. In some embodiments, as similarly described above, the one or more characteristics of the handwritten content include a size of characters in the handwritten content (e.g., length, width, and/or thickness of the lines forming the characters), an orientation of the characters in the handwritten content (e.g., an angle at which the characters are written relative to the user interface 600), a number of lines in which the characters of the handwritten content is written/displayed in the user interface 600, a spacing between adjacent characters and/or words in the handwritten content in the user interface, among other characteristics as discussed in methods 700, 900, and/or 1100.

In FIG. 6X, the electronic device 500 is displaying handwritten content 605 having one or more first characteristics in the user interface 600. For example, as shown in FIG. 6X, the handwritten content 605 has a first orientation in the user interface 600. As shown in FIG. 6X, the characters of the handwritten content 605 are displayed in the user interface 600 at a first angle (e.g., as dictated by the bottom portions of the handwritten characters of the handwritten content 605) relative to a reference orientation (e.g., horizontal orientation) associated with the user interface 600.

In FIG. 6X, the electronic device 500 detects initiation of an input corresponding to a request to delete a portion of the handwritten content 605 in the user interface 600. For example, as shown in FIG. 6X, the electronic device 500 detects contact of the stylus 602 on the surface of the electronic device 500 (e.g., the touch screen 504), as indicated in the side view 610, followed by continuous and/or sequential movement of the stylus 602 on the surface, as shown in FIG. 6Y. In some embodiments, as similarly discussed herein, the movement of the stylus 602 on the surface of the electronic device 500 corresponds to and/or generates handwritten marks 607f. In some embodiments, as shown in FIG. 6Y, the handwritten marks 607f are directed to the portion of the handwritten content 605, particularly the text “Alice” in the handwritten content 605. In some embodiments, as shown in FIG. 6Y and as similarly discussed above, the electronic device 500 display a representation of the handwritten marks 607f concurrently with (e.g., overlaid on) the portion of the handwritten content 605.

In some embodiments, when the electronic device 500 deletes the portion of the handwritten content 605 designated by the handwritten marks 607f, the electronic device 500 reflows the (e.g., other portions of the) handwritten content 605 based on the one or more first characteristics of the handwritten content 605. For example, in FIG. 6Z, after the portion of the handwritten content 605 (e.g., the text “Alice”) is deleted in the user interface 600 (e.g., after detecting that the threshold amount of time, as indicated by the threshold time 611 in the time bar 609, has elapsed while detecting contact of the stylus 602 on the surface of the electronic device 500 after providing the handwritten marks 607f), the electronic device 500 reflows the handwritten content 605 based on the first orientation of the handwritten content 605 in the user interface (e.g., after detecting that the second threshold amount of time, as indicated by the threshold time 615 in the time bar 613, has elapsed since deleting the portion of the handwritten content 605). Particularly, as shown in FIG. 6Z, the electronic device 500 moves the characters of the handwritten content 605 leftward along the first angle of the bottom portions of the characters of the handwritten content 605 (e.g., relative to the horizontal orientation of the user interface), such that the text “was beginning” occupies the location of the deleted text “Alice” and the text “to” is shifted upward from the second line of the handwritten content 605 in FIG. 6Y to the first line of the handwritten content 605 in the user interface 600.

In some embodiments, the electronic device 500 provides for manipulation of handwritten content, including adjusting a boundary associated with the handwritten content. As previously discussed above, the boundary of the handwritten content corresponds to and/or is based on a (e.g., predefined or user-defined) margin of the user interface 600, which optionally (e.g., at least partially) dictates a number of characters contained within a respective line of a plurality of lines in which the handwritten content is displayed. Similarly, in some embodiments, the boundary of the handwritten content (e.g., at least partially) dictates a number of the plurality of lines in which the handwritten content is displayed, and/or a size of the characters of the handwritten content displayed in the user interface. In some embodiments, as described below, the electronic device 500 is configured to display one or more graphical user interface elements for controlling and/or changing one or more metrics of the boundary of the handwritten content, including changing a size of the boundary.

In FIG. 6AA, the electronic device 500 is displaying handwritten content 625 in the user interface 600. As shown in FIG. 6AA, and as similarly discussed above, the handwritten content 625 is displayed in a plurality of lines (e.g., five lines of characters) in the user interface 600. In FIG. 6AA, while displaying the handwritten content 625 in the user interface 600, the electronic device 500 detects a tap of a contact 601 (e.g., tap of a finger of a hand of the user) directed to a location of the user interface 600 corresponding to the handwritten content 625. For example, as shown in FIG. 6AA, the electronic device 500 detects a tap of the contact 601 on the touch screen 504 of the electronic device 500, indicated in the side view 610, over text “Alice” in the handwritten content 625. In some embodiments, the tap of the contact 601 is a single tap (e.g., a tap of the finger of the user followed by liftoff of the finger from the touch screen 504).

In some embodiments, as shown in FIG. 6BB, in response to detecting the tap of the contact 601 directed to the handwritten content 625, the electronic device 500 displays one or more graphical user interface elements in the user interface 600. In some embodiments, as shown in FIG. 6BB, the one or more graphical user interface elements include bounding box 630. As shown in FIG. 6BB, the bounding box 630 is displayed around (e.g., visually wraps around) the handwritten content 625 in the user interface 600 (and optionally not solely around the word “Alice” to which the tap of the contact 601 in FIG. 6AA was directed). In some embodiments, the bounding box 630 provides a visual indication of a current size of the boundary of the handwritten content 625 in the user interface 600. Additionally, in some embodiments, the one or more graphical user interface elements include a set of resizing handles that are selectable to initiate adjustment of one or more metrics of the boundary, including the size of the boundary. For example, as shown in FIG. 6BB, the electronic device displays a first resizing handle 631a (e.g., at a first edge/side of the bounding box 630), a second resizing handle 631b (e.g., at a second, opposite, edge/side of the bounding box 630), and a third resizing handle 631c (e.g., at a corner of the bounding box 630) in the user interface 600. In some embodiments, the first resizing handle 631a and/or the second resizing handle 631b are selectable and/or movable to initiate changing a width of the bounding box 630, and therefore a width of the boundary of the handwritten content 625 (e.g., which affects the number of characters of the handwritten content 625 that is able to be displayed in a respective line of the plurality of lines of the handwritten content 625). In some embodiments, the third resizing handle 631c is selectable and/or movable to initiate changing a length and/or the width of the bounding box 630 (e.g., depending on a direction of the movement of the third resizing handle 631c), and therefore the length and/or the width of the boundary of the handwritten content 625. For example, in FIG. 6BB, vertical movement of the third resizing handle 631c in the user interface 600 causes the electronic device 500 to change the length of the bounding box 630, which changes the length of the boundary, while diagonal movement of the third resizing handle 631c in the user interface 600 causes the electronic device 500 to change the length and the width of the bounding box 630 (e.g., and therefore the length and the width of the boundary).

In FIG. 6BB, while displaying the one or more graphical user interface elements described above, the electronic device 500 detects movement of contact 601 on the surface of the electronic device 500 (e.g., the touch screen 504) directed to the third resizing handle 631c in the user interface 600. For example, as shown in FIG. 6BB, the electronic device 500 detects a tap of a finger of the user directed to the third resizing handle 631c, as indicated in the side view 610, followed by diagonal movement of the contact 601 corresponding to movement of the third resizing handle 631c away from the handwritten content 625 in the user interface 600 (optionally without detecting liftoff of the contact 601 from the surface of the electronic device 500).

In some embodiments, as shown in FIG. 6CC, in response to detecting the movement of the third resizing handle 631c in the user interface 600, the electronic device 500 increases the size (e.g., width and length) of the boundary of the handwritten content 625, as indicated by the increased size of the bounding box 630. For example, because the movement of the third resizing handle 631c corresponds to movement diagonally away from the handwritten content 625, the electronic device 500 increases the size of the boundary of the handwritten content 625, as opposed to decreasing the size of the boundary (e.g., which occurs in response to detecting movement of the third resizing handle 631c in a direction that is toward the handwritten content 625 in the user interface 600). In some embodiments, as shown in FIG. 6CC, when the electronic device 500 increases the size of the boundary of the handwritten content 625, the electronic device 500 correspondingly increases the size of the handwritten content 625 in the user interface 600. For example, as shown in FIG. 6CC, the electronic device 500 uniformly increases the sizes of the characters of the handwritten content 625 by an amount that is based on and/or corresponds to the distance that the third resizing handle 631c is moved in the user interface 600.

In some embodiments, in accordance with a determination that the movement of the third resizing handle 631c causes the boundary of the user interface 600 to increase to a point that the aspect ratio of the handwritten content 625 changes as the size of the handwritten content 625 increases, the electronic device 500 reflows the handwritten content 625 as similarly discussed above. For example, in FIG. 6CC, the electronic device 500 detects further movement of the contact 601 on the surface of the electronic device 500, as indicated in the side view 610, corresponding to further movement of the third resizing handle 631c diagonally (e.g., in a same direction as above) in the user interface 600.

In some embodiments, as shown in FIG. 6DD, as similarly described above, in response to detecting the movement of the third resizing handle 631c, the electronic device 500 increases the boundary of the handwritten content 625 further, as reflected in the increased size of the bounding box 630, in accordance with the movement of the third resizing handle 631c. In some embodiments, when the electronic device 500 increases the size of the boundary as illustrated in FIG. 6DD, the electronic device 500 increases the size of the handwritten content 625 as similarly described above. As shown in FIG. 6DD, the increase in the size of the handwritten content 625 results in a change in aspect ratio of the handwritten content 625 (compared to FIG. 6BB). Accordingly, the electronic device 500 reflows the handwritten content 625 in the user interface 600. For example, as shown in FIG. 6DD, the electronic device 500 updates the locations at which characters and/or words are displayed in the plurality of lines of the handwritten content 625. As shown in FIG. 6DD, the electronic device 500 increases the number of the plurality of lines in which the handwritten content is displayed from five lines to seven lines to accommodate the increased sizes of the characters in the handwritten content 625.

In FIG. 6EE, the electronic device 500 is displaying the handwritten content 625 in the user interface 600, as previously illustrated and described above with reference to FIG. 6AA. As shown in FIG. 6EE, the electronic device 500 detects a tap of a contact 601 (e.g., tap of a finger of a hand of the user) directed to a location of the user interface 600 corresponding to the handwritten content 625. For example, as shown in FIG. 6EE, the electronic device 500 detects a tap of the contact 601 on the touch screen 504 of the electronic device 500, indicated in the side view 610, over text “was” in the handwritten content 625. In some embodiments, the tap of the contact 601 is a double tap (e.g., a first tap of the finger of the user followed by liftoff of the finger from the touch screen 504, followed by a second tap of the finger).

In some embodiments, as shown in FIG. 6FF, in response to detecting the double tap of the contact directed to the handwritten content 625, the electronic device 500 displays the one or more graphical user interface elements described above with reference to FIG. 6BB. For example, as shown in FIG. 6FF, the electronic device 500 displays the bounding box 630 and the first, second, and third resizing handles 631a-631c in the user interface with the handwritten content 625. Additionally, in some embodiments, as shown in FIG. 6FF, the electronic device 500 selects the text “was” in the handwritten content 605, as indicated by visual indication 612 (e.g., highlighting), and optionally displays toolbar element 614 in the user interface 600. In some embodiments, the toolbar element 614 corresponds to the toolbar element 614 illustrated in FIG. 6G. In some embodiments, as shown in FIG. 6FF, when the electronic device 500 selects the text “was” in the handwritten content 605 in response to detecting the double tap of the contact 601 as discussed above, the electronic device 500 displays first and second scaling handles 634a and 634b in the user interface 600. As shown in FIG. 6FF, the electronic device 500 displays the first and second scaling handles 634a and 634b adjacent to (e.g. surrounding) the text “was” in the user interface 600. In some embodiments, the first scaling handle 634a and the second scaling handle 634b are selectable and/or movable to initiate changing a size of the text “was” in the handwritten content 625, without changing a size of other characters/words in the handwritten content 625 in the user interface 600.

FIGS. 6A-6FF are further described with reference to method 700 of FIG. 7.

FIG. 7 is a flowchart illustrating a method for facilitating manipulation of handwritten content in accordance with some embodiments. The method 700 is optionally performed at an electronic device such as device 100, device 300, device 500, or device 580 as described above with reference to FIGS. 1A-1B, 2-3, 4A-4B, 5A-5C and 5I. Some operations in method 700 are, optionally combined and/or order of some operations is, optionally, changed.

As described below, the method 700 provides ways of facilitating deletion of portions of handwritten content and subsequent reflow of undeleted portions of the handwritten content. The method reduces the cognitive burden on a user when interacting with a user interface of the device of the disclosure, thereby creating a more efficient human-machine interface. For battery-operated electronic devices, increasing the efficiency of the user's interaction with the user interface conserves power and increases the time between battery charges.

In some embodiments, the method 700 is performed at an electronic device (e.g., electronic device 500 in communication with a display generation component (e.g., touch screen 504) and one or more input devices (e.g., stylus 602). For example, a mobile device (e.g., a tablet, a smartphone, a media player, or a wearable device), a computer (e.g., a desktop computer, a laptop computer), or a wearable device (e.g., a watch, a head-mounted device), optionally in communication with one or more of a mouse (e.g., external), trackpad (optionally integrated or external), remote control device (e.g., external), another mobile device (e.g., separate from the electronic device), a handheld device (e.g., external), and/or a controller (e.g., external), or a set-top box in communication one or more input devices (e.g., a remote control). In some embodiments, the display generation component is a display integrated with the electronic device (optionally a touch screen display), external display such as a monitor, projector, television, or a hardware component (optionally integrated or external) for projecting a user interface or causing a user interface to be visible to one or more users. In some embodiments, the one or more sensors optionally include one or more sensors of FIG. 1A. In some embodiments, the one or more input devices include a stylus in communication with the electronic device.

In some embodiments, while displaying, in a user interface (e.g., user interface 600 in FIG. 6B), a first representation of handwritten content that includes a sequence of characters (e.g., displayed in response to detecting handwritten input on a surface (e.g., a touch-sensitive surface of the one or more input devices)), such as handwritten content 605 in FIG. 6B, the electronic device detects (702), via the one or more input devices, a first input corresponding to a request to delete a first portion of the sequence of characters of the first representation of handwritten content, such as handwritten marks 607a provided by stylus 602 as shown in FIG. 6C, wherein the first portion of the sequence of characters is displayed at a first location in the user interface, such as the location of words “sitting by” in the user interface 600 in FIG. 6B. For example, the user interface corresponds to a text composition user interface associated with a note-taking application, a messaging application, a journaling or scheduling application, a text-editor application, and/or a text annotation application or any other region that can accept handwritten input. In some embodiments, the user interface includes a handwriting entry region configured to receive handwritten input (e.g., provided directly into the user interface region (e.g., the touch sensitive surface includes the user interface) or populated into the user interface by the electronic device after receiving the handwritten input via a separate touch-sensitive surface such as a trackpad)). In some embodiments, the first representation of handwritten content is displayed within the handwriting entry region discussed above (e.g., such that the first location is within the handwriting entry region). In some embodiments, the first representation of handwritten content corresponds to a representation of the handwritten input, which includes representations of handwritten words. In some embodiments, the sequence of characters of the first representation of handwritten content is displayed within the user interface in a first number of lines of characters, such as 1, 2, 3, 4, 5, 8, 10, or 12 lines, and optionally corresponds to the number of lines in which the handwritten words, numbers, and/or special characters were written in the handwritten input. In some embodiments, the sequence of characters corresponds to a paragraph displayed in a first number of lines of characters and/or a paragraph having a first width (e.g., the first number of lines of characters extends a first distance (e.g. horizontally) across the user interface), which optionally corresponds to a width of a bounding box containing/confining the lines of the sequence of characters. In some embodiments, the sequence of characters corresponds to a list (e.g., a bulleted list, a numbered list, or a lettered list) of words displayed in a first number of lines of words. In some embodiments, as mentioned above, the first representation of handwritten content is displayed in the user interface in response to handwritten input received via an external device/tool for providing handwritten input (e.g., a stylus) or via a finger of a hand of a user of the electronic device. In some embodiments, the handwritten input includes continuous and/or subsequent strokes and/or contacts (e.g., provided by the stylus or finger of the user) detected on the touch sensitive surface that are recognized by the electronic device as handwritten input (e.g., handwritten words, numbers, special characters, and/or shapes), as discussed below. In some embodiments, the first portion of the sequence of characters corresponds to a single or collection of letter(s), number(s), or special character(s) of the sequence of characters of the first representation of handwritten content. In some embodiments, the first portion of the sequence of characters corresponds to a single word of the sequence of characters of the first representation of handwritten content. In some embodiments, the first portion of the sequence of characters corresponds to a plurality of words (optionally a sentence or multiple sentences) of the sequence of characters of the first representation of handwritten content. In some embodiments, the first portion of the sequence of characters corresponds to a paragraph (or a plurality of paragraphs) of the sequence of characters of the first representation of handwritten content.

In some embodiments, the electronic device receives the first input via an external device/tool for providing handwritten input (e.g., a stylus) or via a finger of a hand of the user of the electronic device, such as the stylus 602 in FIG. 6C. In some embodiments, as described in more detail below, the first input includes respective handwritten input, such as continuous and/or subsequent strokes and/or contacts detected on the touch sensitive surface. For example, the respective handwritten input includes handwritten lines, scratch marks, and/or similar patterns/shapes. In some embodiments, as discussed in more detail below, the respective handwritten input is directed to the first portion of the sequence of characters of the first representation of handwritten content in the user interface. For example, the respective handwritten input includes handwritten lines and/or scratch marks over and/or across the first portion of the sequence of characters of the first representation of handwritten content in the user interface. Additionally, in some embodiments, as discussed in more detail below, the respective handwritten input is followed by a hold of a contact (e.g., a stylus or a finger) on the surface (e.g., the touch-sensitive surface) for at least a first threshold amount of time (e.g., 0.25, 0.5, 0.75, 1, 2, 3, 5, or 10 seconds). In some embodiments, as discussed in more detail below, the first input includes a tap or touch input (e.g., of a stylus or finger) directed to the first portion of the sequence of characters of the first representation of handwritten content. For example, the first input includes a selection input directed to the first portion of the sequence of characters.

In some embodiments, in response to detecting the first input (704), the electronic device deletes (706), at the first location in the user interface, the first portion of the sequence of characters of the first representation of the handwritten content, such as deleting the words “sitting by” in the handwritten content 605 as shown in FIG. 6D. For example, the electronic device removes (e.g., ceases display of) the first portion of the sequence of characters of the first representation of the handwritten content from the first location in the user interface. In some embodiments, after the first portion of the sequence of characters is deleted at the first location in the user interface, a space or vacancy (e.g., white or blank space) is created within the representation of handwritten content at the first location in the user interface. For example, if the first portion of the sequence of characters corresponds to a single word/term, deleting the first portion of the sequence of characters creates and/or causes the electronic device to display a blank space having a size (e.g., length and/or height) corresponding to a size of the single word/term in the first representation of the handwritten content. As another example, if the first portion of the sequence of characters corresponds to a single character (e.g., letter, number, or special character) within a word/term, deleting the first portion of the sequence of characters creates and/or causes the electronic device to display a blank space having a size corresponding to a size of the single letter, number, or special character. In some embodiments, after the first portion of the sequence of characters of the first representation of the handwritten content is deleted at the first location in the user interface, the undeleted portions of the sequence of characters of the first representation of the handwritten content remain unchanged within the user interface. For example, the electronic device temporarily (e.g., as discussed below) forgoes moving, shifting and/or otherwise updating display of the portions of the sequence of characters of the first representation of handwritten content that are not deleted in the user interface (e.g., such that the undeleted portions of the sequence of characters remain displayed at their prior and/or current locations in the user interface relative to the first location).

In some embodiments, in accordance with a determination that a second input that includes first handwritten input on a surface (e.g., on a touch-sensitive surface in communication with the electronic device and/or integrated with the display generation component) directed to at least the first location in the user interface is not detected via the one or more input devices, such as the stylus 602 not being in contact with the surface of the electronic device 500 as shown in side view 610 in FIG. 6E, within a threshold amount of time (e.g., 0.5, 0.75, 1, 2, 3, 4, 5, 8, 10, or 15 seconds), as indicated by threshold time 615 in time bar 613 in FIG. 6E, of deleting the first portion of the sequence of characters (708), the electronic device updates (710) display of the first representation of handwritten content to include a second portion, different from the first portion (e.g., following/proceeding the first portion of the sequence of characters), of the sequence of characters at the at least the first location in the user interface (which optionally includes portions of the sequence of characters previously occupying lines in the first representation of handwritten content following the current line corresponding to the first location in the user interface), such as shifting the words “her sister on” to be located at the location of the deleted words “sitting by” as shown in FIG. 6E. For example, after deleting the first portion of the sequence of characters at the first location in the user interface, the electronic device provides a delay (e.g., equal to the threshold amount of time) during which the user of the electronic device is able to provide subsequent input (e.g., subsequent handwritten input) directed to the first location in the user interface (e.g., write and/or draw, via the stylus or finger of the user, handwritten words, numbers, special characters, and/or shapes directed to and/or at the first location in the user interface). In some embodiments, if the electronic device determines that no subsequent input, including subsequent handwritten input, is detected directed to the first location in the user interface before the threshold amount of time has elapsed since deleting the first portion of the sequence of characters, the electronic device updates the first representation of handwritten content to include a second character (e.g., letter, number, or special character), word, sentence, or group of sentences at the at least the first location in the user interface. Particularly, the electronic device optionally shifts/moves the second portion of the sequence of characters following (e.g., adjacent to) the blank space created after deleting the first portion of the sequence of characters in the user interface, such that the second portion of the sequence of characters at least partially occupies the blank space at the first location in the user interface. For example, if the first portion of the sequence of characters corresponds to a first word and the second portion of the sequence of characters corresponds to a second word, that follows the first word in the first representation of handwritten content, the electronic device shifts/moves the second word (e.g., to the left and/or up) in the user interface, such that the second word at least partially occupies (e.g., replaces) the blank space created at the first location when the first word is deleted (e.g., such that the second portion, including third portions following/proceeding the second portion, of the sequence of characters optionally are located at different/updated locations in the user interface compared to prior to the threshold amount of time elapsing without detecting further input as discussed above). Accordingly, in some embodiments, the first portion and the second portion of the sequence of characters are concurrently included in the first representation of handwritten content when the first input discussed above is detected. In some embodiments, the electronic device updates the representation of handwritten content with an animation of the second portion of the sequence of characters moving into the blank space at the first location of the user interface. In some embodiments, a magnitude (e.g., amount, such as distance, and/or direction) that the second portion of the sequence of characters moves within the user interface to the first location is based on a size of the blank space at the first location, and thereby, the size of the first portion of the sequence of characters, as similarly discussed above, and an orientation of the blank space at the first location, and thereby, an orientation of the first portion of the sequence of characters of the first representation of handwritten content. In some embodiments, as discussed in more detail below, updating the first representation of handwritten content in the manner discussed above in the user interface causes the number of lines of characters in which the sequence of characters is displayed (e.g., lines in the paragraph) to be updated. For example, the electronic device decreases the number of lines from the first number of lines discussed above to a second number of lines, fewer than the first number of lines (optionally due to the first portion of the sequence of characters being deleted and the second portion of the sequence of characters being shifted in the user interface to occupy the first location in the user interface). In some embodiments, when the electronic device updates the number of lines of characters in which the sequence of characters is displayed (e.g., lines in the paragraph), the electronic device maintains the width of the lines (e.g., the width of the paragraph) in the user interface. For example, maintaining the width of the paragraph including the sequence of characters controls the manner in which the number of lines is updated (e.g., by how many lines the number of lines decreases as discussed above). Accordingly, the particular characters and/or words that are included in the lines following the line containing the first location in the user interface are optionally moved to and/or redisplayed at different locations within their respective lines in the first representation of handwritten content or are moved to and/or redisplayed within different lines (e.g., than previously) in the first representation of handwritten content when the second portion of the sequence of characters is displayed at the at least the first location in the user interface. Additionally, in some embodiments, when the first representation of handwritten content is updated to include the second portion of the sequence of characters at the at least the first location in the user interface, the portions of the sequence of characters that preceded the first portion of the sequence of characters in the first representation of handwritten content (e.g., the letters, numbers, and/or special characters spatially located before the first portion of the sequence of characters within the first representation of the handwritten content prior to the first portion being deleted) are not updated in the user interface. For example, the electronic device forgoes moving/shifting the portions of the sequence of characters that preceded the first portion at the first location in the user interface.

In some embodiments, in accordance with a determination that the second input is detected, such as handwriting input 617 provided by the stylus 602 in FIG. 6J, within the threshold amount of time, as indicated by the threshold time 615 in the time bar 613 in FIG. 6J, of deleting the first portion of the sequence of characters (712), the electronic device updates (714) display of the first representation of handwritten content to include a first representation of the first handwritten input at the at least the first location in the user interface (e.g., representation of the handwritten input 617 in FIG. 6K), without updating (and/or delaying updating) display of the first representation of handwritten content to include the second portion of the sequence of characters at the at least the first location in the user interface. For example, as similarly discussed above, the electronic device receives subsequent input via an external device/tool for providing handwritten input (e.g., a stylus) or via a finger of a hand of a user of the electronic device. In some embodiments, the second input includes continuous and/or subsequent strokes and/or contacts (e.g., provided by the stylus or finger of the user) detected on the touch sensitive surface that are recognized by the electronic device as handwritten input (e.g., handwritten words, numbers, special characters, and/or shapes), as similarly discussed above. In some embodiments, the first handwritten input is directed to the first location in the user interface (e.g., the blank space created after the first portion of the sequence of characters is deleted). In some embodiments, while receiving the strokes and/or contacts of the second input that form the first handwritten input, the electronic device displays a second representation of the first handwritten input at the at least the first location in the user interface. In some embodiments, the second representation of the first handwritten input corresponds to representations of handwritten words, number, special characters, and/or shapes written/drawn at the at least the first location in the user interface. In some embodiments, because the second representation of the first handwritten input is displayed at the first location in the user interface, thus occupying the blank space created by the deletion of the first portion of the sequence of characters, the electronic device forgoes updating the first representation of handwritten content to include the second portion of the sequence of characters at the first location in the user interface. For example, the electronic device forgoes shifting/moving the second portion of the sequence of characters in the user interface to occupy the blank space created by the deletion of the first portion of the sequence of characters. In some embodiments, as discussed in more detail below, displaying the second representation of the first handwritten input in the first representation of handwritten content causes the electronic device to shift the second portion of the sequence of characters in the other direction (e.g., to the right and/or down in the user interface) to accommodate the second representation of the first handwritten input (e.g., a length and/or size of the newly handwritten words, numbers, special characters, and/or shapes), which optionally causes the electronic device to also update the number of lines in which the sequence of characters is displayed as similarly discussed above (e.g., increases the number of lines, rather than decreases the number of lines). Updating display of a representation of a handwritten sequence of characters in a user interface based on whether handwritten input is detected within a threshold amount of time of deleting a portion of the handwritten sequence of characters facilitates user input for replacing the deleted portion of the handwritten sequence of characters with new handwritten characters and/or enables the display of the representation of the handwritten sequence of characters to be updated automatically after the portion of the handwritten sequence of characters is deleted, thereby improving user-device interaction.

In some embodiments, the first input corresponding to the request to delete the first portion of the sequence of characters of the first representation of handwritten content includes one or more handwritten marks provided by an input device (e.g., a stylus or similar input device or a finger of a hand of the user) in communication with the electronic device on the surface directed to the first portion of the sequence of characters, such as handwritten marks 607a provided by stylus 602 as shown in FIG. 6C. For example, detecting the first input includes detecting one or more strokes of the input device on the surface at a location on the surface corresponding to the first portion of the sequence of characters. In some embodiments, the one or more handwritten marks provided by the electronic device are detected continuously (e.g., without detecting liftoff of the input device from the surface in between successive handwritten marks of the one or more handwritten marks). In some embodiments, the one or more handwritten marks provided by the electronic device are detected sequentially (e.g., with detecting liftoff of the input device from the surface in between successive handwritten marks of the one or more handwritten marks). In some embodiments, in response to detecting the one or more handwritten marks provided by the input device, the electronic device displays, in the user interface, a representation of the one or more handwritten marks concurrently with the first representation of handwritten content. For example, the electronic device displays one or more lines overlaid on, above, below, and/or adjacent to the first portion of the sequence of characters in the user interface. In some embodiments, as discussed in more detail below, the one or more handwritten marks encompass, overlap with, and/or otherwise include the first portion of the sequence of characters in the user interface.

In some embodiments, the first input corresponding to the request to delete the first portion of the sequence of characters of the first representation of handwritten content includes contact of the input device on the surface for at least a second threshold amount of time (e.g., 0.25, 0.5, 0.75, 1, 2, 3, 5, or 10 seconds), such as contact of the stylus 602 on touch screen 504 for threshold time 611 in time bar 609 as shown in FIG. 6C. For example, the electronic device detects the input device on the surface for at least the second threshold amount of time after detecting the one or more handwritten marks provided by the input device. In some embodiments, the electronic device detects the input device on the surface for at least the threshold amount of time without detecting liftoff of the input device from the surface after detecting the one or more handwritten marks. In some embodiments, the electronic device detects the contact of the input device on the surface for at least the second threshold amount of time without detecting prior liftoff of the input device from the surface, such as between detecting the one or more handwritten marks and the contact of the input device on the surface. In some embodiments, a location of the contact of the input device on the surface need not necessarily be directed to the first portion of the sequence of characters for the second threshold amount of time. In some embodiments, one or more of the one or more handwritten marks at least partially intersects with and/or overlaps the first portion of the sequence of characters. Accordingly, in some embodiments, as discussed above, in response to detecting the one or more handwritten marks on the surface directed to the first portion of the sequence of characters in the user interface, followed by the contact of the input device on the surface for at least the second threshold amount of time, the electronic device deletes, at the first location in the user interface, the first portion of the sequence of characters of the first representation of the handwritten content. Deleting a portion of a representation of a handwritten sequence of characters in a user interface in response to detecting one or more handwritten marks provided by an input device directed to the portion, followed by contact of the input device on a surface for at least a threshold amount of time helps avoid undesired and/or unintentional deletion of the portion of the representation of the handwritten sequence of characters and/or reduces the number of inputs needed to delete the portion of the representation of the handwritten sequence of characters, thereby improving user-device interaction.

In some embodiments, while displaying the first representation of handwritten content that includes the sequence of characters, the electronic device detects, via the one or more input devices, a second input directed to a respective portion, different from the first portion, of the sequence of characters, wherein the second input includes one or more handwritten marks provided by the input device (e.g., as similarly discussed above) on the surface, such as handwritten marks 607c provided by the stylus 602 as shown in FIG. 6L, without contact of the input device on the surface for at least the second threshold amount of time (e.g., 0.25, 0.5, 0.75, 1, 2, 3, 5, or 10 seconds), as indicated by threshold time 611 in time bar 609 in FIG. 6L. For example, the electronic device detects liftoff of the input device from the surface after detecting the one or more handwritten marks provided by the input device on the surface. In some embodiments, the electronic device detects the liftoff of the input device from the surface before the second threshold amount of time elapses since detecting the one or more handwritten marks provided by the input device on the surface.

In some embodiments, in response to detecting the second input, in accordance with a determination that the respective portion of the sequence of characters corresponds to handwritten text (e.g., is a respective representation of handwritten input having a size, a shape, an orientation, a spacing between the characters, a thickness of lines forming the characters, and/or one or more stroke patterns used to form the characters according to the handwritten input), such as handwritten text “to get” in the handwritten content 605 in FIG. 6L, the electronic device displays, in the user interface, a representation of the one or more handwritten marks concurrently with the first representation (e.g., as similarly discussed above), without deleting the respective portion of the sequence of characters, such as displaying the handwritten marks 607c in the user interface 600 without deleting the text “to get” as shown in FIG. 6L. For example, as previously discussed above, because the one or more handwritten marks are detected without detecting the contact of the input device on the surface for at least the second threshold amount of time, the electronic device forgoes deleting the respective portion of the sequence of characters. In some embodiments, a location of the representation of the one or more handwritten marks (e.g., lines, strokes, and/or slashes) in the user interface corresponds to the location of the one or more handwritten marks provided by the input device on the surface. Additionally, in some embodiments, because the respective portion of the sequence of characters is not deleted from the user interface, the electronic device forgoes updating display of the first representation of handwritten content to include a second respective portion, different from the respective portion (e.g., following/proceeding the respective portion of the sequence of characters), of the sequence of characters at a location of the respective portion of the sequence of characters in the user interface.

In some embodiments, in accordance with a determination that the respective portion of the sequence of characters corresponds to font-based text (e.g., unlike the handwritten text and is 10-point sized, 12-point sized, etc. and optionally is Arial, Calibri, Times New Roman, etc.), the electronic device deletes the respective portion of the sequence of characters, as similarly described with reference to FIG. 6L, which would result in the deletion of the text “to get” in the user interface 600. For example, the electronic device removes (e.g., ceases display of) the respective portion of the sequence of characters of the first representation of the handwritten content from the second location in the user interface, as similarly discussed above. In some embodiments, deleting the respective portion of the sequence of characters has one or more characteristics of deleting the first portion of the sequence of characters discussed above. In some embodiments, because the respective portion of the sequence of characters corresponds to font-based text, the electronic device deletes the respective portion of the sequence of characters in response to detecting the one or more handwritten marks, irrespective of whether contact of the input device is detected on the surface for at least the second threshold amount of time. Additionally, in some embodiments, as similarly discussed above, after deleting the respective portion of the sequence of characters, in accordance with a determination that a third input that includes second handwritten input on the surface (e.g., on a touch-sensitive surface in communication with the electronic device and/or integrated with the display generation component) directed to at least the location of the respective portion of the sequence of characters in the user interface is not detected via the one or more input devices within the threshold amount of time (e.g., 0.5, 0.75, 1, 2, 3, 4, 5, 8, 10, or 15 seconds) of deleting the respective portion of the sequence of characters, the electronic device updates display of the first representation of handwritten content to include a second respective portion, different from the respective portion (e.g., following/proceeding the respective portion of the sequence of characters), of the sequence of characters at the at least the location of the respective portion in the user interface (which optionally includes portions of the sequence of characters previously occupying lines in the first representation of handwritten content following the current line corresponding to the location in the user interface). Deleting a portion of a representation of a handwritten sequence of characters in a user interface in response to detecting one or more handwritten marks provided by an input device directed to the portion based on whether the portion of the representation of the handwritten sequence of characters corresponds to handwritten text or font-based text helps avoid undesired and/or unintentional deletion of the portion of the representation of the handwritten sequence of characters and/or reduces the number of inputs needed to delete the portion of the representation of the handwritten sequence of characters, thereby improving user-device interaction.

In some embodiments, while displaying the first representation of handwritten content that includes the sequence of characters, the electronic device detects, via the one or more input devices, a third input corresponding to a request to delete a respective portion, different from the first portion, of the sequence of characters of the first representation of handwritten content, wherein the respective portion of the sequence of characters is displayed at a second location, different from the first location, in the user interface, such as the text “very” in the handwritten content 605 in FIG. 6F. In some embodiments, the respective portion of the sequence of characters corresponds to a single or collection of letter(s), number(s), or special character(s) of the sequence of characters of the first representation of handwritten content. In some embodiments, the respective portion of the sequence of characters corresponds to a single word of the sequence of characters of the first representation of handwritten content. In some embodiments, the respective portion of the sequence of characters corresponds to a plurality of words (optionally a sentence or multiple sentences) of the sequence of characters of the first representation of handwritten content. In some embodiments, the respective portion of the sequence of characters corresponds to a paragraph (or a plurality of paragraphs) of the sequence of characters of the first representation of handwritten content.

In some embodiments, the third input includes selection of the respective portion of the sequence of characters, such as a tap of stylus 602 on the touch screen 504 in FIG. 6F. For example, the electronic device detects a tap of a contact on the surface described above directed to the respective portion of the sequence of characters in the user interface. In some embodiments, the electronic device detects the selection via a tap of a finger of the user directed to the respective portion of the sequence of characters. In some embodiments, the electronic device detects the selection via a tap of an input device (e.g., a stylus) directed to the respective portion of the sequence of characters, optionally for a threshold amount of time (e.g., 0.25, 0.5, 0.75, 1, 2, 3, 5, or 10 seconds). In some embodiments, in response to detecting the selection of the respective portion of the sequence of characters, the electronic device displays the respective portion with a visual indication of the selection in the user interface. For example, the electronic device updates the display of the first representation of handwritten content to include highlighting, shading, a visual boundary, or other visual indication surrounding, overlapping, and/or otherwise associated with the respective portion of the sequence of characters in the user interface. Additionally, as discussed below, in response to detecting the selection of the respective portion of the sequence of characters, the electronic device displays a menu, toolbar, or other user interface object in the user interface that includes a plurality of options for performing a plurality of operations associated with the respective portion of the sequence of characters. In some embodiments, the toolbar is displayed relative to the representation of the first representation of handwritten content in the user interface region (e.g., above, below, or adjacent to the respective portion of the sequence of characters). In some embodiments, the toolbar is displayed in a predefined portion of the user interface (e.g., along a side or top region of the user interface).

In some embodiments, the third input includes selection of a first option that is displayed in the user interface in response to the selection of the respective portion of the sequence of characters, such as selection of selectable option 616c in FIG. 6G. As mentioned above, in some embodiments, in response to detecting the selection of the respective portion of the sequence of characters, the electronic device displays a plurality of options, including the first option, in the user interface. In some embodiments, the plurality of selectable options is selectable to perform corresponding operations involving the sequence of characters, including the respective portion, of the first representation of handwritten content. For example, the plurality of selectable options includes a copy option, a cut option, a text (e.g., font-based text) insertion option, a paste option (if applicable), and/or a delete option. In some embodiments, the first option corresponds to the delete option of the plurality of selectable options displayed in the user interface.

In some embodiments, in response to detecting the third input, the electronic device deletes, at the second location in the user interface, the respective portion of the sequence of characters of the first representation of the handwritten content, such as deleting the word “very” in the user interface 600 as shown in FIG. 6H. For example, the electronic device removes (e.g., ceases display of) the respective portion of the sequence of characters of the first representation of the handwritten content from the second location in the user interface, as similarly discussed above. In some embodiments, deleting the respective portion of the sequence of characters has one or more characteristics of deleting the first portion of the sequence of characters discussed above.

In some embodiments, the electronic device updates display of the first representation of handwritten content to include a third portion, different from the respective portion (e.g., following/proceeding the respective portion of the sequence of characters), of the sequence of characters at the at least the second location in the user interface, such as moving the word “tired” in the user interface 600 to the location of the deleted word “very” as shown in FIG. 6H. In some embodiments, the electronic device updates the display of the first representation of handwritten content to include the third portion of the sequence of characters at the at least the second location in the user interface after deleting the respective portion of the sequence of characters irrespective of whether a fourth input that includes second handwritten input on the surface directed to at least the second location in the user interface is not detected via the one or more input devices within the threshold amount of time (e.g., 0.5, 0.75, 1, 2, 3, 4, 5, 8, 10, or 15 seconds) of deleting the respective portion of the sequence of characters. For example, because the third input corresponding to the request to delete the respective portion of the sequence of characters of the first representation of handwritten content includes interaction with the toolbar discussed above (e.g., selection of the delete option), the electronic device does not wait for the threshold amount of time to elapse after deleting the respective portion of the sequence of characters to move/shift the third portion of the sequence of characters to the second location in the user interface. In some embodiments, updating display of the first representation of handwritten content to include the third portion of the sequence of characters at the at least the second location in the user interface has one or more characteristics of updating display of the first representation of handwritten content to include the second portion of the sequence of characters at the at least the first location in the user interface as discussed above. Updating display of a representation of a handwritten sequence of characters in a user interface after deleting a portion of the handwritten sequence of characters in response to detecting a selection of a delete option within a toolbar reduces the number of inputs needed to update the display of the representation of the handwritten sequence of characters to be after the portion of the handwritten sequence of characters is deleted and/or helps avoid undesired and/or unintentional deletion of the portion of the representation of the handwritten sequence of characters, thereby improving user-device interaction.

In some embodiments, the sequence of characters is displayed in a plurality of lines in the user interface (e.g., 2, 3, 4, 5, 6, 8, 10, 12, etc. lines, as similarly discussed above), such as the plurality of lines of the handwritten content 605 in FIG. 6B, and the first location of the first portion of the sequence of characters corresponds to a first line of the plurality of lines (e.g., the first portion of the sequence of characters is located in a first line in the user interface, but not necessarily a top or numerically first line of the plurality of lines in the user interface), such as the second line of the handwritten content 605 in FIG. 6I. In some embodiments, in response to detecting the first input, in accordance with a determination that updating display of the first representation of handwritten content to include the first representation of the first handwritten input at the at least the first location (e.g., in the first line of the plurality of lines) in the user interface in accordance with the determination that the second input is detected within the threshold amount of time (e.g., as previously discussed above) of deleting the first portion of the sequence of characters, such as the handwriting input 617 provided by the stylus 602 as shown in FIG. 6J, causes a respective portion (e.g., following/proceeding the first portion of the sequence of characters of the first representation of the first handwritten input) of the sequence of characters in the first line to extend beyond a boundary of the first line (e.g., a right edge or left edge in the user interface), such as the word “her” extending beyond a boundary of the second line of the handwritten content 605 in FIG. 6J, the electronic device updates display of the first representation of handwritten content to include at least a portion of the respective portion in a second line, different from the first line, in the user interface, such as moving the word “her” form the second line to a third line, below the second line, of the handwritten content 605 as shown in FIG. 6K. In some embodiments, the respective portion of the sequence of characters is or includes the second portion of the sequence of characters discussed above. In some embodiments, the respective portion of the sequence of characters is different from the second portion of the sequence of characters. In some embodiments, as similarly described above, when the electronic device updates display of the first representation of handwritten content to include the first representation of the first handwritten input, the electronic device shifts/moves the respective portion of the sequence of characters in the first line as the electronic device displays the first representation of the first handwritten input. In some embodiments, one or more characteristics of the display of the first representation of the first handwritten input causes the respective portion of the sequence of characters in the first line to extend beyond the boundary of the first line. For example, a size (e.g., a width and/or length) of the first representation of the first handwritten input, which optionally depends on a number of letters, words, numbers, or other characters or groups of characters detected in the first handwritten input, causes the respective portion of the sequence of characters to be shifted/moved in the first line (e.g., to accommodate the size of the first representation of the first handwritten input) by a respective distance that is based on the size of the first representation of the first handwritten input. In some embodiments, the first representation of the first handwritten input is displayed in the first line of the plurality of lines in the user interface (e.g., in the same line as the respective portion of the sequence of characters). In some embodiments, the one or more characteristics of the display of the first representation of the first handwritten input include an orientation of the first representation of the first handwritten input (e.g., orientation of the characters and/or other shapes included in the first handwritten input), a width and/or number of blank spaces included in the first representation of the first handwritten input (e.g., blank spaces separating words and/or numbers included in the first handwritten input), and/or the sizes of the individual characters included in the first representation of the first handwritten input. In some embodiments, the boundary of the first line corresponds to an edge/boundary of the user interface, which optionally corresponds to a physical boundary/edge of the display generation component and/or a physical boundary/edge of the surface (e.g., the touch-sensitive surface, such as a touchscreen, discussed above). In some embodiments, the boundary of the first line is determined according to a predefined margin of the user interface of a respective size (e.g., 1, 2, 3, 4, 5, etc. cm), optionally defined by the user prior to detecting the first handwritten input discussed above and/or defined by the electronic device prior to detecting the first handwritten input (e.g., according to a default setting). In some embodiments, the boundary of the first line corresponds to a boundary of the plurality of lines (e.g., each line of the plurality of lines has a same boundary). Accordingly, in some embodiments, the boundary determines an amount of (e.g., a number of) the sequence of characters of the first representation of handwritten content that is included in the first line of the plurality of lines. In some embodiments, a location of the boundary of the first line is based on a language setting associated with the user interface and/or the electronic device. For example, if the user interface is configured to read and be interacted with according to a language that reads left to right (e.g., English, Spanish, Latin, or Greek), which causes the sequence of characters and therefore the first representation of the first handwritten input to be displayed in a manner that read left to right, the boundary of the first line is located on a right side of the user interface. Alternatively, in some embodiments, if the user interface is configured to read and be interacted with according to a language that reads right to left (e.g., Arabic, Hebrew, Aramaic, or Persian), which causes the sequence of characters and therefore the first representation of the first handwritten input to be displayed in a manner that read right to left, the boundary of the first line is located on a left side of the user interface.

In some embodiments, if displaying the first representation of the first handwritten input causes the respective portion of the sequence of words to be shifted/moved within the first line beyond the boundary of the first line, the electronic device displays one or more characters of the respective portion of the sequence of characters in the second line in the user interface, such as moving the words “the bank” in the third line in the user interface 600 to a fourth, new line of the handwritten content 605 as shown in FIG. 6K. In some embodiments, the electronic device shifts/moves the respective portion of the sequence of words within the first line as the electronic device detects the first handwritten input of the second input (e.g., as the electronic device displays the first representation of the first handwritten input at the first location and along the first line in the user interface). In some embodiments, the second line spatially proceeds the first line in the user interface. In some embodiments, the second line spatially precedes the first line in the user interface. In some embodiments, an amount of the respective portion of the sequence of characters that is displayed in the second line is based on an amount of the respective portion of the sequence of characters that extends beyond the boundary of the first line. For example, if one word of the respective portion of the sequence of characters is caused to extend beyond the boundary of the first line when the first representation of the first handwritten input is displayed (e.g., in the first line) in the user interface, the electronic device displays the one word in (e.g., moves/shifts the one word to) the second line in the user interface. In some embodiments, if multiple words of the respective portion of the sequence of characters is caused to extend beyond the boundary of the first line when the first representation of the first handwritten input is displayed (e.g., in the first line) in the user interface, the electronic device displays the multiple words in (e.g., moves/shifts the multiple words to) the second line in the user interface. In some embodiments, when the electronic device displays at least the portion of the respective portion of the sequence of characters in the second line in the user interface, the electronic device updates display of the first representation of handwritten content to include at least a portion of a second respective portion of the sequence of characters that were previously in the second line in a third line, different from the second line, in the user interface. For example, prior to detecting the first input discussed above, the second respective portion of the sequence of characters is displayed in the second line in the user interface, and when the electronic device detects the second input (e.g., the first handwritten input), the movement of the at least the respective portion of the sequence of characters from the first line to the second line causes at least a portion of the second respective portion of the sequence of characters in the second line to extend beyond a boundary of the second line in the user interface. Accordingly, in some embodiments, the electronic device moves/shifts at least a portion of the second respective portion of the sequence of characters to the third line (e.g., preceding or following the second line) in the user interface as similarly discussed above. In some embodiments, when the electronic device displays at least the portion of the respective portion of the sequence of characters in the second line in the user interface, the electronic device introduces/displays a hyphen (e.g., that was previously not included in the sequence of words) in accordance with a determination that displaying the at least the portion of the respective portion of the sequence of characters in the second line causes a word in respective portion of the sequence of characters to be broken up/divided between adjacent letters of the word. For example, the electronic device visually separates a first letter and a second letter of the respective portion of the sequence of characters in the user interface using the hyphen. In some embodiments, the first letter is a last letter of a portion of a word displayed in the first line in the user interface, and the second letter is a first letter of the portion of the word displayed in the second line (e.g., below the first line) in the user interface after displaying the first representation of the first handwritten input. In some embodiments, the electronic device displays the hyphen between syllables of the word of the respective portion of the sequence of characters. For example, the first letter is part of an end of a first syllable of the word and the second letter is part of a beginning of a second syllable, following the first syllable, of the word. In some embodiments, the hyphen is a font-based hyphen or a graphical hyphen (e.g., selected by the electronic device based on an appearance (e.g., shape, form, thickness, and/or style) of the first representation of handwritten content). In some embodiments, in accordance with a determination that updating display of the first representation of handwritten content to include the first representation of the first handwritten input at the at least the first location in the user interface in accordance with the determination that the second input is detected within the threshold amount of time of deleting the first portion of the sequence of characters does not cause the respective portion of the sequence of characters in the first line to extend beyond the boundary of the first line, the electronic device maintains the respective portion in the first line in the user interface while concurrently displaying the first representation of the first handwritten input. Updating a line in which a portion of a representation of a handwritten sequence of characters is displayed in a user interface based on whether detected handwritten input causes the portion of the representation of the handwritten sequence of characters to extend beyond a boundary of the line enables the display of the representation of the handwritten sequence of characters to be updated automatically in response to detecting the handwritten input, which reduces and/or avoids the need for user input for manually updating the line in which the portion of the representation of the handwritten sequence of characters is displayed to accommodate the handwritten input, thereby preserving computing resources and improving user-device interaction.

In some embodiments, the sequence of characters of the first representation of handwritten content includes a first group of characters in a first region of the user interface (e.g., first group of handwritten content 605a in FIG. 6M) and a second group, different from the first group, of characters in a second region, different from the first region, of the user interface (e.g., second group of handwritten content 605b in FIG. 6M). For example, the first representation of handwritten content is displayed in and/or incudes a plurality of paragraphs in the user interface. In some embodiments, the first group of characters corresponds to a first paragraph and the second group of characters corresponds to a second paragraph, following the first paragraph (e.g., located below the first paragraph in the user interface). In some embodiments, the first group in the first region and the second group in the second region are divided/spatially separated by blank space in the user interface. For example, as discussed below, the user interface includes a third region, separating the first region and the second region, that does not include any handwritten content (e.g., does not include any characters or other shapes) in the user interface.

In some embodiments, while displaying the first representation of handwritten content that includes the sequence of characters, the electronic device detects, via the one or more input devices, a third input corresponding to a request to delete at least a third region, different from the first region and the second region, in the user interface, wherein the third region does not include a portion of the sequence of characters of the first representation of handwritten content, such as handwritten marks 607d overlapping a portion of the first group of handwritten content 605a and a portion of the blank space below the first group of handwritten content 605a in FIG. 6N. For example, as similarly discussed above, the electronic device receives the third input via an external device/tool for providing handwritten input (e.g., a stylus) or via a finger of a hand of the user of the electronic device. In some embodiments, as similarly discussed above, the electronic device detects handwritten lines, scratch marks, and/or similar patterns/shapes directed to at least the third region of the user interface. Additionally, in some embodiments, as similarly described above, the handwritten lines, scratch marks, and/or similar patterns/shapes are followed by a hold of a contact (e.g., a stylus or a finger) on the surface (e.g., the touch-sensitive surface) for at least the first threshold amount of time (e.g., 0.25, 0.5, 0.75, 1, 2, 3, 5, or 10 seconds). In some embodiments, detecting the third input corresponding to the request to delete the at least the third region in the user interface includes detecting a request to delete at least a portion of the first group of characters in the first region and/or at least a portion of the second group of characters in the second region. For example, the one or more handwritten lines, scratch marks, and/or similar patterns/shapes span one or more characters in the first group of characters, the third region, and/or one or more characters in the second group of characters in the user interface. In some embodiments, the third input has one or more characteristics of the first input described above.

In some embodiments, in response to detecting the third input, the electronic device forgoes updating display of the first representation of handwritten content to include at least a portion of the second group of characters in the first region of the user interface, such as forgoing moving a portion of the second group of handwritten content 605b upward in the user interface as shown in FIG. 6O. For example, in response to detecting the third input, the electronic device forgoes deleting and/or removing the blank space separating the first group of characters in the first region and the second group of characters in the second region in the user interface. In some embodiments, if the third input also corresponds to a request to delete a portion of the first group of characters in the first region, the electronic device deletes the portion of the first group of characters in the first region in the user interface. Similarly, in some embodiments, if the third input also corresponds to a request to delete a portion of the second group of characters in the second region, the electronic device deletes the portion of the second group of characters in the second region in the user interface. However, in some embodiments, when the electronic device deletes the portion of the first group of characters and/or the portion of the second group of characters, the electronic device forgoes shifting/moving other characters (e.g., undeleted characters) from the first group of characters and/or other characters (e.g., undeleted characters) from the second group of characters to the third region and/or the first region of the user interface. Accordingly, in some embodiments, the electronic device maintains the third region in the user interface (e.g., maintains display of the blank space separating the first region and the second region in the user interface) irrespective of whether any portions of the first group of characters and/or the second group of characters are deleted from the user interface in response to detecting the third input. For example, the electronic device maintains the separation between the first paragraph and the second paragraph of the first representation of handwritten content in the user interface in response to detecting the third input. Maintaining a separation between paragraphs within a representation of a handwritten sequence of characters in a user interface in response to detecting an input corresponding to a request to delete a portion of the representation of the handwritten sequence of characters, including the separation between the paragraphs, in the user interface helps avoid undesired and/or unintentional deletion of the separation between the paragraphs of the representation of the handwritten sequence of characters, which therefore reduces input for reintroducing the separation between the paragraphs in the user interface, thereby improving user-device interaction and preserving computing resources.

In some embodiments, the first input corresponding to the request to delete the first portion of the sequence of characters of the first representation of handwritten content includes one or more handwritten marks provided by an input device in communication with the electronic device directed to the first portion of the sequence of characters (e.g., as similarly described above), such as handwritten marks 607d provided by stylus 602 in FIG. 6N. In some embodiments, in accordance with a determination that one or more characteristics of the one or more handwritten marks have one or more first values, the first portion of the sequence of characters is a first amount of the first representation of handwritten content (e.g., a first number of characters in the sequence of characters), such as the amount of the first group of handwritten content 605 deleted in FIG. 6O. In some embodiments, the one or more characteristics of the one or more handwritten marks include a number of the one or more handwritten marks. For example, the one or more first values of the one or more handwritten marks correspond to a first number of the one or more handwritten marks. In some embodiments, the one or more characteristics of the one or more handwritten marks include a size of the one or more handwritten marks, including a length of a respective mark of the one or more handwritten marks and/or a thickness of the respective mark of the one or more handwritten marks. In some embodiments, the one or more first values of the one or more handwritten marks correspond to a first size of the one or more handwritten marks, including a first length and/or a first thickness of the one or more handwritten marks. In some embodiments, the one or more characteristics of the one or more handwritten marks include an orientation of the one or more handwritten marks. For example, the one or more first values of the one or more handwritten marks correspond to a first orientation of the one or more handwritten marks. In some embodiments, the one or more characteristics of the one or more handwritten marks include a location of the one or more handwritten marks in the user interface. For example, the one or more first values of the one or more handwritten marks correspond to a first location of the one or more handwritten marks in the user interface. In some embodiments, the one or more characteristics of the one or more handwritten marks include a speed at which the one or more handwritten marks are detected (e.g., a speed of movement of the input device on the surface forming/providing the one or more handwritten marks). For example, the one or more first values of the one or more handwritten marks correspond to a first speed at which the one or more handwritten marks are drawn/provided in the user interface. In some embodiments, the amount of the first representation of handwritten content and the specific portion of the sequence of characters that is deleted from the user interface in response to detecting the first input is based on the one or more characteristics of the one or more handwritten marks. For example, the size (e.g., the length and/or thickness), orientation, location, and/or number of the one or more handwritten marks determine the manner in which the one or more handwritten marks overlap with and/or otherwise intersect with the first portion of the sequence of characters in the user interface. Particularly, the one or more characteristics of the one or more handwritten marks having the one or more first values cause a first amount of the first representation of handwritten content (e.g., a first number and/or a first line of characters in the sequence of characters) to be designated for deletion in the user interface. In some embodiments, as discussed in more detail below, the one or more first values of the one or more handwritten marks do not necessarily include and/or correspond to overlap of the one or more handwritten marks with the first amount of the first representation of handwritten content. For example, as described below, the one or more handwritten marks need not overlap and/or intersect with each character of the first portion of the sequence of characters to cause the electronic device to delete the first amount of the first representation of handwritten content in the user interface.

In some embodiments, in accordance with a determination that the one or more characteristics of the one or more handwritten marks have one or more second values, different from the one or more first values, the first portion of the sequence of characters is a second amount, different from the first amount, of the first representation of handwritten content (e.g., a second number, different from the first number, of characters in the sequence of characters), such as the amount of the second group of handwritten content 605b deleted in FIG. 6Q. For example, the one or more second values of the one or more handwritten marks correspond to a second number of the one or more handwritten marks, a second size of the one or more handwritten marks, including a second length and/or a second thickness of the one or more handwritten marks, a second orientation of the one or more handwritten marks, a second location of the one or more handwritten marks in the user interface, and/or a second speed at which the one or more handwritten marks are drawn/provided in the user interface, optionally different from those of the one or more first values discussed above. In some embodiments, the second amount of the first representation of handwritten content is greater than the first amount of the first representation of handwritten content. In some embodiments, the second amount of the first representation of handwritten content is less than the first amount of the first representation of handwritten content. In some embodiments, as discussed in more detail below, the one or more second values of the one or more handwritten marks do not necessarily include and/or correspond to overlap of the one or more handwritten marks with the second amount of the first representation of handwritten content. For example, as described below, the one or more handwritten marks need not overlap and/or intersect with each character of the first portion of the sequence of characters to cause the electronic device to delete the second amount of the first representation of handwritten content in the user interface. Deleting a portion of a representation of a handwritten sequence of characters in a user interface in response to detecting one or more handwritten marks provided by an input device directed to the portion based on one or more characteristics of the one or more handwritten marks helps avoid undesired and/or unintentional deletion of other portions of the representation of the handwritten sequence of characters and/or reduces the number of inputs needed to delete the portion of the representation of the handwritten sequence of characters, thereby improving user-device interaction.

In some embodiments, the determination that the one or more characteristics of the one or more handwritten marks have the one or more first values is in accordance with a determination that the one or more handwritten marks satisfy one or more first criteria, including a criterion that is satisfied when the one or more handwritten marks overlap with the first amount of the first representation of handwritten content (e.g., intersect with a first number of characters of the sequence of characters), such as the overlap of the handwritten marks 607d with a portion of the first group of handwritten content 605a in FIG. 6N, and a criterion that is satisfied based on one or more lengths (e.g., lengths of the handwritten marks 607d in FIG. 6N) or one or more velocities of the one or more handwritten marks, as indicated by speed bar 619 in FIG. 6N. For example, the representation of the one or more handwritten marks in the user interface overlap with one or more letters, numbers, and/or special characters in the sequence of characters. In some embodiments, in response to detecting the one or more handwritten marks that overlap with the first number of characters of the sequence of characters and/or are provided with one or more first lengths or one or more first velocities, the electronic device deletes the first number of characters, without deleting others of the sequence of characters that are not overlapped by the one or more handwritten marks. For example, the electronic device only deletes the characters that are overlapped by and/or intersected by the one or more handwritten marks, which, as similarly discussed above, depends on one or more of the size (e.g., length and/or thickness) of the one or more handwritten marks, the location of the one or more handwritten marks, the orientation of the one or more handwritten marks, and the number of the one or more handwritten marks. Additionally or alternatively, in some embodiments, the one or more handwritten marks satisfy the one or more first criteria when the one or more handwritten marks are detected as being provided by the input device with a first speed that is below a speed threshold (e.g., less than 1, 2, 3, 5, 10, 15, 20, 30, etc. m/s). For example, if the handwritten marks are detected as being provided by the input device with a speed that is below the speed threshold, the electronic device deletes only the characters that are overlapped by and/or intersected by the one or more handwritten marks.

In some embodiments, the determination that the one or more characteristics of the one or more handwritten marks have the one or more second values is in accordance with a determination that the one or more handwritten marks satisfy one or more second criteria (optionally the same as the one or more first criteria or different from the one or more first criteria), including a criterion that is satisfied when the one or more handwritten marks overlap with the second amount of the first representation of handwritten content (e.g., intersect with a second number, different from the first number, of characters of the sequence of characters), and a criterion that is satisfied based on one or more lengths (e.g., one or more second lengths, different from the one or more first lengths above) or one or more velocities (e.g., one or more second velocities, different from the one or more first velocities above) of the one or more handwritten marks (e.g., as similarly discussed above but specific to the second number of characters of the sequence of characters), such as the lengths of the handwritten marks 607a in FIG. 6C. Deleting a portion of a representation of a handwritten sequence of characters in a user interface in response to detecting one or more handwritten marks provided by an input device directed to the portion based on one or more characteristics of the one or more handwritten marks helps avoid undesired and/or unintentional deletion of other portions of the representation of the handwritten sequence of characters and/or reduces the number of inputs needed to delete the portion of the representation of the handwritten sequence of characters, thereby improving user-device interaction.

In some embodiments, the determination that the one or more characteristics of the one or more handwritten marks have the one or more first values is in accordance with a determination that the one or more handwritten marks satisfy one or more first criteria, including a criterion that is satisfied when the one or more handwritten marks at least partially (and optionally does not fully) overlap with the first amount of the first representation of handwritten content (e.g., at least partially intersects with a first number of characters of the sequence of characters), such as the overlap of the handwritten marks 607e with a portion of the second group of handwritten content 605b in FIG. 6P, and a criterion that is satisfied based on one or more lengths (e.g., one or more first lengths) or one or more velocities (e.g., one or more first velocities) of the one or more handwritten marks, such as the lengths of the handwritten marks 607e or the speed indicated in speed bar 619 in FIG. 6P. For example, the electronic device deletes a first portion of the sequence of characters in the first representation of handwritten content that is intersected by the one or more handwritten marks and deletes a second portion, different (e.g., separate) from the first portion, of the sequence of characters in the first representation of handwritten content that is not necessarily intersected by the one or more handwritten marks. In some embodiments, the one or more handwritten marks overlap with one or more letters in a word, but not all letters in the word, and in response, the electronic device deletes the word in the user interface. Similarly, as an example, the one or more handwritten marks overlap with a plurality of words of a paragraph in the user interface, and in response, the electronic device deletes the paragraph in the user interface. In some such embodiments, the one or more handwritten marks span a length/width of the paragraph, but do not necessarily overlap with each word, number, and/or special character that is present in the paragraph. Additionally, in some embodiments, the one or more handwritten marks satisfy the one or more first criteria when the one or more handwritten marks are detected as being provided by the input device with a first speed that is above a speed threshold (e.g., less than 1, 2, 3, 5, 10, 15, 20, 30, etc. m/s). For example, if the handwritten marks are detected as being provided by the input device with a speed that is above the speed threshold, the electronic device deletes not only the characters that are overlapped by and/or intersected by the one or more handwritten marks but also other characters not specifically overlapped by and/or intersected by the one or more handwritten mars, such as characters within a same word, term, phrase, line, and/or paragraph. Accordingly, in some embodiments, as the values of the one or more characteristics of the one or more handwritten marks increase (e.g., the sizes (e.g., length and/or thickness) of the one or more handwritten marks increase and/or the number of the one or more handwritten marks increases), the larger the portion of the sequence of characters that is deleted in the user interface.

In some embodiments, the determination that the one or more characteristics of the one or more handwritten marks have the one or more second values is in accordance with a determination that the one or more handwritten marks satisfy one or more second criteria (optionally the same as the one or more first criteria or different from the one or more first criteria), including a criterion that is satisfied when the one or more handwritten marks at least partially (and optionally does not fully) overlap with the second amount of the first representation of handwritten content (e.g., at least partially intersects a second number, different from the first number, of characters of the sequence of characters), and a criterion that is satisfied based on one or more lengths (e.g., one or more second lengths, different from the one or more first lengths discussed above) or one or more velocities (e.g., one or more second velocities, different from the one or more first velocities discussed above) of the one or more handwritten marks (e.g., as similarly discussed above but specific to the second number of characters of the sequence of characters), such as the lengths of the handwritten marks 607b in FIG. 6I. Deleting a portion of a representation of a handwritten sequence of characters in a user interface in response to detecting one or more handwritten marks provided by an input device directed to the portion based on one or more characteristics of the one or more handwritten marks helps avoid undesired and/or unintentional deletion of other portions of the representation of the handwritten sequence of characters and/or reduces the number of inputs needed to delete the portion of the representation of the handwritten sequence of characters, thereby improving user-device interaction.

In some embodiments, while displaying the first representation of handwritten content that includes the sequence of characters, the electronic device detects, via the one or more input devices, a third input provided by an input device in communication with the electronic device directed to a respective location in the user interface corresponding to a respective portion of the first representation of handwritten content, wherein the third input is a first type of input, such as contact of stylus 602 on the surface of the electronic device 500 for threshold time 623 in time bar 621 as shown in FIG. 6R. For example, the electronic device detects contact of a stylus or finger of the user on a touch-sensitive surface directed to the respective portion of the first representation of handwritten content in the user interface. In some embodiments, the first type of input is or includes contact of the input device on the surface for at least a threshold amount of time (e.g., 0.25, 0.5, 0.75, 1, 2, 3, 5, or 10 seconds), optionally without detecting liftoff of the input device from the surface. In some embodiments, the respective location in the user interface corresponding to the respective portion of the first representation of handwritten content is a blank space in the user interface (e.g., a blank space between words in the user interface or a blank space between characters (e.g., letters, numbers, and/or special characters) within a single word or term in the user interface). In some embodiments, the third input has one or more characteristics of the first input discussed above.

In some embodiments, in response to detecting the third input, the electronic device displays, via the display generation component, a cursor (e.g., a text cursor) at the respective location in the user interface, such as cursor 620 in FIG. 6S. For example, the electronic device displays a cursor at the location of the input device relative to the surface in the user interface. In some embodiments, as discussed in more detail below, the display of the cursor is maintained in the user interface while the input device (e.g., the stylus) remains in contact with the surface. In some embodiments, as discussed in more detail below, the location at which the cursor is displayed in the user interface is updated according to detected movement of the input device (e.g., the stylus) on the surface. In some embodiments, the cursor is a selection cursor (e.g., a dot, arrow, carrot, etc.) rather than a text cursor. In some embodiments, the cursor is displayed concurrently with the first representation of handwritten content (e.g., at the respective location) in the user interface. In some embodiments, as described in more detail below, the cursor provides a visual indication of a location at which a blank space is able to be inserted/created within the first representation of handwritten content in the user interface in response to detecting further/additional input (e.g., such as detecting liftoff of the input device from the surface and/or movement of the input device on the surface, as discussed below). In some embodiments, if the third input of the first type is detected as not being directed to a portion of the first representation of handwritten content (e.g., the third input provided by the input device is directed to blank or open space in the user interface that does not include or correspond to the sequence of characters, the electronic device forgoes displaying the cursor in the user interface based on the location of the input device on the surface. Displaying a cursor with a representation of a handwritten sequence of characters in a user interface in response to detecting input provided by an input device on a surface directed to a portion of the representation of the handwritten sequence of characters facilitates user input for performing one or more cursor interactions directed to the handwritten sequence of characters and/or reduces the number of inputs needed to display the cursor with the representation of the handwritten sequence of characters for subsequently performing the one or more cursor interactions, thereby improving user-device interaction.

In some embodiments, after (and/or while) displaying the cursor at the respective location in the user interface (e.g., in the manner discussed above), the electronic device detects, via the one or more input devices, termination of the third input provided by the input device, such as liftoff of the stylus 602 from the surface of the electronic device 500 as shown in the side view 610 in FIG. 6T. For example, the electronic device detects liftoff of the input device (e.g., stylus or finger of the user) from the surface while the cursor is displayed at the respective location in the user interface. In some embodiments, the electronic device detects movement of the input device more than a threshold distance from the surface, such as more than 0, 0.05, 0.15, 0.25, 0.5, 0.75, 1, 1.5, 2, 3, etc. cm from the surface.

In some embodiments, in response to detecting the termination of the third input, the electronic device updates display of the first representation of handwritten content to include a blank space in at least the respective location in the user interface, such as blank space 603e as shown in FIG. 6T. For example, the electronic device shifts/moves a portion of the sequence of characters at the respective location in the user interface (e.g., adjacent to and/or following the respective location in the user interface) to generate a blank space at the least the respective location in the user interface. In some embodiments, the blank space has a predetermined size (e.g., determined automatically by the electronic device or determined by the user prior to detecting the third input via one or more settings associated with the display of the user interface). In some embodiments, the blank space has a size that is based on a distance between the respective location in the user interface and a boundary/edge (e.g., margin) of the sequence of characters. For example, as similarly described herein above, the sequence of characters is displayed in a plurality of lines and the respective location corresponds to a first line of the plurality of lines. Accordingly, in some embodiments, when the electronic device displays the blank space in the at least the respective location of the user interface, the blank space extends from the respective location to a boundary/edge of the first line of the plurality of lines (e.g., such that characters of the sequence of characters in the first line are shifted/moved to a second line, different from the first line, of the plurality of lines (e.g., a line following/below the first line, as previously described herein). Additionally, as similarly discussed above, a direction in which the blank space is inserted into the first representation of handwritten content is based on a language setting of the user interface (e.g., whether the sequence of characters is written in a left to right or a right to left language). For example, if the sequence of characters is written in a language that reads left to right, the first representation of handwritten content is updated to include a blank space having a size that extends rightward relative to the respective location, and if the sequence of characters is written in a language that reads right to left, the first representation of handwritten content is updated to include a blank space having a size that extends leftward relative to the respective location in the user interface. In some embodiments, when the electronic device displays the blank space in the user interface at the at least the respective location, the electronic device ceases display of the cursor in the user interface. In some embodiments, as similarly described above, after the blank space has been inserted at the at least the respective location in the user interface, new and/or additional handwritten content, such as handwritten text, is able to be provided at and/or over the blank space (e.g., in response to the electronic device detecting handwritten input, as similarly discussed above). Similarly, in some embodiments, after the blank space has been inserted at the at least the respective location in the user interface, new and/or additional font-based text is able to be inserted at and/or over the blank space in the user interface, such as in response to detecting user input via a keyboard in communication with the electronic device (e.g., or a digital keyboard associated with the user interface) and/or user input pasting font-based text at the location of the blank space, as similarly described in method 1100. Inserting a blank space at a location of a cursor within a representation of a handwritten sequence of characters in a user interface in response to detecting liftoff of an input device from a surface reduces the number of inputs needed to insert a blank space at a respective location relative to the representation of the handwritten sequence of characters, which facilitates user input for adding new handwritten characters at the location of the blank space in the user interface, thereby improving user-device interaction.

In some embodiments, after (and/or while) displaying the cursor at the respective location in the user interface (e.g., in the manner discussed above), the electronic device detects, via the one or more input devices, movement of the input device relative to the respective location in the user interface, such as movement of the stylus 602 on the surface of the electronic device 500 while the cursor 620 is displayed as shown in FIG. 6U. For example, without detecting liftoff of the input device from the surface, the electronic device detects movement of the input device on the surface corresponding to movement of the cursor relative to the respective location in the user interface. In some embodiments, the electronic device detects the input device move on the surface in a respective direction and/or with a respective magnitude (e.g., relative to the respective location).

In some embodiments, in response to detecting the movement of the input device, the electronic device updates display of the first representation of handwritten content to include a blank space in at least the respective location in the user interface, such as blank space 603f in FIG. 6V, wherein one or more characteristics of the blank space are based on the movement of the input device relative to the respective location, such as a size of the blank space 603f corresponding to a distance of the movement of the stylus 602 from FIGS. 6U-6V. In some embodiments, displaying the blank space in the user interface has one or more characteristics of the display of the blank space discussed above. In some embodiments, the one or more characteristics of the blank space include a size of the blank space in the user interface. For example, as similarly discussed above, the electronic device shifts/moves a portion of the sequence of characters at the respective location in the user interface (e.g., adjacent to and/or following the respective location in the user interface) by a respective amount (e.g., a respective distance) to generate a blank space at the least the respective location in the user interface having a particular size. In some embodiments, the size of the blank space is determined based on the movement of the input device. For example, the size of the blank space corresponds to a distance of the movement of the input device relative to the respective location in the user interface. In some embodiments, the display of the blank space in the user interface is limited to a single line of characters in the user interface. For example, as similarly discussed above, the sequence of characters is displayed in a plurality of lines and the respective location in the user interface corresponds to a first line of the plurality of lines. Accordingly, in some embodiments, the movement of the input device relative to the respective location is limited to a single axis associated with the user interface (e.g., a horizontal axis running across the user interface), such that the display of the blank space is limited to a single line of the plurality of lines (e.g., the first line). In some embodiments, the axis associated with the user interface is based on an orientation of the first representation of handwritten content (e.g., an orientation associated with the sequence of characters in the user interface, such as a general angle/direction at which the sequence of characters is displayed in the user interface). In some embodiments, the axis associated with the user interface is aligned to a horizontal axis of the user interface. In some embodiments, the one or more characteristics of the blank space include a direction in which the blank space extends relative to the respective location in the user interface. For example, as similarly discussed above, the electronic device updates the first representation of handwritten content to include a blank space having a size as discussed above extending rightward or leftward relative to the respective location in the user interface (e.g., rightward or leftward along the axis discussed above). In some embodiments, the direction in which the blank space is displayed is based on the direction of the movement of the input device relative to the respective location in the user interface. For example, if the movement of the input device is rightward relative to the respective location (e.g., along the axis associated with the user interface), the first representation of handwritten content is updated to include a blank space having a size that extends rightward relative to the respective location, and if the movement of the input device is leftward relative to the respective location, the first representation of handwritten content is updated to include a blank space having a size that extends leftward relative to the respective location in the user interface. In some embodiments, in accordance with a determination that the movement of the input device is detected without detecting liftoff of the input device from the surface, the electronic device maintains display of the cursor in the user interface (e.g., but moves the cursor in accordance with the movement of the input device relative to the respective location). Inserting a blank space at a location of a cursor within a representation of a handwritten sequence of characters in a user interface having one or more characteristics in response to detecting movement of an input device within the user interface reduces the number of inputs needed to insert a blank space having the one or more characteristics at a respective location relative to the representation of the handwritten sequence of characters, which facilitates user input for adding new handwritten characters at the location of the blank space in the user interface, thereby improving user-device interaction.

In some embodiments, the sequence of characters is displayed in a plurality of lines in the user interface (e.g., as similarly discussed above), such as the plurality of lines of handwritten content 605a in FIG. 6U, and the respective location of the respective portion of the first representation of handwritten content corresponds to a first line of the plurality of lines, such as the third line in the user interface 600 in FIG. 6U. In some embodiments, in response to detecting the movement of the input device, in accordance with a determination that the movement of the input device is in a first direction relative to the respective location (e.g., rightward relative to the respective location and along the axis associated with the user interface discussed above), such as rightward relative to the location of the cursor 620 as shown in FIG. 6U, and updating display of the first representation of handwritten content to include the blank space (e.g., having a respective size as discussed above) in the at least the respective location in the user interface causes a first respective portion (e.g., one or more first characters following/proceeding the blank space) of the sequence of characters in the first line to extend beyond a boundary of the first line (e.g., an end/edge of the first line, such as at a margin of the user interface or an edge of the display generation component as similarly discussed above, optionally at a right side of the user interface), such as the word “on” in the handwritten content 605a extending beyond a boundary of the third line in FIG. 6U, the electronic device updates display of the first representation of handwritten content to include the first respective portion in a second line, following the first line, in the user interface, such as moving the word “on” to the fourth line, below the third line, of the handwritten content 605a in the user interface 600 as shown in FIG. 6V. For example, as similarly discussed above, the electronic device shifts/moves the one or more first characters following the blank space to the second line below the first line in the user interface to accommodate the size of the inserted blank space in the first line (e.g., as determined by the movement of the input device, as previously discussed above). In some embodiments, just as the insertion of the blank space in the first line in the user interface follows and/or is based on the movement of the input device in the first direction along the first line as previously discussed above, the movement of the first respective portion of the sequence of characters from the first line to the second line follows and/or is based on the movement of the input device in the first direction. For example, a number of the sequence of characters in the first line that is shifted to the second line in the user interface is based on the distance that the input device is moved relative to the respective location in the user interface. Additionally, in some embodiments, because the movement of the input device is in the first direction (e.g., rightward) relative to the respective location in the user interface, the first respective portion of the sequence of characters in the first line is moved to a line below (e.g., following) the first line (e.g., the second line discussed above), rather than to a line above (e.g., preceding) the first line, as discussed in more detail below. Updating a line in which a portion of a representation of a handwritten sequence of characters is displayed in a user interface based on whether insertion of a blank space causes the portion of the representation of the handwritten sequence of characters to extend beyond a boundary of the line enables the display of the representation of the handwritten sequence of characters to be updated automatically when the blank space is inserted, which reduces and/or avoids the need for user input for manually updating the line in which the portion of the representation of the handwritten sequence of characters is displayed to accommodate the blank space, thereby preserving computing resources and improving user-device interaction.

In some embodiments, the sequence of characters is displayed in a plurality of lines in the user interface (e.g., as similarly discussed above), such as the plurality of lines of the handwritten content 605a in FIG. 6V, and the respective location of the respective portion of the first representation of handwritten content corresponds to a first line of the plurality of lines, such as the third line in the user interface 600 in FIG. 6V. In some embodiments, in response to detecting the movement of the input device, in accordance with a determination that the movement of the input device is in a second direction relative to the respective location (e.g., leftward relative to the respective location and along the axis associated with the user interface discussed above), such as leftward in the user interface 600 as shown in FIG. 6V, and updating display of the first representation of handwritten content to include the blank space (e.g., having a respective size as discussed above) in the at least the respective location in the user interface causes a first respective portion (e.g., one or more first characters preceding the blank space) of the sequence of characters in the first line to extend beyond a boundary of the first line (e.g., an end/edge of the first line, such as at a margin of the user interface or an edge of the display generation component as similarly discussed above, optionally at a left side of the user interface), such as the word “by” extending beyond a left boundary of the third line of the handwritten content 605a in FIG. 6V, the electronic device updates display of the first representation of handwritten content to include the first respective portion in a second line, preceding the first line, in the user interface, such as moving the word “by” from the third line up to the second line above the first line in the user interface 600 as shown in FIG. 6W. For example, as similarly discussed above, the electronic device shifts/moves the one or more first characters preceding the blank space to the second line above the first line in the user interface to accommodate the size of the inserted blank space in the first line (e.g., as determined by the movement of the input device, as previously discussed above). In some embodiments, just as the insertion of the blank space in the first line in the user interface follows and/or is based on the movement of the input device in the second direction along the first line as previously discussed above, the movement of the first respective portion of the sequence of characters from the first line to the second line follows and/or is based on the movement of the input device in the second direction. For example, a number of the sequence of characters in the first line that is shifted to the second line in the user interface is based on the distance that the input device is moved relative to the respective location in the user interface. Additionally, in some embodiments, because the movement of the input device is in the second direction (e.g., leftward) relative to the respective location in the user interface, the first respective portion of the sequence of characters in the first line is moved to a line above (e.g., preceding) the first line (e.g., the second line discussed above), rather than to a line below (e.g., proceeding) the first line, as discussed previously. Updating a line in which a portion of a representation of a handwritten sequence of characters is displayed in a user interface based on whether insertion of a blank space causes the portion of the representation of the handwritten sequence of characters to extend beyond a boundary of the line enables the display of the representation of the handwritten sequence of characters to be updated automatically when the blank space is inserted, which reduces and/or avoids the need for user input for manually updating the line in which the portion of the representation of the handwritten sequence of characters is displayed to accommodate the blank space, thereby preserving computing resources and improving user-device interaction.

In some embodiments, updating display of the first representation of handwritten content to include the blank space in the at least the respective location in the user interface includes moving a subset of characters of the sequence of characters (e.g., one or more characters adjacent to the blank space, such as preceding or proceeding the blank space in the user interface) relative to the respective location according to a spring-based model in the user interface, such as movement of the word “sister” of the handwritten content 605a in the user interface 600 according to a spring-based model from FIGS. 6U-6V. For example, the electronic device subjects the subset of characters of the sequence of characters to a simulated Hooke's law using a predetermined spring constant when the blank space is inserted in the at least the respective location in the user interface (e.g., the subset of the characters of the sequence of characters are moved with a simulated mass along with a simulated spring). In some embodiments, the subset of characters corresponds to a predetermined number of characters, such as a predetermined number of characters in a first word or term adjacent to the respective location. In some embodiments, the subset of characters corresponds to a predetermined number of words adjacent to the respective location. In some embodiments as similarly discussed above, the subset of characters is at least partially determined based on the direction of movement of the input device relative to the respective location in the user interface. For example, if the movement of the input device is in the first direction described previously above (e.g., rightward) relative to the respective location in the user interface, the first subset of characters follows (e.g., is located directly to the right of) the blank space at the respective location in the user interface. In some embodiments, if the movement of the input device is in the second direction described previously above (e.g., leftward) relative to the respective location in the user interface, the first subset of characters precedes (e.g., is located directly to the left of) the blank space at the respective location in the user interface. In some embodiments, when the electronic device moves the subset of characters of the sequence of characters relative to the respective location according to the spring-based model, the electronic device moves the subset of characters in a direction in the user interface corresponding to the movement of the input device relative to the respective location, and subsequently moves (e.g., as in a pulling or “rubberbanding” motion) the subset of characters back toward the respective location in the user interface. In some embodiments, the electronic device detects an amount of displacement measured between the input device and the respective location in the user interface and animates a translation of the subset of characters with a magnitude of acceleration based on the displacement, such that the greater the displacement, the greater the acceleration of the subset of characters when the input provided by the input device is terminated (e.g., when the electronic device detects liftoff of the input device from the surface). In some embodiments, the relationship between the displacement and the simulated acceleration of the subset of characters moving back toward the respective location is linear, exponential, logarithmic, and/or some other non-linear relationship between the displacement and the simulated acceleration. In some embodiments, the characters in the subset of characters are moved differently in the user interface relative to the respective location because of the spring-based model. As an illustrative example, the subset of characters includes a plurality of words, including a first word, a second word, and a third word. In some embodiments, when the electronic device detects the movement of the input device on the surface, the application of the spring-based model simulates a pulling of the first word by the (e.g., tip of the) input device (e.g., as in a mass attached to a spring). In some embodiments, the movement of the first word produces a movement/pulling on the second word, which is “attached” (e.g., per the spring-based model) to the first word, which subsequently produces a movement/pulling on the third word, which is “attached” to the second word. In some embodiments, a fourth word of the sequence of characters, which is not included in the subset of characters that follows the subset of characters, is not moved according to the spring-based model (e.g., the fourth word is not “attached” to any of the first word, the second word, and the third word of the subset of characters). In some embodiments, the electronic device moves the subset of characters of the sequence of characters relative to the respective location in the user interface according to the spring-based model without moving other characters of the sequence of characters relative to the respective location according to the spring-based model. For example, the movement of the other characters of the sequence of characters relative to the respective location in the user interface follows a linear displacement model. Moving a subset of characters of a representation of a handwritten sequence of characters in a user interface according to a spring-based model when inserting a blank space within the representation of the handwritten sequence of characters helps smoothen and/or visually improve the movement of a portion of the representation of the handwritten sequence of characters when the blank space is inserted, which helps reduce eye strain or general discomfort for the user, thereby improving user-device interaction.

In some embodiments, updating display of the first representation of handwritten content to include the second portion of the sequence of characters at the at least the first location in the user interface (e.g., in response to detecting the first input described above and after deleting the first portion of the sequence of characters) includes moving the second portion of the sequence of characters to the at least the first location in the user interface (e.g., as similarly described above), including, in accordance with a determination that one or more characteristics of the first representation of handwritten content have one or more first values, such as the orientation of the handwritten content 605 in FIG. 6X, moving the second portion in a first manner in the user interface (e.g., moving the second portion in a first direction and/or over a first distance), such as moving the word “was” of the handwritten content 605 in FIG. 6Z according to the orientation of the handwritten content 605. For example, the one or more first values of the one or more characteristics correspond to a first number of characters in the sequence of characters of the first representation of handwritten content, a first size of the sequence of characters of the first representation of handwritten content, including a first length and/or a first thickness of strokes/lines that form the sequence of characters, a first orientation of the sequence of characters of the first representation of handwritten content, such as an angle/direction in which the sequence of characters is written/displayed in the user interface, and/or a first location of the sequence of characters in the user interface. In some embodiments, the electronic device moves the second portion of the sequence of characters to the at least the first location in the user interface based on the one or more first values of the one or more characteristics of the first representation of handwritten content. For example, the orientation of the sequence of characters of the first representation of handwritten content dictates a direction in which the second portion of the sequence of characters is moved in the user interface (e.g., the second portion of the sequence of characters is moved in a same or similar direction as the angle at which the sequence of characters is displayed adjacent to the first location in the user interface). As another example, the size of the sequence of characters of the first representation of handwritten content affects a distance over which the second portion of the sequence of characters is moved toward the first location in the user interface. For example, if the second portion of the sequence of characters is comprised of strokes/lines having a first size, the electronic device moves the second portion a first distance to the first location in the user interface, and if the second portion of the sequence of characters is comprised of strokes/lines having a second size, larger than the first size, the electronic device moves the second portion a second distance, smaller than the first distance, to the first location in the user interface.

In some embodiments, in accordance with a determination that the one or more characteristics of the first representation of handwritten content have one or more second values, such as the orientation of the handwritten content 605 in FIG. 6B, different from the one or more first values, the electronic device moves the second portion in a second manner, different from the first manner, in the user interface (e.g., moving the second portion in a second direction, different from the first direction, and/or over a second distance, different from the first distance above), such as moving the word “her” leftward in the user interface 600 according to the orientation of the handwritten content 605 in FIG. 6E. For example, as similarly discussed above, the one or more second values of the one or more characteristics correspond to a second number of characters in the sequence of characters of the first representation of handwritten content, a second size of the sequence of characters of the first representation of handwritten content, including a second length and/or a second thickness of the strokes/lines that form the sequence of characters, a second orientation of the sequence of characters of the first representation of handwritten content, such as the angle/direction in which the sequence of characters is written/displayed in the user interface, and/or a second location of the sequence of characters in the user interface, optionally different from those of the one or more first values discussed above. In some embodiments, moving the second portion of the first representation of handwritten content to the first location based on the one or more second values of the one or more characteristics of the first representation of handwritten content has one or more characteristics of moving the second portion to the first location based on the one or more first values as discussed above. Moving a second portion of a representation of a handwritten sequence of characters in a user interface, after deleting a first portion of the handwritten sequence of characters, in a manner that is based on one or more characteristics of the representation of the handwritten sequence of characters enables the display of the representation of the handwritten sequence of characters to be updated automatically after the first portion of the handwritten sequence of characters is deleted, thereby improving user-device interaction.

In some embodiments, the sequence of characters is displayed in a plurality of lines in the user interface (e.g., 2, 3, 4, 5, 6, 8, 10, 12, etc. lines, as similarly discussed above), such as the plurality of lines of handwritten content 605 in FIG. 6I, and the first location of the first portion of the sequence of characters corresponds to a first line of the plurality of lines (e.g., the first portion of the sequence of characters is located in a first line in the user interface, but not necessarily a top or numerically first line of the plurality of lines in the user interface), such as the second line of the handwritten content 605 in FIG. 6I. In some embodiments, after updating display of the first representation of handwritten content to include the first representation of the first handwritten input at the at least the first location (e.g., in the first line of the plurality of lines) in the user interface in accordance with the determination that the second input is detected within the threshold amount of time (e.g., as previously discussed above) of deleting the first portion of the sequence of characters, in accordance with a determination that the first representation of the first handwritten input has a first size in the first line in the user interface (e.g., occupies a first amount of the first line in the user interface), such as the size of the representation of handwritten input 617 in FIG. 6J, the electronic device moves a respective portion (e.g., following/proceeding the first portion of the sequence of characters of the first representation of the first handwritten input) of the sequence of characters a first distance relative to the at least the first location in the user interface, such as the movement of the word “her” by a first amount in the second line of the handwritten content 605 as shown in FIG. 6J. In some embodiments, the respective portion of the sequence of characters is or includes the second portion of the sequence of characters discussed above. In some embodiments, the respective portion of the sequence of characters is different from the second portion of the sequence of characters. In some embodiments, as similarly described above, when the electronic device updates display of the first representation of handwritten content to include the first representation of the first handwritten input, the electronic device shifts/moves the respective portion of the sequence of characters in the first line as the electronic device displays the first representation of the first handwritten input. In some embodiments, the electronic device moves the respective portion of the sequence of characters by an amount (e.g., a distance) in the first line and/or in a second line, following or preceding the first line, that enables the first representation of the first handwritten input to be sufficiently (e.g., visibly) displayed in the user interface. For example, after the first representation of the first handwritten input is displayed at the at least the first location in the user interface, the first representation of handwritten content includes a blank space between the first representation of the first handwritten input and the respective portion of the sequence of words in the user interface, where the blank space is created as a result of the movement of the respective portion as discussed above. In some embodiments, after the first representation of the first handwritten input is displayed at the at least the first location in the user interface, the electronic device moves the respective portion a second time, toward the first representation of the first handwritten input in the user interface (e.g., to reduce the size of and/or remove the blank space created between the first representation of the first handwritten input and the respective portion of the sequence of characters). In some embodiments, a distance that the respective portion is moved back toward the at least the first location in the first line in the user interface is based on the size (e.g., length and/or width) of the first representation of the first handwritten input in the first line. For example, the size of the first representation of the first handwritten input determines the distance that the respective portion of the sequence of characters is initially moved relative to the at least the first location in the first line (e.g., while detecting the second input discussed above), and thus determines the distance that the respective portion of the sequence of characters is moved back toward/relative to the at least the first location in the first line. In some embodiments, moving the respective portion of the sequence of characters relative to the at least the first location in the user interface includes moving the respective portion from a second line (e.g., following or preceding the first line) back to the first line in the user interface.

In some embodiments, in accordance with a determination that the first representation of the first handwritten input has a second size, different from the first size, in the first line in the user interface, such as the size of the representation of handwritten input 617 in FIG. 6K, the electronic device moves the respective portion of the sequence of characters a second distance, different from the first distance, relative to the at least the first location in the user interface, such as moving the word “her” by a second amount, greater than the first amount, that causes the word to be displayed in a third line below the second line of the handwritten content 605 in FIG. 6K. For example, if the second size of the first representation of the first handwritten input is greater than the first size, the electronic device moves the respective portion of the sequence of characters the second distance that is greater than the first distance relative to the at least the first location in the user interface. In some embodiments, if the second size of the first representation of the first handwritten input is less than the first size, the electronic device moves the respective portion of the sequence of characters the second distance that is less than the first distance relative to the at least the first location in the user interface. Updating display of a representation of a handwritten sequence of characters in a user interface based on an amount of handwritten input that is detected enables the display of the representation of the handwritten sequence of characters to be updated automatically based on the handwritten input, which reduces and/or avoids the need for user input for manually updating the lines in which the representation of the handwritten sequence of characters is displayed after the handwritten input, thereby preserving computing resources and improving user-device interaction.

In some embodiments, the sequence of characters is displayed in a plurality of lines in the user interface (e.g., as similarly discussed above), such as the plurality of lines of the handwritten content 625 in FIG. 6AA. In some embodiments, while displaying the first representation of handwritten content that includes the sequence of characters, the electronic device detects, via the one or more input devices, a third input directed to a respective location in the user interface that includes a third portion of the sequence of words of the first representation of handwritten content, such as a tap of contact 601 directed to the word “Alice” in the handwritten content 625 in FIG. 6AA, wherein the respective location of the third portion of the sequence of characters corresponds to a first line of the plurality of lines (e.g., the third portion of the sequence of characters is displayed in the first line in the user interface). In some embodiments, the third portion of the sequence of characters corresponds to a single or collection of letter(s), number(s), or special character(s) of the sequence of characters of the first representation of handwritten content. In some embodiments, the third portion of the sequence of characters corresponds to a single word of the sequence of characters of the first representation of handwritten content. In some embodiments, the third portion of the sequence of characters corresponds to a plurality of words (optionally a sentence or multiple sentences) of the sequence of characters of the first representation of handwritten content. In some embodiments, the third portion of the sequence of characters corresponds to a paragraph (or a plurality of paragraphs) of the sequence of characters of the first representation of handwritten content. In some embodiments, the third input includes a tap of a contact directed to the third portion of the sequence of characters at the respective location in the user interface. For example, the electronic device detects a tap of a finger or input device (e.g., a stylus) on the surface directed to the respective location in the user interface, such as a tap of a finger on a touchscreen at a location corresponding to the third portion of the sequence of characters in the user interface.

In some embodiments, in response to detecting the third input, the electronic device displays, in the user interface, one or more graphical user interface elements (e.g., bounding box 630 and/or resizing handles 631a-631c in FIG. 6BB) for changing one or more metrics (e.g., a text size, line width and/or line size) associated with a boundary of the first representation of handwritten content (e.g., a right edge or left edge in the user interface to which the first representation of handwritten content is confined), wherein the one or more metrics include a size of the boundary of the first representation of handwritten content. In some embodiments, the boundary of the first representation of handwritten content has one or more characteristics of the boundaries discussed above. In some embodiments, the one or more graphical user interface elements include one or more resizing handles that are selectable to initiate changing of the one or more metrics associated with the boundary of the first representation of handwritten content. For example, the one or more graphical user interface elements include a first resizing handle that is configured to be manipulated (e.g., selected and dragged/moved within the user interface) to change a width of the boundary and thus change a quantity of the sequence of characters that are contained on a respective line of the handwritten content. In some embodiments, the one or more graphical user interface elements include a second resizing handle that is configured to be manipulated to change a length of the boundary and thus change a size of and/or a number of the plurality of lines in which the handwritten content is displayed in the user interface. In some embodiments, the one or more graphical user interface elements include a third resizing handle that is configured to be manipulated to change both the width and the length of the boundary (e.g., by the same amount) and thus a size of the sequence of characters of the first representation of handwritten input in the user interface. In some embodiments, displaying the one or more graphical user interface elements includes displaying a bounding box around the sequence of characters in the user interface. In some embodiments, the bounding box corresponds to a visual representation of the boundary of the first representation of handwritten content. In some embodiments, the bounding box is displayed around the third portion of the sequence of characters in the user interface. In some embodiments, the one or more resizing handles discussed above are displayed overlaid on the bounding box in the user interface (e.g., at edges and/or corners of the bounding box in the user interface). In some embodiments, the location of a respective resizing handle on the bounding box visually indicates the corresponding metric the resizing handle is selectable to change. For example, the first resizing handle discussed above is displayed on a left and/or a right side/edge of the bounding box. In some embodiments, the second resizing handle discussed above is displayed on a top and/or a bottom side/edge of the bounding box. In some embodiments, the third resizing handle discussed above is displayed at a corner of the bounding box.

In some embodiments, while displaying the one or more graphical user interface elements, the electronic device detects, via the one or more input devices, a third input that includes movement of a first graphical user interface element of the one or more graphical user interface elements in a first direction, such as movement of the contact 601 directed to third resizing handle 631c in the user interface 600 as shown in FIG. 6BB. For example, the third input includes manipulation of a resizing handle displayed in the user interface, such as the third resizing handle discussed above. In some embodiments, the third input is provided by a finger of the user or input device (e.g., a stylus) directed to the first graphical user interface element in the user interface. In some embodiments, the third input is detected on and/or via the surface discussed above, such as a touchscreen via which the user interface is displayed. In some embodiments, the third input includes movement of the first graphical user interface element in a respective direction (e.g., rightward or leftward across the surface of the user interface), which optionally causes the electronic device to update one or more of the one or more metrics associated with the boundary of the first representation of handwritten content, as discussed below.

In some embodiments, in response to detecting the third input, the electronic device changes the size of the size of the boundary based on the movement of the first graphical user interface element in the first direction, as indicated by the increased size of the bounding box 630 in FIG. 6CC. For example, the electronic device increases or decreases the size of the boundary of the first representation of handwritten content in accordance with the movement of the first graphical user interface element in the user interface. In some embodiments, the movement of the first graphical user interface element in the first direction causes the size of the boundary to increase in the user interface. For example, the first direction of the movement of the first graphical user interface element corresponds to movement of the first graphical user interface element in a direction that is away from the existing boundary of the first representation of the handwritten content in the user interface. In some embodiments, as discussed above, the third resizing handle (e.g., corresponding to the first graphical user interface element) is displayed at a corner of the bounding box surrounding the sequence of characters in the user interface, such as a right corner or a left corner. Accordingly, the movement of the first graphical user interface element optionally causes the bounding box surrounding the sequence of characters to increase in size, which correspondingly causes the size of the boundary to increase in size. In some embodiments, the movement of the first graphical user interface element in the first direction causes the size of the boundary to decrease in the user interface. For example, the first direction of the movement of the first graphical user interface element corresponds to movement of the first graphical user interface element in a direction that is toward the existing boundary of the first representation of the handwritten content in the user interface. In some embodiments, an amount (e.g., distance) by which the first graphical user interface element is moved in the user interface determines an amount (e.g., length and/or width) by which the size of the boundary is increased. In some embodiments, the increase of the size of the boundary is directly proportional and/or is equal to the distance by which the first graphical user interface element is moved in the user interface. In some embodiments, the movement of the first graphical user interface element optionally causes the bounding box surrounding the sequence of characters to decrease in size, which correspondingly causes the size of the boundary to decrease in size.

In some embodiments, in accordance with a determination that changing the size of the boundary in the user interface does not cause an aspect ratio of the first representation of handwritten content to change in the user interface, such as the aspect ratio of the handwritten content 625 remaining unchanged in FIG. 6CC, the electronic device changes the size of the sequence of characters in the user interface based on the change in the size of the boundary, such as increasing the size of the handwritten content 625 as shown in FIG. 6CC, while maintaining display of the first representation of handwritten content to include the third portion in the first line in the user interface, such as maintaining the same number of lines of the handwritten content 625 in FIG. 6CC. For example, the first representation of handwritten content has a ratio of width to height within the user interface (e.g., an aspect ratio before detecting the third input). In some embodiments, the aspect ratio of the first representation of handwritten content is determined by the handwritten content itself (e.g., the input detected by the electronic device that caused the electronic device to display the first representation of handwritten content in the user interface as discussed previously above). For example, when the input providing the handwritten content (e.g., via a stylus or finger of the user) was detected prior to the display of the first representation of handwritten content, a particular drawing implement was selected and/or one or more settings of the drawing implement were selected (e.g., line thickness, color, etc.), such as a pen drawing implement, a highlighter drawing implement, a pencil drawing implement, a paintbrush drawing implement, etc. In some embodiments, the selected drawing implement and/or the one or more settings of the drawing implement contribute to the size of the characters of the sequence of characters of the first representation of handwritten content, as well as characteristics of the input itself, such as the manner in which the handwritten strokes/lines are provided to the electronic device by the stylus or finger to form the first representation of handwritten content. In some embodiments, in accordance with a determination that changing the size of the boundary does not cause the aspect ratio of the first representation of handwritten content to change in the user interface, the electronic device increases or decreases the size of the sequence of characters of the first representation of handwritten content in accordance with the movement of the first graphical user interface element in the user interface. In some embodiments, if the movement of the first graphical user interface element in the first direction causes the size of the boundary to increase, the electronic device increases the size of the sequence of characters in the user interface. In some embodiments, if the movement of the first graphical user interface element in the first direction causes the size of the boundary to decrease, the electronic device decreases the size of the sequence of characters in the user interface. In some embodiments, the electronic device changes the size of the sequence of characters in a uniform manner in the user interface (e.g., the sizes of the characters in the sequence of characters are updated by a same amount in response to detecting the third input). Additionally, in some embodiments, an amount (e.g., distance) by which the first graphical user interface element is moved in the user interface determines an amount (e.g., number of pixels) by which the size of the sequence of characters is increased. In some embodiments, the increase of the size of the sequence of characters is directly proportional and/or is equal to the distance by which the first graphical user interface element is moved in the user interface. In some embodiments, the movement of the first graphical user interface element optionally causes the bounding box surrounding the sequence of characters to decrease in size, which correspondingly causes the size of the sequence of characters to decrease in size. In some embodiments, the electronic device changes the size of the sequence of characters in the user interface without changing a size of the user interface. In some embodiments, the electronic device changes the size of the sequence of characters in the user interface without changing a size of other content displayed in the user interface, such as other content that is not bounded by the bounding box of the one or more graphical user interface elements as discussed above. In some embodiments, the electronic device changes the size of the boundary as discussed above without changing the aspect ratio of the first representation of handwritten content in the user interface. For example, the size of the characters in the sequence of characters (e.g., the lengths and/or thicknesses of the strokes/lines forming the characters) is changed in the user interface without affecting/changing the ratio of the width of the first representation of handwritten content to the height of the first representation of handwritten content. In some embodiments, in the instance that changing the size of the boundary does not cause the aspect ratio of the first representation of handwritten content to change in the user interface, the electronic device forgoes changing the number of lines in which the sequence of characters is displayed when the size of the sequence of characters is changed, which includes maintaining the third portion of the sequence of characters in the first line in the user interface. For example, the electronic device increases or decreases the size of the third portion of the sequence of characters in the first line in the user interface without moving/shifting any portions of the sequence of characters from the first line to a second line (e.g., following or preceding the first line) in the user interface. Changing a size of a representation of a handwritten sequence of characters in a user interface without changing a number of lines in which the handwritten sequence of characters is displayed in accordance with a determination that changing the size of the representation of the handwritten sequence of characters does not change an aspect ratio of the representation enables the size of the representation of the handwritten sequence of characters to be changed while automatically maintaining other visual aspects of the handwritten sequence of characters, thereby improving user-device interaction.

In some embodiments, in response to detecting the third input, in accordance with a determination that the changing the size of the boundary of the first representation of handwritten content in the user interface causes the aspect ratio of the first representation of handwritten content to change in the user interface, such as the aspect ratio of the handwritten content 625 increasing in FIG. 6DD, the electronic device changes the size of the sequence of characters in the user interface based on the change in the size of the boundary, such as increasing the size of the handwritten content 625 as shown in FIG. 6DD, and updates display of the first representation of handwritten content to include the third portion in a second line, different from the first line, in the user interface, such as increasing the number of lines in which the handwritten content 625 is displayed in FIG. 6DD. For example, the size of the boundary of the first representation of handwritten content is changed in the user interface while affecting/changing the ratio of the width of the first representation of handwritten content to the height of the first representation of handwritten content. In some embodiments, in the instance that changing the size of the boundary of the first representation of handwritten content causes the aspect ratio of the first representation of handwritten content to change in the user interface, the electronic device changes the size of the sequence of characters in the user interface as similarly discussed above and changes the number of lines in which the sequence of characters is displayed, which includes shifting/moving the third portion of the sequence of characters from the first line to a second line of the plurality of lines in the user interface, as similarly discussed herein. For example, if the electronic device increases the size of the boundary in response to detecting the third input described above to the point that the aspect ratio of the first representation of handwritten content changes, the electronic device increases the size of the sequence of characters and moves/shifts the third portion of the sequence of characters from the first line to a second line, following the first line, in the user interface. In some embodiments, if the electronic device decreases the size of the boundary in response to detecting the third input described above to the point that the aspect ratio of the first representation of handwritten content changes, the electronic device decreases the size of the sequence of characters and moves/shifts the third portion of the sequence of characters from the first line in the user interface to a third line, preceding the first line, in the user interface. Changing a number of lines in which a representation of a handwritten sequence of characters is displayed when changing a size of the representation of the handwritten sequence of characters in a user interface in accordance with a determination that the changing the size of the representation of the handwritten sequence of characters changes the aspect ratio of the representation enables visual aspects, other than the size, of the representation of the handwritten sequence of characters to be updated automatically, thereby avoiding the need for input to manually change the other visual aspects of the representation and improving user-device interaction.

In some embodiments, while displaying the first representation of handwritten content that includes the sequence of characters, the electronic device detects, via the one or more input devices, a third input directed to a respective location in the user interface that includes a third portion of the sequence of characters of the first representation of handwritten content, such as a tap of contact 601 directed to the word “Alice” in the handwritten content 625 as shown in FIG. 6AA. For example, the electronic device detects input provided by an input device (e.g., a stylus) or a finger of the hand of the user on the surface directed to the third portion of the sequence of characters in the user interface. In some embodiments, the third input has one or more characteristics of the third input described above.

In some embodiments, in response to detecting the third input, in accordance with a determination that the third input includes a first number of taps (e.g., 1, 2, 3, 4, etc.) of a contact (e.g., input device or finger of the user) on the surface directed to the third portion of the sequence of characters, the electronic device displays, such as the single tap of the contact 601 in FIG. 6AA, in the user interface, one or more graphical user interface elements for changing one or more metrics associated with the sequence of characters, such as the bounding box 630 and the resizing handles 631a-631c in FIG. 6BB. For example, the electronic device detects a first number of taps of a stylus or finger of the user on a touchscreen of the electronic device at a location corresponding to the third portion of the sequence of characters in the user interface. In some embodiments, in response to detecting the first number of taps of the contact on the surface directed to the third portion of the sequence of characters, the electronic device displays one or more resizing handles that are selectable to initiate changing of the one or more metrics associated with the sequence of characters. In some embodiments, the one or more graphical user interface elements have one or more characteristics of the one or more graphical user interface elements discussed above. Additionally, in some embodiments, when the electronic device displays the one or more graphical user interface elements in the user interface, the electronic device displays a bounding box in the user interface at a location that includes the third portion of the sequence of characters. In some embodiments, as similarly described above, when the electronic device displays the bounding box in the user interface, the bounding box is displayed around the third portion of the sequence of characters. In some embodiments, the electronic device displays the bounding box around the sequence of characters in the user interface. In some embodiments, if the sequence of characters corresponds to a plurality of paragraphs (and/or a plurality of groups of characters), the electronic device displays the bounding box around a first paragraph of the plurality of paragraphs that includes the third portion of the sequence of characters. In some embodiments, as similarly discussed above, the electronic device displays the one or more graphical user interface elements at one or more locations of the bounding box (e.g., at an edge/side of the bounding box and/or at a corner of the bounding box). Displaying one or more graphical user interface elements in a user interface that includes a representation of a handwritten sequence of characters in a user interface in response to detecting a first number of taps of a contact on a surface directed to a portion of the representation of the handwritten sequence of characters in the user interface facilitates user input for changing one or more metrics associated with the sequence of characters via the one or more graphical user interface elements and/or reduces the number of inputs needed to display the one or more graphical user interface elements in the user interface, thereby improving user-device interaction.

In some embodiments, in response to detecting the third input, in accordance with a determination that the third input includes a second number (e.g., 2, 3, 4, 5, etc.), greater than the first number, of taps of the contact (e.g., input device or finger of the user) on the surface directed to the third portion of the sequence of characters, such as the double tap of the contact 601 directed to the word “was” in the handwritten content 605 as shown in FIG. 6EE, the electronic device displays, in the user interface, the one or more graphical user interface elements for changing the one or more metrics associated with the sequence of characters (e.g., as similarly described above), such as the bounding box 630 and the resizing handles 631a-631c as shown in FIG. 6FF. In some embodiments, as similarly described above, the electronic device displays the one or more graphical user interface elements concurrently with a bounding box that is displayed at a location that includes the third portion of the sequence of characters (and optionally the sequence of characters) in the user interface in response to detecting the second number of taps of the contact on the surface directed to the third portion of the sequence of characters.

In some embodiments, the electronic device displays a plurality of options for performing a plurality of operations associated with the third portion of the sequence of characters, such as the toolbar element 614 and the scaling handles 634a and 634b as shown in FIG. 6FF. For example, in response to detecting the third input that includes the second number of taps of the contact on the surface, the electronic device displays a toolbar user interface object including the plurality of options in the user interface. In some embodiments, the plurality of options has one or more characteristics of the plurality of options discussed above. In some embodiments, when the toolbar user interface object is displayed in the user interface, the electronic device displays the third portion of the sequence of characters with visual emphasis relative to other characters of the sequence of characters in the user interface. For example, while the bounding box described above is displayed around the sequence of characters in the user interface (or a subset thereof), the electronic device displays the third portion of the sequence of characters with highlighting, bolding, underlining, brightness, or other visual effect indicating that the third portion of the sequence of characters is selected. In some embodiments, as similarly discussed above, the plurality of options is selectable to perform a plurality of corresponding operations directed to the third portion of the sequence of characters, without necessarily performing one or more operations on the other characters of the sequence of characters. Additionally, in some embodiments, the electronic device displays a set of resizing affordances, different from the one or more graphical user interface elements discussed above (e.g., the resizing handles of the bounding box described above), with the third portion of the sequence of characters in the user interface. In some embodiments, the set of resizing affordances is displayed on either side/end of the third portion of the sequence of characters. For example, if the third portion of the sequence of characters is a word, the set of resizing affordances (e.g., a first resizing affordance and a second resizing affordance) is displayed at a beginning of the word and at an end of the word. In some embodiments, the set of resizing affordances is selectable to initiate changing a size of the third portion of the sequence of characters within the first representation of handwritten content in the user interface. For example, movement of a first resizing affordance of the set of resizing affordances (e.g., in a respective direction and/or with a respective magnitude) causes the third portion of the sequence of characters to increase or decrease in size in the user interface, without changing a size of other portions of the sequence of characters in the user interface. Displaying one or more graphical user interface elements and a toolbar user interface object in a user interface that includes a representation of a handwritten sequence of characters in a user interface in response to detecting a second number of taps of a contact on a surface directed to a portion of the representation of the handwritten sequence of characters in the user interface facilitates user input for changing one or more metrics associated with the sequence of characters and/or for performing one or more operations directed to the portion of the sequence of characters elements and/or reduces the number of inputs needed to display the one or more graphical user interface elements and/or the toolbar user interface object in the user interface, thereby improving user-device interaction.

It should be understood that the particular order in which the operations in FIG. 7 have been described, optionally including the additional and/or alternatives operations to the illustrated operations in FIG. 7 described herein, is merely exemplary and is not intended to indicate that the described order is the only order in which the operations could be performed. One of ordinary skill in the art would recognize various ways to reorder the operations described herein.

The operations in the information processing methods described above are, optionally, implemented by running one or more functional modules in an information processing apparatus such as general purpose processors (e.g., as described with respect to FIGS. 1A-1B, 3, 5A-5I) or application specific chips. Further, the operations described above with reference to FIG. 7 are, optionally, implemented by components depicted in FIGS. 1A-1B. For example, displaying operations 702, 710 and 714, and detecting operation 702, are, optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

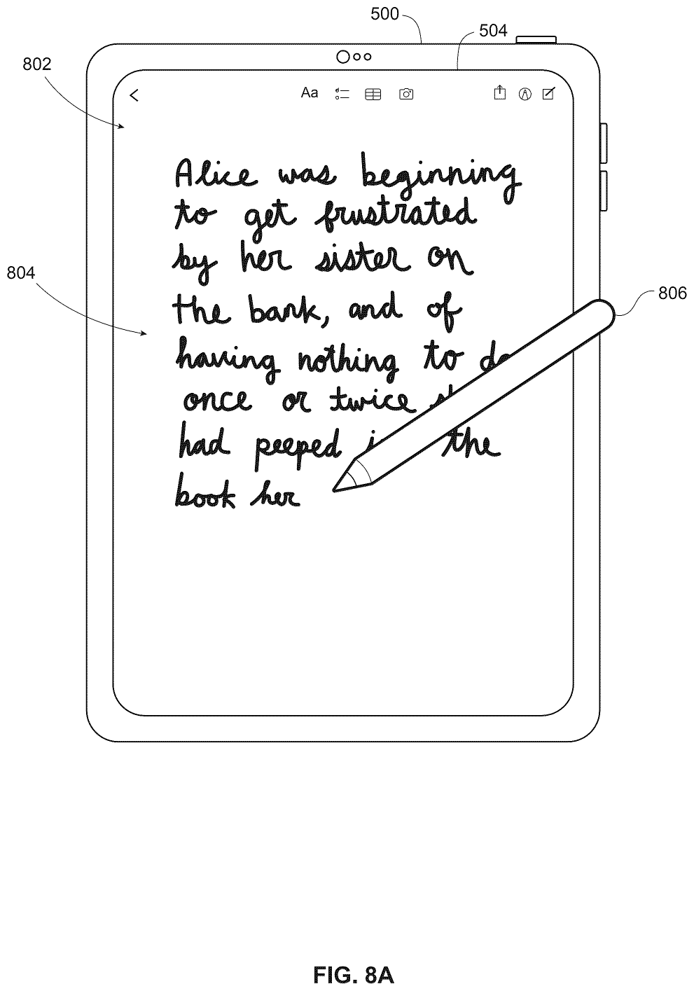

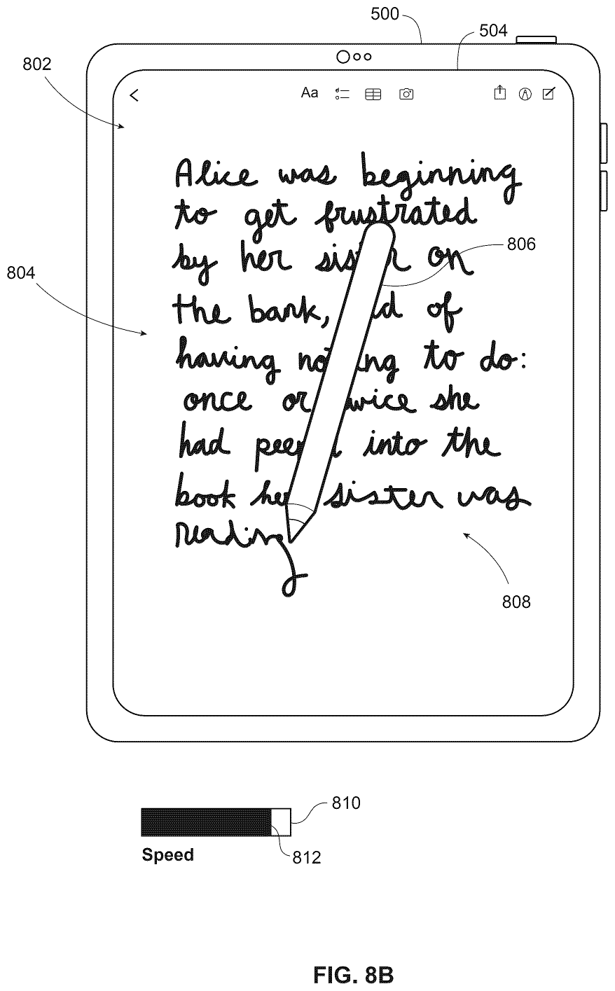

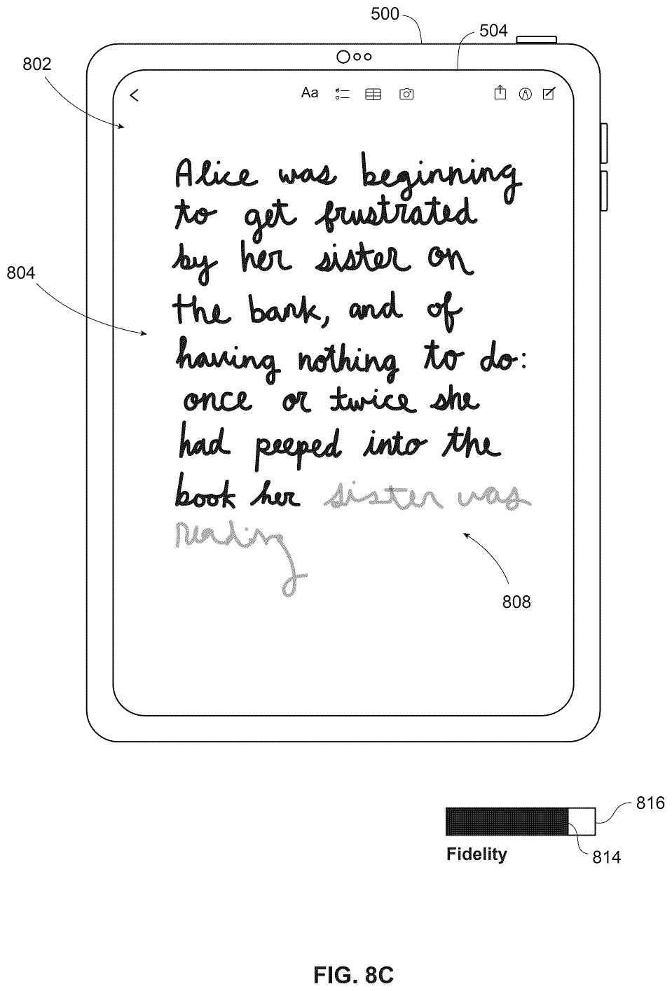

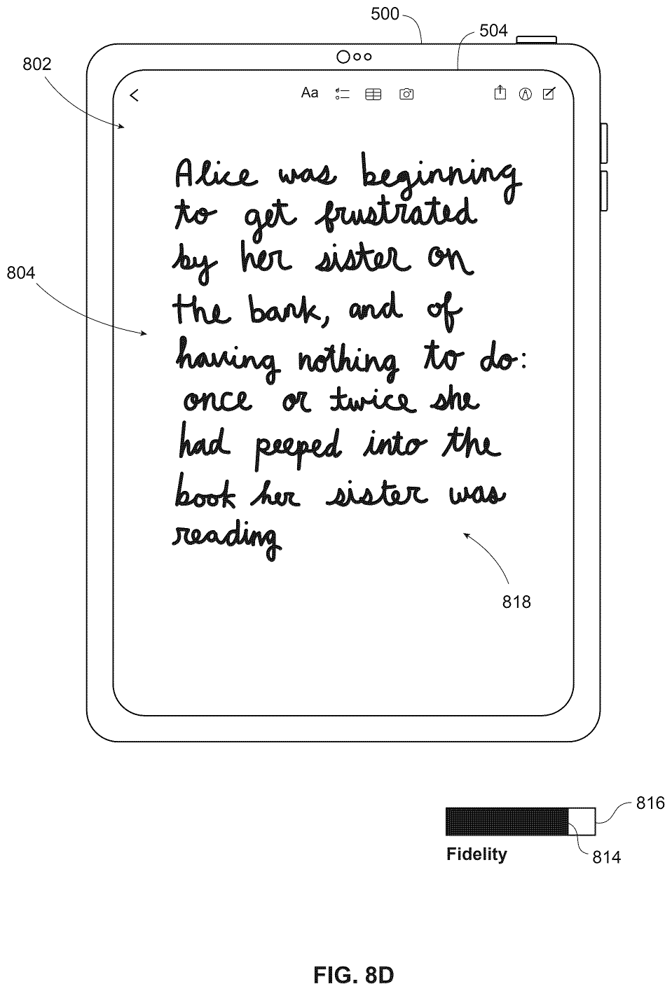

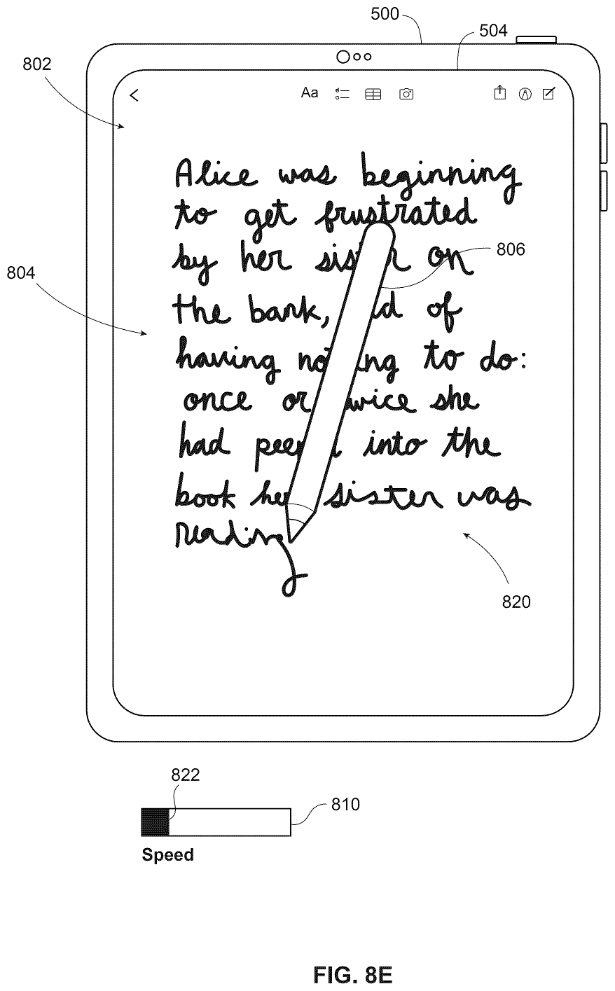

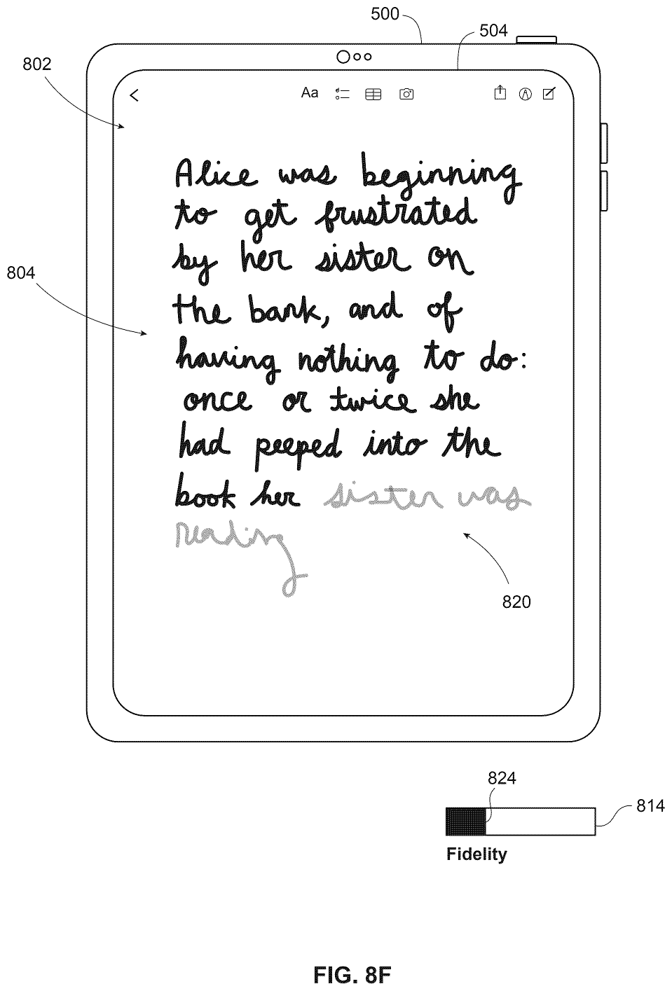

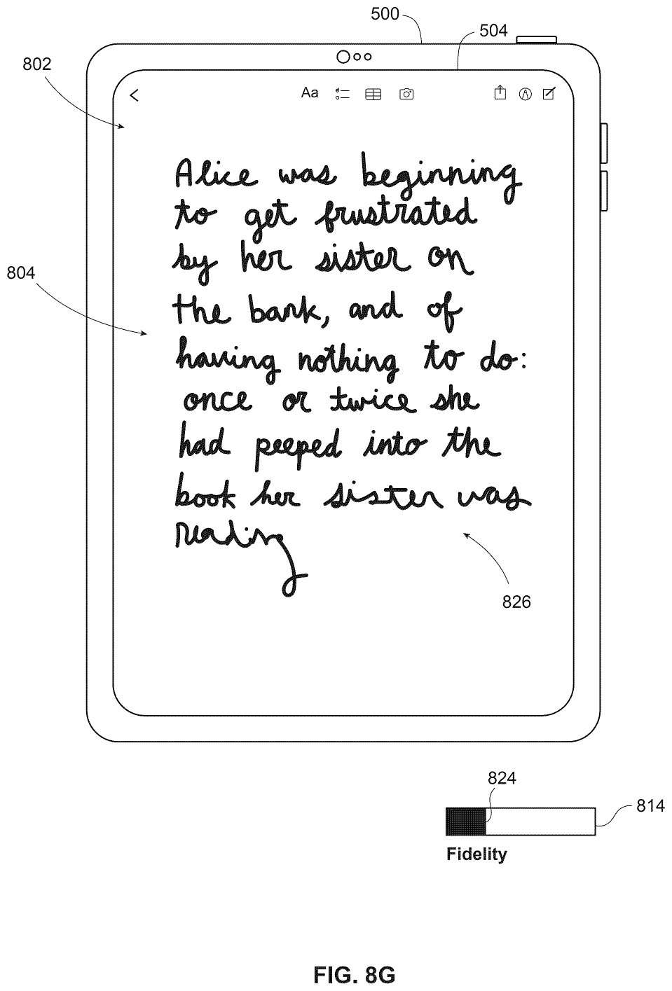

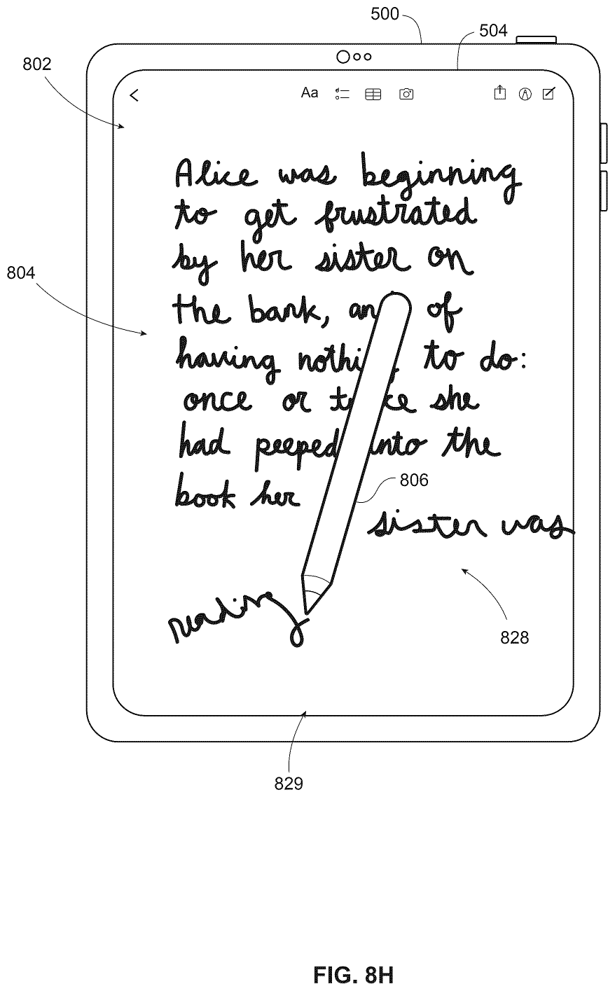

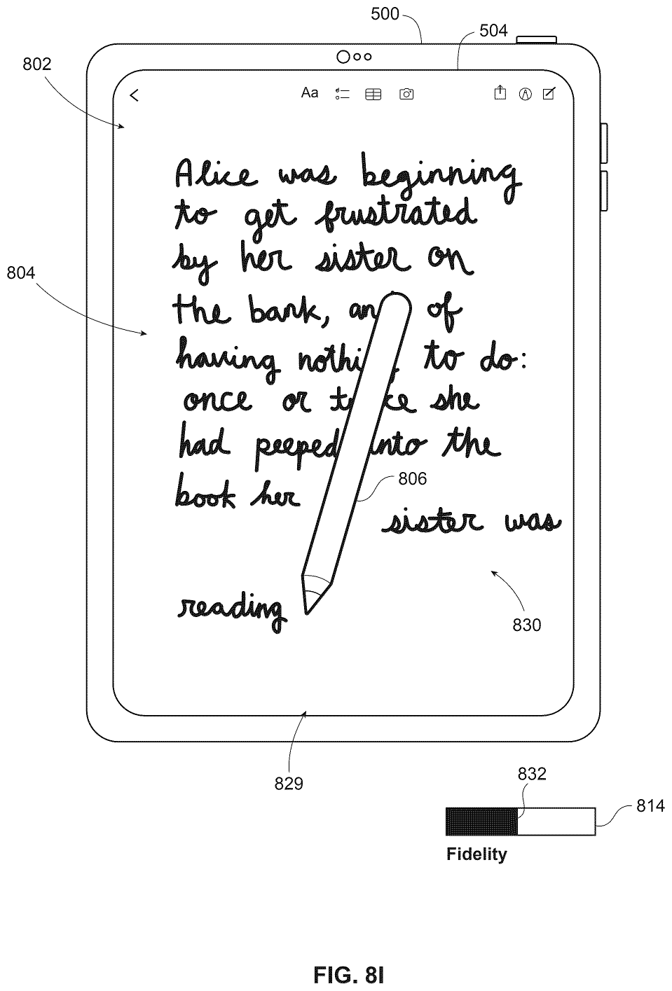

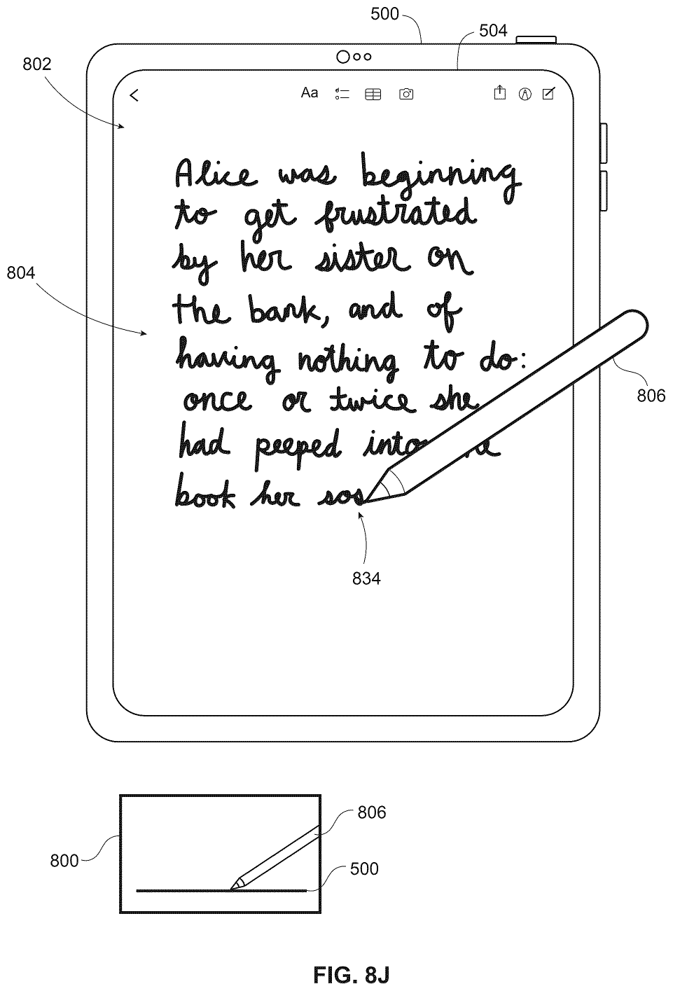

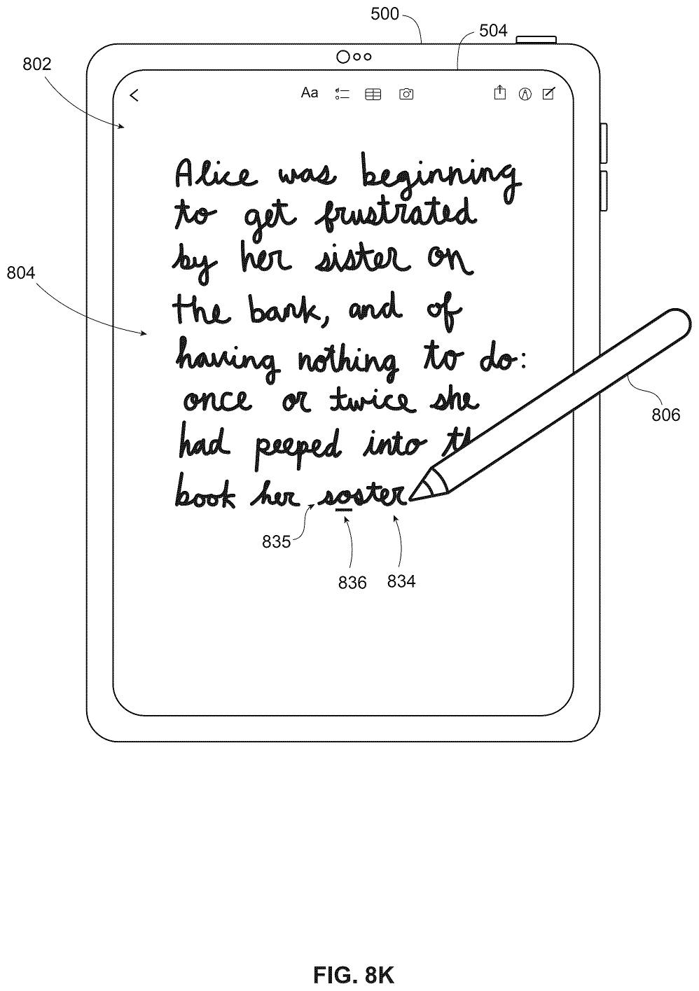

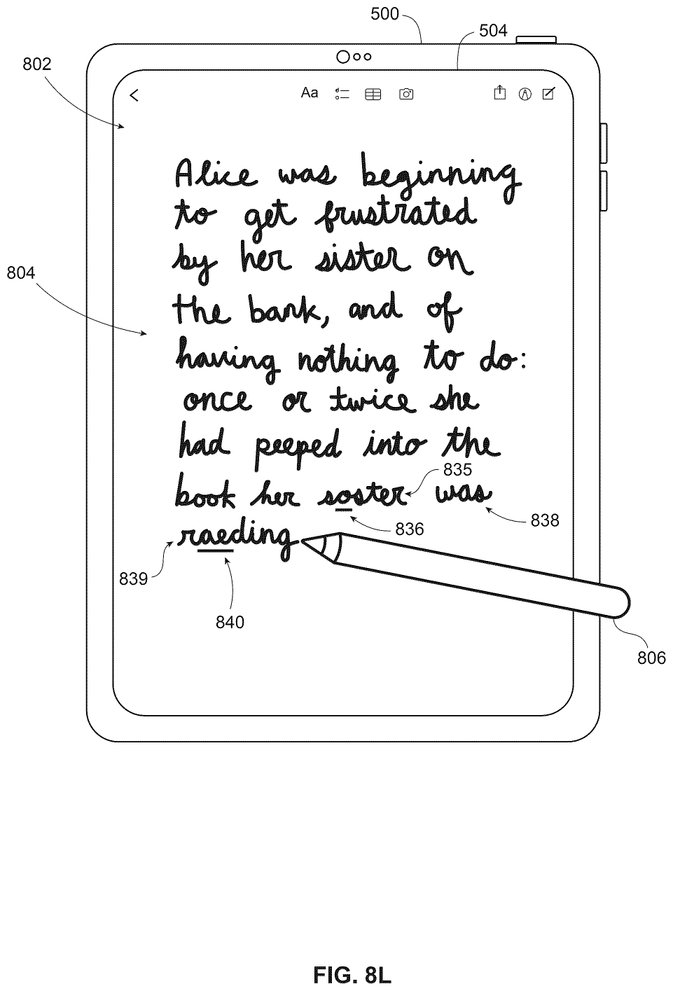

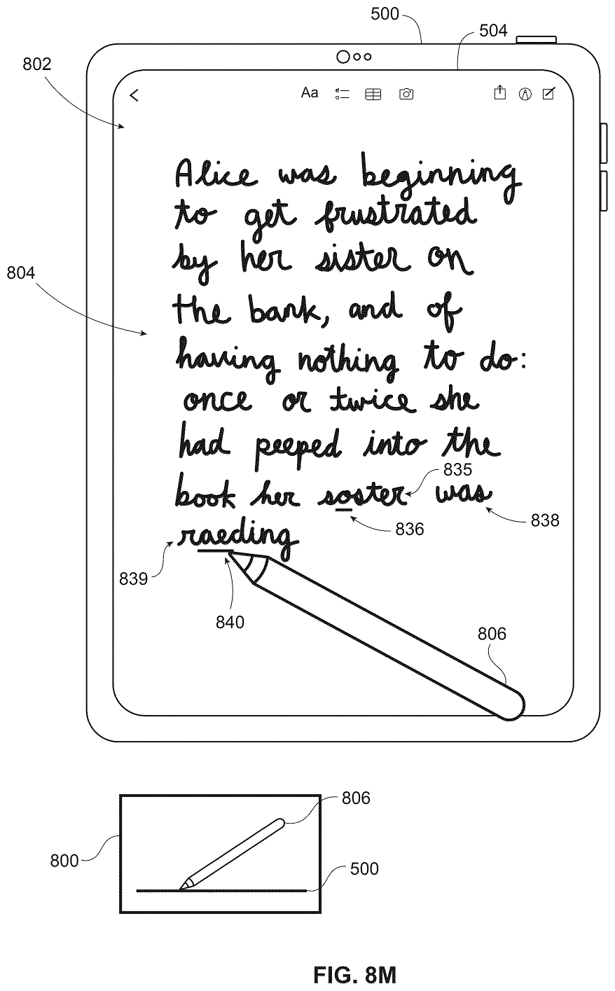

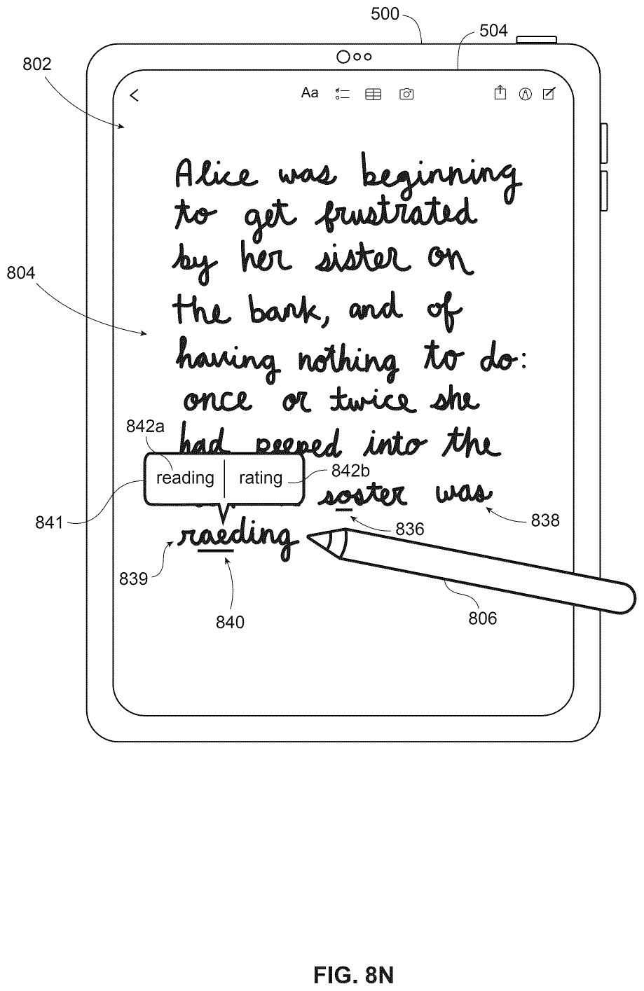

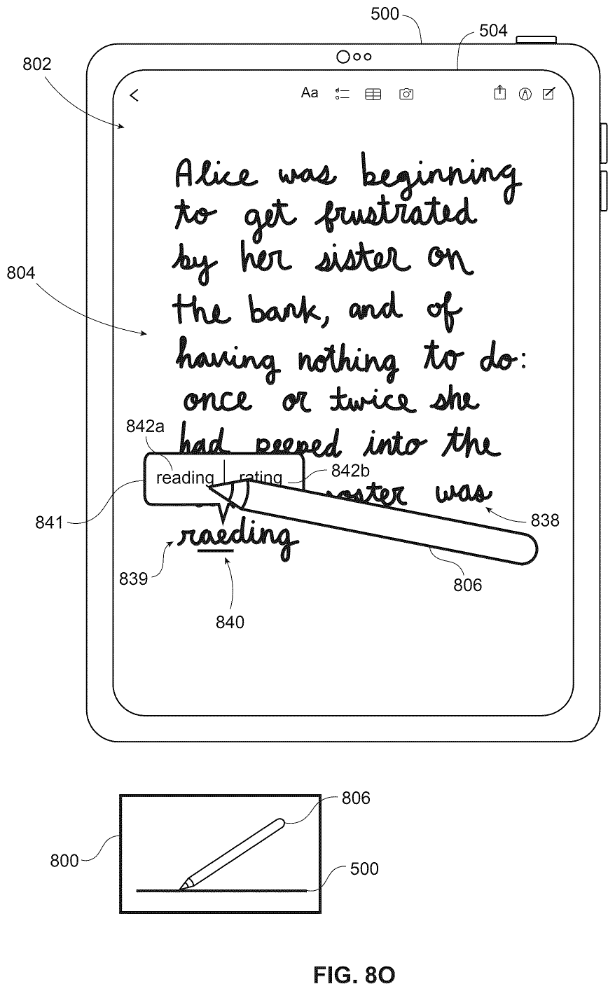

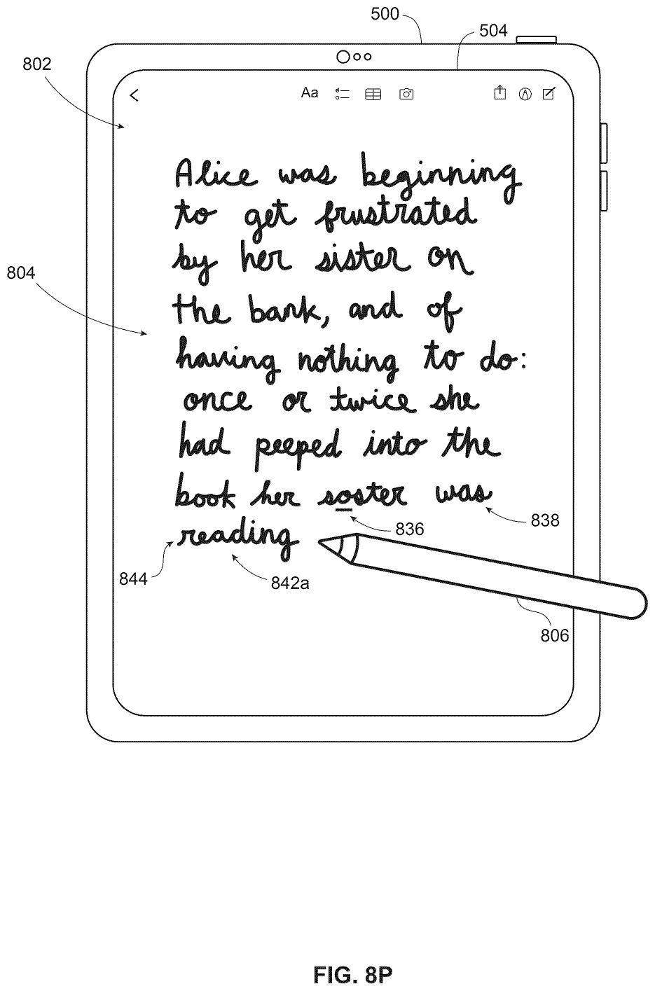

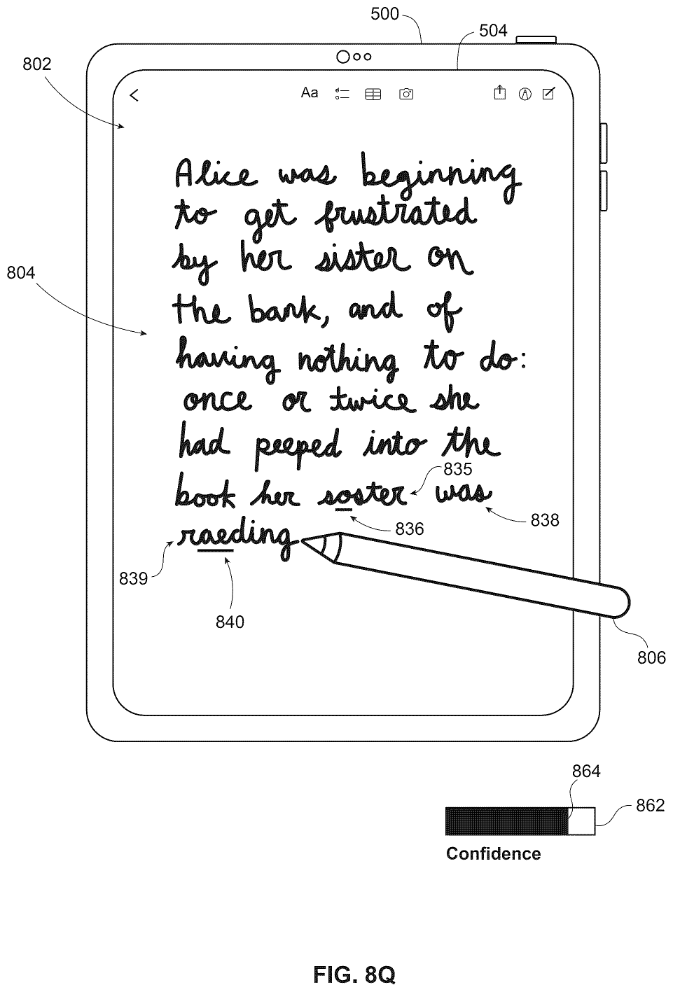

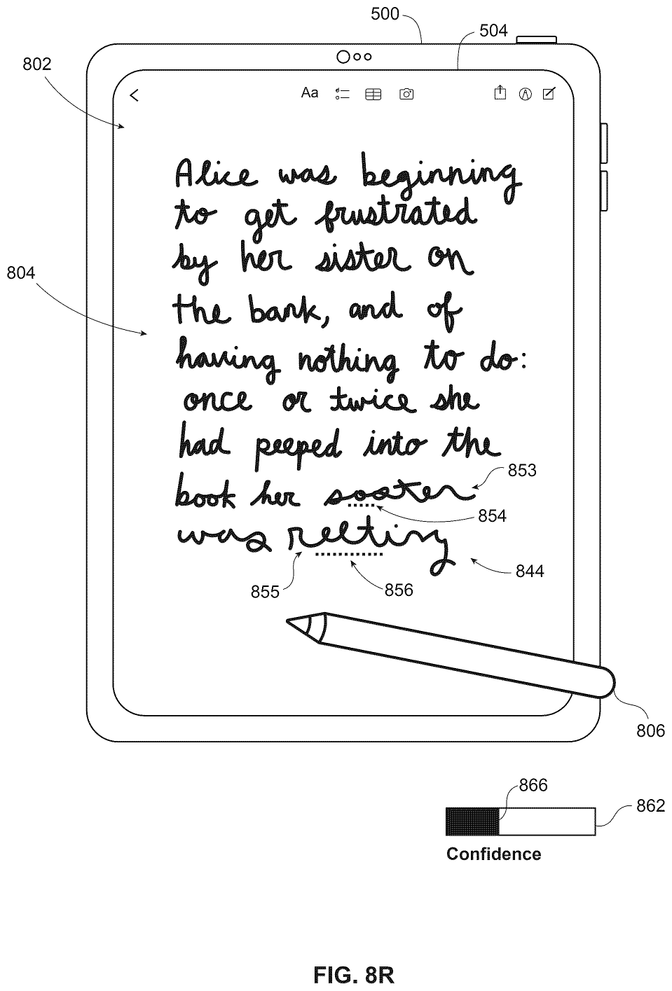

FIGS. 8A-8R illustrate various examples of the operation of an electronic device that converts handwritten input into handwriting based on a model handwriting. The embodiments in these figures are used to illustrate the processes described below, including the processes described with reference to FIG. 9. Although FIGS. 8A-8R illustrate various examples of ways an electronic device is able to perform the processes described below with respect to FIG. 9, it should be understood that these examples are not meant to be limiting, and the electronic device is able to perform one or more processes described below with reference to FIG. 9 in ways not expressly described with reference to FIGS. 8A-8R.

FIG. 8A illustrates electronic device 500 displaying user interface 802 (e.g., via a display device, via a display generation component, or via a touch screen) and an electronic stylus 806 interacting with the user interface 802. In some embodiments, user interface 802 is displayed via a display generation component. In some embodiments, the display generation component is a hardware component (e.g., including electrical components) capable of receiving display data and displaying a user interface. In some embodiments, examples of a display generation component include a touch screen display (such as touch screen 504), a monitor, a television, a projector, an integrated, discrete, or external display device, or any other suitable display device that is in communication with electronic device 500. The user interface 802 is, for example, a text composition user interface associated with a note-taking application, a messaging application, a journaling or scheduling application, a text-editor application, and/or a text annotation application or any other region that can accept handwritten input.

In FIG. 8A, the electronic device 500 is displaying a representation of previous handwritten input 804 on the user interface 802. The previous handwritten input was provided by a user writing on the touch screen 504 using the stylus 806. In some embodiments, the user wrote on the touch screen 504 using a finger (not shown). The electronic device 500 received, via the touch screen 504, the previous handwritten input (as will be described further in this disclosure in reference to representations of a first handwritten input) and in response, displayed the representation of the previous handwritten input 804 (e.g., paragraph “Alice was beginning . . . book her”) on the user interface 802. The representation of handwritten input 804 has a visual appearance. As described in this disclosure, a visual appearance of a representation of handwritten input corresponds to one or more characteristics of the representation of the handwritten input including a size of characters of the representation of handwritten input, a shape of the characters, an orientation of the characters, a spacing between the characters, a thickness of lines forming the characters, one or more stroke patterns used to form the characters of the handwritten input, and/or variations and/or patterns of any one of these characteristics included within the representation of the handwritten input.

In FIG. 8B, the electronic device 500 receives a first handwritten input from the electronic stylus 806. In particular, the electronic device 500 detects continuous and/or subsequent strokes and/or contacts provided by the stylus 806 of the user on the touch screen 504 of the electronic device 500. In response, the electronic device 500 displays the first representation of the first handwritten input 808, as shown in FIG. 8B. The electronic device 500 displays the first representation of the handwritten input while receiving the first handwritten input (e.g., the handwritten text is displayed as the user writes). The first representation of the first handwritten input 808 includes handwritten characters, such as letters, words, numbers, special characters, and/or shapes that are recognized by the electronic device 500 as handwritten input. In the embodiment illustrated in FIG. 8B, the first representation of the first handwritten input 808 is “sister was reading.” The first representation of the first handwritten input 808 has a first visual appearance. As shown by the illustrative irregularities of the handwritten text, the visual appearance of the first representation of the first handwritten input 808 corresponds to a raw and accurate representation of the user's contact and motions/strokes in a text entry region of the user interface 802 (e.g., the first representation of handwritten input 808 is displayed as the user wrote it). Accordingly, the first representation of the first handwritten input 808 has a first visual appearance that reflects the user's handwriting (e.g., corresponds to one or more characteristics of the user's handwriting).

In FIGS. 8C and 8D, the electronic device 500 converts the user's handwriting to a handwriting corresponding to a handwriting model stored at the electronic device. Before initiating the conversion, the electronic device 500 detects that one or more criteria are satisfied. The one or more criteria include a criterion that is satisfied, for example, when the electronic device detects a pause in the handwritten input lasting a threshold duration such as 1, 2, 3, 4 or 5 seconds (e.g., a threshold amount of time has elapsed since detecting a cease in motion of the stylus or finger), and/or when the electronic device detects a threshold number of words, such as 1, 2, 3, or 5 words, within the recognized words from the first handwritten input discussed above, and/or when the electronic device 500 detects a predefined character within the recognized characters from the first handwritten input, such as a punctuation mark (e.g., comma, a semi-colon, a period, etc.). The electronic device 500 detects that the one or more criteria are satisfied while displaying the first representation of the first handwritten input 808 in the user interface 802 that has the first visual appearance (e.g., the handwritten “sister was reading” as shown in FIG. 8B).

In FIG. 8C, in response to detecting that the one or more criteria are satisfied, in accordance with a determination that a handwriting model at the electronic device 500 is a first handwriting model, the electronic device 500 ceases display of the first representation of the first handwritten input 808. The handwriting model optionally comprises a set of characteristics that define a particular handwriting. In some embodiments, the handwriting model is generated based on one or more previously detected handwritten inputs (e.g., handwritten inputs detected prior to the first handwritten input discussed above). In the embodiment illustrated, the first handwriting model is generated based on the representation of previous handwritten input 804 currently displayed on the user interface 802 (e.g., “Alice was beginning . . . ”). In some embodiments, the handwriting model defines (e.g., determines) a visual appearance of a representation of the handwriting model. Accordingly, in some embodiments, the visual appearance optionally corresponds to one or more characteristics of the representation of the handwriting model. In the embodiment illustrated in FIG. 8C, since the first handwritten model is based on the representation of previous handwritten input 804, the visual appearance defined by the first handwritten model corresponds to or matches the visual appearance of the representation of previous handwritten input 804 (e.g., “Alice was beginning”). Staying with FIG. 8C, the newly written text “sister was reading” (e.g., the first representation of the first handwritten input 808) is shown fading out of the user interface 802 as the electronic device 500 ceases display of the first representation of the first handwritten input 808 as part of the conversion of the user's handwriting to a handwriting according to the first model handwriting.

In FIG. 8D, the electronic device 500 displays a second representation of the first handwritten input 818. The second representation of the first handwritten input 818 is the converted handwriting according to the first handwriting model and replaces the first representation of the first handwritten input 808 (e.g., the user's raw handwritten input). As shown, therefore, the second representation of the first handwritten input 818 has a second visual appearance, different from the first visual appearance of the first representation of the first handwritten input 808 displayed in FIG. 8B, as the handwriting of “sister is reading” in FIG. 8D differs from the converted handwriting of “sister is reading” in FIG. 8B. This is because the electronic device 500 displays the second visual appearance of the second representation of the first handwritten input 818 in FIG. 8D in accordance with the first handwriting model, unlike the first visual appearance which reflected the user's raw handwritten input as shown in FIG. 8B. Accordingly, the second visual appearance of the second representation of the first handwritten input 818 (e.g., “sister is reading”) matches the visual appearance of the representation of previous handwritten input 804 (e.g., “Alice was beginning . . . ”).

In some embodiments, the handwriting model is based on a stored representation of a handwritten input directed to the user interface received prior to receiving the first handwritten input. For example, in FIGS. 8A-8D, as previously described, the first handwriting model is based on the representation of previous handwritten input 804. Accordingly, as shown in FIG. 8D for example, the visual appearance of the second representation of the first handwritten input 818 matches the visual appearance of the representation of previous handwritten 804 upon which the handwriting model is based. The converted handwriting 818 (e.g., “sister is reading”) based on the handwriting model thus matches the handwriting of the representation of previous handwritten input 804 (e.g., “Alice was beginning . . . ”) upon which the handwriting model is based.

In some embodiments, a fidelity of the displayed converted handwriting to model handwriting varies with a speed of the handwritten input. In some embodiments, fidelity is a measure of how many characteristics are shared between the first visual appearance and the visual appearance defined by the first handwriting model (e.g., how many of a size of characters, a shape of characters, an orientation of characters, a spacing between characters, a thickness of lines forming characters, one or more stroke patterns used to form characters, and/or variations or patterns of any one of these characteristics). In particular, the electronic device 500 receives the first handwritten input which includes detecting contact of the electronic stylus 806 (e.g., or a finger) on the touch screen 504 with a respective speed. The respective speed refers to the speed of movement of the input device (e.g., stylus) 806 (e.g., or a finger) forming/providing the first handwritten input on a surface of the touch screen 504. Referring back to FIG. 8B, the respective speed is a first speed 812 as shown in the speed bar 810. In accordance with a determination that the respective speed is a first speed 812 (e.g., a high speed 812), the second representation of the first handwritten input 818 (e.g., the converted handwriting 818) has a first fidelity (e.g., match) to the first handwriting model (e.g., to the visual appearance of the representation of previous handwritten input 804). In FIG. 8D, it is shown that, because the first speed 812 is high, the fidelity of the second representation of handwritten input 818 to the first model handwriting (e.g., to the visual appearance of the representation of previous handwritten input 804) is equally high, as indicated by the fidelity level 814 and by the visual appearance of the converted handwriting 818, which matches the the representation of previous handwritten input 804.

In FIGS. 8E-8G, the respective speed at which the electronic device detects contact of the stylus 806 on the touch screen 504 is a second speed 822, different from the first speed 812. In FIG. 8E, the electronic device 500 is shown receiving the first handwritten input at the second speed 812 (as shown in the speed bar 810) and displaying the raw handwritten input as the first representation of the first handwritten input 820 in response. In this example, the user is writing very slowly, as shown as the low speed 822.

In FIG. 8F, in response to detecting that one or more criteria are satisfied and in accordance with a determination that a handwriting model at the electronic device 500 is a first handwriting model (e.g., the handwriting model based on and reflected by the representation of previous handwritten input 804), the electronic device 500 ceases display of the first representation of the first handwritten input 820 (e.g., shown fading away).

In FIG. 8G, the electronic device 500 displays, in the user interface 802, a second representation of the first handwritten input 826 that has a second visual appearance, different from the first visual appearance, wherein the second visual appearance of the second representation of the first handwritten input 826 is in accordance with the first handwriting model. In accordance with a determination that the speed is a second speed 822, different from the first speed 812, the second representation of the first handwritten input has a second fidelity 824, different from the first fidelity 814 (e.g., see FIG. 8D), to the first handwriting model (e.g., the handwriting model based on and reflected by the representation of previous handwritten input 804). The converted handwriting 826 has less fidelity 824 to the first handwriting model, as represented by the representation of previous handwritten input 804, because the handwritten input had a slower speed 822 than the first speed 812 (e.g., the user writes at a slower speed). In contrast, in FIGS. 8B-8D, fidelity 814 of the converted writing 818 to the first handwritten model (as represented by the representation of previous handwritten input 804) is greater due to the greater speed 812 of the first handwritten input (or faster first handwritten input).

Staying with FIGS. 8H and 8I, in some embodiments, a fidelity of the displayed handwriting varies with a respective distance of the current handwritten input from previous handwritten input on the user interface 802. In FIG. 8H, the electronic device 500 receives a first handwritten input directed at a location of the user interface 802 that is a respective distance from the representation of previous handwritten input 804 and displays, on the user interface 802, the first representation of the first handwritten input 828 at the respective distance. The words of the first handwritten input 828 (e.g., “sister was reading”) are each displayed at greater, second distance from the representation of previous handwritten input 804 (e.g., “Alice was beginning . . . book her”) than they were in FIG. 8B, where they were written at a first distance closer to the the representation of previous handwritten input 804. In FIG. 8I, in accordance with a determination that the respective distance is a second distance, different from the first distance, the second representation of the first handwritten input 830 has a second fidelity 832, different from the first fidelity 814 (see FIG. 8D), to the first handwriting model (e.g., as represented by the representation of previous handwritten input 804). Accordingly, the converted handwriting 830 of FIG. 8I has less fidelity to the visual appearance of the representation of previous handwritten input 804 than the converted handwriting 818 of FIG. 8D because the converted handwriting 830 was entered and is displayed further from the the representation of previous handwritten input 804 than converted handwriting 818 of FIG. 8D.

In some embodiments, a spacing between words of the first representation of the first handwritten input and corresponding words of the second representation of the first handwritten input is maintained. In particular, in some embodiments, the first representation of the first handwritten input 828 input includes a plurality of words (e.g., “sister was reading”) and in accordance with the determination that the handwriting model at the electronic device 500 is the first handwriting model, a first spacing between adjacent words of the plurality of words corresponds to (e.g., is the same as) a second spacing between corresponding adjacent words of the second representation of the first handwritten input 830. Accordingly, for example, as shown in FIGS. 8H and 8I, the spacing (e.g., the size of the blank space) between “sister” and “was” is maintained between the first representation of the first handwritten input 828 and the second representation of the first handwritten input 830. Similarly, referring back to FIGS. 8B and 8D for example, the spacing between “sister” and “was” is preserved between the first representation of the first handwritten input 808 and the second representation of the first handwritten input 818.

In some embodiments, a relative position of words is maintained between words of first representation of the first handwritten input 828 and corresponding words of the second representation of the first handwritten input 830. For example, in some embodiments, the first representation of the first handwritten input 828 includes a first word and a second word having a first spatial arrangement (e.g., relative position and/or orientation) in the user interface 802. In FIG. 8H for example, in the first representation of the first handwritten input 828, the word “reading” is located at a respective distance and respective direction or orientation from the words “sister” on the user interface 802. The first spatial arrangement of “sister” and “reading” is thus the combination of the distance (e.g., an inch) and the orientation (e.g., a clock position of “8 o'clock”) of “reading” relative to “sister.” In accordance with the determination that the handwriting model at the electronic device 500 is the first handwriting model, the first word (e.g., “sister”) and the second word (e.g., “reading”) of the second representation of the first handwritten input 830 have a second spatial arrangement corresponding to (e.g., the same as) the first spatial arrangement in the user interface 802. Accordingly, in FIG. 8I, which shows the electronic device 500 displaying the second representation of the first handwritten input 830 in the user interface 802 (e.g., the converted handwriting), the spatial arrangement of “sister” and “reading” is the same as in FIG. 8H (in the first representation of the first handwritten input).

In some embodiments, the electronic device 500 corrects for tilt in the converted handwriting. In particular, in some embodiments, at least a portion of the first representation of the first handwritten input 828 has a first orientation relative to an axis of the user interface 802, and at least a corresponding portion of the second representation of the first handwritten input 830 has a second orientation (optionally different from the first orientation) that is aligned with the axis of the user interface. For example, in FIG. 8I, the word “reading” (e.g., the portion of the first representation of the first handwritten input 828) is tilted at approximately 30 degrees from a horizontal axis of the user interface 802 (e.g., an axis parallel to the bottom border 829 of the touch screen 504 in this example). The first orientation of “reading” is therefore the angle of 30 degrees relative to the horizontal axis of the user. In FIG. 8H, the electronic device 500 has corrected the 30-degree tilt of the word “reading” in the second representation of the first handwritten input 830 such that the word “reading” has a second orientation in this representation of the first handwritten input that is aligned with the horizontal axis of the user interface (e.g., in parallel with the bottom border 829 of the touch screen 504 in this example). Accordingly, the electronic device 500 has corrected the tilt (e.g., non-horizontal alignment) of the word “reading” in the converted handwriting 830.

FIGS. 8J-8R illustrate examples of the electronic device 500 detecting a typographical error (e.g., a misspelling) in the handwritten input and in response displaying an indication associated with the typographical error (e.g., the misspelling). In FIG. 8J, the electronic device 500 displays a representation of previous handwritten input 804 and is in the process of receiving the first handwritten input via electronic stylus 806 and displaying, on the user interface 802, the second representation of the first handwritten input 834 in accordance with the first handwriting model (e.g., the converted handwriting) that replaces the first representation (e.g., the raw handwriting, not shown) as previously described. As shown, the electronic device 500 has detected the word “sos” so far.

In FIG. 8K, the electronic device 500 has detected more of the first handwritten input (e.g., the user has written more) and in response displayed on the user interface 802 more of the second representation of handwritten input 834, which now reads “soster.” While displaying the second representation of the first handwritten input 834 that has the second visual appearance in accordance with the determination that the handwriting model at the electronic device 500 is the first handwriting model, the electronic device 500 determines that a portion 835 of the second representation of the first handwritten input 834 includes a typographical error. In particular, the electronic device 500 illustrated in FIG. 8K detects that the word “soster” in the second representation of the first handwritten input 834 includes a typographical error and that the correct spelling of the word is “sister.” In some embodiments, the electronic device 500 determines that the portion 835 (“soster”) has a typographical error using a digital dictionary stored and/or otherwise accessible at the electronic device. For example, the electronic device 500 performs a comparison of a respective detected word (e.g., “soster”) in the second representation of the first handwritten input 834 with a corresponding word (e.g., “sister”) in the digital dictionary to determine whether the respective detected word includes a typographical error. In response to determining that the portion 835 of the second representation of the first handwritten input 834 includes the typographical error, the electronic device 500 displays, in the user interface 802, an indication 836 of the typographical error associated with the portion 835. As shown, the indication 836 of the typographical error is displayed adjacent to the portion 835. The indication 836 in the embodiment illustrated is a line displayed under the misspelled word 835.

In some embodiments, the indication 836 is only associated and/or displayed with the misspelled portion 835 of the misspelled word. In particular, the portion 835 of the second representation of the first handwritten input 834 corresponds to one or more first characters (e.g., of a given word) and the indication 836 of the typographical error is associated with (e.g., displayed relative to) the one or more first characters (e.g., of the given word) of the second representation of the first handwritten input 834 corresponding to the typographical error, without being associated with (e.g., displayed relative to) one or more second characters (e.g., of the given word), different from the one or more first characters, that do not correspond to (e.g., do not contain) the typographical error. For example, in FIG. 8K, the indication 836 of the typographical error is associated with the character “o” of the misspelled word “soster” (e.g., the portion 835 of the second representation of the first handwritten input 834) that corresponds to the typographical error, whereas the indication 836 is not associated with the rest of the characters (e.g., “s” or “ster”) in the misspelled word “soster.” Accordingly, only the “o” is underlined with the indication 836.

In FIG. 8L, the electronic device 500 has received more handwritten input and in response, displays on the user interface 802 the second representation of the first handwritten input 838 as “soster was raeding.” An indication 836 of typographical error underlines the portion character “o” associated with the misspelling of the word “soster,” (e.g., a first portion 835 of the second representation of the first handwritten input 834 that includes a typographical error), whereas an indication 840 of typographical error underlines the characters “ae”, which represent the characters associated with the misspelled portion of the misspelled word “raeding.” (e.g., a second portion 839 of the second representation of the first handwritten input 834 that includes the typographical error).

In FIG. 8M, the electronic device 500 detects a selection of indication 840 of a typographical error of the second representation of the first handwritten input 838. In particular, the electronic device 500 detects contact of electronic stylus 806 on the indication (e.g., underline) 840 of the misspelled portion 839 (e.g., the characters “ae”) of the word “raeding.”

In FIG. 8N, in response to the selection of the indication 840, the electronic device 500 displays in proximity to the portion 839 of the second representation of the first handwritten input 838 that includes the typographical error, one or more suggested words 842a, 842b, etc. (e.g., words having the proper spelling or properly spelled versions of the misspelled word) corresponding to the portion having the typographical error corrected. For example, suggested word 842a (“reading”) and 842b (“rating”) correspond to the misspelled word “raeting” of the second representation of the first handwritten input 838. In some embodiments, the electronic device 500 displays the one or more suggested words 842a, 842b, etc. in a pop-up 841 located in proximity to the portion 839 of the second representation of the first handwritten input 838 that includes the typographical error.

In FIGS. 8O-8P, an input directed to a displayed suggested word replaces the misspelled word with the suggested word. In particular, in FIG. 8O, while displaying the one or more words 842a, 842b corresponding to the portion 839 having the typographical error corrected (e.g., in the pop-up 841), the electronic device 500 receives, via the touch screen 504, a first input directed to the one or more words 842a, 842b. In the embodiment illustrated, the first input is a stylus contact directed to the suggested word 842a (e.g., the word “reading”) for the misspelled word “raeding.”

In FIG. 8P, in response to receiving the first input, in accordance with a determination that the first input is directed to a first word 842a (e.g., “reading”) of the one or more words 842a, 842b, etc. having the typographical error corrected, the electronic device 500 replaces display of the portion 839 (e.g., “raeding”) of the second representation of the first handwritten input 838 that includes the typographical error with a second portion 844 of handwritten representation that includes the first word 842a (e.g., “reading”) of the one or more words having the typographical error corrected. Accordingly, as shown in FIG. 8P, the misspelled word “raeding” is replaced with the suggested word “reading” in response to a stylus input directed to the display of the word 842a in the pop-up 841 of FIG. 8O.

In some embodiments, a first characteristic of the indication of typological error varies based on a confidence in the transcription of the detected word (and thus the suggested correction). In particular, in some embodiments, the portion of the second representation of the first handwritten input having the typographical error is associated with a respective confidence level. The confidence level is a measure of the confidence that the electronic device 500 has that the portion of the second representation of the first handwritten input having the typographical error is an accurate transcription of a corresponding portion of the first representation of the first handwritten input. In some embodiments, the confidence level is a measure of how easily the electronic device 500 has deciphered the user's handwriting (e.g., recognized characters and words of the corresponding portion of first representation of the first handwritten input) and the accuracy of such recognition. In accordance with a determination that the respective confidence level is a first confidence level, the electronic device 500 displays the indication with a first visual characteristic having a first value. For example, in FIG. 8Q, the second representation of the first handwritten input 838 is shown with portion 835 underlined with the indication 836 to indicate a misspelling in the word “soster” (similarly, portion 839 is underlined with the indication 840 to indicate a misspelling in the word “raeding”). A confidence bar 862 shows the first confidence level 864 of the portion 836 of the second representation of the first handwritten input 838 having a typographical error, indicating that confidence level 864 in the transcription of the portion is high. Accordingly, the indication 836 associated with the portion or misspelled word 835 has a first visual characteristic having a first value. In some embodiments, the first visual characteristic is the color of the indication 836. Therefore, for example, the indication 836 (e.g., the line under the “o” of “soster”) has a first color (e.g., green) corresponding to the first value (e.g., reflecting a high confidence in the transcription of the misspelled word “soster”). In the embodiment illustrated, the first value of the first visual characteristic of the indication 836 is represented by the solid line of the indication.

In FIG. 8R, the second representation of the first handwritten input 844 is shown with portion 853 underlined with the indication 854 to indicate a misspelling in the word “sooster” (and portion 856 underlined with the indication 856 to indicate a misspelling in the word “reeting”). Unlike FIG. 8Q, the confidence level in the transcription of the portion 853 of the second representation of the first handwritten input having the typographical error (“sooster”) is low, as indicated by second confidence level 864 shown on confidence bar 862. For example, the second representation of the first handwritten input 844 has less fidelity to the first handwriting model, as shown by the difference in the visual appearance between the second representation of the first handwritten input 844 and representation of previous handwritten input 804 on which the first handwriting model is based (e.g., as explained in reference to FIGS. 8A-8G). In accordance with a determination that the respective confidence level is a second confidence level 866, different from the first confidence level, the electronic device 500 displays the indication 854 with a first visual characteristic (e.g., color) having a second value (e.g., red). Accordingly, here, the indication 854 (e.g., the line under the first “o” of “sooster”) has a color red showing that the electronic device 500 has a low confidence level in the transcription of the first handwritten input corresponding to the word “sooster.”

FIG. 9 is a flowchart illustrating a method for converting handwritten input into handwriting based on a model handwriting in accordance with some embodiments. The method 900 is optionally performed at an electronic device such as device 100, device 300, device 500, or device 580 as described above with reference to FIGS. 1A-1B, 2-3, 4A-4B, 5A-5C and 5I. Some operations in method 900 are, optionally combined and/or order of some operations is, optionally, changed.

As described below, the method 900 provides ways of facilitating converting handwritten input into handwriting based on a model handwriting. The method reduces the cognitive burden on a user when interacting with a user interface of the device of the disclosure, thereby creating a more efficient human-machine interface. For battery-operated electronic devices, increasing the efficiency of the user's interaction with the user interface conserves power and increases the time between battery charges.

In some embodiments, method 900 is performed at an electronic device (e.g., electronic device 500 in FIG. 8A) in communication with a touch-sensitive display generation component (e.g., touch screen 504). For example, a mobile device (e.g., a tablet, a smartphone, a media player, or a wearable device), a computer (e.g., a desktop computer, a laptop computer), or a wearable device (e.g., a watch, a head-mounted device), optionally in communication with one or more of a mouse (e.g., external), trackpad (optionally integrated or external), remote control device (e.g., external), another mobile device (e.g., separate from the electronic device), a handheld device (e.g., external), and/or a controller (e.g., external), or a set-top box in communication one or more input devices (e.g., a remote control). In some embodiments, the touch-sensitive display generation component is a display integrated with the electronic device (e.g., a touch-screen display), external display such as a monitor, television, or a hardware component (optionally integrated or external) for projecting a user interface or causing a user interface to be visible to one or more users. In some embodiments, the electronic device has one or more characteristics of the electronic devices of methods 700 and/or 1100. In some embodiments, the touch-sensitive display generation component has one or more characteristics of display generation components in methods 700 and/or 1100.

In some embodiments, while displaying, via the touch-sensitive display, a user interface (e.g., user interface 802), the electronic device receives (902a), via the touch-sensitive display, first handwritten input directed to the user interface, such the handwritten first input provided by stylus 806 in FIG. 8B. For example, the user interface corresponds to a text (e.g., handwritten text and/or font-based text) composition user interface associated with a note-taking application, a messaging application, a journaling or scheduling application, a text-editor application, and/or a text annotation application, an image management application, a digital content management application, a drawing application, a presentation application, or any other region that can accept handwritten input. In some embodiments, the user interface includes a handwriting entry region configured to receive handwritten input (e.g., provided directly into the user interface region (e.g., the touch sensitive surface includes the user interface) or populated into the user interface by the electronic device after receiving the handwritten input via a separate touch-sensitive surface such as a trackpad). In some embodiments, the handwriting entry region optionally accepts drawing and/or displays drawing input, or handwritten input as drawing input. In some embodiments, the user interface has one or more characteristics of the user interfaces in methods 700 and/or 1100. In some embodiments, the electronic device receives the first handwritten input via an external device/tool for providing handwritten input (e.g., a stylus) or via a finger of a hand of the user of the electronic device. In some embodiments, the handwritten input includes continuous and/or subsequent strokes and/or contacts (e.g., provided by the stylus or finger of the user) detected on the touch sensitive surface. In some embodiments, the first handwritten input has one or more characteristics of handwritten input in methods 700 and/or 1100.

In some embodiments, while (and/or in response to) receiving the first handwritten input, the electronic device displays (902b), via the touch-sensitive display generation component, a first representation of the first handwritten input in the user interface that has a first visual appearance, such as the first representation of handwritten input 808 in FIG. 8B. In some embodiments, as the electronic device receives the continuous and/or subsequent strokes and/or contacts provided by the stylus or finger of the user on the touch sensitive surface, the electronic device displays the first representation of the first handwritten input in the user interface in accordance with the first handwritten input. The first representation of the first handwritten input optionally includes handwritten characters, such as letters, words, numbers, special characters, and/or shapes that are recognized by the electronic device as handwritten input. In some embodiments, the first representation of handwritten input is displayed within the handwriting entry region discussed above. In some embodiments, the first representation of handwritten input is displayed within the user interface in a first number of lines of characters, such as 1, 2, 3, 4, 5, 8, 10, or 12 lines, and optionally corresponds to the number of lines in which the handwritten words, numbers, and/or special characters were written in the first handwritten input. In some embodiments, the sequence of characters corresponds to a paragraph displayed in a first number of lines of characters and/or a paragraph having a first width (e.g., the first number of lines of characters extends a first distance (e.g., horizontally) across the user interface), which optionally corresponds to a width of a bounding box containing/confining the lines of the sequence of characters. In some embodiments, the sequence of characters corresponds to a list (e.g., a bulleted list, a numbered list, or a lettered list) of words displayed in a first number of lines of words. In some embodiments, the first representation of handwritten input has a first visual appearance. In some embodiments, displaying the first representation of the first handwritten input has one or more characteristics of displaying a representation of handwritten input as discussed in methods 700 and/or 1100. The first visual appearance optionally corresponds to one or more characteristics of the user's handwriting (e.g., as detected via the first handwritten input). In some embodiments, the first visual appearance includes a size of the characters, a shape of the characters, an orientation of the characters, a spacing between the characters, a thickness of lines forming the characters, one or more stroke patterns used to form the characters of the handwritten input, and/or variations and/or patterns of any one of these characteristics included within the first representation of the first handwritten input. In some embodiments, the first representation of the first handwritten input represents the handwritten input as provided by the user. For example, the first representation of the first handwritten input corresponds to a raw or accurate representation of the user's contacts and motions/strokes in the text entry region of the user interface.

In some embodiments, while displaying the first representation of the first handwritten input in the user interface that has the first visual appearance, the electronic device detects (902c) that one or more criteria are satisfied, such as the criterion that is satisfied when the electronic device 500 detects a threshold number of words (e.g., 3 words) within the recognized words from the first handwritten input in FIG. 8B. In some embodiments, the one or more criteria include a criterion that is satisfied when, while detecting the first handwritten input, the electronic device detects an indication of a pause or an indication of an end of the first handwritten input. For example, the one or more criteria are satisfied in accordance with a determination that a pause is detected during and/or after detecting the first handwritten written input, wherein the pause exceeds a threshold duration such as 1, 2, 3, 4 or 5 seconds (e.g., a threshold amount of time has elapsed since detecting a cease in motion of the stylus or finger). In some embodiments, the one or more criteria include a criterion that is satisfied when, while detecting the first handwritten input, the electronic device detects stylus lift off or a finger lift off (e.g., such that the stylus or finger is no longer contacting the touch-sensitive display generation component). In some embodiments, the one or more criteria include a criterion that is satisfied when, while detecting the first handwritten input, the electronic device detects a threshold number of characters, such as 1, 2, 5, 15, 15 or 20 characters, within the recognized characters from the first handwritten input discussed above. In some embodiments, the one or more criteria include a criterion that is satisfied when, while detecting the first handwritten input, the electronic device detects a threshold number of words, such as 1, 2, 3, or 5 words, within the recognized words from the first handwritten input discussed above. In some embodiments, the one or more criteria include a criterion that is satisfied when, while detecting the first handwritten input, the electronic device detects a specific character (e.g., a predefined character) within the recognized characters from the first handwritten input, such as a punctuation mark (e.g., a comma, a colon, a semi-colon, a period, an exclamation mark, a question mark, and/or other punctuation marks).

In some embodiments, in response to detecting that the one or more criteria are satisfied (902d), in accordance with a determination that a handwriting model at the electronic device is a first handwriting model, the electronic device ceases (902e) display of the first representation of the first handwritten input, such as in FIG. 8C where the electronic device 500 ceases display of the first representation of the first handwritten input 808. In some embodiments, the electronic device stores a first handwriting model. The handwriting model optionally comprises a set of characteristics that define particular style of handwriting. In some embodiments, the handwriting model is generated based on one or more previously detected handwritten inputs (e.g., handwritten inputs detected prior to the first handwritten input discussed above). In some embodiments, the handwriting model is generated based on a representation of a previous handwritten input currently displayed on the user interface (e.g., a representation of handwritten input displayed in the user interface prior to displaying the first representation of the first handwritten input discussed above). In some embodiments, the one or more previous handwriting inputs are generated from the previous handwritten input of a user of the electronic device, such that the handwriting model corresponds to the handwriting of the user discussed above. In some embodiments, the handwriting model is not generated based on a handwritten input by a user, but instead, is optionally a predetermined handwriting model stored by the electronic device. In some embodiments, the predetermined handwriting model is generated from a plurality of handwriting samples (e.g., such as provided by training datasets). In some embodiments, the handwriting model does not correspond to a font or font-based text and/or is not generated from font-based text. In some embodiments, the handwriting model defines (e.g., determines) a visual appearance of a representation of the handwriting model. Accordingly, in some embodiments, the visual appearance optionally corresponds to one or more characteristics of the representation of the handwriting model. For example, the visual appearance includes a size of the characters, a shape of the characters, an orientation of the characters, a spacing between the characters, a thickness of lines forming the characters, one or more stroke patterns used to form the characters of a handwritten input corresponding to the handwriting model, and variations or patterns of any one of these characteristics within a representation of the handwriting model. If the handwriting model was generated based on the handwriting of a respective user, the handwriting model shares one or more of the above-described characteristics with the handwriting of the respective user. In some embodiments, a handwriting model at the electronic device optionally changes or is different or is refined or is regenerated based on another (and/or subsequent) handwritten input. For example, one or more characteristics of a visual appearance of a representation of a handwriting model generated based on the handwriting of a respective user optionally changes if the handwriting model is refined or changed or regenerated based on the handwritten input of another user. For example, the electronic device removes the first representation of the first handwritten input from the text entry region and replaces display of the first representation with a blank space at the location in the handwriting region of the user interface where the first representation of the first handwritten input was displayed.

In some embodiments, the electronic device displays (e.g., using an AI process or a generative AI process), in the user interface, a second representation of the first handwritten input that has a second visual appearance (e.g., automatically-generated text content and or generative text content), different from the first visual appearance, wherein the second visual appearance of the second representation of the first handwritten input is in accordance with the first handwriting model, such as the second representation of the first handwritten input 818 in FIG. 8D. For example, the electronic device displays the second representation of the first handwritten input in the location of the first representation of the first handwritten input (e.g., in the location of the blank space discussed above), such that the second representation of the first handwritten input has replaced the first representation of the first handwritten input in the user interface. Accordingly, the same sequence of characters previously displayed and removed by the electronic device is optionally displayed again but according to the first handwriting model. As such, the second visual appearance of the second representation (e.g., defined according to the first handwriting model) of the first handwritten input optionally differs from the first visual representation (e.g., the user's raw handwritten input) with regard to one or more of the characteristics of the first representation, but optionally not with regard to the content or substance of the first representation of the first handwritten input (e.g., not with regard to the characters, words, phrases, sentences, and/or the sequence of the above in the handwritten input). For example, one or more of a size of the characters, a shape of the characters, an orientation of the characters, a spacing between the characters, a thickness of lines forming the characters, one or more stroke patterns used to form the characters, and/or variations or patterns of any one of these characteristics of the second visual appearance differs from the first visual appearance as defined by the first handwriting model.

In some embodiments, in accordance with a determination that the handwriting model at the electronic device is a second handwriting model, different from the first handwriting model, the electronic device ceases (902f) display of the first representation of the first handwritten input, such as in FIG. 8C, where the electronic device 500 ceases display of the first representation of the first handwritten input 808. As previously described, the electronic device optionally stores a plurality of handwriting models optionally generated from handwritten input from one or more users. Optionally or alternatively, a handwriting model is not generated based on a user's input. Handwriting models differ from each other based on one or more characteristics of the respective visual appearances of their respective representations. Characteristics that differ between respective visual appearances of respective representations of handwriting models include for example, one or more of a size of characters, a shape of characters, an orientation of characters, a spacing between characters, a thickness of lines forming characters, one or more stroke patterns used to form characters, and variations or patterns of any one of these characteristics. As previously described, the electronic device optionally removes the first representation of the first handwritten input from the text entry region and instead displays a blank space at the location in the handwriting region of the user interface where the first representation of the first handwritten input was displayed.

In some embodiments, the electronic device displays (e.g., using an AI process or a generative AI process), in the user interface, a third representation of the first handwritten input that has a third visual appearance (e.g., automatically-generated text content and or generative text content), different from the first visual appearance and the second visual appearance, wherein the third visual appearance of the third representation of the first handwritten input is in accordance with the second handwriting model, such as in FIG. 8D, as if the representation of the first handwritten input 818 were the third representation of the first handwritten input (e.g., and not the first handwriting model). The electronic device optionally thus displays the user's handwritten input in a second handwriting different from the first. For example, as described with reference to the second representation of the first handwritten input, the electronic device displays the third representation of the first handwritten input (e.g., according to the second handwriting model) in the location of the first representation of the first handwritten input (e.g., the user's raw handwritten input) in the user interface, such that the third representation of the first handwritten input has replaced the first representation of the first handwritten input. Accordingly, the same sequence of characters previously displayed and erased by the electronic device is displayed again but according to the second handwriting model. As such, the third visual appearance of the third representation (e.g., defined according to the second handwriting model) of the first handwritten input optionally differs from the first visual representation (e.g., the user's raw handwritten input) with regard to one or more of the characteristics of the first representation. For example, one or more of a size of the characters, a shape of the characters, an orientation of the characters, a spacing between the characters, a thickness of lines forming the characters, one or more stroke patterns used to form the characters, and/or variations or patterns of any one of these characteristics of the third visual appearance differs from the first visual appearance (e.g., and the second visual appearance) as defined by the second handwriting model. Updating the display of a representation of a handwritten input to a handwriting model helps reduce or minimize the need to rewrite handwritten input for increased legibility, which improves user-device interaction for both the user who provided the input (e.g., less rewrites for legibility) and by other users unfamiliar with the user's handwriting (e.g., easier as difficult handwriting are optionally converted to more legible handwritings based on handwriting models), and thus decreases the duration of interaction with the device for writing or reading handwritten text, which reduces power usage and improves battery life.

In some embodiments, the first representation of the first handwritten input, the second representation of the first handwritten input, and the third representation of the first handwritten input include one or more characters having one or more characteristics, including, while displaying the first representation of the first handwritten input in the user interface that has the first visual appearance, the one or more characteristics have one or more first values; while displaying the second representation of the first handwritten input that has the second visual appearance, the one or more characteristics have one or more second values corresponding to the first handwriting model, different from the one or more first values; and while displaying the third representation of the first handwritten input that has the third visual appearance, the one or more characteristics have one or more third values corresponding to the second handwriting model, different from the one or more first values and the one or more second values, such as the first representation of handwritten input 808 in FIG. 8B and the second representation of handwritten input 818 in FIG. 8D. In some embodiments, the one or more characteristics include a size of the one or more characters of the first representation of the first handwritten input, the second representation of the first handwritten input, and the third representation of the first handwritten input, a shape of the one or more characters, an orientation of the one or more characters, a spacing between the one or more characters, a thickness of lines forming the one or more characters, and/or one or more stroke patterns forming the one or more characters. As an illustrative example, a shape of a character of the first representation of the first handwritten input optionally has a first value corresponding to a roundness or degree of roundness of the character as detected by the electronic device from the first handwritten input. In this case, a second value for the shape of the character corresponding to the first handwriting model, different from the first, and corresponding to the roundness of the second representation of the first handwritten input optionally reflects a different degree of roundness for this character as represented based on the first handwriting model. Similarly, a third value corresponding to the second handwriting model and different from the first and the second, reflects another degree of roundness different from the roundness of the character in the first and second representations of handwritten input. As another illustrative example, an orientation (e.g., a slant) of a character of the first representation of the first handwritten input optionally has a first value corresponding to degree and/or direction of slant of the character as detected by the electronic device from the first handwritten input. In this case, a second value for the orientation of the character corresponding to the first handwriting model, different from the first, and corresponding to the slant of the second representation of the first handwritten input optionally reflects a different degree and/or direction of slant for this character as represented based on the first handwriting model. Similarly, a third value corresponding to the second handwriting model and different from the first and the second, reflects another degree and/or direction of slant different from the degree and/or direction of slant of the character in the first and second representations of handwritten input. Defining the one or more characteristics and their corresponding values for representations of handwritten input enables the electronic to display a respective representation of handwritten input (e.g., as based on a handwriting model) with a consistent visual appearance or consistent handwriting, which helps reduce or minimize the need to rewrite handwritten input for increased legibility, which improves user-device interaction for both the user who provided the input (e.g., less rewrites for legibility) and by other users unfamiliar with the user's handwriting (e.g., easier as difficult handwriting are optionally converted to more legible handwritings based on handwriting models), and thus decreases the duration of interaction with the device for writing or reading handwritten text, which reduces power usage and improves battery life.

In some embodiments, the handwriting model is based on a stored representation of a handwritten input directed to the user interface received prior to receiving the first handwritten input (e.g., in a current session of handwriting input to the user interface), such as the representation of previous handwritten input 804 in FIG. 8D. In some embodiments, the handwriting model is generated based on one or more previously detected handwritten inputs (e.g., handwritten inputs detected prior to the first handwritten input discussed above). For example, the handwriting model is optionally generated based on one or more paragraphs of handwritten text that the user has written on the user interface before the first representation of handwritten input. The electronic device optionally stores the one or more paragraphs in this example and generates the handwriting model based on the stored one or more paragraphs of handwritten text. It is noted that the one or more paragraphs are illustrative, and that the handwriting model is optionally based on a stored representation of handwritten input having any size or length (e.g., a sentence, a paragraph, multiple paragraphs, etc.) that was provided by the user. In some embodiments, the handwriting model is optionally generated based on a representation of a previous handwritten input currently displayed on the user interface (e.g., a representation of handwritten input displayed in the user interface prior to displaying the first representation of the first handwritten input discussed above). In some embodiments, the previous handwritten input was directed to the current instance of the user interface (e.g., the previous handwritten input was detected during the current writing session on the user interface). For example, in the scenario described above, the one or more paragraphs of handwritten text (e.g., the representation of previous handwritten input) are optionally currently displayed, and further are optionally stored by the electronic device to generate the handwriting model that is optionally applied to convert the user's handwritten input into a representation consistent with the model. In some embodiments, a visual appearance of the representation of the previous handwritten input (e.g., currently displayed) is optionally in accordance with a respective handwriting model (e.g., the first handwriting model and/or the second handwriting model, etc.). In some embodiments, the one or more previous handwriting inputs are optionally generated from the previous handwritten input of a user of the electronic device, such that the handwriting model corresponds to the handwriting of the user discussed above. Basing the handwriting model on a stored representation of a handwritten input received prior to the first handwritten input helps ensure fidelity of the handwriting model to the user's handwriting, which helps reduce or minimize the need to rewrite handwritten input for increased legibility, which improves user-device interaction for both the user who provided the input (e.g., less rewrites for legibility) and by other users unfamiliar with the user's handwriting (e.g., easier as difficult handwriting are optionally converted to more legible handwritings based on handwriting models), and thus decreases the duration of interaction with the device for writing or reading handwritten text, which reduces power usage and improves battery life.

In some embodiments, the handwriting model is based on a stored representation of a handwritten input directed to a previous instance of the display of the user interface (e.g., prior to the current instance of the display of the user interface), such as if the representation of previous handwriting 804 in FIG. 8D were directed to a previous instance of the display of the user interface 802. As previously described, the user interface is optionally associated with an application (e.g., any application that optionally includes a text entry region such as a note-taking application, a text editor application, etc.). In some embodiments, the previous instance of the display of the user interface was optionally generated when the application associated with the user interface was last opened. For example, when the application was last opened and the user interface displayed, the electronic device optionally received handwritten input from the user, displayed a representation of the handwritten input, and stored the representation of the handwritten input to generate and/or help generate the handwriting model. The application was subsequently closed (e.g., in response to detecting user input), and later opened and the electronic device optionally displayed the current instance of the user interface during which the first handwritten input was received. For example, if the application associated with the user interface is a note-taking application, the handwriting model is optionally based on handwritten input provided by the user in the note-taking application during a previous time the user opened the application. In some embodiments, the previous instance of the display of the user interface was optionally generated during the current instance of the application associated with the user interface (e.g., the instance during which the electronic device received the first handwritten input). For example, the application optionally enables the user to open and close the user interface (e.g., including the text entry region) without closing the application. In the example of the note-taking application, the electric device optionally receives handwritten input directed to a user interface corresponding to a document or note that can be closed or opened while the application remains open. The handwriting model is optionally based on handwritten input represented on a previous instance of the display of the user interface (e.g., on writing of a previous note or document that is now closed while the application remains open). In some embodiments, the previous instance of the display of the user interface is the instance immediately before the current instance of the display of the user interface. In some embodiment, there are one or more intervening instances of the display of the user interface between the previous instance and the current instance. In some embodiments, the handwriting model is based on multiple stored representations of handwritten input directed to multiple previous instances of the display of the user interface. In some embodiments, the previous handwriting input upon which the handwriting model is based is optionally collected from both previous handwritten input (e.g., handwriting input directed to a previous instance of the display of the user interface as described above) and current handwriting input (e.g., the first handwritten input). For example, if the user had a previous handwriting session during a previous instance of the user interface and/or the application, subsequently closed the user interface (e.g., along with the application or while the application remains open) and later reopened the user interface, thus initiating the current instance of the display of the user interface, and provided the first handwritten input directed to the user interface, the handwriting model is optionally based on both the previous handwriting session (e.g., a representation of handwritten input received during the previous session) and the first representation of handwritten input (e.g., the current handwriting session). In some embodiments, a slider displayed on the user interface optionally determines a weight of previous handwritten input (e.g., handwritten input directed to a previous instance of the display of the user interface) and current handwritten input (e.g., the first handwritten input) in generating the handwritten model. A position of a button on the slider optionally corresponds to a ratio of a previous handwriting input to current handwritten input for generating the handwriting model, and the user is able to set the ratio by actuating the slider (e.g., the electronic device receives via the touch-sensitive display generation component an input directed to the slider). For example, as the button is moved toward one end of the slider (e.g., the left end of a horizontal slider), the weight of the previous handwriting input for generating the handwriting model is optionally increased and the weight of the current handwritten input is optionally decreased, and as the button is moved toward the other end of the slider, the weight of the previous handwriting input for generating the handwriting model is optionally decreased and the weight of the current handwritten input is optionally increased. Basing the handwriting model a stored representation of a handwritten input directed to a previous instance of the display of the user interface helps ensure fidelity of the handwriting model to the user's handwriting by enabling more opportunity for collecting handwriting samples for the handwriting model, which helps reduce or minimize the need to rewrite handwritten input for increased legibility, which improves user-device interaction for both the user who provided the input (e.g., less rewrites for legibility) and by other users unfamiliar with the user's handwriting (e.g., easier as difficult handwriting are optionally converted to more legible handwritings based on handwriting models), and thus decreases the duration of interaction with the device for writing or reading handwritten text, which reduces power usage and improves battery life.

In some embodiments, receiving the first handwritten input includes detecting contact of an object (e.g., an input device, a finger, or other input device) on the touch-sensitive display generation component with a respective speed, and in accordance with a determination that the respective speed is a first speed, such as the first speed 822 in FIG. 8E, the second representation of the first handwritten input has a first fidelity (e.g., match) to the first handwriting model, such as the second representation of first handwritten input 826 in FIG. 8G having a first fidelity 824, and in accordance with a determination that the speed is a second speed, such as the second speed 812 in FIG. 8B, different from the first speed, the second representation of the first handwritten input has a second fidelity (e.g., match), different from the first fidelity, to the first handwriting model, such as the second representation of the first handwritten input 818 in FIG. 8D having a second fidelity 814, different from the first fidelity 824. In some embodiments, the respective speed at which contact of the input device is detected includes the speed of movement of the input device forming/providing the first handwritten input on a surface of the touch-sensitive display generation component. The fidelity of the converted handwriting (e.g., the second representation of the first handwritten input) to the handwriting model optionally varies with the respective speed of the handwritten input. Accordingly, in some embodiments, when the respective speed is a first speed, the first representation of the first handwritten input has a first fidelity to the handwriting model, e.g., the first visual appearance of the first representation of the first handwritten input optionally shares one or more characteristics of a visual appearance defined by (e.g., and corresponding to) the first handwriting model for the first representation thereof. The first fidelity is optionally a measure of how many of the one or more characteristics are shared between the first visual appearance and the visual appearance defined by the first handwriting model (e.g., how many of a size of the characters, a shape of the characters, an orientation of the characters, a spacing between the characters, a thickness of lines forming the characters, one or more stroke patterns used to form the characters, and/or variations or patterns of any one of these characteristics), as well as for each of the one or more characteristics, how close the corresponding values are between the first visual appearance and the visual appearance defined by the first handwriting model (e.g., a degree to which each of the one or more characteristics of the first visual appearance matches a corresponding characteristic of the visual appearance defined by the first handwriting model). When the respective speed is a second speed, the second representation optionally has a second fidelity, e.g., the one or more characteristics shared between the first visual appearance and the visual appearance defined by the first handwriting model optionally differ from those of the first fidelity. For example, a greater number, a smaller number, or different ones, of the one or more characteristics corresponding to the first fidelity correspond to the second fidelity, and/or for each of the one or more characteristics, a first value corresponding to the first fidelity optionally differs from a second value corresponding to the second fidelity. Accordingly, in some embodiments, the converted handwriting based on the handwriting model optionally has a greater fidelity to or less fidelity to (e.g., is more or less faithful to or more or less resembles) the handwriting model depending on the speed of the user's handwriting. Varying the fidelity of displayed handwriting to handwriting model based on a speed of the handwritten input enables the user to dictate the fidelity of the handwriting input to the handwriting model without having to provide an input separate from the handwriting input (e.g., a setting), which facilitates the use of the electronic device, simplifies the interaction between the user and the electronic device, enhances the operability of the electronic device and makes the user-device interface more efficient, which additionally reduces power usage and improves battery life of the electronic device by enabling the user to use the electronic device more quickly and efficiency.

In some embodiments, the second speed is greater than the first speed and the second fidelity is greater than the first fidelity, such as if speed 812 in 8D represented the second speed and speed 822 in FIG. 8E represented the first speed, and fidelity 814 in 8D represented the second fidelity and fidelity 824 in 8G represented the first fidelity. The second speed or greater speed optionally causes the electronic device to display the second representation of the first handwritten input having a greater fidelity to a visual appearance defined by the handwriting model than the first speed. Accordingly, the faster the user writes on the user interface (e.g., the greater the speed of movement of the input device forming/providing the first handwritten input on a surface of the touch-sensitive display generation component), the more faithful the displayed converted handwriting appears to the handwriting model (e.g., a visual appearance defined by the handwriting model), in some embodiments. As a result, when the respective speed is the second (faster) speed, a greater number of the one or more characteristics is optionally shared between the first visual appearance and the visual appearance defined by the first handwriting model than when the respective speed is the first speed, and/or for the one or more characteristics shared, the corresponding values are closer between the first visual appearance and the visual appearance defined by the first handwriting model (e.g., a degree to which each of the one or more characteristics of the first visual appearance matches a corresponding characteristic of the visual appearance defined by the first handwriting model) than when the speed respective speed is the first speed. Optionally or alternatively, the second speed or greater speed optionally causes the electronic device to display the second representation of the first handwritten input having a less fidelity to first visual appearance of the first representation of the first handwritten input than the first speed. Accordingly, the faster the user writes on the user interface, the less faithful the displayed converted handwriting appears to the first representation of the first handwritten input (e.g., the first visual appearance of the raw handwritten input), in some embodiments. Optionally or alternatively, in some embodiments, when the second representation of the first handwritten input has less fidelity to the handwritten model, the second representation of the first handwritten input has more fidelity to the first representation of the first handwritten input, and when the second representation of the first handwritten input has more fidelity to the handwritten model, the second representation of the first handwritten input has less fidelity to the first representation of the first handwritten input. In some embodiments, when the respective speed detected for the first handwritten input is below a threshold speed, the electronic device optionally displays the second representation of the first handwritten input having no fidelity to the handwriting model (e.g., the second representation of the first handwritten input is the same as the first representation of the first handwritten input). In such a case (e.g., when the respective speed is below the threshold), in some embodiments, the electronic device forgoes displaying the second representation of handwritten input. Accordingly, when the user writes very slowly, the user's handwriting is not converted according to the handwriting model, in some embodiments. Increasing the fidelity of displayed handwriting to handwriting model with the speed of the handwritten input enables the user to dictate the fidelity of the handwriting input to the handwriting model without having to provide an input separate from the handwriting input (e.g., a setting), which facilitates the use of the electronic device, simplifies the interaction between the user and the electronic device, enhances the operability of the electronic device and makes the user-device interface more efficient, which additionally reduces power usage and improves battery life of the electronic device by enabling the user to use the electronic device more quickly and efficiency.

In some embodiments, the first handwritten input is directed to a location of the user interface that is a respective distance from a respective representation of respective handwritten input, different from the first representation of the first handwritten input, displayed on the user interface, in accordance with a determination that the respective distance is a first distance, the second representation of the first handwritten input has a first fidelity to the first handwriting model, such as the second representation of the first handwritten input 818 in FIG. 8D, and in accordance with a determination that the respective distance is a second distance, different from the first distance, the second representation of the first handwritten input has a second fidelity, different from the first fidelity, to the first handwriting model, such as the second representation of the first handwritten input 830 in FIG. 8I. In some embodiments, the respective distance is a distance from the last representation of handwritten input in response of handwritten input before display of the first representation of handwritten input. In some embodiments, the respective distance is optionally the shortest distance between the location on the user interface to which the first representation of handwritten input is directed and the previous representation of handwritten input. As previously described, the first fidelity is optionally a measure of how many of the one or more characteristics are shared between the first visual appearance and a visual appearance defined by the first handwriting model (e.g., how many of a size of the characters, a shape of the characters, an orientation of the characters, a spacing between the characters, a thickness of lines forming the characters, one or more stroke patterns used to form the characters, and variations or patterns of any one of these characteristics), as well as for each of the one or more characteristics, how close the corresponding values are between the first visual appearance and the visual appearance defined by the first handwriting model (e.g., a degree to which each of the one or more characteristics of the first visual appearance matches a corresponding characteristic of the visual appearance defined by the first handwriting model). When the respective distance is a second distance, the second representation optionally has a second fidelity, e.g., the one or more characteristics shared between the first visual appearance and the visual appearance defined by the first handwriting model optionally differ from those of the first fidelity. For example, a greater number, a smaller number, or different ones, of the one or more characteristics corresponding to the first fidelity correspond to the second fidelity, and/or for each of the one or more characteristics, a first value corresponding to the first fidelity optionally differs from a second value corresponding to the second fidelity. Accordingly, in some embodiments, the converted handwriting based on the handwriting model optionally has a greater fidelity to or less fidelity to (e.g., is more or less faithful to or more or less resembles) the handwriting model depending on how far from the previous handwriting the first handwritten input is located on the user interface. For example, if the previous handwriting is located near the top of the text entry region, and the first representation of the first handwritten input is directed to the middle of the text entry region, the second representation of the first handwritten input has a first fidelity to the handwriting model. If the first representation of the first handwritten input is directed to the bottom of the text entry region, which is further away (e.g., at a greater distance) from the previous representation of the handwriting input than the middle of the text entry region, the second representation of the first handwritten input has a second fidelity to the handwriting model, which is less than the first fidelity associated with the handwritten input directed to the middle of the text entry region. Optionally or alternatively, in some embodiments, when the second representation of the first handwritten input has less fidelity to the handwritten model, the second representation of the first handwritten input has more fidelity to the first representation of the first handwritten input, and when the second representation of the first handwritten input has more fidelity to the handwritten model, the second representation of the first handwritten input has less fidelity to the first representation of the first handwritten input. Varying the fidelity of displayed handwriting to handwriting model based on a distance of the handwritten input from previous handwritten input on the same user interface enables the electronic device to further characterize by visual appearance representations of handwritten input located apart on the interface, which provides an additional visual cue beyond distance between representations, which facilitates the use of the electronic device, simplifies the interaction between the user and the electronic device, enhances the operability of the electronic device and makes the user-device interface more efficient, which additionally reduces power usage and improves battery life of the electronic device by enabling the user to use the electronic device more quickly and efficiency.

In some embodiments, in accordance with the determination that the handwriting model at the electronic device is the first handwriting model, ceasing display of the first representation of the first handwritten input and displaying, in the user interface, the second representation of the first handwritten input includes displaying an animation of the first representation of the first handwriting input morphing into the second representation of the first handwritten input, such as if the first representation of the first handwritten input 830 in FIG. 8F were an animation. In some embodiments, the animation includes a fade effect. For example, the animation optionally includes the first representation of the of the first handwritten input fading out and the second representation of the first handwritten input fading in. In some embodiments, the second representation of the first handwritten input optionally begins fading in before the first representation of the first handwritten input has completely faded out. In some embodiments, the animation includes a gaussian blur effect. For example, the animation optionally includes the first representation of the of the first handwritten input blurring out and the second representation of the first handwritten input blurring in. In some embodiments, the second representation of the first handwritten input optionally begins blurring in before the first representation of the first handwritten input has completely blurred out. In some embodiments, the animation mimics wet ink drying. For example, the first visual appearance of the first representation of handwritten input corresponds to the appearance of wet ink, and second visual appearance of the second representation of handwritten input corresponds to the appearance of dry ink, and the animation morphs the representations between the first visual appearance and the second visual appearance. In some embodiments, the animation includes an alpha threshold effect. In some embodiments, displaying an animation of the first representation of the first handwriting input morphing into the second representation of the first handwritten input includes displaying the first representation of the first handwriting input and the second representation of the first handwritten input concurrently during a phase of the animation. In some embodiments, in accordance with the determination that the handwriting model at the electronic device is the second handwriting model, ceasing display of the first representation of the first handwritten input and displaying, in the user interface, the third representation of the first handwritten input includes displaying an animation of the first representation of the first handwritten input morphing into the third representation of the first handwritten input. In some embodiments, displaying an animation of the first representation of the first handwriting input morphing into the third representation of the first handwritten input includes displaying the first representation of the first handwriting input and the third representation of the first handwritten input concurrently during a phase of the animation. In some embodiments, the animation has one or more characteristics of the animation discussed above. Morphing the first representation of the first handwriting into the second representation of the first handwriting allows the electronic device to provide the user with a visual cue of how long since the handwritten input has been received and how long the handwritten input has been processed, which facilitates the use of the electronic device, simplifies the interaction between the user and the electronic device, enhances the operability of the electronic device and makes the user-device interface more efficient, which additionally reduces power usage and improves battery life of the electronic device by enabling the user to use the electronic device more quickly and efficiency.

In some embodiments, the user interface includes a selectable option for enabling or disabling representations of the first handwritten input other than the first representation of the first handwritten input, and the one or more criteria include a criterion that is satisfied when the selectable option is selected, such as if in FIG. 8B, where the electronic device 500 displays the first representation of the first handwritten input 808 on the user interface 802, the selectable option were enabled. Accordingly, in some embodiments, when the selectable option is set to enable representations of the first handwritten input other than the first representation of the first handwritten input, the electronic device optionally converts the first representation of handwritten input into the second representation or the third representation of handwritten input provided that the one or more criteria are satisfied, as previously described. When the selection option is set to disable the representations of the first handwritten input other than the first representation of the first handwritten input, the electronic device optionally does not convert the first representation of handwritten input into the second or third representations in response to receiving the input and the first representation of handwritten input remains as displayed even after the one more criteria are satisfied. In some embodiments, the selectable option for enabling or disabling representations of the first handwritten input other than the first representation of the first handwritten input is optionally displayed as a button, a toggle, a menu option, or any other interface element that is able to receive a selection input. Providing the user with the ability to enable or disable the conversion of handwritten input based on a handwriting model allows the electronic device to provide the user with the choice to forgo any additional processing involved in converting the handwritten input at the electronic device, which facilitates the use of the electronic device, simplifies the interaction between the user and the electronic device, enhances the operability of the electronic device and makes the user-device interface more efficient, which additionally reduces power usage and improves battery life of the electronic device by enabling the user to use the electronic device more quickly and efficiency.

In some embodiments, the first representation of the first handwritten input includes a plurality of words; and in accordance with the determination that the handwriting model at the electronic device is the first handwriting model, a first spacing between adjacent words of the plurality of words corresponds to (e.g., is the same as) a second spacing between corresponding adjacent words of the second representation of the first handwritten input, such as in FIGS. 8B and 8D, a first spacing between adjacent words of the first representation of the first handwritten input 808 in FIG. 8B corresponds to a second spacing between adjacent words of the second representation of handwritten words 818 in FIG. 8D. In some embodiments, the first spacing optionally refers to any blank space between two adjacent sequences of characters of the first representation of the first handwritten input that the electronic device recognizes as words. The electronic device optionally preserves the spacing between the two words when user's handwritten input is converted to a handwriting consistent with the model handwriting. Accordingly, the blank space between two words adjacent words of the first representation of the first handwritten input optionally has the same size (e.g., as measured in a distance on the user interface (e.g., millimeters, inches, pixels)) as the blank space between the same two words in the second representation of the first handwritten input. For example, if the first spacing between two words of the first representation of the first handwritten input is 0.5 inches wide, the second spacing between the corresponding words of the second representation of the first handwritten input is optionally 0.5 inches wide. In some embodiments, in accordance with a determination that a spacing between two adjacent words of the first representation of the first handwritten input is a first spacing, a corresponding spacing between corresponding adjacent words of the second representation of the first handwritten input is (e.g., matches and/or is equal to) the first spacing, and in accordance with a determination that the spacing between two adjacent words of the first representation of the first handwritten input is a second spacing, different from the first spacing, the corresponding spacing between corresponding adjacent words of the second representation of the first handwritten input is (e.g., matches and/or is equal to) the second spacing. In some embodiments, in accordance with the determination that the handwriting model at the electronic device is the second handwriting model, the first spacing between adjacent words of the plurality of words corresponds to a third spacing between corresponding adjacent words of the third representation of the first handwritten input. Maintaining a spacing between adjacent words of the handwritten input and corresponding adjacent words of the converted handwriting based on the handwriting model allows the electronic device to facilitate legibility of the converted handwriting for the user, which facilitates the use of the electronic device, simplifies the interaction between the user and the electronic device, enhances the operability of the electronic device and makes the user-device interface more efficient, which additionally reduces power usage and improves battery life of the electronic device by enabling the user to use the electronic device more quickly and efficiency.

In some embodiments, the first representation of the first handwritten input is displayed in a first number of lines, and in accordance with the determination that the handwriting model at the electronic device is the first handwriting model, a number of lines of the second representation of the first handwritten input is equal to the first number of lines of the first representation of the first handwritten input, such as in FIGS. 8B and 8D, where a number of lines of the second representation of the first handwritten input 818 is equal to the first number of lines of the first representation of the first handwritten input 808. As previously described, in some embodiments, the first representation of handwritten input is optionally displayed within the user interface in a first number of lines of characters, such as 1, 2, 3, 4, 5, 8, 10, or 12 lines, and optionally corresponds to the number of lines in which the handwritten words, numbers, and/or special characters were written in the first handwritten input. A number of lines of the second representation of the first handwritten input is optionally equal to the number of lines of the first representation of the first handwritten input. For example, if the user wrote three lines of text (e.g., the electronic device received the first handwritten input and displayed the first representation of the first handwritten input as having three lines), the converted handwriting (e.g., the second representation of handwritten input) also has three lines. In some embodiments, a sequence of characters, words, and/or spacing between characters and/words of each line of the first representation of the first handwritten input optionally corresponds to a sequence of characters, words, and/or spacing between characters and/words of the corresponding line of the second representation of the first handwritten input. In some embodiments, in accordance with a determination that a number of lines of the first representation of the first handwritten input is a first number of lines, a corresponding number of lines of the second representation of the first handwritten input is (e.g., matches and/or is equal to) the first number of lines and, in accordance with a determination that the number of lines of the first representation of the first handwritten input is a second number of lines, different from the first number of lines, the corresponding number of lines of the second representation of the first handwritten input is (e.g., matches and/or is equal to) the second number of lines. In some embodiments, in accordance with the determination that the handwriting model at the electronic device is the second handwriting model, a number of liens of the third representation of the first handwritten input is equal to the first number of lines of the first representation of the first handwritten input. Maintaining a number of lines between the handwritten input and the converted handwriting allows the electronic device to facilitate legibility of the converted handwriting for the user, which facilitates the use of the electronic device, simplifies the interaction between the user and the electronic device, enhances the operability of the electronic device and makes the user-device interface more efficient, which additionally reduces power usage and improves battery life of the electronic device by enabling the user to use the electronic device more quickly and efficiency.

In some embodiments, the first representation of the first handwritten input includes a first word and a second word having a first spatial arrangement (e.g., relative position and/or orientation) in the user interface, and in accordance with the determination that the handwriting model at the electronic device is the first handwriting model, the first word and the second word of the second representation of the first handwritten input have a second spatial arrangement corresponding to (e.g., the same as) the first spatial arrangement in the user interface, such as the first representation of the first handwritten 828 in FIG. 8H and the second representation of the first handwritten 830 in FIG. 8I. In some embodiments, the spatial arrangement is optionally a combination of a direction and a distance of the second word from the first word. For example, the second word is optionally located at a first distance (e.g., in millimeters, inches, pixels, etc.) from a location of the first word and a first angle (e.g., in degrees) from vertical at the location of the first word in the first representation of the first handwritten input. The combination of the first distance and the first angle optionally constitutes the first spatial arrangement, in some embodiments. Accordingly, the second representation of the first handwritten optionally mirrors the first spatial arrangement, such that in the second spatial arrangement, the second word of the second representation of the first handwritten input is optionally located at the first distance (e.g., in millimeters, inches, pixels, etc.) from the location of the first word of the second representation of the first handwritten input, and a first angle (e.g., in degrees) from vertical at the location of the first word in the second representation of the first handwritten input. Accordingly, the relative positions of words within the first representation of the first handwritten input are preserved in the second representation of the first handwritten input. In some embodiments, in accordance with a determination that a spatial arrangement of the first representation of the first handwritten input is a first spatial arrangement, a corresponding spatial arrangement of the second representation of the first handwritten input is (e.g., matches and/or is equal to) the first spatial arrangement and, in accordance with a determination that the spatial arrangement of the first representation of the first handwritten input is a second spatial arrangement, different from the first spatial arrangement, the corresponding spatial arrangement of the second representation of the first handwritten input is (e.g., matches and/or is equal to) the second spatial arrangement. In some embodiments, in accordance with the determination that the handwriting model at the electronic device is the second handwriting model, the first word and the second word of the third representation of the first handwritten input have a third spatial arrangement corresponding to the first spatial arrangement in the user interface. Maintaining a spatial arrangement between words of the handwritten input and corresponding words of the converted handwriting based on a handwriting model allows the electronic device to facilitate legibility of the converted handwriting for the user, which facilitates the use of the electronic device, simplifies the interaction between the user and the electronic device, enhances the operability of the electronic device and makes the user-device interface more efficient, which additionally reduces power usage and improves battery life of the electronic device by enabling the user to use the electronic device more quickly and efficiency.

In some embodiments, the first representation of the first handwritten input has a first orientation relative to an axis of the user interface, and (at least a corresponding portion of) the second representation of the first handwritten input has a second orientation (optionally different from the first orientation) that is aligned with the axis of the user interface, such as the first representation of the first handwritten input 828 in FIG. 8H and the second representation of the first handwritten input 830 in FIG. 8I. In some embodiments, the third representation of the first handwritten input has a third orientation (optionally different from the first orientation and the second orientation) that is aligned with the axis of the user interface. In some embodiments, the axis is a horizontal axis of the user interface. In some embodiments, the first orientation is an orientation of a character and/or a word and/or a line and/or a portion of a line of the first representation of the first handwritten input. For example, the first representation of the first handwritten input is optionally tilted relative to a horizontal axis of the user interface by a first angle (e.g., because the user wrote at an angle corresponding to the tilt). For example, the user wrote a word and/or a line (e.g., of characters and/or words) and/or a portion of a line at an angle of 25 degrees from the horizontal axis on the user interface, which the electronic displays in response as the first representation of the first handwritten input, also tilted at an angle of 25 degrees from the horizontal axis. When the electronic device the displays the second representation of the first handwritten input or the third representation of the first handwritten input (e.g., according to the first or second handwriting model), the second representation or the third representation of the first handwritten input is optionally aligned with (e.g., at zero degree from) the horizontal axis (e.g., the word and/or the line (e.g., of characters and/or words) and/or the portion of a line are aligned (e.g., at zero degree from) the horizontal axis). Correcting the tilt of the handwriting input to align with an axis of the user interface in converted handwriting based on a handwriting model allows the electronic device to facilitate legibility of the converted handwriting for the user, which facilitates the use of the electronic device, simplifies the interaction between the user and the electronic device, enhances the operability of the electronic device and makes the user-device interface more efficient, which additionally reduces power usage and improves battery life of the electronic device by enabling the user to use the electronic device more quickly and efficiency.

In some embodiments, while displaying the second representation of the first handwritten input that has the second visual appearance, in accordance with the determination that the handwriting model at the electronic device is the first handwriting model, the electronic device determines that a portion of the second representation of the first handwritten input includes a typographical error; and in response to determining that the portion of the second representation of the first handwritten input includes the typographical error, the electronic device displays, in the user interface, an indication of the typographical error associated with the portion, such as the second representation in FIGS. 8K and 8L. In some embodiments, the portion of the second representation of the first handwritten input that includes a typographical error is optionally a word (e.g., the portion is a misspelled word). In some embodiments, the electronic device optionally determines that the portion has a typographical error using a digital dictionary stored and/or otherwise accessible at the electronic device. For examples, the electronic device performs a comparison of a respective detected word in the second representation of the first handwritten input with a corresponding word in the digital dictionary to determine whether the respective detected word includes a typographical error. In some embodiments, the electronic device optionally determines that a respective portion of the second representation of the first handwritten input includes a grammatical error (e.g., an error in punctuation and/or usage), and in response to determining that the respective portion of the second representation of the first handwritten input includes the grammatical error, displays, in the user interface, a respective indication of the typographical error associated with the respective portion. In some embodiments, the electronic device optionally determines that the portion of second representation of the first handwritten input includes a typographical error (and/or a grammatical error) while displaying the second representation of the first handwritten input. In some embodiments, the electronic device optionally determines that one or more portions of the second representation of the first handwritten input at corresponding one or more locations of the user interface include corresponding one or more typographical errors (and/or grammatical errors), and in response, displays one or more corresponding indications of a typographical error (and/or grammatical error) associated with the one or more portions and displayed in proximity to the one or more portions at the one or more locations. In some embodiments, the indication of typographical error is displayed adjacent to the portion of the second representation of the second handwritten input that includes a typographical error. In some embodiments, the indication is optionally one or more of an underline of the portion (e.g., a line under the portion), a highlight of the portion, and a change in the thickness of lines forming the second representation of the first handwritten input (e.g., displaying the portion in bold handwriting). In some embodiments, the indication optionally blinks or flashes (e.g., periodically displayed and removed or erase by the electronic device). In some embodiments, the indication is animated. In some embodiments, the electronic device displays the indication for a predetermined duration (e.g., 1, 2, 3, 5, 8, 10, 15, 20, 30 seconds) and ceases display of the indication after the predetermined duration elapses. In some embodiments, the indication optionally shares one or more characteristics with the second visual appearance of the second representation of the first handwritten input. In some embodiments, the indication has one or more characteristics that differ from or contrast with one or more characteristics of the second visual appearance of the second representation of the first handwritten input. For example, the indication has a different color from the second representation of handwritten input. In some embodiments, if the electronic device is displaying the third representation of the first handwritten input that has the third visual appearance, and determines that a portion of the third representation of the first handwritten input includes a typographical error, the electronic device displays, in the user interface, an indication of the typographical error associated with the portion. Detecting and displaying an indication of a typographical error in the converted handwriting enables the electronic device to automatically alert to the user to errors in the handwritten text and provide the user with an opportunity to make corrections, which facilitates the use of the electronic device, simplifies the interaction between the user and the electronic device, enhances the operability of the electronic device and makes the user-device interface more efficient, which additionally reduces power usage and improves battery life of the electronic device by enabling the user to use the electronic device more quickly and efficiency.

In some embodiments, the indication of the typographical error includes a line that is displayed under the portion of the second representation of the first handwritten input, such as line 840 in FIG. 8L. In some embodiments, the line is optionally one of a solid line, a dashed line, a dotted line, and a double line. In some embodiments, the line is optionally a curved line or a straight line. In some embodiments, the line has a visual appearance corresponding to a handwritten line. In some embodiments, the line is optionally thicker or thinner than a line forming a character of the second representation of the first handwritten input. In some embodiments, the line optionally blinks or flashes (e.g., periodically displayed and erased). In some embodiments, the line is optionally animated. In some embodiments, the line optionally has a color (e.g., red) different from a color of the portion of the second representation of the first handwritten input (e.g., black). Displaying a line under a misspelled word as an indication of a typographical error in the converted handwriting enables the electronic device to automatically alert to the user to errors in the handwritten text and provide the user with an opportunity to make corrections, which facilitates the use of the electronic device, simplifies the interaction between the user and the electronic device, enhances the operability of the electronic device and makes the user-device interface more efficient, which additionally reduces power usage and improves battery life of the electronic device by enabling the user to use the electronic device more quickly and efficiency.

In some embodiments, the portion of the second representation of the first handwritten input corresponds to one or more first characters (e.g., of a given word); and the indication of the typographical error is associated with (e.g., displayed relative to) the one or more first characters (e.g., of the given word) of the second representation of the first handwritten input corresponding to the typographical error, without being associated with (e.g., displayed relative to) one or more second characters (e.g., of the given word), different from the one or more first characters, that do not correspond to (e.g., do not contain) the typographical error, such as the indication 836 in FIG. 8K. Accordingly, in some embodiments, the indication is optionally only associated with specific characters (e.g., the one or more first characters) of the misspelled part of a word, but not with the rest of the word that is not misspelled. The indication is optionally displayed to the specific characters of the one or more characters, in some embodiments. For example, if, as previously described, the indication is a line that is displayed under the portion of the second representation of the first handwriting input corresponding to the typographical error, the line is displayed under the one or more characters corresponding to the typographical error, and the line is not displayed under the rest of the characters that do not correspond to the typographical error. Displaying an indication of typographical error associated with misspelled portions (e.g., characters) of misspelled words in the converted handwriting enables the electronic device to automatically refine alerts to the user of errors in the handwritten text and pinpoint for the user the exact errors thus enabling the user to make more accurate corrective inputs, which facilitates the use of the electronic device, simplifies the interaction between the user and the electronic device, enhances the operability of the electronic device and makes the user-device interface more efficient, which additionally reduces power usage and improves battery life of the electronic device by enabling the user to use the electronic device more quickly and efficiency.

In some embodiments, while displaying the indication of the typographical error associated with the portion that includes the typographical error, the indication is displayed at a first location in the user interface (e.g., displayed relative to the portion), and while displaying the indication of the typographical error associated with the portion at the first location in the user interface (e.g., displayed relative to the portion), the electronic device receives, via the touch-sensitive display generation component, second handwritten input directed to the user interface. In some embodiments, in response to receiving the second handwritten input, the electronic device displays, via the touch-sensitive display generation component, a first representation of the second handwritten input. In some embodiments, in accordance with a determination that displaying the first representation of the second handwritten input causes the portion of the second representation of the first handwritten input to no longer include a typographical error and causes a second portion (different from the earlier portion) of the second representation of the first handwritten input and/or the second handwritten input to include a typographical error, the electronic device displays, in the user interface, an indication of a typographical error associated with the second portion of the second representation of the first handwritten input and/or the second handwritten input at a second location, different from the first location, in the user interface corresponding to the second portion of the second representation of the first handwritten input and/or the second handwritten input, such as if in FIG. 8L, the indication of the typographical error 836 at a first location had moved to the second location. For example, in some embodiments, the second representation of the first handwritten input is optionally a portion of word (e.g., a first sequence of characters that forms part of a word) that does not correspond to a correctly spelled word (e.g., the electronic device has not identified the portion of word as a word in a digital dictionary). In response, the electronic device optionally displays the indication of the typographical associated with the portion of the word at the first location corresponding to the portion of word. The electronic device subsequently optionally receives second handwritten input directed to the user interface and at or adjacent to the portion of word to complete the word, and in response, the electronic device optionally displays a first representation of the second handwritten input that includes a second sequence of characters that when appended to and/or added to the portion of word (e.g., the first sequence characters) of the second representation of the first handwritten input, forms in combination with the portion word a correctly spelled word. In response to detecting the correctly spelled word, the electronic device optionally ceases displays of the indication of typographical error associated with the portion of word of the second representation of the first handwritten input at the first location. In some embodiments, in accordance with a determination that a portion of the first representation of the second handwritten input includes a typographical error at a second location, different from the first location, the electronic device displays an indication of typographical error associated with the portion of the first representation of the second handwritten input that includes a typographical error at the second location. Accordingly, in some embodiments, the electronic device optionally moves the indication of typographical error from a displayed portion of handwriting to a newly displayed portion of handwriting when the new portion of handwriting causes fixes the typographical error in the displayed portion of handwriting but introduces a typographical error at a different location from the displayed portion of handwriting. Moving the indication of the typographical error associated with misspelled words and/or misspelled portions (e.g., characters) of misspelled words in the converted handwriting enables the electronic device to accurately alert the user of errors in the handwritten text and pinpoint for the user the exact errors even after further handwriting input is detected, thus enabling the user to make more accurate corrective inputs, which facilitates the use of the electronic device, simplifies the interaction between the user and the electronic device, enhances the operability of the electronic device and makes the user-device interface more efficient, which additionally reduces power usage and improves battery life of the electronic device by enabling the user to use the electronic device more quickly and efficiency.

In some embodiments, in response to determining that the portion of the second representation of the first handwritten input includes the typographical error, the electronic device displays, in proximity to the portion of the second representation of the first handwritten input that includes the typographical error, one or more suggested words corresponding to the portion having the typographical error corrected, such as the suggested words 842a and 842b in FIG. 8N. In some embodiments, the one or more words are one or more suggested corrections (e.g., properly spelled words or corrected words) of misspelled words of the portion of the second representation of the first handwritten input that includes the typographical error. For example, if a word of the second representation of the first handwritten input (e.g., the converted handwriting) is misspelled and the electronic device has displayed an indication of typographical error adjacent to the word (e.g., a line under the misspelled word or one of more characters of the word that is misspelled) as described above, the electronic device further optionally displays one or more corrected words or suggested corrections (e.g., words having the proper spelling or properly spelled versions of the misspelled word) in proximity to the misspelled word. In some embodiments, the one or more words (e.g., suggested corrections) are optionally displayed with a visual appearance different from the second visual appearance of the second representation of the first handwritten input (e.g., the one or more words are displayed in font-based text rather than handwriting text). In some embodiments, one or more words are displayed in a pop-up window adjacent to the misspelled word. In some embodiments, the one or more corrected words are optionally displayed as one or more selectable options, the selection of one or more of which the electronic device is able receive to replace the corresponding misspelled word. Displaying suggested corrections for typographical errors detected by the electronic device in the converted handwriting enables the electronic device to automatically simplify corrective inputs for the user, which facilitates the use of the electronic device, simplifies the interaction between the user and the electronic device, enhances the operability of the electronic device and makes the user-device interface more efficient, which additionally reduces power usage and improves battery life of the electronic device by enabling the user to use the electronic device more quickly and efficiency.

In some embodiments, the one or more words corresponding to the portion having the typographical error corrected are displayed in the user interface in response to detecting a selection of the indication of the typographical error associated with the portion, such as selection of indication 840 in FIGS. 8M and 8L. For example, when the indication of the typographical error is a line under a misspelled word of the second representation of the first handwritten input, an input directed to the line (e.g., a finger tap or stylus tap on the line) or selecting the line optionally causes the electronic device to display, on the user interface, the one or more suggested corrections for the misspelled word. In some embodiments, in response to detecting the input directed to the indication of the typological error, the electronic device displays the one or more suggested corrections in a pop-up window adjacent to the misspelled word. In some embodiments, while the one or more words are displayed, the electronic device optionally ceases display of the one or more words (e.g., suggested corrections) in response to an input directed to or selecting the indication of the typographical error. In some embodiments, the electronic device only displays the one or more words corresponding to the portion having the typographical error corrected on the user interface (e.g., in a pop-up window) in response to detecting the selection of the indication of the typographical error associated with the portion. Displaying suggested corrections for typographical errors detected by the electronic device in the converted handwriting in response to an input on the indication of typographical error enables the electronic device to simplify corrective inputs for the user, which facilitates the use of the electronic device, simplifies the interaction between the user and the electronic device, enhances the operability of the electronic device and makes the user-device interface more efficient, which additionally reduces power usage and improves battery life of the electronic device by enabling the user to use the electronic device more quickly and efficiency.

In some embodiments, while displaying the one or more words corresponding to the portion having the typographical error corrected, the electronic device receives, via the touch-sensitive display, a first input directed to the one or more words. In some embodiments, in response to receiving the first input, in accordance with a determination that the first input is directed to a first word of the one or more words having the typographical error corrected, the electronic device replaces display of the portion of the second representation of the first handwritten input that includes the typographical error with a second portion of handwritten representation that includes the first word of the one or more words having the typographical error corrected. In some embodiments, in accordance with a determination that the first input is directed to a second word of the one or more words having the typographical error corrected, the electronic device replaces display of the portion of the second representation of the first handwritten input that includes the typographical error with a third portion of handwritten representation that includes the second word of the one or more words having the typographical error corrected, such as selection of the word 842a and replacement of the handwritten text “raeding” with the suggested words as shown in FIGS. 80 and 8P. In some embodiments, the input directed to the one or more words is optionally a stylus tap or finger tap input on a display on the one or more words. In some embodiments, replacing the display of the portion of the second representation of the first handwritten input that includes the typographical error with the second or third portion of handwritten representation optionally includes ceasing display of the portion of the second representation and optionally displaying the second portion of handwritten representation that includes the first word of the one or more words having the typographical error corrected or third portion of handwritten representation that includes the second word of the one or more words having the typographical error corrected. In some embodiments, a visual appearance of the second and/or third portions of handwritten representation is in accordance with the first handwriting model. In some embodiments, in response to receiving the first input directed to the one or more words having the typographical error corrected, the electronic device replaces display of the portion of the second representation of the first handwritten input that includes the typographical error with a second portion of handwritten representation that includes the first word and the second word of the one or more words having the typographical error corrected. Replacing a misspelled word in a converted handwriting with a suggested correction in response to an input on the displayed suggested correction on the user interface enables the electronic device to simplify corrective inputs for the user, which facilitates the use of the electronic device, simplifies the interaction between the user and the electronic device, enhances the operability of the electronic device and makes the user-device interface more efficient, which additionally reduces power usage and improves battery life of the electronic device by enabling the user to use the electronic device more quickly and efficiency.

In some embodiments, the portion of the second representation of the first handwritten input is associated with a respective confidence level, and in accordance with a determination that the respective confidence level is a first confidence level, the electronic device displays the indication with a first visual characteristic having a first value, and in accordance with a determination that the confidence level is a second confidence level, different from the first confidence level, the electronic device displays the indication with the first visual characteristic having a second value, different from the first value, such as first indication 840 for confidence level 864 in FIG. 8Q and second indication 856 for confidence level 866 in FIG. 8R. In some embodiments, confidence level is a measure of the confidence that the electronic device has that the portion of the second representation of the first handwritten input having the typographical error is an accurate transcription of a corresponding portion of the first representation of the first handwritten input. In some embodiments, the confidence level is a measure of how easily the electronic device has deciphered the user's handwriting (e.g., recognized characters and words of the corresponding portion of first representation of the first handwritten input) and the accuracy of such recognition. In some embodiments, the confidence level is optionally a percentage (e.g., 25%, 50%, 75%). In some embodiments, a first visual characteristic of the indication of typographical error is optionally based on the confidence level of portion of the second representation of the first handwritten input. The first visual characteristic of the indication optionally includes a color of the indicator, a boldness of the indicator, a transparency of the indicator, a fineness of dashes of the indicator (including no dashes), for example. For example, in an embodiment where the first visual characteristic of the indication is a color of the indication, in accordance with a determination that the respective confidence level associated with the portion of the second representation of the first handwritten input is a first confidence level (e.g., a low confidence level of e.g., 25%), the electronic device optionally displays the indication with the first visual characteristic (e.g., a color of the indication) having a first value of (e.g., corresponding to the color red), and in accordance with a determination that the respective confidence level associated with the portion of the second representation of the first handwritten input is a second confidence level (e.g., a high confidence level of e.g., 75%), different from the first confidence level, the electronic device optionally displays the indication with the first visual characteristic (e.g., a color of the indication) having a second value (e.g., corresponding to the color green), different from the first value (corresponding to the color red). As an another example, in an embodiment where the first visual characteristic of the indication is a transparency of the indication, in accordance with a determination that the respective confidence level associated with the portion of the second representation of the first handwritten input is a first confidence level (e.g., a low confidence level of e.g., 33%), the electronic device optionally displays the indication with the first visual characteristic (e.g., a transparency of the indication) having a first value of (e.g., corresponding to a low transparency of the indication), and in accordance with a determination that the respective confidence level associated with the portion of the second representation of the first handwritten input is a second confidence level (e.g., a high confidence level of e.g., 66%), different from the first confidence level, the electronic device optionally displays the indication with the first visual characteristic (e.g., a transparency of the indication) having a second value (e.g., corresponding to a high transparency), different from the first value (corresponding to a low transparency). In some embodiments, in accordance with a determination that the respective confidence level is above a first threshold (e.g., 75%), the electronic device replaces display of the portion of the second representation of the first handwritten input that includes the typographical error with a second portion that includes the first word of the one or more words having the typographical error corrected. In accordance with a determination that the respective confidence level is below the first threshold, the electronic device optionally displays, in proximity to the portion of the second representation of the first handwritten input that includes the typographical error, one or more words corresponding to the portion having the typographical error corrected. In this instance, the electronic device only replaces display of the portion of the second representation of the first handwritten input that includes the typographical error with a second portion that includes the first word of the one or more words having the typographical error corrected in response to an input directed to the one or more words, as previously described. Accordingly, the electronic device automatically corrects the typographical error if the confidence in the transcription of the user's handwriting is high (e.g., is above the first threshold (e.g., 75%)) but waits for the user's input selecting the corrected word if confidence in the transcription of the user's handwriting is low (e.g., less than the first threshold). Displaying a confidence level of in a portion of the converted handwriting corresponding to a typographical error detected by the electronic device in the converted handwriting enables the electronic device to automatically alert the user as to whether and to what extent the detected typographical error is an actual typographical error or reflection of a difficult transcription (e.g., due to a bad handwriting), which optionally enables to user to adjust the handwriting accordingly to minimize errors, and thus facilitates the use of the electronic device, simplifies the interaction between the user and the electronic device, enhances the operability of the electronic device and makes the user-device interface more efficient, which additionally reduces power usage and improves battery life of the electronic device by enabling the user to use the electronic device more quickly and efficiency.

It should be understood that the particular order in which the operations in FIG. 9 have been described, optionally including the additional and/or alternatives operations to the illustrated operations in FIG. 9 described herein, is merely exemplary and is not intended to indicate that the described order is the only order in which the operations could be performed. One of ordinary skill in the art would recognize various ways to reorder the operations described herein.

The operations in the information processing methods described above are, optionally, implemented by running one or more functional modules in an information processing apparatus such as general purpose processors (e.g., as described with respect to FIGS. 1A-1B, 3, 5A-5I) or application specific chips. Further, the operations described above with reference to FIG. 9 are, optionally, implemented by components depicted in FIGS. 1A-1B. For example, displaying operations 902b, 902e and 902f, receiving operation 902a, and detecting operation 902c, are, optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

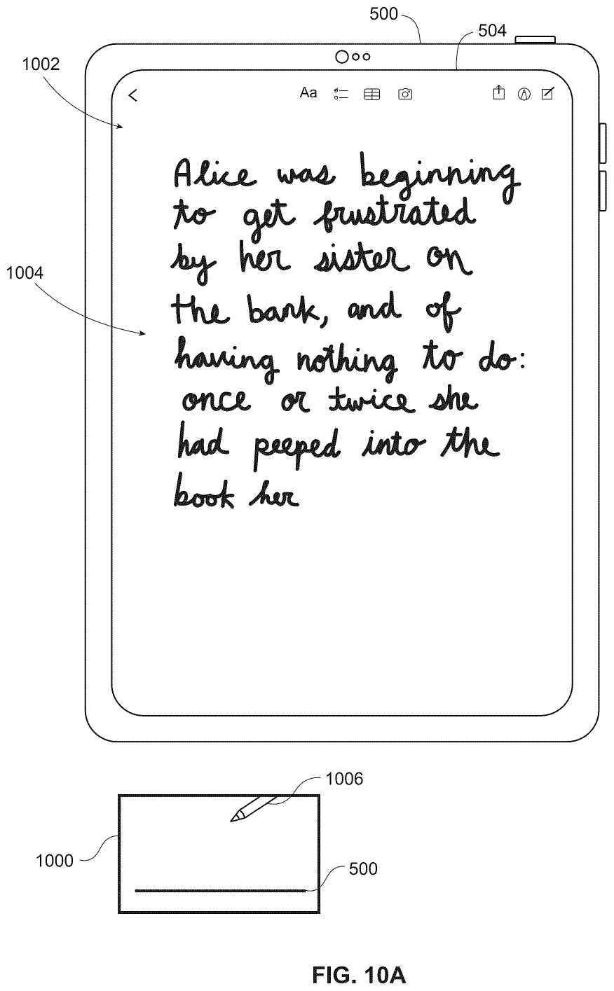

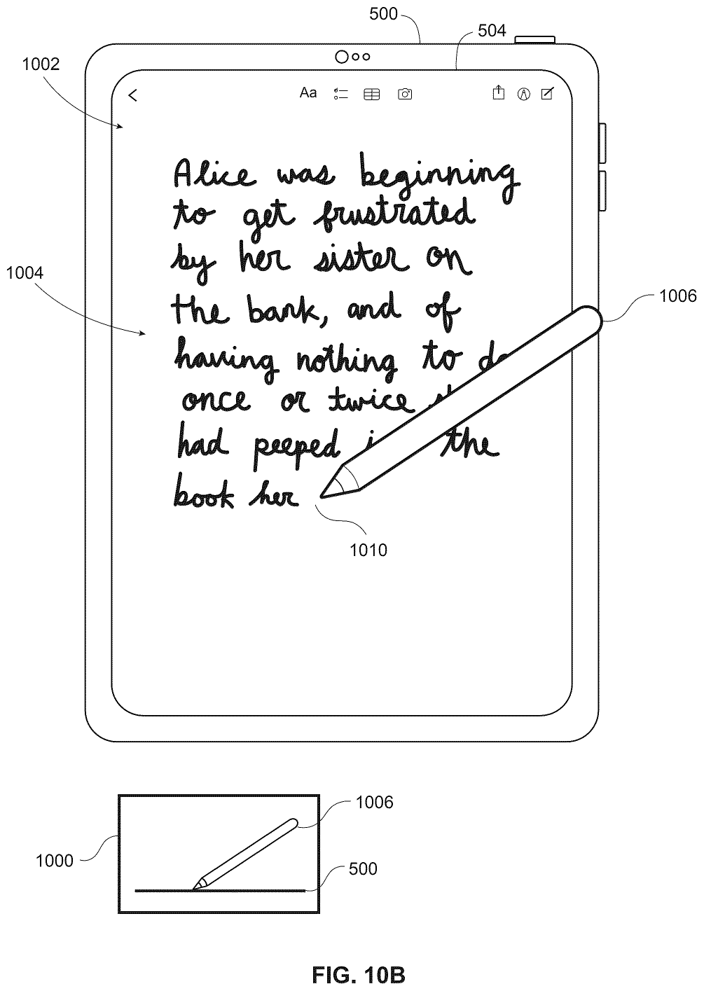

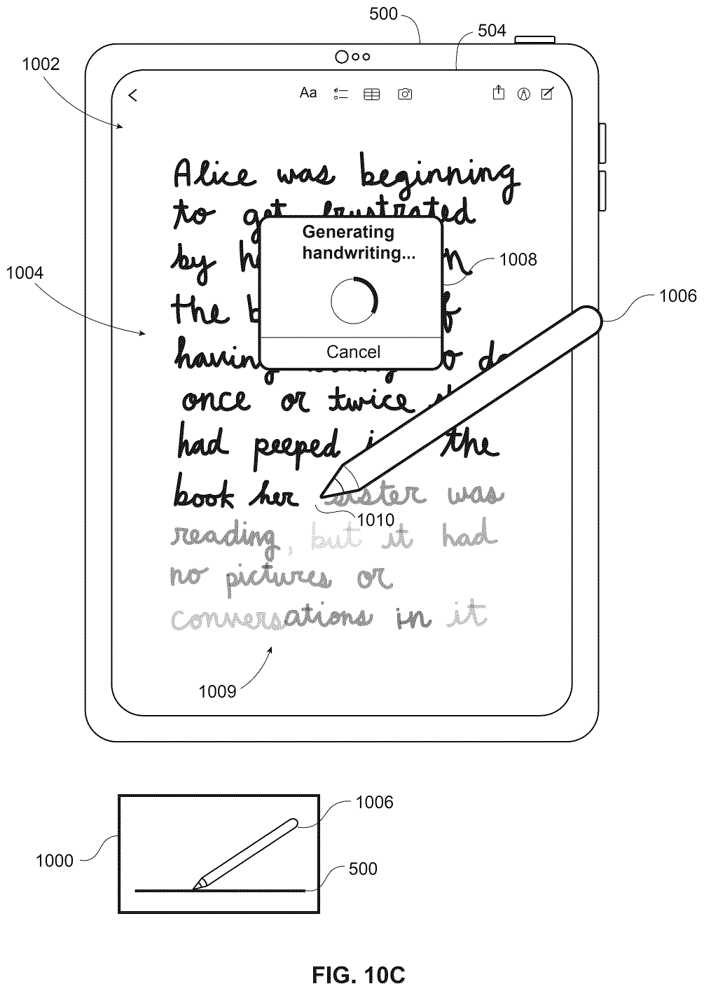

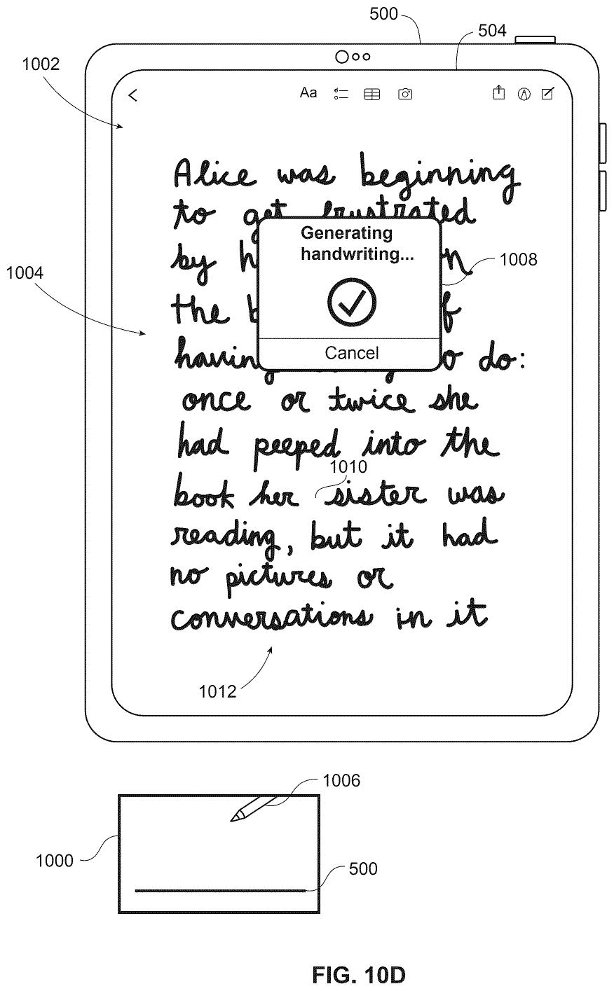

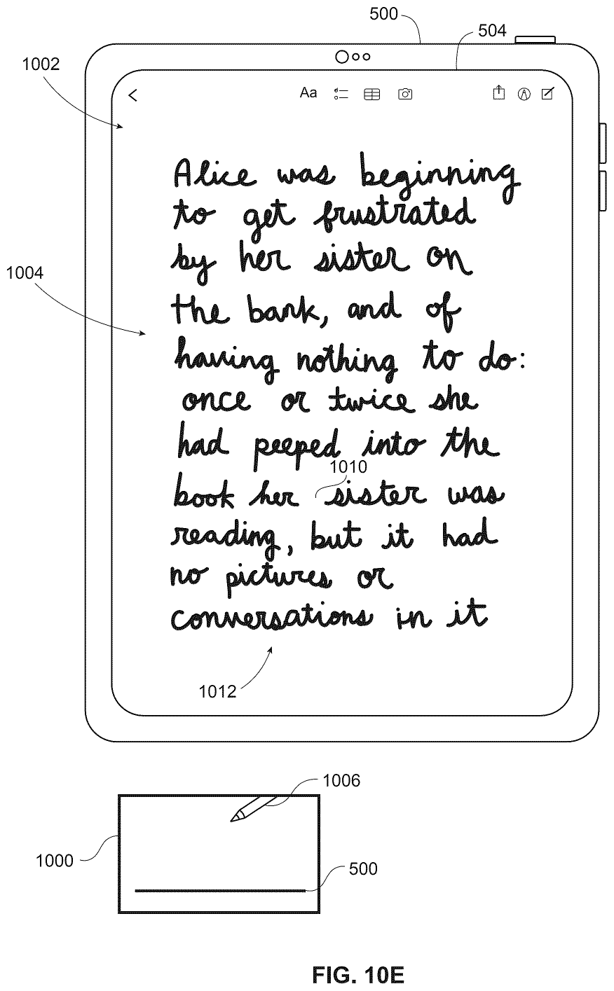

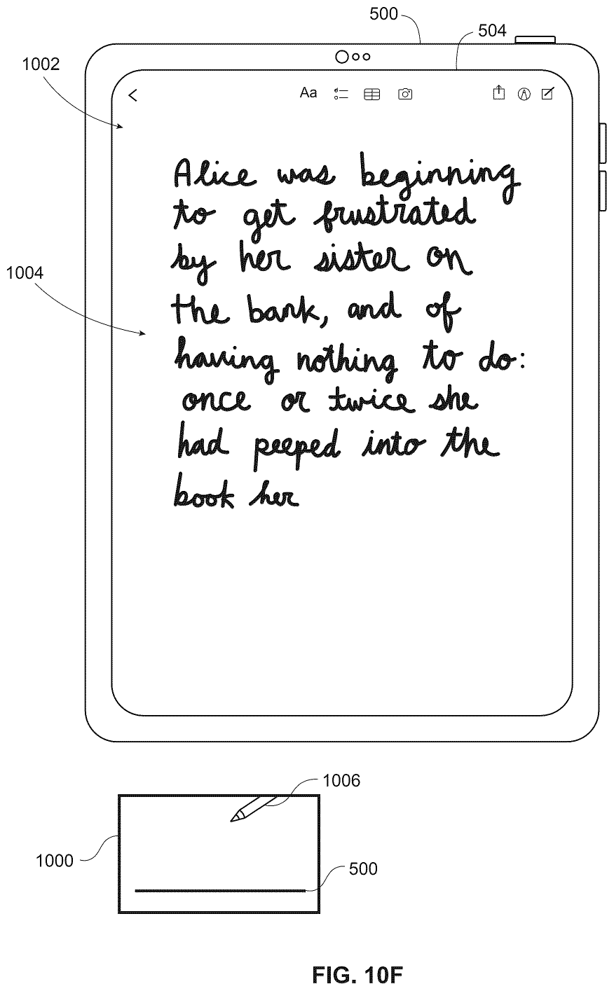

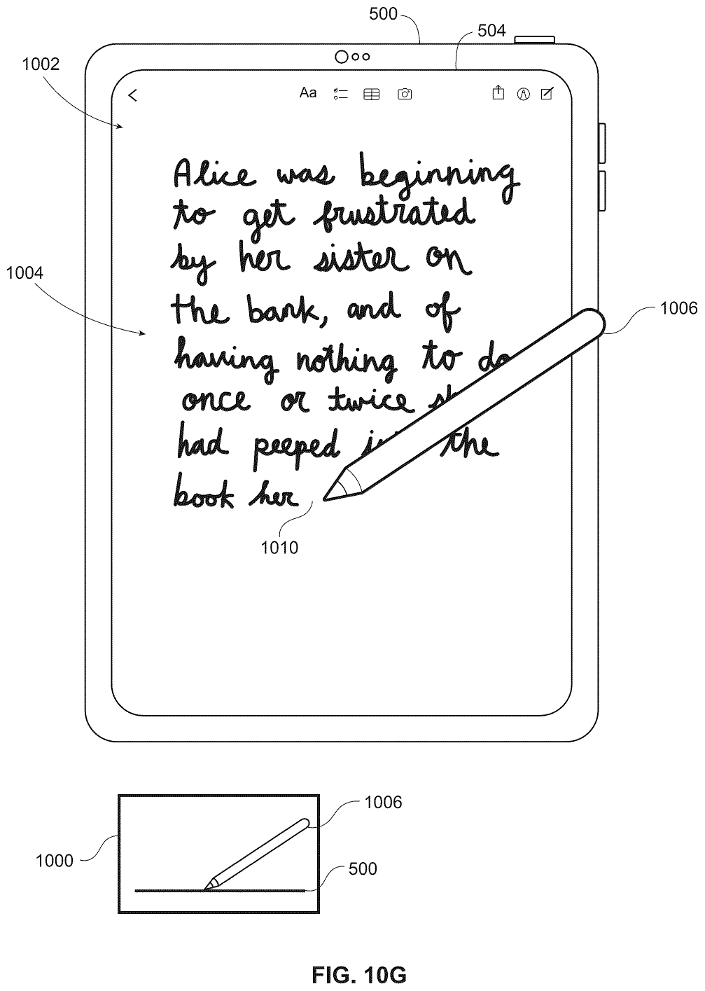

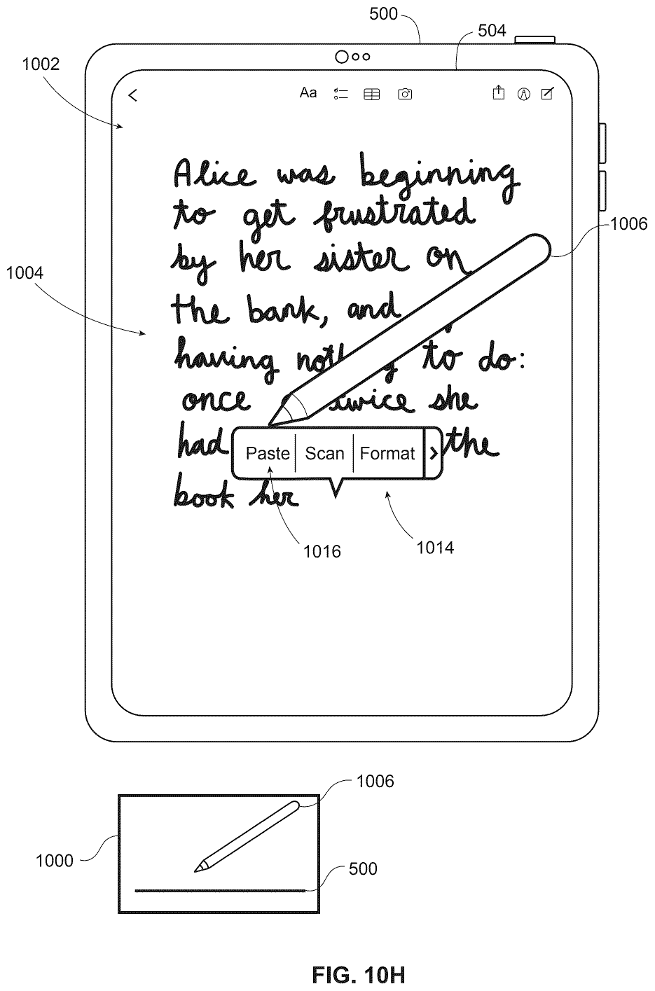

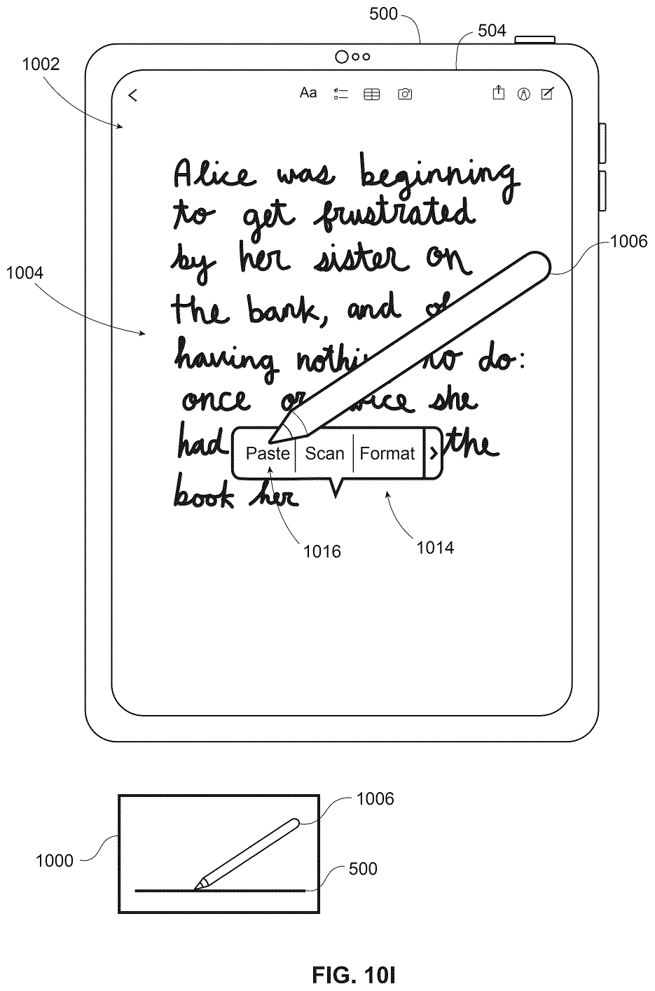

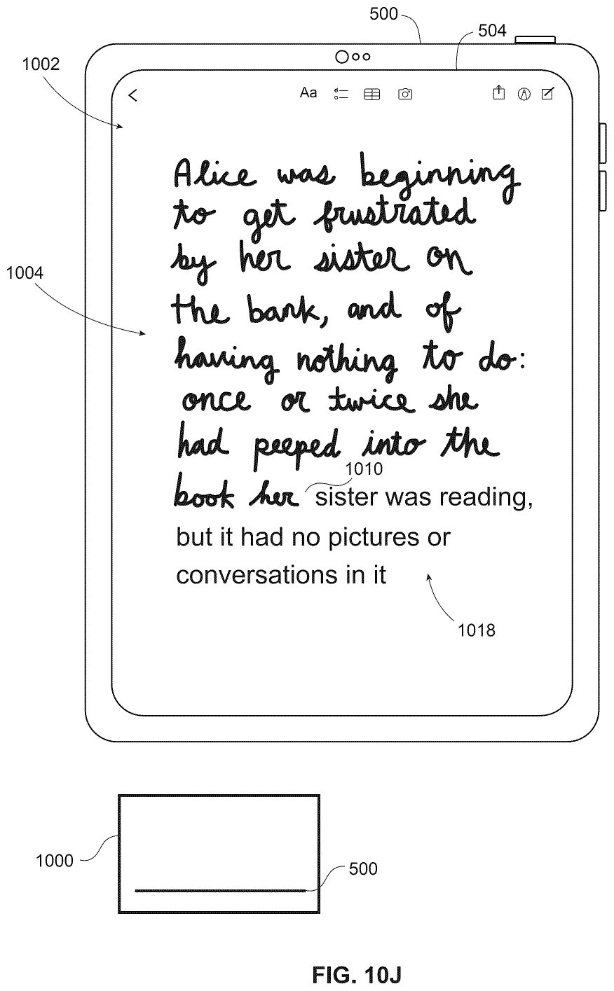

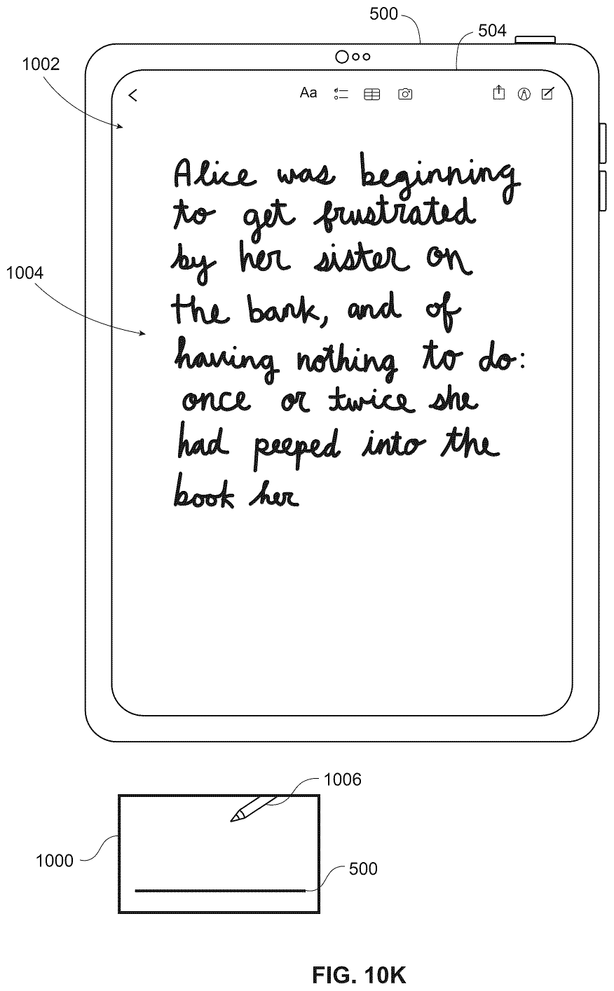

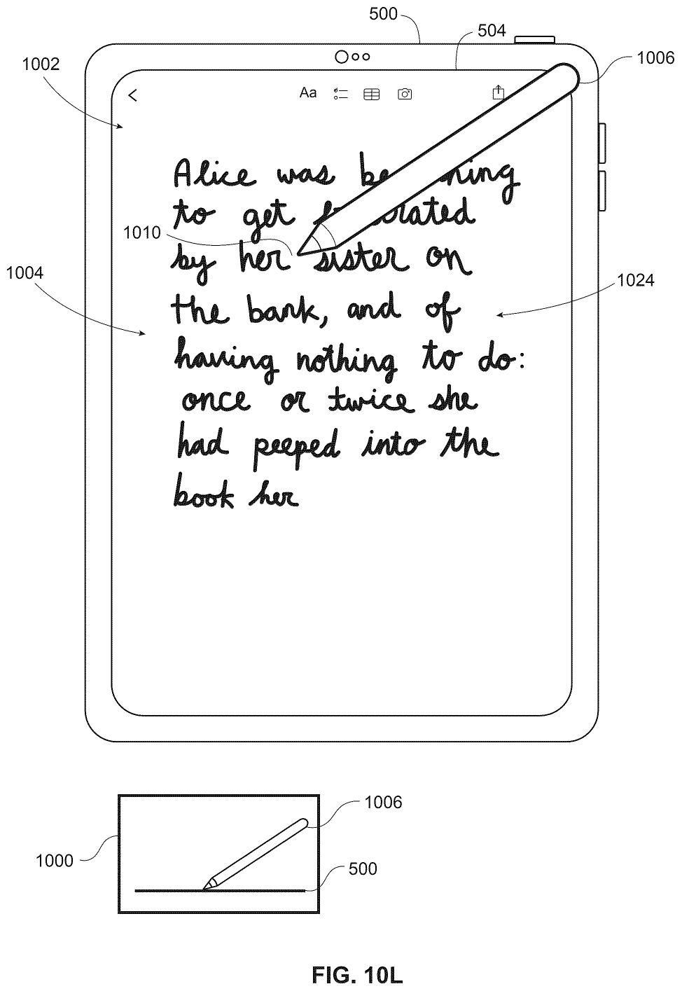

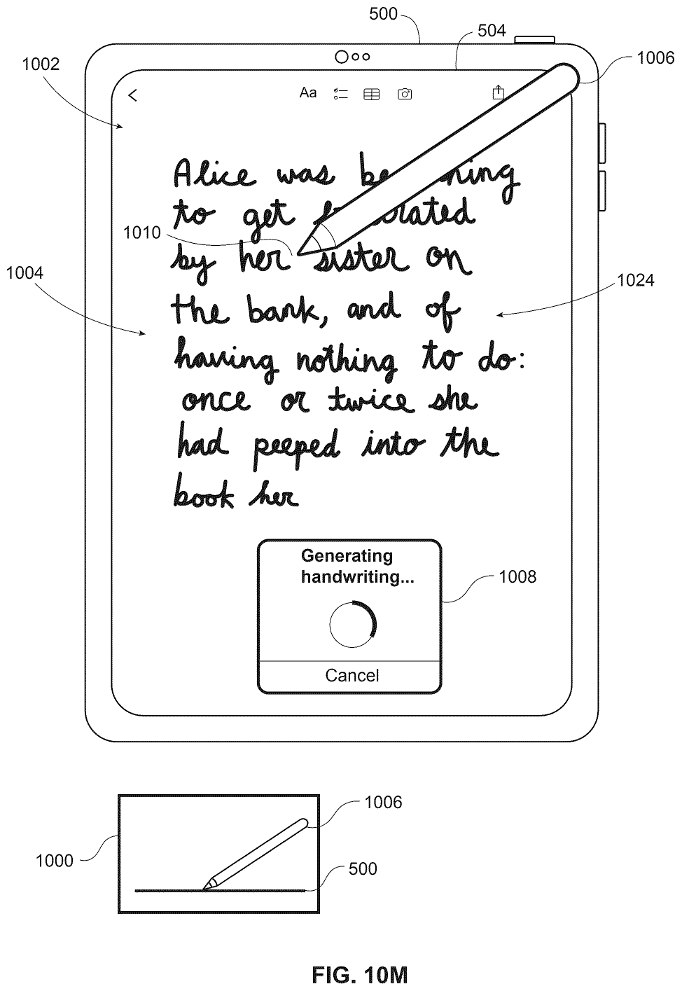

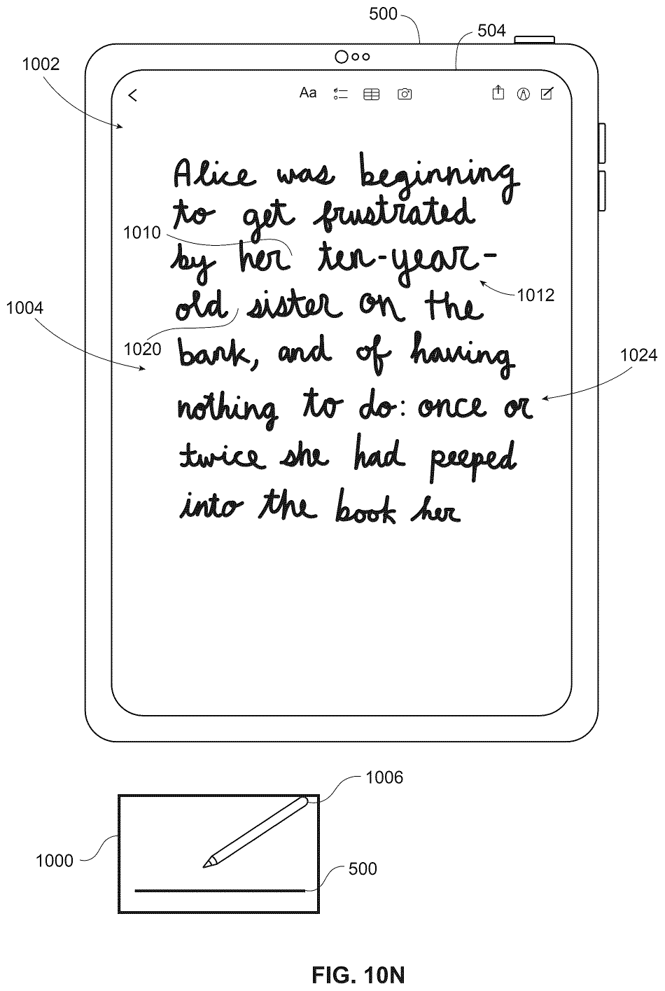

FIGS. 10A-ION illustrate various examples of the operation of electronic device that pastes stored text on a user interface as handwritten text or font-based text based on the type of input. The embodiments in these figures are used to illustrate the processes described below, including the processes described with reference to FIG. 11. Although FIGS. 10A-ION illustrate various examples of ways an electronic device is able to perform the processes described below with respect to FIG. 11, it should be understood that these examples are not meant to be limiting, and the electronic device is able to perform one or more processes described below with reference to FIG. 11 in ways not expressly described with reference to FIGS. 10A-ION.

FIG. 10A illustrates electronic device 500 displaying user interface 1002 (e.g., via a display device, via a display generation component, or via a touch screen 504). In some embodiments, user interface 1002 is displayed via a display generation component. In some embodiments, the display generation component is a hardware component (e.g., including electrical components) capable of receiving display data and displaying a user interface. In some embodiments, examples of a display generation component include a touch screen display (such as touch screen 504), a monitor, a television, a projector, an integrated, discrete, or external display device, or any other suitable display device that is in communication with electronic device 500. The user interface 1002 is, for example, a text composition user interface associated with a note-taking application, a messaging application, a journaling or scheduling application, a text-editor application, and/or a text annotation application or any other region that can accept handwritten input. The electronic device 500 is in communication with an electronic stylus 1006 configured to provide inputs to the electronic device 500.

The electronic device 500 displays a first representation of handwritten content 1004 on the user interface 1002. The first representation of handwritten content 1004 corresponds to a representation of handwritten input, which includes representations of handwritten words. The first representation of the handwritten content 1004 thus includes handwritten characters, such as letters, words, numbers, special characters, and/or shapes that are recognized by the electronic device 500 as handwritten content. The first representation of handwritten content illustrated in FIG. 10A is displayed in lines of characters (e.g., 8 lines) corresponding to the number of lines in which the handwritten words, numbers, and/or special characters were written in the handwritten input. In some embodiments, the first representation of handwritten content 1004 is displayed in the user interface 1002 in response to handwritten input received via an external device/tool for providing handwritten input (e.g., stylus 1006) or via a finger of a hand of a user of the electronic device 500. In some embodiments, the handwritten input includes continuous and/or subsequent strokes and/or contacts (e.g., provided by the stylus or finger of the user) detected on the touch sensitive surface that are recognized by the electronic device 500 as handwritten input (e.g., handwritten words, numbers, special characters, and/or shapes). The representation of the handwritten content 1004 has a visual appearance. As described in this disclosure, a visual appearance of a representation of handwritten content corresponds to one or more characteristics of the representation of the handwritten content including a size of characters of the handwritten content, a shape of the characters, an orientation of the characters, a spacing between the characters, a thickness of lines forming the characters, one or more stroke patterns used to form the characters of the handwritten content, and/or variations and/or patterns of any one of these characteristics included within the representation of the handwritten content.

In FIG. 10B, while displaying, via the touch screen 504 and in the user interface 1002, the first representation of handwritten content 1004, the electronic device 500 receives via the one or more input devices (e.g., stylus 1006), a first input corresponding to a request to insert stored text into the user interface 1002. In some embodiments, the first input is received via a stylus 1006 and optionally includes a stylus gesture, such as a stylus tap, swipe and/or squeeze. In some embodiments, the first input is received via a finger gesture such as a finger tap or swipe. In the embodiment illustrated, the first input includes a stylus 1006 contact on the touch screen 504 at a first location 1010 (e.g., after “book her”) of the user interface 1002 (e.g., a text entry region of the user interface 1002). The first input corresponds to a request to paste stored text into the user interface 1002 (e.g., at the first location 1010). In some embodiments, the stored text refers to text stored in a clipboard (e.g., a memory) of the electronic device 500. The stored text was optionally previously transferred to the clipboard using a cut and/or copy operation performed on source text displayed on the electronic device 500. The stored text was optionally copied and/or cut and/or transferred to the clipboard from a handwritten source text and/or from a font-based source text.

In FIG. 10C, the electronic device 500 detects the stylus contact (e.g., initiated as shown in FIG. 10B as part of the first input) on the surface of the touch screen 504 without detecting liftoff of the stylus 1006 from the surface (e.g., from the contact initiated in FIG. 10B) for a least a threshold duration such as 0.1, 0.2, 0.3, 0.5, 0.8, 1, or 2 seconds (e.g., contact of the stylus 1006 on the surface is maintained for at least that duration). The electronic device 500 determines that the first input is a first type of input, which is the combination of the stylus tap directed to the user interface 1002 followed by the stylus hold (e.g., contact of the stylus 1006 on the touch screen 504 maintained for at least the threshold duration). In accordance with a determination that the first input is a first type of input, the electronic device 500 displays, in the user interface 1002, a first representation of the stored text as handwritten content in the user interface 1002.

In some embodiments, such as shown in FIG. 10C, displaying, on the user interface 1002, the first representation of the stored text as handwritten content includes (e.g., initially) displaying, on the user interface 1002, a placeholder representation of the stored text 1009. As shown, the placeholder representation of the stored text 1009 includes representations of handwritten words corresponding to the stored text. The placeholder representation of the stored text 1009 is a temporary representation displayed on the user interface 1002 while the electronic device 500 generates (e.g., using an AI process or a generative AI process) handwriting for the first representation of stored text (e.g., synthesizes and/or generates the first visual appearance of the first representation of the stored text (e.g., automatically-generated text content or generative text content), or determines and applies one or more characteristics of visual appearance to the first representation of the stored text), in some embodiments. Accordingly, in some embodiments, the placeholder representation of the stored text has a visual appearance that does not correspond to a visual appearance of the stored text or a visual appearance of the first representation of handwritten content 1004. In some embodiments, the visual appearance of the placeholder representation of stored text 1009 has a plurality of colors. The placeholder representation of the stored text 1012 is displayed at the first location 1010 of the user interface 1002, which is the location where the electronic device 500 detected the first input discussed above. In some embodiments, the electronic device 500 does not display the placeholder representation of the stored text 1009 and instead, in accordance with a determination that the first input is the first type of input, the electronic device 500 displays, in the user interface 1002, a first representation of the stored text as handwritten content in the user interface 1002, as will be further described below. In some embodiments, the electronic device 500 displays a progress bar (e.g., a circular progress bar as shown) in a pop-up window 1008 on the user interface 1002 to provide a visual cue of time elapsed since the electronic device 500 determined that the first input is the first type of input. Alternatively, the progress bar in window 1008 indicates a remaining time to the display of the first representation of the stored text.

In FIG. 10D, the electronic device 500 displays the first representation of the stored text 1012 (e.g., the pasted handwritten text). In particular, the electronic device 500 inserts or displays (e.g., pastes), on the user interface 1002, the first representation of the stored text 1012 in response to receiving the first type of input. In some embodiments, the first representation of the stored text 1012 replaces the placeholder representation of the stored text 1009 (e.g., the electronic device 500 ceases display of the placeholder representation of the stored text 1009 and displays the first representation of the stored text 1012 in its place (e.g., at the first location 1010)). In some embodiments, replacing the placeholder representation of the stored text 1009 with the first representation of the stored text 1012 includes the electronic device 500 displaying an animation of the placeholder representation of the stored text 1009 morphing into the first representation of the stored text 1012. As shown, the first representation of the stored text 1012 includes representations of handwritten words (e.g., “sister was reading . . . ”). The first representation of the stored text 1012 thus includes handwritten characters, such as letters, words, numbers, special characters, and/or shapes. The handwritten characters are included regardless of whether the stored text is copied from handwritten content or font-based content. Accordingly, the first representation of the stored text 1012 represents handwritten content converted from a handwritten text and/or a font-based text as a source. The first representation of the stored text 1012 is displayed at the first location 1010 of the user interface 1002, which is the location where the electronic device 500 detected the first input in response to which the first representation of the text 1012 is displayed. In particular, the electronic device 500 displays the first representation of the stored text 1012 such that the handwritten text “sister was reading . . . ” starts at the first location 1010 (e.g., after “book her”). In some embodiments, when the electronic device 500 displays the first representation of the stored text 1012 (e.g., the pasted handwritten text), the electronic device 500 displays in the pop-up window 1008 an indication (e.g., a check mark as shown) that the generation of handwriting for the first representation of the stored text is complete.

In FIG. 10E, the electronic device 500 ceases display of the progress bar in window 1008 after displaying the first representation of the stored text 1012. In some embodiments, the first representation of the stored text 1012 has a first visual appearance. As can be seen in FIG. 10E, the first visual appearance of the first representation of the stored text 1012 corresponds to one or more characteristics of the visual appearance of the first representation of handwritten content 1004 (e.g., a visual appearance of the inserted text 1012 matches characteristics of the first representation of the handwritten content 1004). For example, a size of the characters of the first representation of the stored text 1012, a shape of the characters, an orientation of the characters, a spacing between the characters, a thickness of lines forming the characters, one or more stroke patterns used to form the characters of the stored text, and/or variations and/or patterns of any one of these characteristics included within the first representation of the stored text 1012, match those of the first representation of handwritten content 1004. In some embodiments, the first visual appearance of the first representation of the stored text 1012 matches the visual appearance of the first representation of handwritten content 1004 regardless of the visual appearance of the source text from which the stored text was transferred to the clipboard. Accordingly, the handwriting of the newly inserted or pasted handwritten text 1012 matches the handwriting of the first representation of handwritten content 1004.

Further, as shown in FIG. 10E, the first visual appearance of the first representation of the stored text 1012 is also based on a spatial distribution of one or more characters in the first representation of handwritten content 1004 relative to the user interface 1002. The spatial distribution of the one or more characters in the first representation of handwritten content 1004 include a spacing between lines of the first representation of handwritten content 1004, an alignment of the lines of the first representation of handwritten content 1004, and/or a width of a paragraph of the first representation of handwritten content 1004. Accordingly, a spacing between lines of the first representation of the stored text 1012, an alignment of the lines of the first representation of the stored text 1012, and/or a width of a paragraph of the first representation of the stored text 1012, correspond to or match the spacing between corresponding lines of the first representation of handwritten content 1004, the alignment of the corresponding lines of the first representation of handwritten content 1004, and/or the width of a corresponding paragraph of the first of representation of handwritten content 1004. As a result, the first representation of the stored text 1012 matches a paragraph format of the first representation of handwritten content 1004, as shown in FIG. 10E.

In FIG. 10F, as in FIG. 10A, the electronic device 500 displays a first representation of handwritten content 1004 on the user interface 1002. The first representation of handwritten content 1004 corresponds to a representation of handwritten input, which includes representations of handwritten words, such as described in reference to FIG. 10A.

In FIG. 10G, while displaying, via the touch screen 504 and in the user interface 1002, the first representation of handwritten content 1004, the electronic device 500 receives, via the one or more input devices (e.g., stylus 1006), a second input corresponding to a request to insert stored text into the user interface 1002. As shown, the second input includes a stylus tap on the touch screen 504 at a first location 1010 (e.g., after “book her”) of the user interface 1002 (e.g., a text entry region of the user interface 1002).

In FIG. 10H, in response to detecting the stylus tap, the electronic device 500 displays a pop-up window or pop-up menu 1014. The pop-up menu 1014 displays a paste option 1016 as a selectable option for inserting or pasting the first representation of the stored text on the user interface 1002. The pop-up menu 1014 is displayed at or in proximity to the first location 1010 to which the stylus tap was directed.

In FIG. 10I, the electronic device 500 detects a selection of the paste option 1016. The selection of the paste option 1016 includes contact of the stylus 1006 on the surface directed to the paste option 1016 (e.g., tap of the paste option 1016 in the pop-up menu 1014).

In FIG. 10J, in accordance with a determination that the second input is a second type of input, different from the first type of input discussed previously above, the electronic device 500 displays, in the user interface 1002, a second representation of the stored text 1018 as font-based text in the user interface 1002, wherein the second representation of the stored text 1018 has a second visual appearance, different from the first visual appearance. In the embodiment illustrated, the electronic device 500 has determined that the second input is the second type of input, which is the combination of the detected stylus tap directed to the user interface 1002 followed by the selection of the paste option 1016. In response, the electronic device 500 displays the second representation of the stored text 1018 as font-based text in the user interface 1002, as shown in FIG. 10J. The second representation of the stored text 1018 is displayed at the first location 1010 of the user interface 1002, which is the location where the electronic device 500 detected the second input (e.g., the location where the stylus tap was detected) in response to which the second representation of the stored text 1018 was displayed. In particular, the electronic device 500 displays the second representation of the stored text 1012 such that the handwritten text “sister was reading . . . ” starts at the first location 1010 (e.g., after “book her”). Unlike the first representation of the stored text 1012 in FIG. 10E, which was displayed on the user interface 1002 as handwritten content, the second representation of the stored text 1018 is displayed by the electronic device 500 on the user interface 1002 as font-based text. For example, the second representation of the stored text 1018 in FIG. 10J includes 12-point Times New Roman font (e.g., or other suitable font). In some embodiments, font-based text is 10-point sized, 12-point sized, etc. and optionally is Arial, Calibri, Times New Roman, etc. In some embodiments, such as shown in FIG. 10J, the font-based text of the second representation of the stored text 1018 has the same size as a size of the first representation of handwritten content 1004.

In some embodiments, the second representation of the stored text 1018 has a second visual appearance. The second visual appearance differs from (e.g., does not correspond to) characteristics of the first representation of handwritten content 1004 (e.g., the handwritten content displayed on the user interface before the insertion of the stored text) and instead corresponds to one or more characteristics of the font of the second representation of the stored text 1018. However, as shown in FIG. 10J, the second visual appearance of the second representation of the stored text 1018 is based on a spatial distribution of one or more characters in the first representation of handwritten content 1004 relative to the user interface 1002. Accordingly, a spacing between lines of the second representation of the stored text 1018, an alignment of the lines of the second representation of the stored text 1018, and/or a width of a paragraph of the second representation of the stored text 1018, correspond to or match the spacing between corresponding lines of the first representation of handwritten content 1004, the alignment of the corresponding lines of the first representation of handwritten content 1004, and/or the width of a corresponding paragraph of the first of representation of handwritten content 1004. Accordingly, as with the first representation of the stored text 1012 in FIG. 10E, the second representation of the stored text 1018 matches a paragraph format of the first representation of handwritten content 1004.

In FIG. 10K, as in FIGS. 10A and 10F, the electronic device 500 displays a first representation of handwritten content 1004 on the user interface 1002. The first representation of handwritten content 1004 corresponds to a representation of the handwritten input, which includes representations of handwritten words, such as described in reference to FIGS. 10A and 10F. The first representation of handwritten content 1004 includes a sequence of characters.

In FIG. 10L, while displaying, via the touch screen 504 and in the user interface 1002, the first representation of handwritten content 1004, the electronic device 500 receives via the one or more input devices (e.g., stylus 1006), a third input corresponding to a request to insert stored text into the user interface 1002. The third input is a first type of input (e.g., a stylus tap followed by a stylus hold, such as described in reference to FIGS. 10B-10D) but in this example, the third input is directed to a first location 1010 of the user interface 1002 within the first representation of the handwritten content 1004 (unlike FIGS. 10B-10D where the first input was directed to a location after the last words (e.g., “book her”) of the first representation of the handwritten content 1004).

In FIG. 10N, in accordance with a determination that the third input is directed to the first location 1010 of the user interface 1002 that is within the first representation of the handwritten content 1004 and before a first portion 1024 of the sequence of characters at the first location 1010 in the user interface 1002, the electronic device 500 updates displaying the first representation of the handwritten content 1004 to include the first portion 1024 of the sequence of characters at a second location 1020, different from the first location 1010, in the user interface 1002 that is adjacent to the first representation of the stored text 1012. Accordingly, in the embodiment illustrated, the insertion or pasting of the first representation of the stored text “ten-year-old” at the first location 1010 (e.g., after “by her”) moves or shifts the first portion 1024 (e.g., “sister on the bank . . . ”) of the sequence of characters to the right and/or down to the second location 1020 in order to accommodate the inserted or pasted text 1012 (e.g., “ten-year-old”).

As shown in FIG. 10N, the first visual appearance of the first representation of the stored text 1012 corresponds to one or more characteristics of the visual appearance of the first representation of handwritten content 1004 (e.g., a visual appearance of the inserted text 1012 matches characteristics of the first representation of the handwritten content 1004). For example, a size of the characters of the first representation of the stored text, a shape of the characters, an orientation of the characters, a spacing between the characters, a thickness of lines forming the characters, one or more stroke patterns used to form the characters of the stored text, and/or variations and/or patterns of any one of these characteristics included within the first representation of the stored text 1012, match those of the first representation of handwritten content 1004. In some embodiments, the first visual appearance of the first representation of the stored text 1012 matches the visual appearance of the first representation of handwritten content 1004 regardless of the visual appearance of the source text from which the stored text was transferred to the clipboard. Accordingly, the handwriting of the newly inserted or pasted handwritten text 1012 matches the handwriting of the first representation of handwritten content 1004 within which it is inserted.

Further, as shown in FIG. 10N, the first visual appearance of the first representation of the stored text 1012 is also based on a spatial distribution of one or more characters in the first representation of handwritten content 1004 relative to the user interface 1002. Accordingly, a spacing between lines of the first representation of the stored text 1012, an alignment of the lines of the first representation of the stored text 1012, and/or a width of a paragraph of the first representation of the stored text 1012, correspond to or match the spacing between corresponding lines of the first representation of handwritten content 1004, the alignment of the corresponding lines of the first representation of handwritten content 1004, and/or the width of a corresponding paragraph of the first of representation of handwritten content 1004. As a result, the first representation of the stored text 1012 matches a paragraph format of the first representation of handwritten content 1004.

FIG. 11 is a flowchart illustrating a method for pasting stored text on a user interface as handwritten text or font-based text based on the type of input in accordance with some embodiments. The method 1100 is optionally performed at an electronic device such as device 100, device 300, device 500, or device 580 as described above with reference to FIGS. 1A-1B, 2-3, 4A-4B, 5A-5C and 5I. Some operations in method 1100 are, optionally combined and/or order of some operations is, optionally, changed.

As described below, the method 1100 provides ways of facilitating pasting of portions of stored content into a representation of handwritten content. The method reduces the cognitive burden on a user when interacting with a user interface of the device of the disclosure, thereby creating a more efficient human-machine interface. For battery-operated electronic devices, increasing the efficiency of the user's interaction with the user interface conserves power and increases the time between battery charges.

In some embodiments, the method 1100 is performed at an electronic device (e.g., electronic device 500 in FIG. 10A) in communication with a display generation component and one or more input devices, such as touchscreen 504 in FIG. 10A. In some embodiments, the electronic device has one or more characteristics of the electronic device in methods 700 and/or 900. In some embodiments, the one or more input devices include a stylus in communication with the electronic device. In some embodiments, the one or more input devices have one or more characteristics of the one or more input devices in methods 700 and/or 900. In some embodiments, the touch-sensitive display generation component has one or more characteristics of display generation components in methods 700 and/or 900.

In some embodiments, while displaying, via the display generation component and in a user interface, a first representation of handwritten content (e.g., displayed in response to detecting handwritten input on a surface (e.g., a touch-sensitive surface of the one or more input devices), such as representation of handwritten content 1004 in user interface 1002 as shown in FIG. 10A, (in some embodiments, the handwritten content has one or more characteristics of the handwritten content discussed in method 700), the electronic device receives (1102a), via the one or more input devices, a first input corresponding to a request to insert stored text into the user interface, such as contact of stylus 1006 on the touchscreen 504 of the electronic device 500 as shown in FIG. 10B. For example, the user interface corresponds to a text composition user interface associated with a note-taking application, a messaging application, a journaling or scheduling application, a text-editor application, and/or a text annotation application, an image management application, a digital content management application, a drawing application, a presentation application, or any other region that can accept handwritten input. In some embodiments, the user interface includes a handwriting entry region configured to receive handwritten input (e.g., provided directly into the user interface region (e.g., the touch sensitive surface includes the user interface) or populated into the user interface by the electronic device after receiving the handwritten input via a separate touch-sensitive surface, such as a trackpad, in communication with the electronic device)). In some embodiments, the handwriting entry region optionally accepts drawing and/or displays drawing input, or handwritten input as drawing input. In some embodiments, the (optionally touch-sensitive) display generation component has one or more characteristics of display generation components in methods 700 and/or 900. In some embodiments, the user interface has one or more characteristics of the user interfaces in methods 700 and/or 900. In some embodiments, the first representation of handwritten content is displayed within the handwriting entry region discussed above. In some embodiments, the first representation of handwritten content corresponds to a representation of the handwritten input, which optionally includes representations of handwritten characters and/or words. The first representation of the handwritten content thus optionally includes handwritten characters, such as letters, words, numbers, special characters, and/or shapes that are recognized by the electronic device as handwritten content. In some embodiments, the first representation of handwritten content is displayed within the user interface in a first number of lines of characters, such as 1, 2, 3, 4, 5, 8, 10, or 12 lines, and optionally corresponds to the number of lines in which the handwritten words, numbers, and/or special characters were written in the handwritten input. In some embodiments, the handwritten characters correspond to a paragraph displayed in a first number of lines of characters and/or a paragraph having a first width (e.g., the first number of lines of characters extends a first distance (e.g. horizontally) across the user interface), which optionally corresponds to a width of a bounding box containing/confining the lines of the sequence of characters. In some embodiments, the handwritten characters correspond to a list (e.g., a bulleted list, a numbered list, or a lettered list) of words displayed in a first number of lines of words. In some embodiments, displaying the first representation of the first handwritten input has one or more characteristics of displaying a representation of handwritten input as discussed in methods 700 and/or 900. In some embodiments, as mentioned above, the first representation of handwritten content is displayed in the user interface in response to prior handwritten input received via an external device/tool for providing handwritten input (e.g., a stylus) or via a finger of a hand of a user of the electronic device. In some embodiments, the prior handwritten input includes continuous and/or subsequent strokes and/or contacts (e.g., provided by the stylus or finger of the user) detected on the touch sensitive surface that are recognized by the electronic device as handwritten input (e.g., handwritten words, numbers, special characters, and/or shapes), as discussed below. In some embodiments, the first representation of handwritten content represents prior handwritten input as provided by the user, such as described with reference to 900. For example, the first representation of handwritten content corresponds to a raw or accurate representation of the user's contacts and motions/strokes in the text entry region of the user interface, such as described with reference to 900. In some embodiments, the first representation of handwritten content is not font-based. In some embodiments, the stored text refers to text stored in a clipboard (e.g., a memory) of the electronic device. The stored text was optionally previously transferred to the clipboard using a cut and/or copy operation performed on source text displayed on the electronic device. The stored text was optionally copied and/or cut and/or transferred to the clipboard from a handwritten source text and/or from a font-based source text. In some embodiments, the source text was and/or is displayed on the user interface (e.g., concurrently with the first representation of handwritten content). For example, the source text copied to the clipboard as the stored text is a portion of the first representation of the handwritten content. In some embodiments, the source text was copied and/or cut and/or transferred to the clipboard from a source text that is no longer displayed on the electronic device. In some embodiments the stored text was transferred to the clipboard from the user interface of another application or a different tab, page, and/or file of the application associated with the user interface discussed above. In some embodiments, the stored text was transferred to the clipboard by an operation at the electronic device other than a copy and/or cut operation (e.g., such as via a verbal command or other operation). In some embodiments, the electronic device receives the first input via the one or more input devices previously described, such as a mouse, trackpad, remote control device, another mobile device, a handheld device, and/or a controller, or a set-top box in communication one or more input devices (e.g., a remote control). In some embodiments, the first input is received via a stylus and optionally includes a stylus gesture such as a stylus tap, swipe and/or squeeze. In some embodiments, the first input is received via a finger gesture such as a finger tap or swipe. In some embodiments, the first input is received via an interaction for an input device (e.g., a stylus) or a finger with the user interface such as a tap on a button or selection input (e.g., via a menu). In some embodiments, the first input includes a stylus or finger contact at a location of the text entry region of the user interface.

In some embodiments, in response to receiving the first input (1102b), in accordance with a determination that the first input is a first type of input, such as the stylus gesture directed to the stylus 1006 as described with reference to FIG. 10B, the electronic device displays (1102c) (e.g., using an AI process or a generative AI process), in the user interface, a first representation of the stored text as handwritten content in the user interface (e.g., automatically-generated text content and or generative text content), wherein the first representation of the stored text has a first visual appearance, such as the representation of stored text 1012 in FIG. 10E. The first type of input optionally includes a particular button or gesture or a sequence thereof received via the one or more input devices. For example, if the input device is a stylus, the first type of input is optionally a particular stylus gesture such as a stylus tap, swipe and/or squeeze. If the first input is received via a finger gesture, the first type of input is optionally a particular finger gesture such as a tap or a swipe. In some embodiments, the first type of input optionally includes a particular interaction of an input device (e.g., a stylus) or a finger with the user interface, such as a tap on a button or selection input (e.g., via a menu). The electronic device optionally inserts or displays (e.g., pastes) on the user interface the first representation of the stored text in response to receiving the first type of input. As previously described with reference to the first representation of handwritten content, the first representation of the stored text optionally includes representations of handwritten words. The first representation of the stored text thus optionally includes handwritten characters, such as letters, words, numbers, special characters, and/or shapes. The handwritten characters are optionally included regardless of whether the stored text is copied from handwritten content or font-based content, but first representation of the stored text optionally preserves (e.g., includes without modification) the content or substance of the stored text (e.g., the characters, words, phrases, sentences, and/or the sequence of the above in the stored text). In some embodiments, the first representation of the stored text is not font-based text. Accordingly, the first representation of the stored text optionally represents handwriting converted from a handwritten text and/or a font-based text as a source. As described with reference to the first representation of handwritten content, the first representation of the stored text is displayed within the user interface in a first number of lines of characters, such as 1, 2, 3, 4, 5, 8, 10, or 12 lines. In some embodiments, the handwritten characters correspond to a paragraph displayed in a first number of lines of characters and/or a paragraph having a first width (e.g., the first number of lines of characters extends a first distance (e.g. horizontally) across the user interface), which optionally corresponds to a width of a bounding box containing/confining the lines of the sequence of characters of the first representation of handwritten content. In some embodiments, the handwritten characters correspond to a list (e.g., a bulleted list, a numbered list, or a lettered list) of words displayed in a first number of lines of words. In some embodiments, displaying the first representation of the stored text has one or more characteristics of displaying a representation of handwritten input as discussed in methods 700 and/or 900. In some embodiments, the first representation of the stored text has a first visual appearance. In some embodiments, the first visual appearance includes a size of the characters of the first representation of the stored text, a shape of the characters, an orientation of the characters, a spacing between the characters, a thickness of lines forming the characters, one or more stroke patterns used to form the characters, and/or variations and/or patterns of any one of these characteristics included within the first representation of the stored text. In some embodiments, the first visual appearance optionally corresponds to one or more characteristics of the first representation of the handwritten content (e.g., the visual appearance of the inserted text matches characteristics of the first representation of the handwritten content). For example, a size of the characters of the first representation of the stored text, a shape of the characters, an orientation of the characters, a spacing between the characters, a thickness of lines forming the characters, one or more stroke patterns used to form the characters of the stored text, and/or variations and/or patterns of any one of these characteristics included within the first representation of the stored text, match those of the first representation of handwritten content. In some embodiments, a handwriting of the first representation of the stored text matches a handwriting of the first representation of handwritten content. The first visual appearance optionally corresponds to one or more characteristics of the first representation of the handwritten content when the stored text was copied from handwritten text (e.g., handwritten text displayed in the user interface or in the user interface of another application). In some embodiments, the first visual appearance corresponds to one or more characteristics of the first representation of the handwritten content when the stored text was copied from font-based text. Accordingly, the handwriting of the inserted text optionally matches the displayed text regardless of whether the inserted text was copied from another handwritten text having a different handwriting or font-based text. In some embodiments, the first visual characteristics optionally does not correspond to one or more characteristics of a font-based text. In some embodiments, the first visual appearance corresponds to one or more characteristics of a visual appearance defined according to a handwriting model of the electronic device, such as described above in reference to method 900 (e.g., the first handwriting model and/or the second handwriting).

In some embodiments, in accordance with a determination that the first input is a second type of input, different from the first type of input, such as selection of paste option 1016 provided by the stylus 1006 as shown in FIG. 10I, the electronic device displays (1102d), in the user interface, a second representation of the stored text as font-based text in the user interface, wherein the second representation of the stored text has a second visual appearance, different from the first visual appearance, such as the second representation of stored text 1018 in FIG. 10J. As described in reference to the first type of input, the second type of input includes a particular button or gesture or a sequence thereof, different from those of the first type of input, and received via the one or more input devices. For example, if the input device is a stylus, the second type of input is optionally a particular stylus gesture, such as a stylus tap, swipe and/or squeeze, different from those of the first type of input. If the first input is received via a finger gesture, the second type of input is optionally a particular finger gesture, such as a tap or a swipe, different from those of the first type of input. In some embodiments, the second type of input optionally includes a particular interaction of an input device (e.g., a stylus) or a finger with the user interface, such as a tap on a button or selection input (e.g., via a menu), different from those of the first type of input. The electronic device optionally inserts or displays (e.g., pastes) on the user interface the second representation of the stored text in response to receiving the second type of input. The second representation of the stored text displayed by the electronic device in the user interface optionally includes font-based text, optionally unlike the first representation of stored text discussed above. For example, the second representation of the stored text includes 12-point Times New Roman font (e.g., or other suitable font). In some embodiments, font-based text is 10-point sized, 12-point sized, etc. and optionally is Arial, Calibri, Times New Roman, etc. In some embodiments, the font-based text has the same size as a size of the first representation of handwritten content. In some embodiments, the second representation of the stored text has a second visual appearance. In some embodiments, the second visual appearance includes a size of the characters of the second representation of the stored text, a shape of the characters, an orientation of the characters, a spacing between the characters, a thickness of lines forming the characters, and/or variations and/or patterns of any one of these characteristics included within the second representation of the stored text. In some embodiments, the second visual appearance optionally corresponds to one or more characteristics of a font of the second representation of the stored text. In some embodiments, the second visual appearance optionally differs from (e.g., does not correspond to) characteristics of the first representation of handwritten content (e.g., the handwritten content displayed on the user interface before the insertion of the stored text). For example, a size of the characters of the second representation of the stored text, a shape of the characters, an orientation of the characters, a spacing between the characters, a thickness of lines forming the characters, and/or variations and/or patterns of any one of these characteristics included within the second representation of the stored text is different from corresponding characteristics of the first representation of handwritten content. Accordingly, in some embodiments, the inserted font-based text does not match characteristics of the displayed handwritten text. In some embodiments, the second visual appearance optionally does not correspond to one or more characteristics of a visual appearance defined by a handwriting model. In some embodiments, the visual appearance optionally corresponds to one or more characteristics of a font-based text that is based on handwriting (e.g., a font styled after or as handwriting). In some embodiments, the second visual appearance optionally corresponds to characteristics of a previous representation of the source text. In some embodiments, the second visual appearance optionally corresponds to characteristics of a previous representation of the source text from which the stored text was copied or transferred. For example, a size of the characters of the second representation of the stored text, a shape of the characters, an orientation of the characters, a spacing between the characters, a thickness of lines forming the characters, and/or variations and/or patterns of any one of these characteristics included within the second representation of the stored text optionally corresponds to one or more characteristics of the previous representation of the stored text (e.g., from which the stored text was copied). Accordingly, in some embodiments, the inserted font-based text optionally matches one or more characteristics the displayed source text (e.g., previously displayed or currently displayed) copied or transferred to memory as the stored text. Inserting or pasting stored text into handwritten content as handwritten text or font-based text based on input type simplifies the interaction between the user and the electronic device by reducing and/or minimizing the number of inputs required to convert inserted or pasted text to the desired format, and/or eliminates the need to handwrite font-based text or type handwritten text that the user wants to reproduce, which facilitates the use of the electronic device, simplifies the interaction between the user and the electronic device, enhances the operability of the electronic device and makes the user-device interface more efficient, which additionally reduces power usage and improves battery life of the electronic device by enabling the user to use the electronic device more quickly and efficiency.

In some embodiments, the stored text was copied from a font-based source text prior to receiving the first input, such as the representation of stored text 1012 optionally being copied from a font-based source text prior to the input provided by the stylus 1002 as described with reference to FIG. 10D. For example, the stored text optionally includes 12-point Times New Roman font (e.g., or other suitable font). In some embodiments, font-based text is 10-point sized, 12-point sized, etc. and optionally is Arial, Calibri, Times New Roman, etc. The stored text was optionally previously transferred to the clipboard (e.g., a memory associated with the electronic device and/or the user interface) using a cut and/or copy operation performed on source text displayed on the electronic device. The stored text was optionally copied and/or cut and/or transferred to the clipboard from a font-based source text. In some embodiments, the source text was and/or is displayed on the user interface (e.g., concurrently with the first representation of handwritten content). In some embodiments, the stored text was copied and/or cut and/or transferred to the clipboard from a font-based source text that is no longer displayed on the electronic device. In some embodiments, the source text was displayed by the electronic device on a previous instance of the display of the user interface, such as described in reference to method 900. In some embodiments the stored text was transferred to the clipboard from a font-based source text displayed on the user interface of another application (e.g., a web-browsing application, a document reader application, a text editing application, etc.) or a different tab, page, and/or file of the application associated with the user interface discussed above. In some embodiments, the stored text was transferred to the clipboard from the font-based source text by an operation at the electronic device other than a copy and/or cut operation (e.g., such as via a verbal command or other operation). Inserting or pasting stored text copied from font-based text into handwritten content as handwritten text or font-based text based on input type simplifies the interaction between the user and the electronic device by reducing and/or minimizing the number of inputs required to convert inserted or pasted text to the desired format, and/or eliminates the need to handwrite font-based text or type handwritten text that the user wants to reproduce, which facilitates the use of the electronic device, simplifies the interaction between the user and the electronic device, enhances the operability of the electronic device and makes the user-device interface more efficient, which additionally reduces power usage and improves battery life of the electronic device by enabling the user to use the electronic device more quickly and efficiency.

In some embodiments, the first visual appearance of the first representation of the stored text is different from a visual appearance of a source text to which the stored text corresponds, such as the visual appearance of the representation of stored text 1012 being different from a visual appearance of the corresponding source text as described with reference to FIG. 10E. For example, a size of the characters of the first representation of the stored text, a shape of the characters, an orientation of the characters, a spacing between the characters, a thickness of lines forming the characters, and/or variations and/or patterns of any one of these characteristics included within the first representation of the stored text is optionally different from corresponding characteristics of the representation of the source text. Accordingly, in some embodiments, the inserted handwritten text (e.g., the first representation of the stored text) optionally does not match and/or adhere to characteristics of the source text (e.g., because the inserted handwritten text matches and/or adheres to characteristics of the first representation of handwritten content). In some embodiments, the first representation of the stored text is a representation of handwritten text whereas the source text is font-based text. In some embodiments, the source text is handwritten text but of a different handwriting style and/or appearance than the first representation of the stored text. Displaying the inserted or pasted text with a visual appearance different from that of the source text in a user interface enables the electronic device to automatically match the visual appearance of the existing text with the inserted or pasted text, simplifies the interaction between the user and the electronic device by reducing and/or minimizing the number of inputs required to convert inserted or pasted text to the desired format, which facilitates the use of the electronic device, simplifies the interaction between the user and the electronic device, enhances the operability of the electronic device and makes the user-device interface more efficient, which additionally reduces power usage and improves battery life of the electronic device by enabling the user to use the electronic device more quickly and efficiency.

In some embodiments, the source text is font-based text, such as the source text of the representation of the stored text 1012 being font-based text as described with reference to FIG. 10D. For example, the source text optionally includes 12-point Times New Roman font (e.g., or other suitable font). In some embodiments, font-based text is 10-point sized, 12-point sized, etc. and optionally is Arial, Calibri, Times New Roman, etc. The source text was optionally previously transferred to the clipboard (e.g., a memory) as the stored text using a cut and/or copy operation performed on the source text displayed on the electronic device. In some embodiments, the font-based source text was and/or is displayed on the user interface (e.g., concurrently with the first representation of handwritten content). In some embodiments, the font-based source text that is no longer displayed on the electronic device. In some embodiments, the font-based source text was displayed by the electronic device on a previous instance of the display of the user interface, such as described in reference to method 900. Handwritten content). In some embodiments, the first visual appearance of the first representation of the stored text (e.g., the representation of the stored text inserted or pasted as handwritten text) is optionally different from a visual appearance of the font-based source text because the first representation of the stored text is handwritten text and not font-based text. In some embodiments, the second visual appearance of the second representation of the stored text (e.g., the representation of the stored text inserted or pasted as font-based text) is optionally different from a visual appearance of the font-based source text because the second representation of the stored text optionally includes a different font from the source text (e.g., Times New Roman for the inserted text and Arial for the source text), a different font size (e.g., 8-point sized font for the inserted text and 12-point sized font for the source text), a different formatting (e.g., normal for the inserted text and bold for the source text), among other characteristics. Inserting or pasting font-based text into handwritten content as handwritten text or font-based text based on input type simplifies the interaction between the user and the electronic device by reducing and/or minimizing the number of inputs required to convert inserted or pasted text to the desired format, and/or eliminates the need to handwrite font-based text or type handwritten text that the user wants to reproduce, which facilitates the use of the electronic device, simplifies the interaction between the user and the electronic device, enhances the operability of the electronic device and makes the user-device interface more efficient, which additionally reduces power usage and improves battery life of the electronic device by enabling the user to use the electronic device more quickly and efficiency.

In some embodiments, the first visual appearance of the first representation of the stored text corresponds to a visual appearance of the first representation of handwritten content, such as the visual appearance of the representation of stored text 1012 corresponding to (e.g., matching) a visual appearance of the representation of handwritten content 1004 as described with reference to FIG. 10E. As previous described, in some embodiments, the first representation of the stored text has a first visual appearance. In some embodiments, the first visual appearance optionally corresponds to one or more characteristics of the first representation of the handwritten content (e.g., the visual appearance of the inserted text matches and/or adheres to characteristics of the first representation of the handwritten content). In some embodiments, a handwriting of the first representation of the stored text matches a handwriting of the first representation of handwritten content. The first visual appearance optionally corresponds to one or more characteristics of the first representation of the handwritten content when the stored text was copied from handwritten source text (e.g., handwritten text displayed in the user interface or in the user interface of another application). In some embodiments, the first visual appearance corresponds to one or more characteristics of the first representation of the handwritten content when the stored text was copied from font-based source text. Accordingly, the handwriting of the inserted text optionally matches the displayed text regardless of whether the inserted text was copied from another handwritten source text having a different handwriting or a font-based source text. In some embodiments, the first visual appearance corresponds to one or more characteristics of a visual appearance defined according to a handwriting model of the electronic device, such as described above in reference to method 900 (e.g., the first handwriting model and/or the second handwriting). Matching the inserted or pasted text to the handwritten content into which the text is inserted or pasted simplifies the interaction between the user and the electronic device by reducing and/or minimizing the number of inputs required to convert inserted or pasted text to the desired format, and/or eliminates the need to handwrite font-based text or type handwritten text that the user wants to reproduce, which facilitates the use of the electronic device, simplifies the interaction between the user and the electronic device, enhances the operability of the electronic device and makes the user-device interface more efficient, which additionally reduces power usage and improves battery life of the electronic device by enabling the user to use the electronic device more quickly and efficiency.

In some embodiments, the first visual appearance of the first representation of the stored text is based on (e.g., matches) one or more characteristics of one or more characters in the first representation of handwritten content, such as one or more visual characteristics of the characters in the representation of stored text 1012 corresponding to (e.g., matching) one or more visual characteristics of the characters in the representation of handwritten content 1004 in FIG. 10E. For example, a size of the characters of the first representation of the stored text, a shape of the characters, an orientation of the characters, a color of the characters, a spacing between the characters, a thickness of lines forming the characters, one or more stroke patterns used to form the characters of the stored text, and/or variations and/or patterns of any one of these characteristics included within the first representation of the stored text, match those of the first representation of handwritten content. In some embodiments, matching characteristics of one or more characters has one or more characteristics of matching characteristics of characters as discussed in methods 700 and/or 900. Matching the inserted or pasted text to the handwritten content into which the text is inserted or pasted simplifies the interaction between the user and the electronic device by reducing and/or minimizing the number of inputs required to convert inserted or pasted text to the desired format, and/or eliminates the need to handwrite font-based text or type handwritten text that the user wants to reproduce, which facilitates the use of the electronic device, simplifies the interaction between the user and the electronic device, enhances the operability of the electronic device and makes the user-device interface more efficient, which additionally reduces power usage and improves battery life of the electronic device by enabling the user to use the electronic device more quickly and efficiency.

In some embodiments, the first visual appearance of the first representation of the stored text is based on a spatial distribution of one or more characters in the first representation of handwritten content relative to the user interface, such as a spacing between adjacent characters in the representation of stored text 1012 corresponding to (e.g., matching) a spacing between adjacent characters in the representation of handwritten content 1004 in FIG. 10E. As previously described, the first representation of handwritten content is displayed within the user interface in a first number of lines of characters, such as 1, 2, 3, 4, 5, 8, 10, or 12 lines, and optionally corresponds to the number of lines in which the handwritten words, numbers, and/or special characters were written in the handwritten input. In some embodiments, the handwritten characters correspond to a paragraph displayed in a first number of lines of characters and/or a paragraph having a first width (e.g., the first number of lines of characters extends a first distance (e.g. horizontally) across the user interface), which optionally corresponds to a width of a bounding box containing/confining the lines of the sequence of characters. In some embodiments, the handwritten characters correspond to a list (e.g., a bulleted list, a numbered list, or a lettered list) of words displayed in a first number of lines of words. In some embodiments, the spatial distribution of the one or more characters in the first representation of handwritten content include a spacing between lines of the first representation of handwritten content, an alignment of the lines of the first representation of handwritten content, and/or a width of a paragraph of the first representation of handwritten content. Accordingly, in some embodiments, a spacing between lines of the first representation of the stored text, an alignment of the lines of the first representation of the stored text, and/or a width of a paragraph of the first representation of the stored text, optionally correspond to or match the spacing between corresponding lines of the first representation of handwritten content, the alignment of the corresponding lines of the first representation of handwritten content, and/or the width of a corresponding paragraph of the first of representation of handwritten content. In some embodiments, in accordance with a determination that a spatial arrangement of the first representation of handwritten content is a first spatial arrangement, a corresponding spatial arrangement of the first representation of the stored text is (e.g., matches and/or is equal to) the first spatial arrangement and, in accordance with a determination that the spatial arrangement of the first representation of handwritten content is a second spatial arrangement, different from the first spatial arrangement, the corresponding spatial arrangement of the first representation of the stored text (e.g., matches and/or is equal to) the second spatial arrangement. Matching the inserted or pasted text to the handwritten content into which the text is inserted or pasted simplifies the interaction between the user and the electronic device by reducing and/or minimizing the number of inputs required to convert inserted or pasted text to the desired format, and/or eliminates the need to handwrite font-based text or type handwritten text that the user wants to reproduce, which facilitates the use of the electronic device, simplifies the interaction between the user and the electronic device, enhances the operability of the electronic device and makes the user-device interface more efficient, which additionally reduces power usage and improves battery life of the electronic device by enabling the user to use the electronic device more quickly and efficiency.

In some embodiments, the first type of input is input provided by an input device in communication with the electronic device, such as the stylus 1006 in FIG. 10B. In some embodiments, the one or more input devices have one or more characteristics of the one or more input devices in methods 700 and/or 900. In some embodiments, the one or more input devices include a stylus in communication with the electronic device. In some embodiments, the electronic stylus is communicatively coupled to the electronic device, either via a wired or wireless communication link, and is configured to provide inputs to the electronic device. For instance, the electronic stylus optionally includes one or more components that are configured to allow the electronic device to detect when the electronic stylus is touching the display generation component or is otherwise in near proximity (e.g., within a threshold distance such as 0, 0.01, 0.05, 0.1, 0.2, 0.5, 0.8, 1, 3, 5, 10, 30, 50 or 100 cm) to the electronic device, a screen of the electronic device (e.g., the display generation component), and/or from the displayed user interface that the electronic stylus is interacting with. In some embodiments, the first type of input is a stylus tap. In some embodiments, the first type of input is a finger tap. In some embodiments, the first type of input is directed to the text-entry region of the user interface discussed above. Inserting or pasting stored text into handwritten content in response to detecting input provided with the electronic stylus simplifies the interaction between the user and the electronic device by enabling the insertion of stored text using the same device used to provide handwritten input, which facilitates the use of the electronic device, simplifies the interaction between the user and the electronic device, enhances the operability of the electronic device and makes the user-device interface more efficient, which additionally reduces power usage and improves battery life of the electronic device by enabling the user to use the electronic device more quickly and efficiency.

In some embodiments, the first representation of handwritten content is located in a text-entry region of the user interface, such as the text-entry region of user interface 1002 in FIG. 10A, and the first type of input includes contact of the input device on a surface directed to the text-entry region for at least a threshold duration, such as the stylus 1006 being in contact with the touchscreen 504 for a threshold duration as described with reference to FIG. 10C. In some embodiments, the electronic device detects the input device on the surface without detecting liftoff of the input device from the surface for a least a threshold duration such as 0.1, 0.2, 0.3, 0.5, 0.8, 1 second (e.g., contact of the input device on the surface is maintained for at least that duration). In some embodiments, the first type of input is a stylus contact held on the surface for at least the threshold duration. In some embodiments, the first type of input is a finger contact held on the surface for at least the threshold duration. In some embodiments, if the electronic device detects contact of an object other than a stylus or a finger on the surface without detecting liftoff of the object from the surface for a least a threshold duration, the first input is not the first type of input. In some embodiments, if the electronic device detects contact of an object other than a stylus or a finger on the surface without detecting liftoff of the object from the surface for a least a threshold duration, the first input is the second type of input. In some embodiment, the surface on which the electronic device detects contact of the input device optionally includes a touch-sensitive surface (e.g., of the display generation component and/or of the one or more input devices), a touchscreen, a surface of a trackpad, etc. In some embodiments, the contact of the input device is optionally directed to a first location on the user interface (e.g., the electronic device detects the input device at the first location on the user interface), and the electronic device displays the first representation of the stored text at the first location on the user interface. In some embodiments, the electronic device optionally displays on the user interface the first representation of the stored text at a location where the electronic device has detected the first type of input in response to which the electronic device is displaying the first representation of the stored text. Inserting or pasting stored text into handwritten content as handwritten text using a stylus or finger tap and hold gesture simplifies the interaction between the user and the electronic device by reducing and/or minimizing the number of inputs required to convert inserted or pasted text to the desired format, and/or eliminates the need to handwrite font-based text or type handwritten text that the user wants to reproduce, which facilitates the use of the electronic device, simplifies the interaction between the user and the electronic device, enhances the operability of the electronic device and makes the user-device interface more efficient, which additionally reduces power usage and improves battery life of the electronic device by enabling the user to use the electronic device more quickly and efficiency.

In some embodiments, the first representation of handwritten content is located in a text-entry region of the user interface, and the second type of input includes contact of an object (e.g., an input device, finger of the user, or other object) in communication with the electronic device on a surface directed to the text-entry region, such as contact of the stylus 1006 on the touchscreen 504 as shown in FIG. 10G, followed by a selection of a paste option displayed in the user interface, such as selection of paste option 1016 as shown in FIG. 10H. In some embodiments, the input device corresponds to the input device (e.g., stylus) described above. In some embodiments, the second type of input includes the electronic device detecting contact of the object on the surface and detecting liftoff of the object from the surface before a threshold duration such as 0.1, 0.2, 0.3, 0.5, 0.8, 1 second (e.g., contact of the object on the surface is maintained for less than that duration). In some embodiments, the second type of input includes a stylus contact held on the surface for less than the threshold duration. In some embodiments, the second type of input includes a finger contact held on the surface for less than the threshold duration. In some embodiments, the surface corresponds to the surface (e.g., touch-sensitive surface) described above. In some embodiments, in response to the contact of the input device on the surface directed to the text entry region, the electronic device optionally displays the paste option as a selectable option on the user interface. In some embodiments, the paste option is optionally displayed in a pop-up window (e.g., a toolbar) that the electronic device displays in the user interface in response to detecting the contact directed to the surface of the text entry region. In some embodiments, the pop up window including the paste option is optionally displayed adjacent to the point of contact of the input device in the user interface. In some embodiments, the selection of the paste option includes contact of the input device (e.g., stylus or finger of the user) on the surface directed to the paste option (e.g., tap of the paste option in the user interface (e.g., in the pop up window)). Inserting or pasting stored text into handwritten content as handwritten text using a stylus or finger tap followed by a paste selection simplifies the interaction between the user and the electronic device by reducing and/or minimizing the number of inputs required to convert inserted or pasted text to the desired format, and/or eliminates the need to handwrite font-based text or type handwritten text that the user wants to reproduce, which facilitates the use of the electronic device, simplifies the interaction between the user and the electronic device, enhances the operability of the electronic device and makes the user-device interface more efficient, which additionally reduces power usage and improves battery life of the electronic device by enabling the user to use the electronic device more quickly and efficiency.

In some embodiments, the first representation of handwritten content comprises a sequence of characters, such as the representation of handwritten content 1004 including a sequence of handwritten characters as shown in FIG. 10A. In some embodiments, in response to receiving the first input, in accordance with a determination that the first input is directed to a location of the user interface that is within the first representation of the handwritten content and before a first portion of the sequence of characters at a first location in the user interface, the electronic device updates displaying the first representation of the handwritten input to include the first portion of the sequence of characters at a second location, different from the first location, in the user interface that is adjacent to the first representation of the stored text. In some embodiments, the first portion of the sequence of characters corresponds to one or more characters and/or one or more words and/or one or more sentences, and/or various combinations of characters, words, and sentences. For example, displaying the first representation of the stored text in the first representation of handwritten content causes the electronic device to shift/move the first portion of the sequence of characters to the right and/or down in the user interface to accommodate the first representation of the stored text (e.g., a length and/or size of inserted words, numbers, special characters, and/or shapes), which optionally causes the electronic device to also increase the number of lines in which the sequence of characters is displayed. In some embodiments, the first representation of the stored text comprises a sequence of characters and the last character of the first representation of the stored text is followed by the first character of the first portion of the sequence of characters at the second location. In some embodiments, updating display of the first representation of the handwritten content to include the first portion of the sequence of characters at the second location in the user interface (and optionally additionally moving other portions of the first representation of the handwritten content to create space for the first representation of the stored text) has one or more characteristics of updating display of representations of handwritten content with respect to movement of sequences of characters as described in methods 700 and/or 900. Moving the displayed text after pasting the stored text simplifies the interaction between the user and the electronic device by reducing and/or minimizing the number of inputs required to insert the stored text without deleting a portion of the existing text and/or reduces and/or minimizes the number of inputs needed to move the existing text after inserting the stored text, which facilitates the use of the electronic device, simplifies the interaction between the user and the electronic device, enhances the operability of the electronic device and makes the user-device interface more efficient, which additionally reduces power usage and improves battery life of the electronic device by enabling the user to use the electronic device more quickly and efficiency.

It should be understood that the particular order in which the operations in FIG. 11 have been described, optionally including the additional and/or alternatives operations to the illustrated operations in FIG. 11 described herein, is merely exemplary and is not intended to indicate that the described order is the only order in which the operations could be performed. One of ordinary skill in the art would recognize various ways to reorder the operations described herein.

The operations in the information processing methods described above are, optionally, implemented by running one or more functional modules in an information processing apparatus such as general purpose processors (e.g., as described with respect to FIGS. 1A-1B, 3, 5A-5I) or application specific chips. Further, the operations described above with reference to FIG. 11 are, optionally, implemented by components depicted in FIGS. 1A-1B. For example, displaying operations 1102c and 1102d, and receiving operation 1102a, are, optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

It should be understood that the particular order in which the operations in methods 700, 900, and/or 1100 have been described is merely exemplary and is not intended to indicate that the described order is the only order in which the operations could be performed. One of ordinary skill in the art would recognize various ways to reorder the operations described herein. In some embodiments, aspects/operations of methods 700, 900, and/or 1100 may be interchanged, substituted, and/or added between these methods. For example, the user interfaces in methods 700, 900, and/or 1100, the representations of handwritten content in methods 700, 900, and/or 1100, and/or the interactions with the user interfaces and/or the representations of handwritten content in methods 700, 900, and/or 1100 are optionally interchanged, substituted, and/or added between these methods. For brevity, these details are not repeated here.

Some embodiments described herein can include use of artificial intelligence and/or machine learning systems (sometimes referred to herein as the AI/ML systems). The use can include collecting, processing, labeling, organizing, analyzing, recommending and/or generating data. Entities that collect, share, and/or otherwise utilize user data should provide transparency and/or obtain user consent when collecting such data. The present disclosure recognizes that the use of the data in the AI/ML systems can be used to benefit users. For example, the data can be used to train models that can be deployed to improve performance, accuracy, and/or functionality of applications and/or services. Accordingly, the use of the data enables the AI/ML systems to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the AI/ML systems are also contemplated by the present disclosure.

The present disclosure contemplates that, in some embodiments, data used by AI/ML systems includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with AI/ML systems, should attempt to comply with well-established privacy policies and/or privacy practices.

For example, such entities may implement and consistently follow policies and practices recognized as meeting or exceeding industry standards and regulatory requirements for developing and/or training AI/ML systems. In doing so, attempts should be made to ensure all intellectual property rights and privacy considerations are maintained. Training should include practices safeguarding training data, such as personal information, through sufficient protections against misuse or exploitation. Such policies and practices should cover all stages of the AI/ML systems development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes. User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Further, such entities should subject themselves to evaluation by third parties to certify, as appropriate for transparency purposes, their adherence to widely accepted privacy policies and practices. In addition, policies and/or practices should be adapted to the particular type of data being collected and/or accessed and tailored to a specific use case and applicable laws and standards, including jurisdiction-specific considerations.

In some embodiments, AI/ML systems may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In other implementations, the training of the model can be performed using one or more other devices (e.g., server(s)) in addition to the user device but done in a privacy preserving manner, e.g., via multi-party computation as may be done cryptographically by secret sharing data or other means so that the user data is not leaked to the other devices.

In some embodiments, the trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior of the user or the device may not be leaked, while taking advantage of increased computational resources of the other devices to train and execute the ML model. Accordingly, user-collected data can be protected. In some implementations, data from multiple devices can be combined in a privacy-preserving manner to train an ML model.

In some embodiments, the present disclosure contemplates that data used for AI/ML systems may be kept strictly separated from platforms where the AI/ML systems are deployed and/or used to interact with users and/or process data. In such embodiments, data used for offline training of the AI/ML systems may be maintained in secured datastores with restricted access and/or not be retained beyond the duration necessary for training purposes. In some embodiments, the AI/ML systems may utilize a local memory cache to store data temporarily during a user session. The local memory cache may be used to improve performance of the AI/ML systems. However, to protect user privacy, data stored in the local memory cache may be erased after the user session is completed. Any temporary caches of data used for online learning or inference may be promptly erased after processing. All data collection, transfer, and/or storage should use industry-standard encryption and/or secure communication.

In some embodiments, as noted above, techniques such as federated learning, differential privacy, secure hardware components, homomorphic encryption, and/or multi-party computation among other techniques may be utilized to further protect personal information data during training and/or use of the AI/ML systems. The AI/ML systems should be monitored for changes in underlying data distribution such as concept drift or data skew that can degrade performance of the AI/ML systems over time.

In some embodiments, the AI/ML systems are trained using a combination of offline and online training. Offline training can use curated datasets to establish baseline model performance, while online training can allow the AI/ML systems to continually adapt and/or improve. The present disclosure recognizes the importance of maintaining strict data governance practices throughout this process to ensure user privacy is protected.

In some embodiments, the AI/ML systems may be designed with safeguards to maintain adherence to originally intended purposes, even as the AI/ML systems adapt based on new data. Any significant changes in data collection and/or applications of an AI/ML system use may (and in some cases should) be transparently communicated to affected stakeholders and/or include obtaining user consent with respect to changes in how user data is collected and/or utilized.

Despite the foregoing, the present disclosure also contemplates embodiments in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In another example, the present technology should be configured to allow users to select not to provide certain data for training the AI/ML systems and/or for use as input during the inference stage of such systems. In yet another example, the present technology should be configured to allow users to be able to select to limit the length of time data is maintained or entirely prohibit the use of their data for use by the AI/ML systems. In addition to providing “opt in” and “opt out” options, the present disclosure contemplates providing notifications relating to the access or use of personal information. For instance, a user can be notified when their data is being input into the AI/ML systems for training or inference purposes, and/or reminded when the AI/ML systems generate outputs or make decisions based on their data.

The present disclosure recognizes AI/ML systems should incorporate explicit restrictions and/or oversight to mitigate against risks that may be present even when such systems having been designed, developed, and/or operated according to industry best practices and standards. For example, outputs may be produced that could be considered erroneous, harmful, offensive, and/or biased; such outputs may not necessarily reflect the opinions or positions of the entities developing or deploying these systems. Furthermore, in some cases, references to third-party products and/or services in the outputs should not be construed as endorsements or affiliations by the entities providing the AI/ML systems. Generated content can be filtered for potentially inappropriate or dangerous material prior to being presented to users, while human oversight and/or ability to override or correct erroneous or undesirable outputs can be maintained as a failsafe.

The present disclosure further contemplates that users of the AI/ML systems should refrain from using the services in any manner that infringes upon, misappropriates, or violates the rights of any party. Furthermore, the AI/ML systems should not be used for any unlawful or illegal activity, nor to develop any application or use case that would commit or facilitate the commission of a crime, or other tortious, unlawful, or illegal act. The AI/ML systems should not violate, misappropriate, or infringe any copyrights, trademarks, rights of privacy and publicity, trade secrets, patents, or other proprietary or legal rights of any party, and appropriately attribute content as required. Further, the AI/ML systems should not interfere with any security, digital signing, digital rights management, content protection, verification, or authentication mechanisms. The AI/ML systems should not misrepresent machine-generated outputs as being human-generated.

As described above, one aspect of the present technology is tracking and displaying content. The present disclosure contemplates that in some instances, the data utilized may include personal information data that uniquely identifies or can be used to contact or locate a specific person. Such personal information data can include demographic data, content consumption activity, location-based data, telephone numbers, email addresses, twitter ID's, home addresses, data relating to a person's likeness, name, date of birth, or any other identifying or personal information.

The present disclosure recognizes that the use of such personal information data, in the present technology, can be used to the benefit of users. For example, facilitating manipulation of handwritten content can enhance interactions with the electronic device. Accordingly, use of such personal information data enables users to use electronic devices to perform enhanced manipulation of handwritten content. Further, other uses for personal information data that benefit the user are also contemplated by the present disclosure. For instance, analyzing a user's handwriting may enhance conversion of handwritten input.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of location services, the present technology can be configured to allow users to select to “opt in” or “opt out” of participation in the collection of personal information data during registration for services or anytime thereafter. In another example, users can select not to enable recording of personal information data in a specific application (e.g., first application and/or second application). In addition to providing “opt in” and “opt out” options, the present disclosure contemplates providing notifications relating to the access or use of personal information. For instance, a user may be notified upon initiating content collection that their personal information data will be accessed and then reminded again just before personal information data is accessed by the device(s).

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, an electronic device generated generative visual media content without associating the content with personal user data.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

1. A method comprising:
at an electronic device in communication with a display generation component and one or more input devices:
while displaying, in a user interface, a first representation of handwritten content that includes a sequence of characters, detecting, via the one or more input devices, a first input corresponding to a request to delete a first portion of the sequence of characters of the first representation of handwritten content, wherein the first portion of the sequence of characters is displayed at a first location in the user interface; and
in response to detecting the first input:
deleting, at the first location in the user interface, the first portion of the sequence of characters of the first representation of the handwritten content;
in accordance with a determination that a second input that includes first handwritten input on a surface directed to at least the first location in the user interface is not detected via the one or more input devices within a threshold amount of time of deleting the first portion of the sequence of characters:
updating display of the first representation of handwritten content to include a second portion, different from the first portion, of the sequence of characters at the at least the first location in the user interface; and
in accordance with a determination that the second input is detected within the threshold amount of time of deleting the first portion of the sequence of characters:
updating display of the first representation of handwritten content to include a first representation of the first handwritten input at the at least the first location in the user interface, without updating display of the first representation of handwritten content to include the second portion of the sequence of characters at the at least the first location in the user interface.

2. The method of claim 1, wherein the first input corresponding to the request to delete the first portion of the sequence of characters of the first representation of handwritten content includes:
one or more handwritten marks provided by an input device in communication with the electronic device on the surface directed to the first portion of the sequence of characters; and
contact of the input device on the surface for at least a second threshold amount of time.

3. The method of claim 2, further comprising:
while displaying the first representation of handwritten content that includes the sequence of characters, detecting, via the one or more input devices, a second input directed to a respective portion, different from the first portion, of the sequence of characters, wherein the second input includes one or more handwritten marks provided by the input device on the surface, without contact of the input device on the surface for at least the second threshold amount of time; and
in response to detecting the second input:
in accordance with a determination that the respective portion of the sequence of characters corresponds to handwritten text, displaying, in the user interface, a representation of the one or more handwritten marks concurrently with the first representation, without deleting the respective portion of the sequence of characters; and
in accordance with a determination that the respective portion of the sequence of characters corresponds to font-based text, deleting the respective portion of the sequence of characters.

4. The method of claim 1, further comprising:
while displaying the first representation of handwritten content that includes the sequence of characters, detecting, via the one or more input devices, a third input corresponding to a request to delete a respective portion, different from the first portion, of the sequence of characters of the first representation of handwritten content, wherein the respective portion of the sequence of characters is displayed at a second location, different from the first location, in the user interface, and wherein the third input includes:
selection of the respective portion of the sequence of characters; and
selection of a first option that is displayed in the user interface in response to the selection of the respective portion of the sequence of characters; and
in response to detecting the third input:
deleting, at the second location in the user interface, the respective portion of the sequence of characters of the first representation of the handwritten content; and
updating display of the first representation of handwritten content to include a third portion, different from the respective portion, of the sequence of characters at the at least the second location in the user interface.

5. The method of claim 1, wherein the sequence of characters is displayed in a plurality of lines in the user interface, and the first location of the first portion of the sequence of characters corresponds to a first line of the plurality of lines, the method further comprising:
in response to detecting the first input:
in accordance with a determination that updating display of the first representation of handwritten content to include the first representation of the first handwritten input at the at least the first location in the user interface in accordance with the determination that the second input is detected within the threshold amount of time of deleting the first portion of the sequence of characters causes a respective portion of the sequence of characters in the first line to extend beyond a boundary of the first line:
updating display of the first representation of handwritten content to include at least a portion of the respective portion in a second line, different from the first line, in the user interface.

6. The method of claim 1, wherein the sequence of characters of the first representation of handwritten content includes a first group of characters in a first region of the user interface and a second group, different from the first group, of characters in a second region, different from the first region, of the user interface, the method further comprising:
while displaying the first representation of handwritten content that includes the sequence of characters, detecting, via the one or more input devices, a third input corresponding to a request to delete at least a third region, different from the first region and the second region, in the user interface, wherein the third region does not include a portion of the sequence of characters of the first representation of handwritten content; and
in response to detecting the third input:
forgoing updating display of the first representation of handwritten content to include at least a portion of the second group of characters in the first region of the user interface.

7. The method of claim 1, wherein:
the first input corresponding to the request to delete the first portion of the sequence of characters of the first representation of handwritten content includes one or more handwritten marks provided by an input device in communication with the electronic device directed to the first portion of the sequence of characters;
in accordance with a determination that one or more characteristics of the one or more handwritten marks have one or more first values, the first portion of the sequence of characters is a first amount of the first representation of handwritten content; and
in accordance with a determination that the one or more characteristics of the one or more handwritten marks have one or more second values, different from the one or more first values, the first portion of the sequence of characters is a second amount, different from the first amount, of the first representation of handwritten content.

8. The method of claim 7, wherein:
the determination that the one or more characteristics of the one or more handwritten marks have the one or more first values is in accordance with a determination that the one or more handwritten marks satisfy one or more first criteria, including a criterion that is satisfied when the one or more handwritten marks overlap with the first amount of the first representation of handwritten content, and a criterion that is satisfied based on one or more lengths or one or more velocities of the one or more handwritten marks; and
the determination that the one or more characteristics of the one or more handwritten marks have the one or more second values is in accordance with a determination that the one or more handwritten marks satisfy one or more second criteria, including a criterion that is satisfied when the one or more handwritten marks overlap with the second amount of the first representation of handwritten content, and a criterion that is satisfied based on one or more lengths or one or more velocities of the one or more handwritten marks.

9. The method of claim 7, wherein:
the determination that the one or more characteristics of the one or more handwritten marks have the one or more first values is in accordance with a determination that the one or more handwritten marks satisfy one or more first criteria, including a criterion that is satisfied when the one or more handwritten marks at least partially overlap with the first amount of the first representation of handwritten content, and a criterion that is satisfied based on one or more lengths or one or more velocities of the one or more handwritten marks; and
the determination that the one or more characteristics of the one or more handwritten marks have the one or more second values is in accordance with a determination that the one or more handwritten marks satisfy one or more second criteria, including a criterion that is satisfied when the one or more handwritten marks at least partially overlap with the second amount of the first representation of handwritten content, and a criterion that is satisfied based on one or more lengths or one or more velocities of the one or more handwritten marks.

10. The method of any of claim 1, further comprising:
while displaying the first representation of handwritten content that includes the sequence of characters, detecting, via the one or more input devices, a third input provided by an input device in communication with the electronic device directed to a respective location in the user interface corresponding to a respective portion of the first representation of handwritten content, wherein the third input is a first type of input; and
in response to detecting the third input:
displaying, via the display generation component, a cursor at the respective location in the user interface.

11. The method of claim 10, further comprising:
after displaying the cursor at the respective location in the user interface, detecting, via the one or more input devices, termination of the third input provided by the input device; and
in response to detecting the termination of the third input:
updating display of the first representation of handwritten content to include a blank space in at least the respective location in the user interface.

12. The method of claim 10, further comprising:
after displaying the cursor at the respective location in the user interface, detecting, via the one or more input devices, movement of the input device relative to the respective location in the user interface; and
in response to detecting the movement of the input device:
updating display of the first representation of handwritten content to include a blank space in at least the respective location in the user interface, wherein one or more characteristics of the blank space are based on the movement of the input device relative to the respective location.

13. The method of claim 12, wherein the sequence of characters is displayed in a plurality of lines in the user interface, and the respective location of the respective portion of the first representation of handwritten content corresponds to a first line of the plurality of lines, the method further comprising:
in response to detecting the movement of the input device:
in accordance with a determination that the movement of the input device is in a first direction relative to the respective location and updating display of the first representation of handwritten content to include the blank space in the at least the respective location in the user interface causes a first respective portion of the sequence of characters in the first line to extend beyond a boundary of the first line:
updating display of the first representation of handwritten content to include the first respective portion in a second line, following the first line, in the user interface.

14. The method of claim 12, wherein the sequence of characters is displayed in a plurality of lines in the user interface, and the respective location of the respective portion of the first representation of handwritten content corresponds to a first line of the plurality of lines, the method further comprising:
in response to detecting the movement of the input device:
in accordance with a determination that the movement of the input device is in a second direction relative to the respective location and updating display of the first representation of handwritten content to include the blank space in the at least the respective location in the user interface causes a first respective portion of the sequence of characters in the first line to extend beyond a boundary of the first line:
updating display of the first representation of handwritten content to include the first respective portion in a second line, preceding the first line, in the user interface.

15. The method of claim 12, wherein updating display of the first representation of handwritten content to include the blank space in the at least the respective location in the user interface includes moving a subset of characters of the sequence of characters relative to the respective location according to a spring-based model in the user interface.

16. The method of claim 1, wherein updating display of the first representation of handwritten content to include the second portion of the sequence of characters at the at least the first location in the user interface includes moving the second portion of the sequence of characters to the at least the first location in the user interface, including:
in accordance with a determination that one or more characteristics of the first representation of handwritten content have one or more first values, moving the second portion in a first manner in the user interface; and
in accordance with a determination that the one or more characteristics of the first representation of handwritten content have one or more second values, different from the one or more first values, moving the second portion in a second manner, different from the first manner, in the user interface.

17. The method of claim 1, wherein the sequence of characters is displayed in a plurality of lines in the user interface, and the first location of the first portion of the sequence of characters corresponds to a first line of the plurality of lines, the method further comprising:
after updating display of the first representation of handwritten content to include the first representation of the first handwritten input at the at least the first location in the user interface in accordance with the determination that the second input is detected within the threshold amount of time of deleting the first portion of the sequence of characters:
in accordance with a determination that the first representation of the first handwritten input has a first size in the first line in the user interface, moving a respective portion of the sequence of characters a first distance relative to the at least the first location in the user interface; and
in accordance with a determination that the first representation of the first handwritten input has a second size, different from the first size, in the first line in the user interface, moving the respective portion of the sequence of characters a second distance, different from the first distance, relative to the at least the first location in the user interface.

18. The method of claim 1, wherein the sequence of characters is displayed in a plurality of lines in the user interface, the method further comprising:
while displaying the first representation of handwritten content that includes the sequence of characters, detecting, via the one or more input devices, a third input directed to a respective location in the user interface that includes a third portion of the sequence of words of the first representation of handwritten content, wherein the respective location of the third portion of the sequence of characters corresponds to a first line of the plurality of lines;
in response to detecting the third input, displaying, in the user interface, one or more graphical user interface elements for changing one or more metrics associated with a boundary of the first representation of handwritten content, wherein the one or more metrics include a size of the boundary of the first representation of handwritten content;
while displaying the one or more graphical user interface elements, detecting, via the one or more input devices, a third input that includes movement of a first graphical user interface element of the one or more graphical user interface elements in a first direction; and
in response to detecting the third input:
changing the size of the size of the boundary based on the movement of the first graphical user interface element in the first direction; and
in accordance with a determination that changing the size of the boundary in the user interface does not cause an aspect ratio of the first representation of handwritten content to change in the user interface, changing the size of the sequence of characters in the user interface based on the change in the size of the boundary, while maintaining display of the first representation of handwritten content to include the third portion in the first line in the user interface.

19. The method of claim 18, further comprising:
in response to detecting the third input:
in accordance with a determination that the changing the size of the boundary of the first representation of handwritten content in the user interface causes the aspect ratio of the first representation of handwritten content to change in the user interface, changing the size of the sequence of characters in the user interface based on the change in the size of the boundary and updating display of the first representation of handwritten content to include the third portion in a second line, different from the first line, in the user interface.

20. The method of claim 1, further comprising:
while displaying the first representation of handwritten content that includes the sequence of characters, detecting, via the one or more input devices, a third input directed to a respective location in the user interface that includes a third portion of the sequence of characters of the first representation of handwritten content;
in response to detecting the third input:
in accordance with a determination that the third input includes a first number of taps of a contact on the surface directed to the third portion of the sequence of characters, displaying, in the user interface, one or more graphical user interface elements for changing one or more metrics associated with the sequence of characters.

21. The method of claim 20, further comprising:
in response to detecting the third input:
in accordance with a determination that the third input includes a second number, greater than the first number, of taps of the contact on the surface directed to the third portion of the sequence of characters, displaying, in the user interface:
the one or more graphical user interface elements for changing the one or more metrics associated with the sequence of characters; and
a plurality of options for performing a plurality of operations associated with the third portion of the sequence of characters.

22. An electronic device, comprising:
one or more processors;
memory; and
one or more programs, wherein the one or more programs are stored in the memory and configured to be executed by the one or more processors, the one or more programs including instructions for:
while displaying, in a user interface, a first representation of handwritten content that includes a sequence of characters, detecting, via one or more input devices, a first input corresponding to a request to delete a first portion of the sequence of characters of the first representation of handwritten content, wherein the first portion of the sequence of characters is displayed at a first location in the user interface; and
in response to detecting the first input:
deleting, at the first location in the user interface, the first portion of the sequence of characters of the first representation of the handwritten content;
in accordance with a determination that a second input that includes first handwritten input on a surface directed to at least the first location in the user interface is not detected via the one or more input devices within a threshold amount of time of deleting the first portion of the sequence of characters:
updating display of the first representation of handwritten content to include a second portion, different from the first portion, of the sequence of characters at the at least the first location in the user interface; and
in accordance with a determination that the second input is detected within the threshold amount of time of deleting the first portion of the sequence of characters:
updating display of the first representation of handwritten content to include a first representation of the first handwritten input at the at least the first location in the user interface, without updating display of the first representation of handwritten content to include the second portion of the sequence of characters at the at least the first location in the user interface.

23. A non-transitory computer readable storage medium storing one or more programs, the one or more programs comprising instructions, which when executed by one or more processors of an electronic device, cause the electronic device to perform a method comprising:
while displaying, in a user interface, a first representation of handwritten content that includes a sequence of characters, detecting, via one or more input devices, a first input corresponding to a request to delete a first portion of the sequence of characters of the first representation of handwritten content, wherein the first portion of the sequence of characters is displayed at a first location in the user interface; and
in response to detecting the first input:
deleting, at the first location in the user interface, the first portion of the sequence of characters of the first representation of the handwritten content;
in accordance with a determination that a second input that includes first handwritten input on a surface directed to at least the first location in the user interface is not detected via the one or more input devices within a threshold amount of time of deleting the first portion of the sequence of characters:
updating display of the first representation of handwritten content to include a second portion, different from the first portion, of the sequence of characters at the at least the first location in the user interface; and
in accordance with a determination that the second input is detected within the threshold amount of time of deleting the first portion of the sequence of characters:
updating display of the first representation of handwritten content to include a first representation of the first handwritten input at the at least the first location in the user interface, without updating display of the first representation of handwritten content to include the second portion of the sequence of characters at the at least the first location in the user interface.

24-65. (canceled)
